(19) United States
(12) Patent Application Publication
(10) Pub. No.: US 2024/0230425 A1
(43) Pub. Date: Jul. 11, 2024

(54) PARAMETER RESPONSIVE QUALITY INDICATORS HAVING SHELF-STABLE SUB-ASSEMBLIES

(71) Applicant: VARCODE LTD., Ra'anana (IL)

(72) Inventor: Nemet Yaron, Kdumim (IL)

(21) Appl. No.: 18/561,589

(22) PCT Filed: May 18, 2022
(86) PCT No.: PCT/IL2022/050517

§ 371 Date: Nov. 16, 2023

Related U.S. Application Data
(60) Provisional application No. 63/189,866, filed on May 18, 2021.

(51) Int. Cl. G01K 11/12

(52) U.S. Cl. CPC G01K 11/12

(57) ABSTRACT

A multiplicity of heat responsive quality indicator (HRQI) assemblies, for use in a quality management system for products, each having a plurality of indicator states operative to provide an indication of quality of a product with which the indicator is associated, each HRQI assembly including a shelf-stable, non-heat responsive quality indicator (NHRQI) sub-assembly including at least one coloring material diffuser and at least one indicator template and at least one heat responsive coloring material (HRCM) which is flowable at a temperature exceeding an upper temperature threshold, and which, when injected into the NHRQI sub-assembly, converts the NHRQI sub-assembly to the HRQI assembly, which is responsive to changes in temperature over time in exceedance of the upper temperature threshold, for changing an appearance of the HRQI assembly.

### REFERENCE TO RELATED APPLICATIONS

Reference is made to U.S. Provisional Patent Application Ser. No. 63/189,866, filed May 18, 2021 and entitled “PARAMETER RESPONSIVE QUALITY INDICATORS HAVING SHELF-STABLE SUB-ASSEMBLIES”, the disclosure of which is hereby incorporated by reference and priority of which is hereby claimed.

### FIELD OF THE INVENTION

The present invention relates to quality management systems and methodologies and to indicators useful in such systems and methodologies.

### BACKGROUND OF THE INVENTION

Various types of variable barcoded indicators for indicating exceedance of product affecting parameter thresholds are known.

### SUMMARY OF THE INVENTION

The present invention seeks to provide improved quality management systems and methodologies as well as indicators useful in such systems and methodologies.

There is thus provided in accordance with a preferred embodiment of the present invention, for use in a quality management system for products, a multiplicity of heat responsive quality indicator (HRQI) assemblies, each having a plurality of indicator states operative to provide an indication of quality of a product with which the indicator is associated, each HRQI assembly including a shelf-stable, non-heat responsive quality indicator (NHRQI) sub-assembly including at least one coloring material diffuser and at least one indicator template and at least one heat responsive coloring material (HRCM) which is flowable at a temperature exceeding an upper temperature threshold, and which, when injected into the NHRQI sub-assembly, converts the NHRQI sub-assembly to the HRQI assembly, which is responsive to changes in temperature over time in exceedance of the upper temperature threshold, for changing an appearance of the HRQI assembly.

In accordance with a preferred embodiment of the present invention, the multiplicity of HRQI assemblies are characterized in that the at least one HRCM, once injected into the shelf-stable, NHRQI sub-assembly, is initially maintained under temperature conditions, which are not in exceedance of the upper temperature threshold, such that the at least one HRCM is not flowable.

Preferably, the plurality of indicator states includes a pre-supply visible state, indicating that the at least one HRCM has not yet been injected into the at least one coloring material diffuser of the NHRQI sub-assembly and a post-supply visible state, indicating that the at least one HRCM has been injected into the at least one coloring material diffuser of the NHRQI sub-assembly. Additionally or alternatively, the plurality of indicator states includes at least a first over-temperature visible state, indicating that the at least one HRQI assembly has been exposed to a temperature in exceedance of the upper temperature threshold for at least a first over-temperature cumulative time duration. Additionally, the plurality of indicator states includes at least a second over-temperature visible state, indicating that the HRQI assembly has been exposed to a temperature in exceedance of the upper temperature threshold for at least a second over-temperature cumulative time duration. Additionally, the plurality of indicator states includes at least a third over-temperature visible state, indicating that the HRQI assembly has been exposed to a temperature in exceedance of the upper temperature threshold for at least a third over-temperature cumulative time duration.

In accordance with a preferred embodiment of the present invention the at least one indicator template includes a multiplicity of machine-readable indicia. Additionally, the multiplicity of machine-readable indicia includes a multiplicity of barcodes. Additionally, the changing an appearance of the HRQI assembly includes changing an appearance of at least one of the multiplicity of barcodes. Additionally or alternatively, a single one of the multiplicity of machine-readable indicia is machine readable at all times.

In accordance with a preferred embodiment of the present invention, the indicator template includes at least one human sensible indicium.

Preferably, the HRQI assembly further includes a cold responsive coloring material and the plurality of indicator states includes at least one under-temperature visible state indicating that the HRQI assembly has been exposed to a temperature below a lower temperature threshold for at least an under-temperature time duration. Additionally, the cold responsive coloring material forms part of the at least one indicator template, for changing an appearance of the HRQI assembly. Additionally or alternatively, the cold responsive coloring material forms part of at least one human sensible indicium, for changing an appearance of the HRQI assembly.

In accordance with a preferred embodiment of the present invention the NHRQI sub-assembly also includes an aperture for injecting the HRCM therethrough. Additionally, the aperture is sealed by adhering the HRQI assembly to a container.

There is also provided in accordance with another preferred embodiment of the present invention, for use in a quality management system for products, a multiplicity of heat responsive quality indicator (HRQI) assemblies, each having a plurality of indicator states operative to provide an indication of quality of a product with which the indicator is associated, each HRQI assembly including a shelf-stable, non-heat responsive quality indicator (NHRQI) sub-assembly including at least one coloring material diffuser and at least one indicator template, a first heat responsive coloring material (HRCM) which is flowable at a first temperature exceeding a first upper temperature threshold and a second heat responsive coloring material (HRCM) which is flowable at a second temperature exceeding a second upper temperature threshold, wherein the first HRCM and the second HRCM, when injected into the at least one coloring material diffuser of the NHRQI sub-assembly, convert the NHRQI sub-assembly to the HRQI assembly, the HRQI assembly being responsive to changes in temperature over time in exceedance of each of the first upper temperature threshold and the second upper temperature threshold, for changing an appearance of the HRQI assembly.

In accordance with a preferred embodiment of the present invention each of the HRQI assemblies further includes an additional coloring material diffuser for the diffusion of the second HRCM.

In accordance with a preferred embodiment of the present invention the NHRQI sub-assembly further includes a first aperture for injecting the first HRCM therethrough and a second aperture for injecting the second HRCM therethrough.

There is further provided in accordance with yet another preferred embodiment of the present invention, for use in a quality management system for products, a multiplicity of heat responsive quality indicator (HRQI) assemblies each having a plurality of indicator states operative to provide an indication of quality of a product with which the indicator is associated, each HRQI assembly including an initial heat responsive quality indicator (IHRQI) sub-assembly including at least one indicator template and at least a first heat responsive coloring material (HRCM) which is flowable at a first temperature exceeding a first upper temperature threshold and a second heat responsive coloring material (HRCM) which is flowable at a second temperature exceeding a second upper temperature threshold, the second HRCM, when injected into the IHRQI sub-assembly, converting the IHRQI sub-assembly to the HRQI assembly, the HRQI assembly being responsive to changes in temperature over time in exceedance of each of the first upper temperature threshold and the second upper temperature threshold, for changing an appearance of the HRQI assembly.

In accordance with a preferred embodiment of the present invention each of the IHRQI sub-assemblies further includes a coloring material diffuser for the diffusion of at least one of the first HRCM and the second HRCM. Preferably, each of the HRQI assemblies further includes a first coloring material diffuser for the diffusion of the first HRCM and a second coloring material diffuser for the diffusion of the second HRCM. Additionally or alternatively, the IHRQI sub-assembly further includes at least one aperture for injecting the second HRCM therethrough.

There is still further provided in accordance with still another preferred embodiment of the present invention a quality management system for products including a multiplicity of heat responsive quality indicator (HRQI) assemblies, whose appearance is changeable and being operative to provide a machine-readable indication of exceedance of at least one threshold and an indicator reader operative to read the HRQI assemblies and to provide output indications of product quality status, each of the multiplicity of HRQI assemblies including a shelf-stable, non-heat responsive quality indicator (NHRQI) sub-assembly including at least one coloring material diffuser and at least one indicator template and a heat responsive coloring material (HRCM) which is flowable at a temperature exceeding an upper temperature threshold, and which, when injected into the NHRQI sub-assembly, converts the NHRQI sub-assembly to an HRQI assembly, which is responsive to changes in temperature over time in exceedance of the upper temperature threshold, for changing an appearance of the indicator.

In accordance with a preferred embodiment of the present invention the multiplicity of HRQI assemblies are characterized in that the HRCM, once injected into the shelf-stable, NHRQI sub-assembly, is initially maintained under temperature conditions, which are not in exceedance of the upper temperature threshold, such that the HRCM is not flowable.

In accordance with a preferred embodiment of the present invention the appearance of the HRQI assemblies is further operative to provide a machine-readable indication that the HRCM has not yet been injected into the at least one coloring material diffuser of the NHRQI sub-assembly and a machine-readable indication that the HRCM has been injected into the at least one coloring material diffuser of the NHRQI sub-assembly.

In accordance with a preferred embodiment of the present invention the machine-readable indication of exceedance of at least one threshold includes at least one of a first machine-readable indication of exceedance of a first threshold and a second machine-readable indication of exceedance of a second threshold. Additionally, the first threshold includes an upper temperature threshold and at least a first over-temperature cumulative time duration and the second threshold includes an upper temperature threshold and at least a second over-temperature cumulative time duration.

In accordance with a preferred embodiment of the present invention the machine-readable indication of exceedance of at least one threshold further includes a third machine-readable indication of exceedance of a third threshold. Additionally, the third threshold includes an upper temperature threshold and at least a third over-temperature cumulative time duration.

Preferably, the indicator template includes a multiplicity of machine-readable indicia. Additionally, the multiplicity of machine-readable indicia includes a multiplicity of barcodes. Additionally, the changing an appearance of the HRQI assembly includes changing an appearance of at least one of the multiplicity of barcodes. Additionally or alternatively, a single one of the multiplicity of machine-readable indicia is machine readable at all times.

In accordance with a preferred embodiment of the present invention the indicator template includes at least one human sensible indicium.

Preferably, the HRQI assembly further includes a cold responsive coloring material and the appearance of the HRQI assembly is operative to provide a machine-readable indication that the HRQI assembly has been exposed to a temperature below a lower temperature threshold for at least an under-temperature time duration. Additionally, the cold responsive coloring material forms part of at least one changeable barcode, for changing an appearance of the HRQI assembly. Additionally or alternatively, the cold responsive coloring material forms part of at least one human sensible indicium, for changing an appearance of the HRQI assembly.

In accordance with a preferred embodiment of the present invention the NHRQI sub-assembly also includes an aperture for injecting the HRCM therethrough. Additionally, the aperture is sealed by adhering the HRQI assembly to a container.

There is further provided in accordance with yet another preferred embodiment of the present invention a system for manufacture of heat responsive quality indicator (HRQI) assemblies including a non-heat responsive quality indicator (NHRQI) sub-assembly provider, providing a multiplicity of shelf-stable, NHRQI sub-assemblies, each of the sub-assemblies including at least one coloring material diffuser and at least one indicator template and a heat responsive coloring material supplier (HRCMS) operative to inject a heat responsive coloring material (HRCM) into each of the multiplicity of shelf-stable, NHRQI sub-assemblies, the HRCM being flowable at a temperature exceeding an upper temperature threshold, and which, when injected into the NHRQI sub-assembly by the HRCMS, converts the NHRQI sub-assembly to an HRQI assembly, which is responsive to changes in temperature over time in exceedance of the upper temperature threshold, for changing an appearance of the indicator and is operative to provide a machine-readable indication of exceedance of at least one threshold.

In accordance with a preferred embodiment of the present invention the HRCMS also includes a heating assembly, operative to maintain the HRCM at a temperature at which the HRCM is flowable during the injection thereof into the NHRQI sub-assembly.

In accordance with a preferred embodiment of the present invention the system also includes a container association module operative to affix the HRQI assembly to a product container. Additionally, the HRCM is injected into the NHRQI sub-assembly immediately prior to affixing the HRQI assembly to a product package.

In accordance with a preferred embodiment of the present invention the system also includes a container association module operative to affix the NHRQI sub-assembly to a product package and the HRCM is injected into the NHRQI sub-assembly following affixing the NHRQI sub-assembly to a product package.

Preferably, the HRCMS includes the container association module. Alternatively, the container association module is separate from the HRCMS.

In accordance with a preferred embodiment of the present invention the system also includes an HRCM cooler operative to lower a temperature of the HRCM to a temperature below the upper temperature threshold, such that the HRCM is not flowable, after the injection thereof into the NHRQI sub-assembly. Preferably, the HRCMS includes the HRCM cooler. Alternatively, the HRCM cooler is separate from the HRCMS.

In accordance with a preferred embodiment of the present invention the system also includes an indicator reader operative to read the HRQI assembly and to provide output indications of a status of the HRQI assembly.

There is even further provided in accordance with still another preferred embodiment of the present invention a quality management system for products including a multiplicity of heat responsive quality indicator (HRQI) assemblies, whose appearance is changeable and being operative to provide a machine-readable indication of exceedance of at least one threshold and an indicator reader operative to read the HRQI assemblies and to provide output indications of product quality status, each of the multiplicity of HRQI assemblies including a shelf-stable, non-heat responsive quality indicator (NHRQI) sub-assembly including at least one coloring material diffuser and at least one indicator template, a first heat responsive coloring material (HRCM) which is flowable at a first temperature exceeding a first upper temperature threshold and a second heat responsive coloring material (HRCM) which is flowable at a second temperature exceeding a second upper temperature threshold, the first HRCM and the second HRCM, when injected into the at least one coloring material diffuser of the NHRQI sub-assembly, converting the NHRQI sub-assembly to the HRQI assembly, the HRQI assembly being responsive to changes in temperature over time in exceedance of each of the first upper temperature threshold and the second upper temperature threshold, for changing an appearance of the HRQI assembly.

In accordance with a preferred embodiment of the present invention the system also includes a quality indication computer operative to communicate with the indicator reader. Additionally, the system also includes a database, including at least an event description table and a product status table.

In accordance with a preferred embodiment of the present invention the at least one coloring material diffuser includes a first coloring material diffuser for the diffusion of the first HRCM and a second coloring material diffuser for the diffusion of the second HRCM.

Preferably, the NHRQI sub-assembly also includes a first aperture for injecting the first HRCM therethrough and a second aperture for injecting the second HRCM therethrough. Additionally, each of the first aperture and the second aperture are sealed by adhering the HRQI assembly to a container.

There is also provided in accordance with another preferred embodiment of the present invention a method of quality management for products including associating a multiplicity of heat responsive quality indicator (HRQI) assemblies, each of whose appearance is changeable and is operative to provide an indication of exceedance of at least an upper temperature threshold, with a corresponding multiplicity of product packages, each of the multiplicity of HRQI assemblies including a shelf-stable, non-heat responsive quality indicator (NHRQI) sub-assembly including at least one indicator template and a heat responsive coloring material (HRCM) which is flowable at a temperature exceeding the upper temperature threshold, and which, when injected into the NHRQI sub-assembly, converts the NHRQI sub-assembly to an HRQI assembly, which is responsive to changes in temperature over time in exceedance of the upper temperature threshold for changing an appearance of the indicator template, the associating including injecting the HRCM into the shelf-stable, NHRQI sub-assembly when the HRCM is in a flowable state, immediately after the injecting, lowering a temperature of the HRCM to a temperature below the upper temperature threshold, such that the HRCM is not flowable, thereby creating the HRQI assemblies, whose appearance is changeable and is operative to provide an indication of exceedance of the upper temperature threshold and affixing the HRQI assembly to a product package.

Preferably, the injecting the HRCM into the shelf-stable, NHRQI sub-assembly includes maintaining the HRCM at a temperature at which the HRCM is flowable during the injecting thereof into the NHRQI sub-assembly. Additionally, the maintaining the HRCM at a temperature at which the HRCM is flowable during the injecting thereof into the NHRQI sub-assembly includes heating the HRCM.

In accordance with a preferred embodiment of the present invention the associating includes injecting the HRCM into the shelf-stable, NHRQI sub-assembly immediately prior to the affixing.

Preferably, the lowering the temperature of the HRCM and the affixing include a single step. Alternatively, the lowering the temperature of the HRCM and the affixing include separate steps.

In accordance with a preferred embodiment of the present invention each of the NHRQI sub-assemblies further includes an aperture and the injecting includes injecting the HRCM into the NHRQI sub-assembly through the aperture. Additionally, the affixing the HRQI assembly to the product package also includes sealing the aperture, preventing an egress of the HRCM therefrom.

In accordance with a preferred embodiment of the present invention the appearance of the indicator template is further operative to provide a machine-readable indication that the HRCM has not yet been injected into the NHRQI sub-assembly and a machine-readable indication that the HRCM has been injected into the NHRQI sub-assembly.

In accordance with a preferred embodiment of the present invention the indication of exceedance of at least an upper temperature threshold includes at least one of a first machine-readable indication of exceedance of a first upper temperature threshold and a second machine-readable indication of exceedance of a second upper temperature threshold. Additionally, the exceedance of the first upper temperature threshold includes exceeding the first upper temperature threshold for at least a first over-temperature cumulative time duration and the exceedance of the second upper temperature threshold includes exceeding the second upper temperature threshold for at least a second over-temperature cumulative time duration.

In accordance with a preferred embodiment of the present invention the machine-readable indication of exceedance of at least one upper temperature threshold further includes a third machine-readable indication of exceedance of a third upper temperature threshold. Additionally, the exceedance of the third upper temperature threshold includes exceeding the third upper temperature threshold for at least a third over-temperature cumulative time duration.

In accordance with a preferred embodiment of the present invention the indicator template includes a multiplicity of machine-readable indicia. Additionally, the multiplicity of machine-readable indicia includes a multiplicity of barcodes. Additionally, the changing an appearance of the HRQI assembly includes changing an appearance of at least one of the multiplicity of barcodes. Preferably, a single one of the multiplicity of machine-readable indicia is machine readable at all times.

In accordance with a preferred embodiment of the present invention the indicator template includes at least one human sensible indicium.

In accordance with a preferred embodiment of the present invention the HRQI assembly further includes a cold responsive coloring material and the appearance of the HRQI assembly is operative to provide a machine-readable indication that the HRQI assembly has been exposed to a temperature below a lower temperature threshold for at least an under-temperature time duration. Additionally, the cold responsive coloring material forms part of at least one changeable barcode, for changing an appearance of the HRQI assembly. Additionally or alternatively, the cold responsive coloring material forms part of at least one human sensible indicium, for changing an appearance of the HRQI assembly.

There is still further provided in accordance with yet another preferred embodiment of the present invention a method of quality management for products including associating a multiplicity of heat responsive quality indicator (HRQI) assemblies, each of whose appearance is changeable and is operative to provide an indication of exceedance of at least a first upper temperature threshold and a second upper temperature threshold, with a corresponding multiplicity of product packages, each of the multiplicity of HRQI assemblies including a shelf-stable, non-heat responsive quality indicator (NHRQI) sub-assembly including at least one indicator template, a first heat responsive coloring material (HRCM) which is flowable at a first temperature exceeding the first upper temperature threshold and a second heat responsive coloring material (HRCM) which is flowable at a second temperature exceeding the second upper temperature threshold, the first HRCM and the second HRCM, when injected into the NHRQI sub-assembly, converting the NHRQI sub-assembly to an HRQI assembly, the HRQI assembly being responsive to changes in temperature over time in exceedance of each of the first upper temperature threshold and the second upper temperature threshold for changing an appearance of the indicator template; the associating including injecting the first HRCM and the second HRCM into the shelf-stable, NHRQI sub-assembly when the first HRCM and the second HRCM are in a flowable state, immediately after the injecting, lowering a temperature of the first HRCM and the second HRCM to a temperature below the first upper temperature threshold and the second upper temperature threshold, such that the first HRCM is not flowable and the second HRCM is not flowable, thereby creating the HRQI assemblies, whose appearance is changeable and is operative to provide an indication of exceedance of the upper temperature threshold and affixing the HRQI assembly to a product package.

In accordance with a preferred embodiment of the present invention each of the HRQI assemblies further includes at least one coloring material diffuser for the diffusion of at least one of the first HRCM and the second HRCM.

Preferably, the injecting the first HRCM and the second HRCM into the shelf-stable, NHRQI sub-assembly is performed prior to the affixing the HRQI assembly to the product package.

There is yet further provided in accordance with a further preferred embodiment of the present invention a method of quality management for products including providing a shelf-stable, non-heat responsive quality indicator (NHRQI) sub-assembly including at least one indicator template, injecting, at an injection temperature, a heat responsive coloring material (HRCM) which is flowable at a temperature exceeding an upper temperature threshold into the NHRQI sub-assembly, the injection temperature exceeding the upper temperature threshold, thereby converting the NHRQI sub-assembly to a heat responsive quality indicator (HRQI) assembly, which is operative to display different ones of a plurality of indicator states in response to changes in temperature over time in exceedance of the upper temperature threshold for changing an appearance of the indicator template and affixing the HRQI assembly to a product package.

In accordance with a preferred embodiment of the present invention the HRCM is injected into the NHRQI sub-assembly immediately prior to affixing the HRQI assembly to the product package.

In accordance with a preferred embodiment of the present invention the affixing the HRQI assembly to the product package further includes lowering the temperature of the HRCM.

In accordance with a preferred embodiment of the present invention the method includes lowering the temperature of the HRCM prior to the affixing the HRQI assembly to the product package.

In accordance with a preferred embodiment of the present invention the NHRQI sub-assembly further includes an aperture and the injecting includes injecting the HRCM into the NHRQI sub-assembly through the aperture. Additionally, the affixing the HRQI assembly to the product package also includes sealing the aperture, preventing an egress of the HRCM therefrom.

In accordance with a preferred embodiment of the present invention the appearance of the HRQI assembly is further operative to provide a machine-readable indication that the HRCM has not yet been injected into the NHRQI sub-assembly and a machine-readable indication that the HRCM has been injected into the NHRQI sub-assembly.

Preferably, the plurality of indicator states includes at least a first over-temperature visible state, indicating that the HRQI assembly has been exposed to a temperature in exceedance of the upper temperature threshold for at least a first over-temperature cumulative time duration. Additionally, the plurality of indicator states includes at least a second over-temperature visible state, indicating that the HRQI assembly has been exposed to a temperature in exceedance of the upper temperature threshold for at least a second over-temperature cumulative time duration. Additionally, the plurality of indicator states includes at least a third over-temperature visible state, indicating that the HRQI assembly has been exposed to a temperature in exceedance of the upper temperature threshold for at least a third over-temperature cumulative time duration.

In accordance with a preferred embodiment of the present invention the indicator template includes a multiplicity of machine-readable indicia. Additionally, the multiplicity of machine-readable indicia includes a multiplicity of barcodes. Additionally, the changing an appearance of the HRQI assembly includes changing an appearance of at least one of the multiplicity of barcodes. Preferably, a single one of the multiplicity of machine-readable indicia is machine readable at all times.

In accordance with a preferred embodiment of the present invention the indicator template includes at least one human sensible indicium.

In accordance with a preferred embodiment of the present invention the HRQI assembly further includes a cold responsive coloring material and the appearance of the HRQI assembly is operative to provide a machine-readable indication that the HRQI assembly has been exposed to a temperature below a lower temperature threshold for at least an under-temperature time duration. Additionally, the cold responsive coloring material forms part of at least one changeable barcode, for changing an appearance of the HRQI assembly. Additionally or alternatively, the cold responsive coloring material forms part of at least one human sensible indicium, for changing an appearance of the HRQI assembly.

There is also provided in accordance with yet another preferred embodiment of the present invention a method of quality management for products including providing a shelf-stable, non-heat responsive quality indicator (NHRQI) sub-assembly including at least one indicator template, injecting, at a first injection temperature, a first heat responsive coloring material (HRCM) which is flowable at a first temperature exceeding a first upper temperature threshold into the NHRQI sub-assembly, injecting, at a second injection temperature, a second heat responsive coloring material (HRCM) which is flowable at a second temperature exceeding a second upper temperature threshold into the NHRQI sub-assembly, the injecting the first HRCM and the injecting the second HRCM converting the NHRQI sub-assembly to an HRQI assembly, the HRQI assembly being operative to display different ones of a plurality of indicator states in response to changes in temperature over time in exceedance of each of the first upper temperature threshold and the second upper temperature threshold for changing an appearance of the indicator template and affixing the HRQI assembly to a product package.

In accordance with a preferred embodiment of the present invention the first injection temperature exceeds the first upper temperature threshold and the second injection temperature exceeds the second upper temperature threshold.

In accordance with a preferred embodiment of the present invention the method also includes heating at least one of the first HRCM and the second HRCM during the injecting thereof into the NHRQI sub-assembly.

Preferably, the injecting the first HRCM and the injecting the second HRCM are both performed prior to the affixing the HRQI assembly to the product package.

There is further provided in accordance with another preferred embodiment of the present invention a quality management system for products including a first multiplicity of first heat responsive quality indicator (HRQI) assemblies, whose appearance is changeable and being operative to provide a machine-readable indication of exceedance of at least one first threshold, each of the first multiplicity of first HRQI assemblies including a first shelf-stable, non-heat responsive quality indicator (NHRQI) sub-assembly including at least one coloring material diffuser and at least one first indicator template and a first heat responsive coloring material (HRCM) which is flowable at a temperature exceeding a first upper temperature threshold, and which, when injected into the first NHRQI sub-assembly, converts the first NHRQI sub-assembly to one of the first HRQI assemblies, which is responsive to changes in temperature over time in exceedance of the first upper temperature threshold, for changing an appearance of the first indicator and a second multiplicity of second heat responsive quality indicator (HRQI) assemblies, whose appearance is changeable and being operative to provide a machine-readable indication of exceedance of at least one second threshold, each of the second multiplicity of second HRQI assemblies including a second shelf-stable, non-heat responsive quality indicator (NHRQI) sub-assembly including at least one coloring material diffuser and at least one second indicator template and a second heat responsive coloring material (HRCM) which is flowable at a temperature exceeding a second upper temperature threshold, and which, when injected into the at least one coloring material diffuser of the second NHRQI sub-assembly, converts the second NHRQI sub-assembly to one of the second HRQI assemblies, which is responsive to changes in temperature over time in exceedance of the second upper temperature threshold, for changing an appearance of the second indicator.

In accordance with a preferred embodiment of the present invention the first multiplicity of first HRQI assemblies are each associated with one of a plurality of product packages, the second multiplicity of second HRQI assemblies are each associated with a container, the container containing at least some of the product packages and a relationship between the first upper temperature threshold and the second upper temperature threshold is at least partially determined by an extent of thermal communication between the product packages contained within the container and an ambient environment to which the second HRQI assembly is exposed.

There is yet further provided in accordance with still another preferred embodiment of the present invention a quality management system for products including a multiplicity of quality parameter responsive quality indicator (QPRQI) assemblies and an indicator reader operative to read the QPRQI assemblies and to provide output indications of product quality status, each of the multiplicity of QPRQI assemblies being responsive to changes in a value of a quality parameter, for changing an appearance of the QPRQI assembly when the quality parameter exceeds a threshold, each of the multiplicity of QPRQI assemblies including a shelf-stable, non-quality parameter responsive quality indicator (NQPRQI) sub-assembly including at least one coloring material diffuser and at least one indicator template and a quality parameter responsive coloring material (QPRCM) which, when injected to the at least one coloring material diffuser of the NQPRQI sub-assembly, converts the NQPRQI sub-assembly to an QPRQI assembly.

In accordance with a preferred embodiment of the present invention the NQPRQI further includes at least one aperture for injecting the QPRCM therethrough.

There is still further provided in accordance with yet a further preferred embodiment of the present invention, for use in a quality management system for products, a multiplicity of heat responsive quality indicator (HRQI) assemblies each operative to provide an indication of quality of a product with which the indicator is associated, each HRQI assembly including a shelf-stable, non-heat responsive quality indicator (NHRQI) sub-assembly and at least one heat responsive coloring material (HRCM), which, when injected into the NHRQI sub-assembly, converts the NHRQI sub-assembly to the HRQI assembly, which is responsive to changes in temperature over time in exceedance of the upper temperature threshold.

In accordance with a preferred embodiment of the present invention the NHRQI further includes at least one aperture for injecting the HRCM therethrough.

### BRIEF DESCRIPTION OF THE DRAWINGS

The present invention will be understood and appreciated more fully from the following detailed description, taken in conjunction with the drawings in which:

FIGS. 1A, 1B, 1C, 1D and 1E together are a simplified illustration of a system and methodology for quality management using a heat responsive quality indicator (HRQI) assembly for indicating elapsed time in temperature history, constructed and operative in accordance with a preferred embodiment of the present invention;

FIG. 2 is a simplified illustration of a heat responsive coloring material supplier (HRCMS) useful in supplying a heat responsive coloring material (HRCM) to a first embodiment of the HRQI assemblies of FIGS. 1A-1E;

FIGS. 3A, 3B, 3C and 3D are simplified illustrations showing a preferred method of assembly of the HRQI assembly of FIGS. 1A-2;

FIGS. 4A, 4B, 4C and 4D are each a simplified illustration of a typical operative use case of the HRQI assembly of FIGS. 2-3D;

FIG. 5 is a simplified illustration of another HRCMS useful in supplying an HRCM to a second embodiment of the HRQI assemblies of FIGS. 1A-1E;

FIGS. 6A, 6B, 6C and 6D together are a simplified illustration of a preferred method of construction of the HRQI assembly of FIGS. 1A-1E and FIG. 5;

FIGS. 7A, 7B, 7C, 7D and 7E together are each a simplified illustration of a typical operative use case of the HRQI assembly of FIGS. 5-6D;

FIG. 8 is a simplified illustration of a heat responsive coloring material supplier (HRCMS) useful in supplying a heat responsive coloring material (HRCM) to an additional embodiment of the HRQI assemblies of FIGS. 1A-1E;

FIGS. 9A, 9B, 9C and 9D are simplified illustrations showing a preferred method of assembly of the HRQI assembly of FIGS. 1A-1E and FIG. 8;

FIGS. 10A, 10B, 10C, 10D and 10E are each a simplified illustration of a typical operative use case of the HRQI assembly of FIGS. 8-9D;

FIG. 11 is a simplified illustration of a heat responsive coloring material supplier (HRCMS) useful in supplying a heat responsive coloring material (HRCM) to an additional embodiment of the HRQI assemblies of FIGS. 1A-1E;

FIGS. 12A, 12B, 12C and 12D are simplified illustrations showing a preferred method of assembly of the HRQI assembly of FIGS. 1A-1E and FIG. 11;

FIGS. 13A, 13B, 13C, 13D, 13E and 13F are each a simplified illustration of a typical operative use case of the HRQI assembly of FIGS. 11-12D;

FIG. 14 is a simplified illustration showing an embodiment of a shelf-stable, non-heat responsive quality indicator (NHRQI) sub-assembly useful in an additional embodiment of the HRQI assemblies of FIGS. 1A-1E;

FIGS. 15A & 15B are each a simplified illustration of a typical operative use case of an HRQI assembly constructed from the NHRQI sub-assembly of FIG. 14;

FIG. 16 is a simplified illustration showing an embodiment of a shelf-stable, non-heat responsive quality indicator (NHRQI) sub-assembly useful in an additional embodiment of the HRQI assemblies of FIGS. 1A-1E; and

FIGS. 17A & 17B are each a simplified illustration of a typical operative use case of an HRQI assembly constructed from the NHRQI sub-assembly of FIG. 16.

### DETAILED DESCRIPTION OF PREFERRED EMBODIMENTS

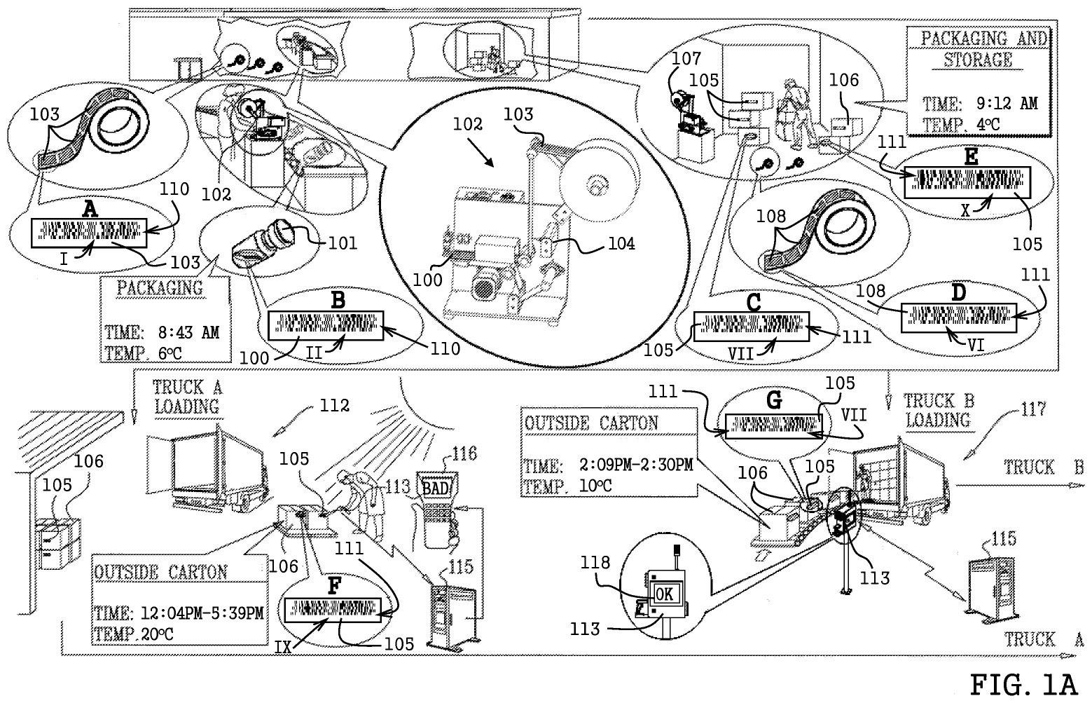

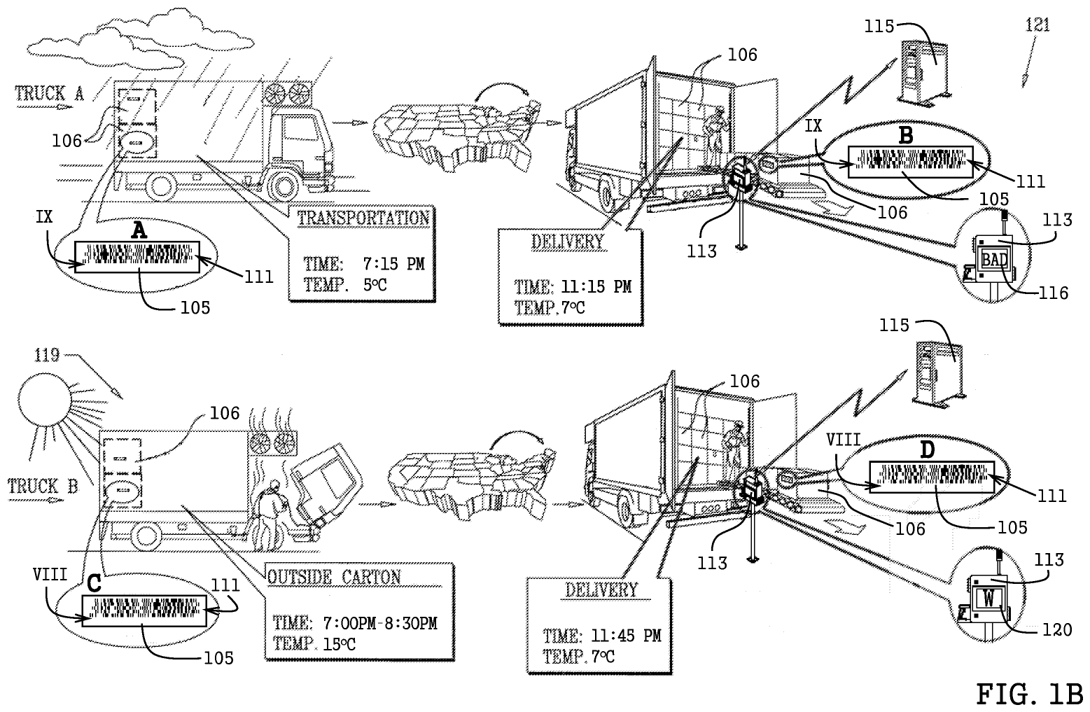

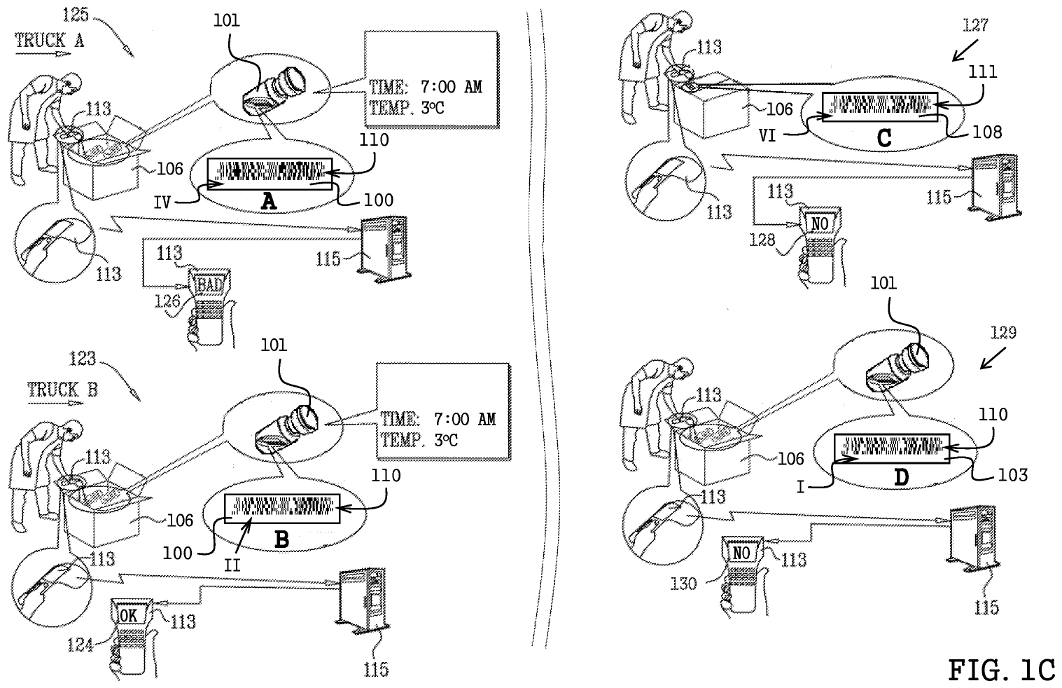

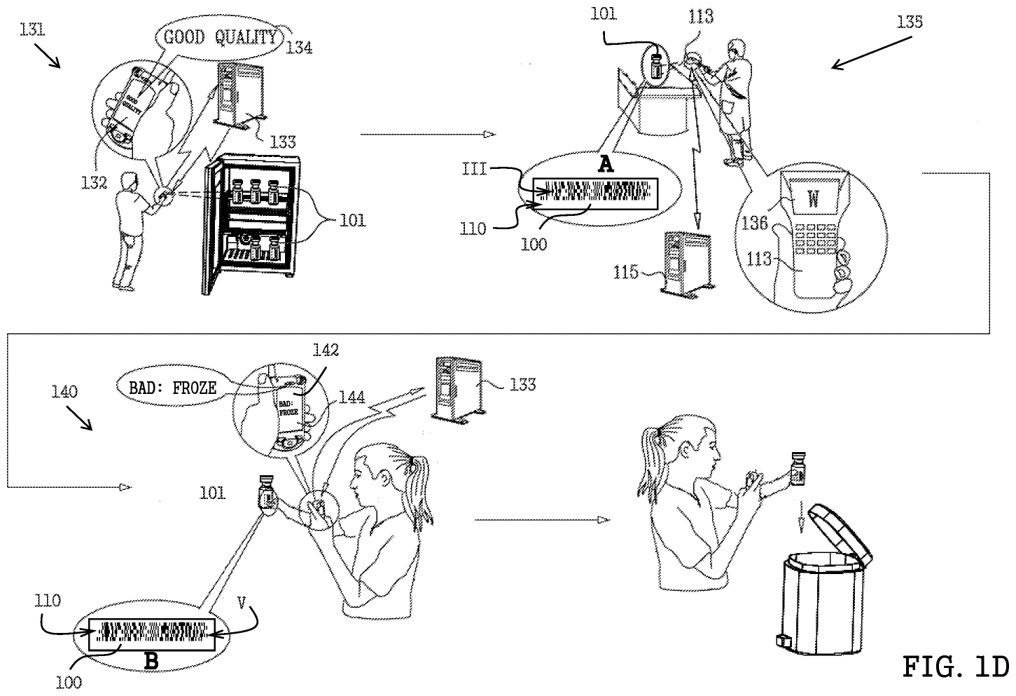

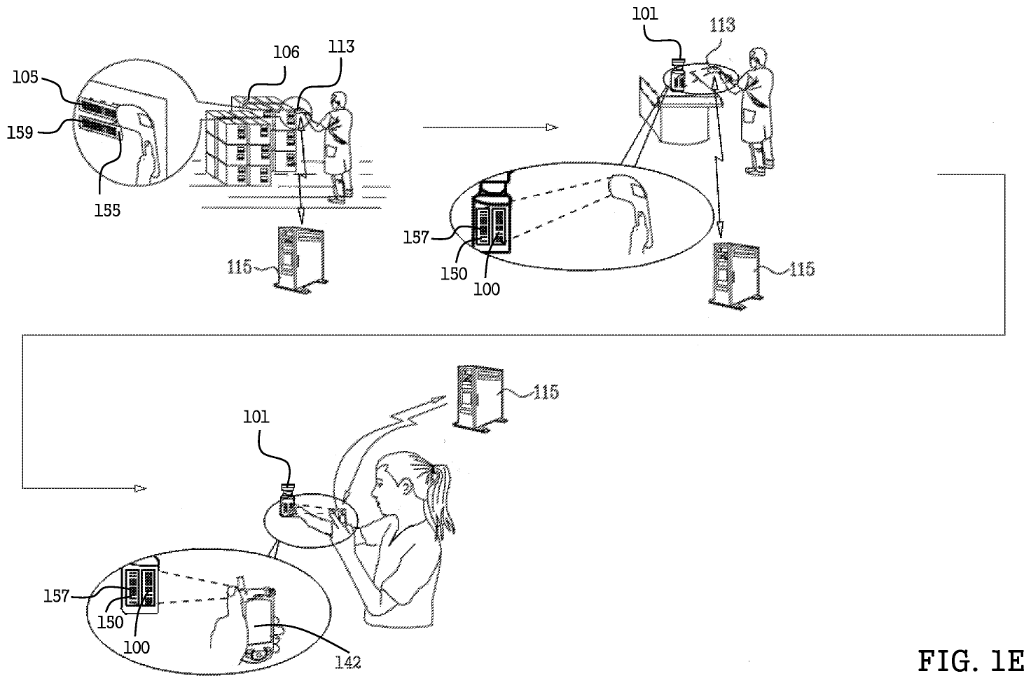

Reference is now made to FIGS. 1A-1E, which, together, are a simplified illustration of a system and methodology for quality management constructed and operative in accordance with a preferred embodiment of the present invention. As seen in FIGS. 1A-1E, there is shown a quality management system and methodology for products including a multiplicity of quality parameter responsive quality indicator (QPRQI) assemblies, such as heat responsive quality indicator (HRQI) assemblies, here shown in the form of changeable barcode indicators, each operative to provide a visible indication, which is preferably machine-readable, and more preferably barcode-reader-readable, indicating an exceedance of at least one threshold by at least one product quality affecting parameter, at least one indicator reader, operative to read the HRQI assemblies and to provide output indications, and a product type responsive indication interpreter, operative to receive the output indications and to provide human sensible, product quality status outputs.

Each of the QPRQI assemblies of the present invention are characterized by a physical appearance that changes when the QPRQI assembly is exposed to a quality parameter either above an upper quality parameter threshold or below a lower quality parameter threshold. For example, as explained in further detail hereinbelow, an appearance of an HRQI changes as a result of the HRQI being exposed to temperatures above an upper temperature threshold for a predetermined time duration or below a lower temperature for a predetermined time duration.

For simplicity and ease of understanding, the terms “upper temperature threshold” and “lower temperature threshold” are used throughout this document. However, it is understood that if the QPRQI assembly or portions thereof are responsive to a quality parameter other than heat, “upper temperature threshold” and “lower temperature threshold” have a meaning of “upper quality parameter threshold” and “lower quality parameter threshold,” respectively, wherein the “quality parameter threshold” is a threshold value of a quality parameter to which the QPRQI or portions thereof are operative to respond. For example, a QPRQI operative to respond to pH may have an upper quality parameter threshold and lower quality parameter threshold which are each defined in accordance with a standard pH scale. Similarly, a QPRQI operative to respond to humidity or moisture may have an upper quality parameter threshold and lower quality parameter threshold which are each defined in accordance with a percentage of water vapor in a given volume of air.

Preferably, in addition to receiving the output indications provided by the indicator reader the indication interpreter may also receive product-related parameters, such as product type, for example “live attenuated influenza vaccine” (LAIV), and product manufacturing date. Additionally or alternatively, the indication interpreter may receive other parameters, for example information relating to the HRQI assembly, such as a range of parameters sensed by the HRQI assembly and the time and place at which at least part of the HRQI assembly was manufactured. Additionally or alternatively, the indication interpreter may also receive parameters relating to the source of the output indications provided, for example, whether the output indications were provided by a hand-held device during inspection, or by a checkout scanner, for example the checkout scanner of a pharmacy or grocery store.

The product-related parameters and the other parameters, such as those relating to the HRQI assembly, may be provided by the HRQI assembly itself or by an additional, separate indicator, such as a barcode-bearing indicator. As a further alternative, these parameters may be provided by, inter alia, sensors, a priori information otherwise available to the indication interpreter or manual entry.

The indication interpreter preferably forms part of, or is otherwise connected to, a quality indication computer, which may be remote from the indicator reader and which preferably includes a decision table providing product quality status outputs based on the output indications provided by the indicator reader and the additional parameters.

It is appreciated that the additional parameters may be provided via another part of the same barcode or by another barcode associated with the same product. Alternatively, the additional parameters may be provided by other methods, such as using RFID technology.

The term “barcode” is used herein to refer to a machine-readable optical code. In the examples in the specification, linear, or one-dimensional, bar codes are illustrated. It is appreciated that the invention may be additionally applicable to two-dimensional bar codes, including, inter alia, QR codes. Similarly, the invention may be applicable to other optical indicators and indicia, particularly, but not limited to, vaccine vial monitors (VVMs), which may be machine-readable, human sensible, or both machine-readable and human sensible.

The HRQI assembly may incorporate a product code, which may include a checksum, such as a European Article Number (EAN) or a Universal Product Code (UPC). The examples shown in the description which follows all illustrate the use of an EAN code. Alternatively, the HRQI assembly may incorporate an Interleaved 2 of 5 (ITF) barcode, Code 128 barcode, Code 32 barcode or any other suitable barcode or optical indicator.

It is appreciated that the fully assembled HRQI assembly is temperature-sensitive and indicates exposure of the HRQI assembly to a temperature, or other suitable quality parameter, in exceedance of a predetermined threshold. The temperature, or other suitable quality parameter, experienced by the HRQI assembly is a useful proxy for a temperature, or other suitable quality parameter, experienced by contents of a package or carton with which the HRQI assembly is associated. Thus, for example, a temperature history of a vial of vaccine can be monitored by monitoring a temperature history of an HRQI assembly affixed to the vial of vaccine.

However, in order for the temperature history of the HRQI assembly to be a useful proxy for the temperature history of the package or carton with which the HRQI assembly is associated, the HRQI assembly must be stored under particular storage conditions before association with the package or carton. For example, an HRQI assembly which indicates exceedance of a first upper temperature threshold and a second upper temperature threshold must be stored at temperatures below both the first upper temperature threshold and a second upper temperature threshold prior to association with a package or carton whose temperature is to be monitored.

It is a particular feature of the present invention that the HRQI assembly of the present invention includes a non-heat responsive portion, such as a non-heat responsive quality indicator (NHRQI) sub-assembly, and a heat responsive portion, such as heat responsive coloring material (HRCM). Preferably, the non-heat responsive portion of the HRQI assembly and the heat responsive portion of the HRQI assembly are stored separately, and are only combined with one another immediately prior to an association of the HQRI assembly with a package whose temperature is to be monitored.

This advantageously lowers the need for temperature-controlled storage of the HRQI assembly, since until the non-heat responsive portion of the HRQI assembly, such as the NHRQI sub-assembly, and the heat responsive portion of the HRQI assembly are combined to form a fully assembled HRQI assembly, both the non-heat responsive portion of the HRQI assembly and the heat responsive portion of the HRQI assembly may be stored at temperatures exceeding a predetermined upper temperature threshold designed to be monitored by the fully assembled HRQI assembly, without affecting the operation or usefulness of the HRQI assembly.

For example, a typical indicator which is operative to provide indications of exceedance of 8 degrees Celsius for a predetermined time duration must be stored below 8 degrees prior to associated with a package or carton. Otherwise, a user cannot differentiate between an exceedance of 8 degrees Celsius by the HRQI assembly alone or by the HRQI assembly and the package or carton together. Storing HRQI assemblies at temperatures below 8 degrees Celsius, however, can be onerous and expensive.

In contrast, an HRQI assembly of the present invention which is operative to provide indications of exceedance of 8 degrees Celsius for a predetermined time duration is provided to a maker, distributor or user of a package or carton as a separate heat-responsive portion and non-heat responsive portion. Advantageously, both the heat-responsive portion of the HRQI assembly and the non-heat responsive portion of the HRQI assembly of the present invention can be stored at temperatures in exceedance of 8 degrees Celsius for an extended period of time without affecting the operation or usefulness of the HRQI assembly. As described hereinbelow, the heat-responsive portion of the HRQI assembly and the non-heat responsive portion of the HRQI assembly are preferably combined to form a fully assembled HRQI assembly substantially immediately prior to an association of the HRQI assembly with a package or carton, and only after the HRQI assembly is fully assembled does the HRQI assembly begin to monitor temperature history.

The term “immediately prior to” is used herein to refer to a relatively short time period prior to an event, such as a time period of less than one hour, less than 45 minutes, less than 30 minutes, less than 15 minutes, less than 10 minutes, less than 5 minutes, less than 3 minutes, less than 1 minute, less than 30 seconds, less than 10 seconds, or less than 1 second.

Turning now to FIGS. 1A-1E, the present invention is illustrated in the context of a typical application, here a vaccine processing plant and distribution chain. A heat responsive quality indicator (HRQI) assembly 100, which is preferably machine-readable, but need not be, is attached to or otherwise incorporated into each of a plurality of packages 101, each of which is embodied here as a vial, such as a vaccine vial. Package 101 bearing HRQI assembly 100 is typically an individual package suitable for use by an end-user, such as a medical practitioner or a patient. It is appreciated that in the illustrated embodiment, the contents of package 101 are sensitive to low temperatures, and should not be used if package 101 has ever been frozen or exposed to temperatures of 0° C. (32° F.) or lower. Additionally, in the illustrated embodiment, the contents of package 101 are sensitive to elevated temperatures, and should not be used if package 101 has been exposed to a predetermined upper temperature threshold for an over-temperature cumulative time duration.

It is appreciated that although package 101 is exemplified herein with reference to FIGS. 1A-7E as a vial, such as a vaccine vial, package 101 may be any suitable package, including a package containing, inter alia, at least one of a food product, a beverage product, a medical product, a scientific product, a manufacturing product, a biological specimen and a botanical product.

In accordance with a preferred embodiment of the present invention, a suitable heat responsive coloring material supplier (HRCMS), such as an HRCMS indicated by reference numeral 102, supplies a heat responsive coloring material (HRCM) to HRQI assemblies 100 at the same location as that at which HRQI assemblies 100 are associated with packages 101. The HRCM is characterized by a viscosity and melting point such that the HRCM is flowable at temperatures above an upper temperature threshold and is not flowable at temperatures below the upper temperature threshold.

In a preferred embodiment of the present invention, the association of HRQI assembly 100 with package 101 is embodied as an affixation of HRQI assembly 100 to package 101, and more particularly as an adherence of HRQI assembly 100 to package 101. Preferably, HRCMS 102 is operative to be used as part of an automated assembly system, such as a conveyer belt system. However, HRCMS 102 may also be used as part of a manual assembly system, such as described hereinbelow.

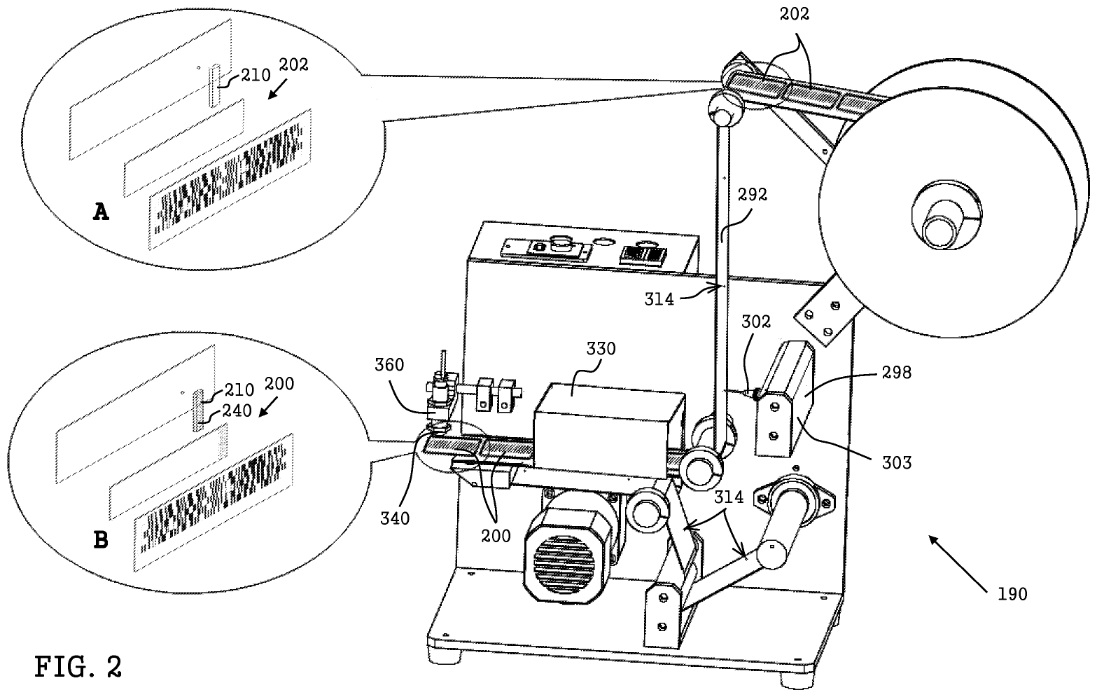

As is described in more detail hereinbelow with reference to FIGS. 2-3D and 5-6D, HRCMS 102 preferably supplies the HRCM to a shelf-stable, non-heat responsive quality indicator (NHRQI) sub-assembly 103, thereby producing HRQI assembly 100. Preferably, HRCMS 102 supplies the HRCM to the NHRQI sub-assembly 103 by injecting the HRCM into the NHRQI sub-assembly 103. Preferably, HRQI assembly 100 is produced immediately prior to associating HQRI assembly 100 with package 101. In a preferred embodiment of the present invention, HRCMS 102 both produces HRQI assembly 100, by supplying the HRCM to NHRQI sub-assembly 103, and associates HRQI assembly 100 with package 101, preferably by affixing HRQI assembly 100 to package 101, and more preferably by adhering HRQI assembly 100 to package 101. In a preferred embodiment of the present invention, HRCMS 102 uses an injection module 104 to inject the HRCM into NHRQI sub-assembly 103. Preferably, injection module 104 includes a heating assembly, such as a resistive heating assembly, thereby maintaining the HRCM at a temperature at which the HRCM is flowable during the supply thereof to NHRQI sub-assembly 103.

It is appreciated that as used herein, “heat responsive” is used to indicate an element or system that changes as a result of heat, wherein “heat” is used to indicate a temperature exceeding an upper temperature threshold, such as a temperature at which the HRCM is flowable. Similarly, as used herein, “non-heat responsive” is used to indicate an element or system that does not change as a result of heat, wherein “heat” is used to indicate a temperature exceeding an upper temperature threshold, such as a temperature at which the HRCM is flowable.

For simplicity and ease of understanding, “heat responsive” is used throughout this document. However, it is understood that if the QPRQI assembly or portions thereof are responsive to a quality parameter other than heat, “heat responsive” has a meaning of “quality parameter responsive,” wherein the “quality parameter” is a quality parameter to which the QPRQI or portions thereof are operative to respond, such as, inter alia, moisture, force, pressure, pH and elapsed time. For example, descriptions of NHRQI sub-assemblies and initial heat responsive quality indicator (IHRQI) sub-assemblies forming part of HRQI assemblies are understood to include respective non-quality parameter responsive quality indicator (NQPRQI) sub-assemblies and initial quality parameter responsive quality indicator (IQPRQI) sub-assemblies forming part of QPRQI assemblies.

Additionally, as used herein, “shelf-stable” is used to describe a product or an indicator which can be readily stored under typical warehouse conditions, such as under a standard range of values of temperature, pH, humidity and pressure, to which human beings are typically exposed, without any appreciable loss of functionality or shortening of shelf-life of the product or the indicator. For example, as used herein “shelf-stable” and “non-heat responsive” quality indicators sub-assemblies do not require refrigeration prior to being included in a heat-responsive quality indicator assembly.

As seen in FIG. 1A, an additional heat responsive quality indicator (HRQI) assembly 105, which is preferably similar to or the same as HRQI assemblies 100, is associated with a carton 106 containing multiple packages 101 bearing HRQI assemblies 100. In a preferred embodiment of the present invention, the association of HRQI assembly 105 with carton 106 is embodied as an affixation of HRQI assembly 105 to carton 106, and more particularly as an adherence of HRQI assembly 105 to carton 106. Preferably, HRQI assembly 105 is produced immediately prior to affixing HQRI assembly 105 to carton 106.

It is appreciated that carton 106 may be formed of cardboard, but need not be. More generally, carton 106 is preferably a suitable container containing one, and more typically a plurality of, packages 101. For example, carton 106 may be embodied as, inter alia, a box, a bag, an envelope, a polystyrene foam container, a crate, a barrel, a drum, a pallet and a shipping container.

Preferably a heat responsive coloring material supplier (HRCMS), such as an HRCMS indicated by reference numeral 107, supplies an HRCM to HRQI assemblies 105 at the same location as that at which HRQI assemblies 105 are associated with cartons 106. Typically, HRCMS 107 is similar to HRCMS 102, but may be placed at a location which is different from the location of HRCMS 102. In a preferred embodiment of the present invention, the HRQI assembler uses an injection module to inject the HRCM into a shelf-stable, NHRQI sub-assembly 108. Preferably, the injection module of HRCMS 107 includes a heating assembly, such as a resistive heating assembly, thereby maintaining the HRCM at a temperature at which the HRCM is flowable during the supply thereof to NHRQI sub-assembly 108. Alternatively, the HRCM may be injected into NHRQI sub-assemblies 108 by HRCMS 102.

As seen in the example illustrated in FIG. 1A, HRCMS 107 is a stand-alone system, and is operative to be used as part of a manual assembly system, such as an assembly system wherein a worker manually retrieves an HRQI assembly 105 from HRCMS 107 for manual association with a carton 106. In another embodiment of the present invention, HRCMS 107 is operative to be used as part of an automated assembly system, such as a conveyer belt system. In such an automated embodiment, HRCMS 107 preferably both produces HRQI assemblies 105, by supplying the HRCM to NHRQI sub-assemblies 108, and associates each HRQI assembly 105 with a carton 106, preferably by affixing HRQI assemblies 105 to corresponding cartons 106, and more preferably by adhering HRQI assemblies 105 to corresponding cartons 106.

Different types of HRQI assemblies 100 and 105 may be employed for different types of packages. For example, HRQI assembly 105 used on carton 106 containing individual packages 101 may be more or less accurate than or have a larger or smaller dynamic range of indications than HRQI assembly 100 used on individual package 101. Thus, HRQI assembly 105 may respond to a larger or smaller dynamic range of temperatures and/or times than that to which an HRQI assembly 100 responds. Additionally or alternatively, HRQI assembly 105 associated with a carton 106 may include an indicator capable of indicating exceedance of additional thresholds, not included in HRQI assemblies 100 associated with individual packages 101 contained therein, or fewer thresholds than HRQI assemblies 100 associated with individual packages 101 contained therein.

In one embodiment of the present invention, a relationship between the dynamic range of temperatures and/or times to which an HRQI assembly 105 responds and the dynamic range of temperatures and/or times to which an HRQI assembly 100 responds is at least partially determined by an extent of thermal communication between a package 101 inside carton 106 and an ambient environment to which HRQI assembly 105 is exposed. Thus, for example, if a carton 106 has a relatively high thermal conductance, the dynamic range of temperatures and/or times to which an HRQI assembly 105 responds and the dynamic range of temperatures and/or times to which an HRQI assembly 100 responds are preferably fairly similar to one another. However, if a carton 106 has a relatively low thermal conductance, the dynamic range of temperatures and/or times to which an HRQI assembly 105 responds and the dynamic range of temperatures and/or times to which an HRQI assembly 100 responds are preferably fairly dissimilar to one another, more specifically HRQI assembly 105 is preferably more tolerant of extreme temperatures and times than is a corresponding HRQI assembly 100.

As described in more detail hereinbelow with reference to FIGS. 2-7E, in the illustrated embodiment of FIGS. 1A-1E, NHRQI sub-assemblies 103 and HRQI assemblies 100 each include a plurality of barcodes 110. Similarly, NHRQI sub-assemblies 108 and HRQI assemblies 105 each include a plurality of barcodes 111. As seen in FIGS. 1A-1E, HRQI assemblies 100 preferably have a pre-supply visible state I, as seen in enlargement circle A of FIG. 1A, a post-supply visible state II, as seen in enlargement circles B of FIG. 1A and B of FIG. 1C, and a first over-temperature visible state III, as seen in enlargement circle A of FIG. 1D, indicating an exceedance of an upper temperature threshold, for example 8 degrees Celsius, for at least a first over-temperature cumulative time duration, for example one hour. HRQI assemblies 100 preferably also have a second over-temperature visible state IV, as seen in enlargement circle A of FIG. 1C, indicating an exceedance of the upper temperature threshold for at least a second over-temperature cumulative time duration, for example four hours.

In the embodiment illustrated in FIGS. 1A-1E, HRQI assemblies 100 further have an under-temperature visible state V, as seen in enlargement circle B of FIG. 1D, which indicates an exposure to a temperature below a lower temperature threshold, for example 2 degrees Celsius, for an under-temperature time duration. Each of the lower temperature threshold and the under-temperature time duration is preferably selected based on specific parameters of the package 101 to be monitored by the HRQI assembly 100 associated therewith. In one embodiment of the present invention, the under-temperature time duration is very short, preferably less than 60 seconds, more preferably less than 30 seconds, more preferably less than 15 seconds, even more preferably less than 10 seconds and most preferably less than 5 seconds. In another embodiment of the present invention, the under-temperature time duration is relatively long, and may be, for example, 5 minutes, 10 minutes, 20 minutes, 30 minutes or 45 minutes.

In one embodiment of the present invention, the under-temperature time duration is a cumulative time duration. In this embodiment, if the under-temperature time duration is, for example, 30 minutes, when HRQI assembly 100 is exposed to a temperature below the lower temperature threshold for 10 minutes, then is exposed to a temperature above the lower temperature threshold for an hour, and thereafter is exposed to a temperature below the lower temperature threshold for an additional 20 minutes, then HRQI assembly 100 assumes under-temperature visible state V.

In another embodiment of the present invention, HRQI assembly 100 only assumes under-temperature visible state V when exposed to a temperature below the lower temperature threshold for an uninterrupted under-temperature time duration. In this embodiment, if the under-temperature time duration is, for example 30 minutes, when HRQI assembly 100 is exposed to a temperature below the lower temperature threshold for 10 minutes, then is exposed to a temperature above the lower temperature threshold for an hour, and only thereafter is exposed to a temperature below the lower temperature threshold for an additional 20 minutes, then HRQI assembly 100 does not assume under-temperature visible state V. However, when HRQI assembly 100 is exposed to a temperature below the lower temperature threshold for an uninterrupted interval of 30 minutes, then HRQI assembly 100 does assume under-temperature visible state V.

In an alternative embodiment of the present invention, HRQI assembly 100 is not operative to assume under-temperature visible state V.

It is appreciated that NHRQI sub-assemblies 103 typically only assume visible states I and V described above with reference to HRQI assemblies 100.

In a preferred embodiment of the present invention, as described hereinbelow with reference to FIGS. 2-4D, a different single one of barcodes 110 is machine-readable at each of visible states I, II, III, IV and V. For example, in the example illustrated in FIGS. 1A-1E, visible state I is read as 7290003804191, visible state II is read as 7290003804108, visible state III is read as 7290003804122, visible state IV is read as 7290003804115 and visible state V is read as 7290003804139. In one embodiment of the present invention, at least some of the characters associated with a numeric or alphanumeric code are a quality code.

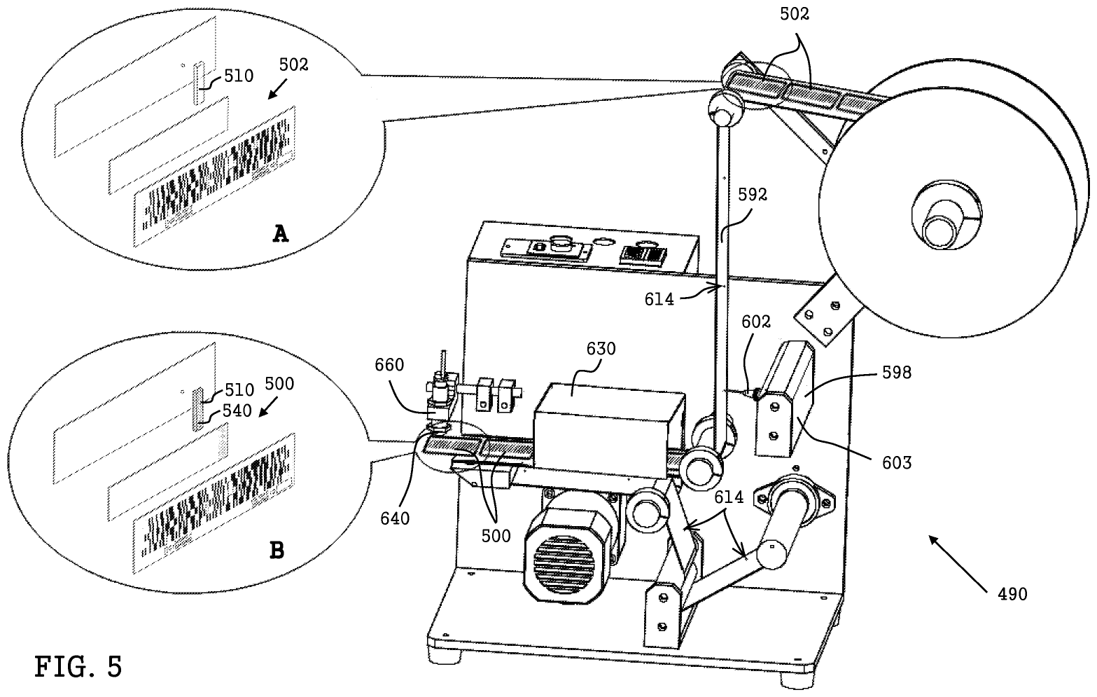

In another preferred embodiment of the present invention, as described hereinbelow with reference to FIGS. 5-7E, at least one of visible states I, II, III, IV and V may not be associated with any of barcodes 110. Instead, the one or more visible states I, II, III, IV and V which are not associated with any of barcodes 110 is associated with a change in HRQI assembly 100 that is readily human sensible, machine-readable or both human sensible and machine-readable.

HRQI assemblies 100 are preferably assembled by supplying HRCM thereto, as described hereinbelow with reference to FIGS. 2-3D and FIGS. 5-6D.

It is appreciated that in addition to providing an indication of temperature, HRQI assemblies 100 and/or 105 may be operative to provide an indication of at least one alternative or additional quality parameter, including, inter alia, moisture, force, pressure, pH and elapsed time.

It is appreciated that the HRCM is one type of a quality parameter responsive coloring material (QPRCM). QPRCM is typically embodied as one or more of inter alia, a temperature sensitive coloring material such as an HRCM, a pH sensitive coloring material useful in litmus paper and a humidity responsive coloring material such as silica gel.

In the illustrated embodiment, HRQI assemblies 105 preferably have a pre-supply visible state VI, as seen in enlargement circle D of FIG. 1A, a post-supply visible state VII, as seen in enlargement circles C & G of FIG. 1A, and a first over-temperature visible state VIII, as seen in enlargement circles C & D of FIG. 1B, indicating an exceedance of an upper temperature threshold, for example 8 degrees Celsius, for at least a first over-temperature cumulative time duration, for example one hour. HRQI assemblies 105 preferably also have a second over-temperature visible state IX, as seen in enlargement circles F of FIG. 1A and A & B of FIG. 1B, indicating an exceedance of the upper temperature threshold for at least a second over-temperature cumulative time duration, for example four hours. In the embodiment illustrated in FIGS. 1A-1E, as seen in enlargement circle E of FIG. 1A, HRQI assemblies 105 further have an under-temperature visible state X, which indicates an exposure to a temperature below a lower temperature threshold for an under-temperature time duration. In one embodiment of the present invention, the under-temperature time duration is very short, preferably less than 60 seconds, more preferably less than 30 seconds, more preferably less than 15 seconds, even more preferably less than 10 seconds and most preferably less than 5 seconds. In another embodiment of the present invention, the under-temperature time duration is relatively long, and may be, for example, 5 minutes, 10 minutes, 20 minutes, 30 minutes or 45 minutes.

In one embodiment of the present invention, the under-temperature time duration is a cumulative time duration. In this embodiment, if the under-temperature time duration is, for example, 30 minutes, when HRQI assembly 105 is exposed to a temperature below the lower temperature threshold for 10 minutes, then is exposed to a temperature above the lower temperature threshold for an hour, and thereafter is exposed to a temperature below the lower temperature threshold for an additional 20 minutes, then HRQI assembly 100 assumes under-temperature visible state X.

In another embodiment of the present invention, HRQI assembly 100 only assumes under-temperature visible state X when exposed to a temperature below the lower temperature threshold for an uninterrupted under-temperature time duration. In this embodiment, if the under-temperature time duration is, for example 30 minutes, when HRQI assembly 105 is exposed to a temperature below the lower temperature threshold for 10 minutes, then is exposed to a temperature above the lower temperature threshold for an hour, and only thereafter is exposed to a temperature below the lower temperature threshold for an additional 20 minutes, then HRQI assembly 105 does not assume under-temperature visible state X. However, when HRQI assembly 105 is exposed to a temperature below the lower temperature threshold for an uninterrupted interval of 30 minutes, then HRQI assembly 105 does assume under-temperature visible state X.

In an alternative embodiment of the present invention, HRQI assembly 105 is not operative to assume under-temperature visible state X.

It is appreciated that NHRQI sub-assemblies 108 typically only assume visible states VI and X described above with reference to HRQI assemblies 105.

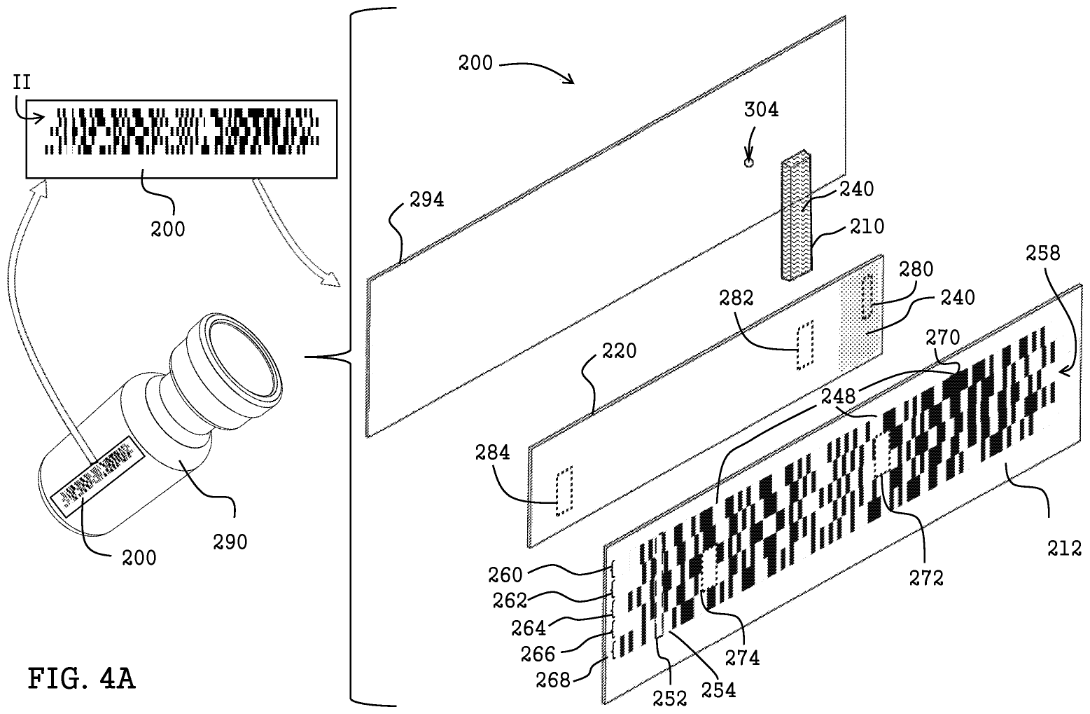

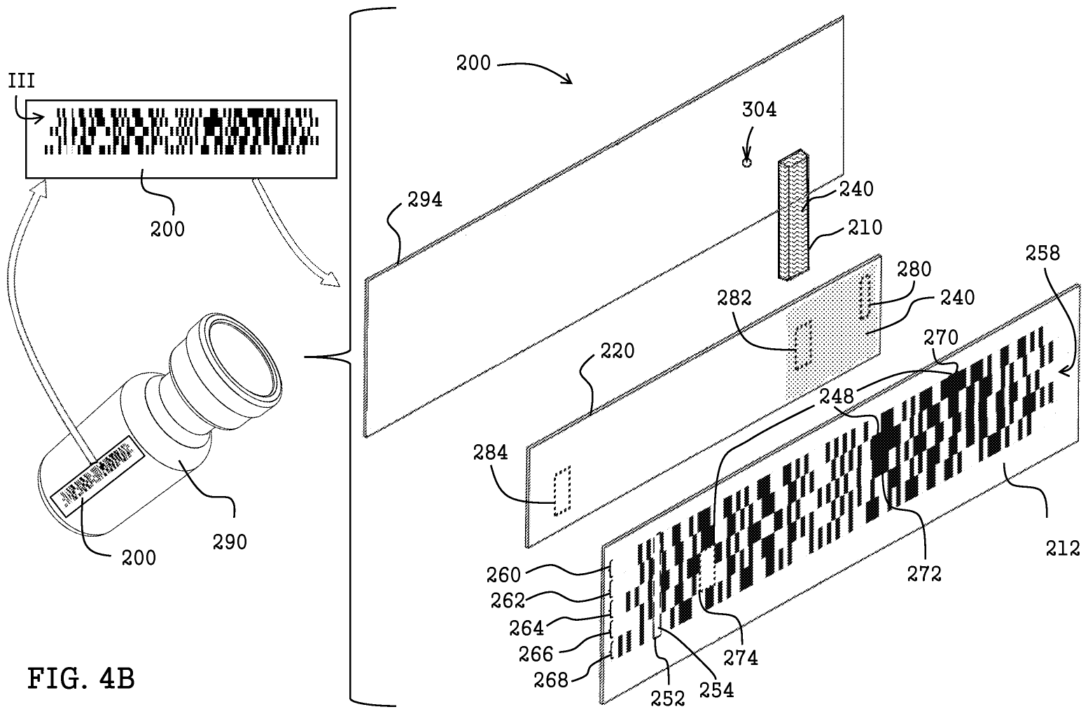

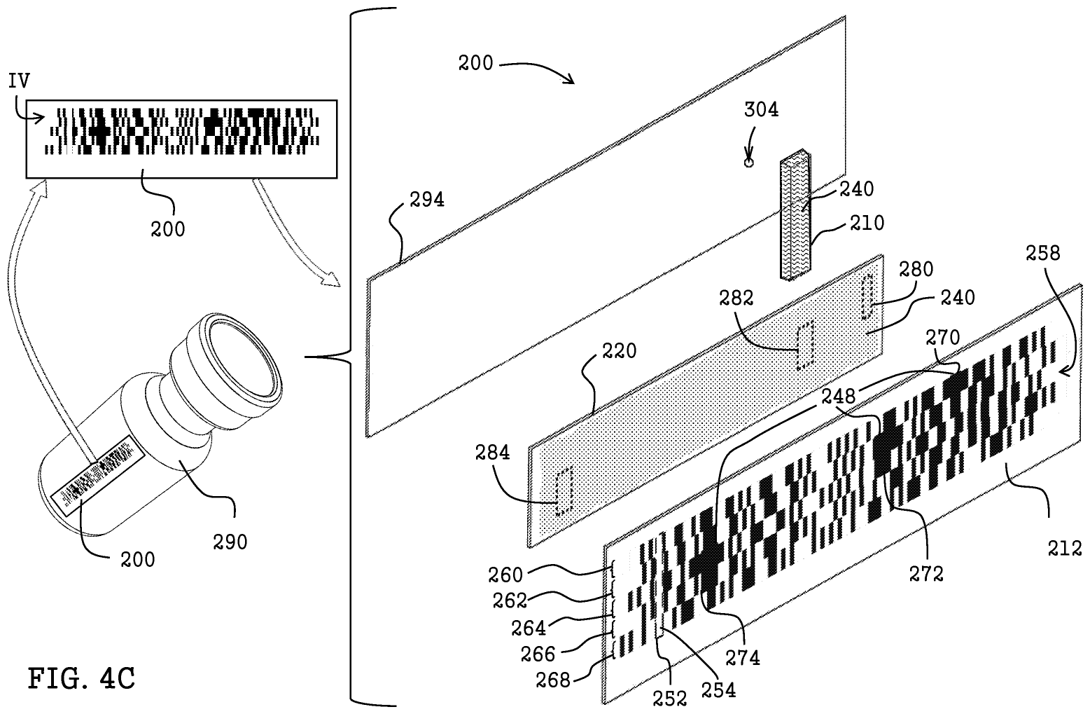

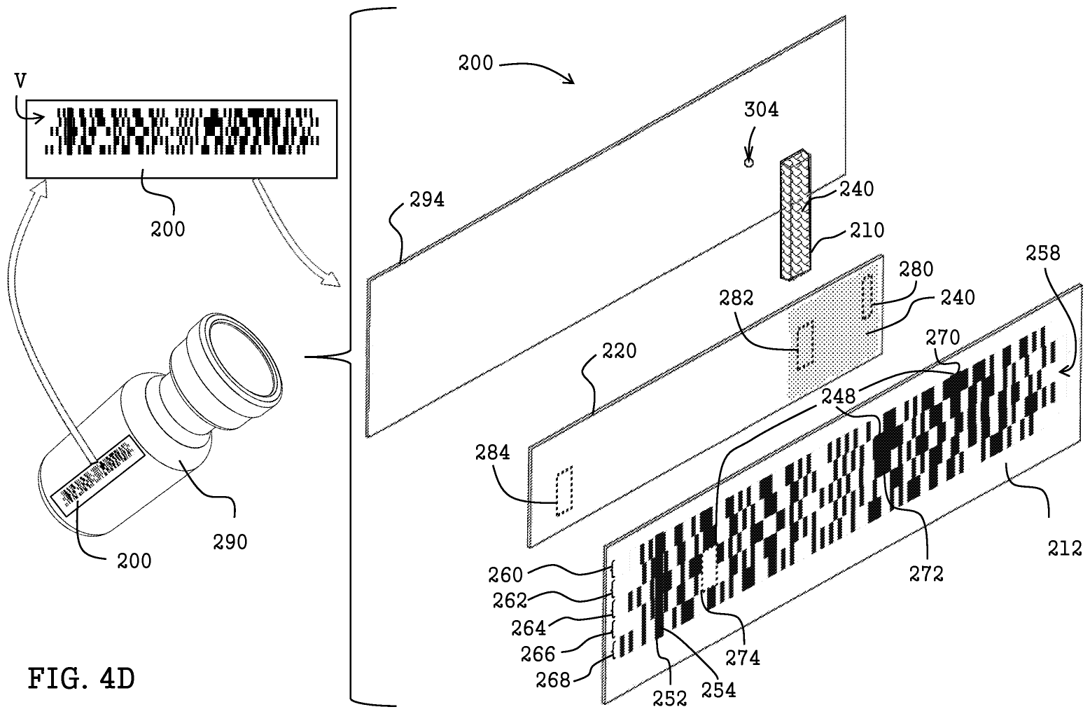

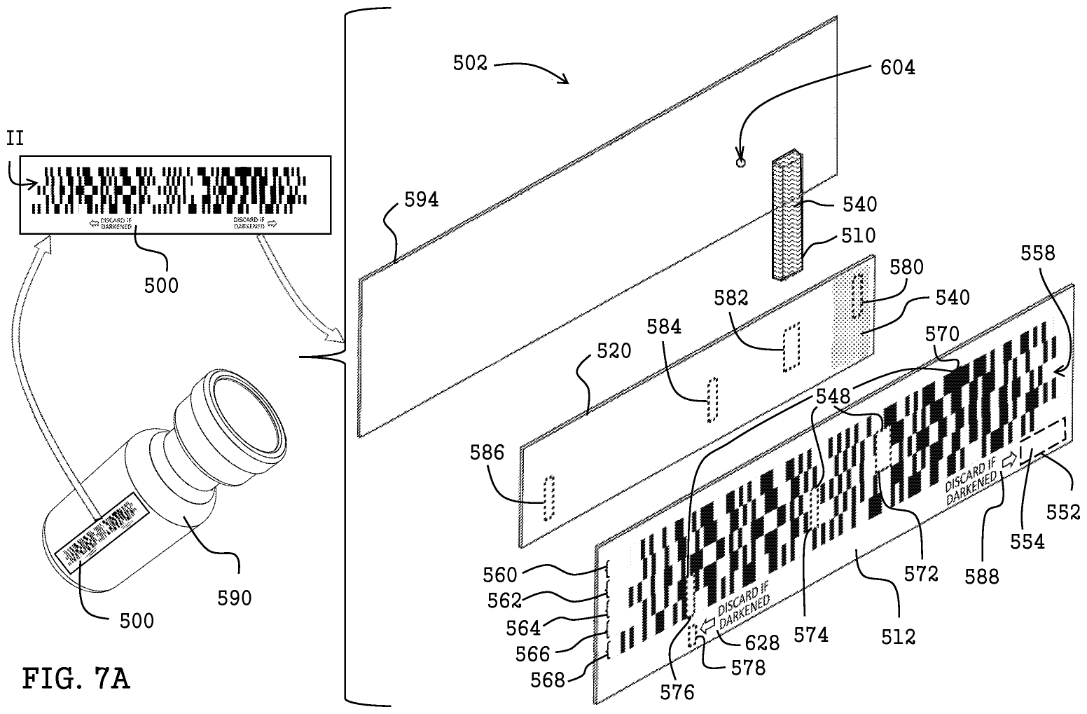

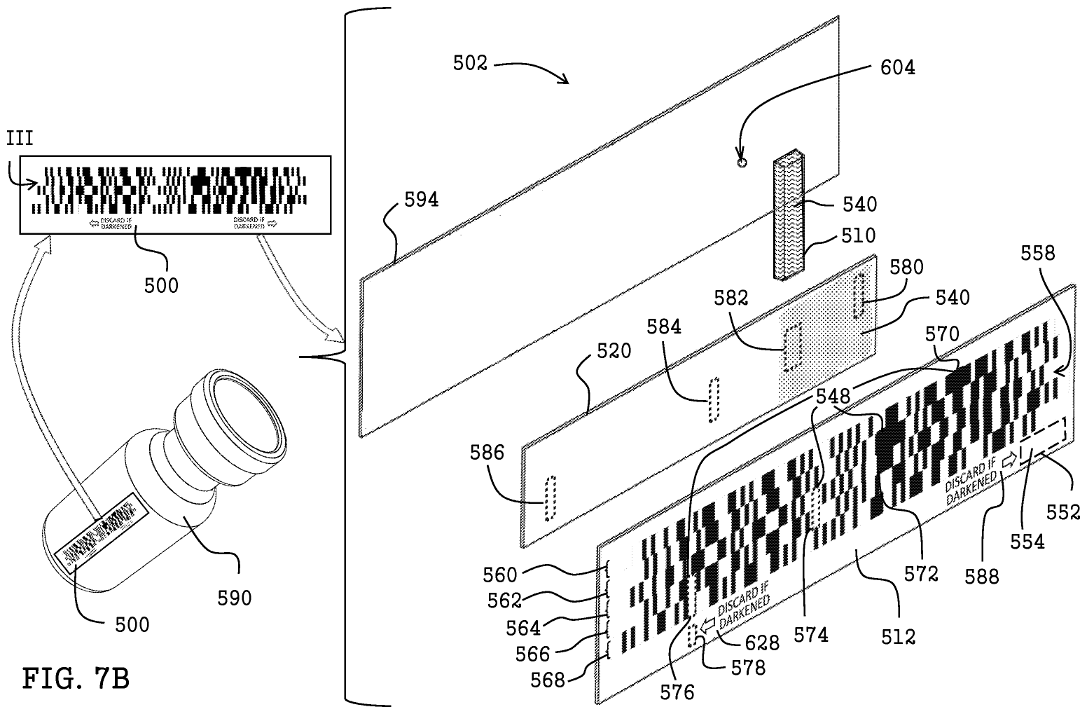

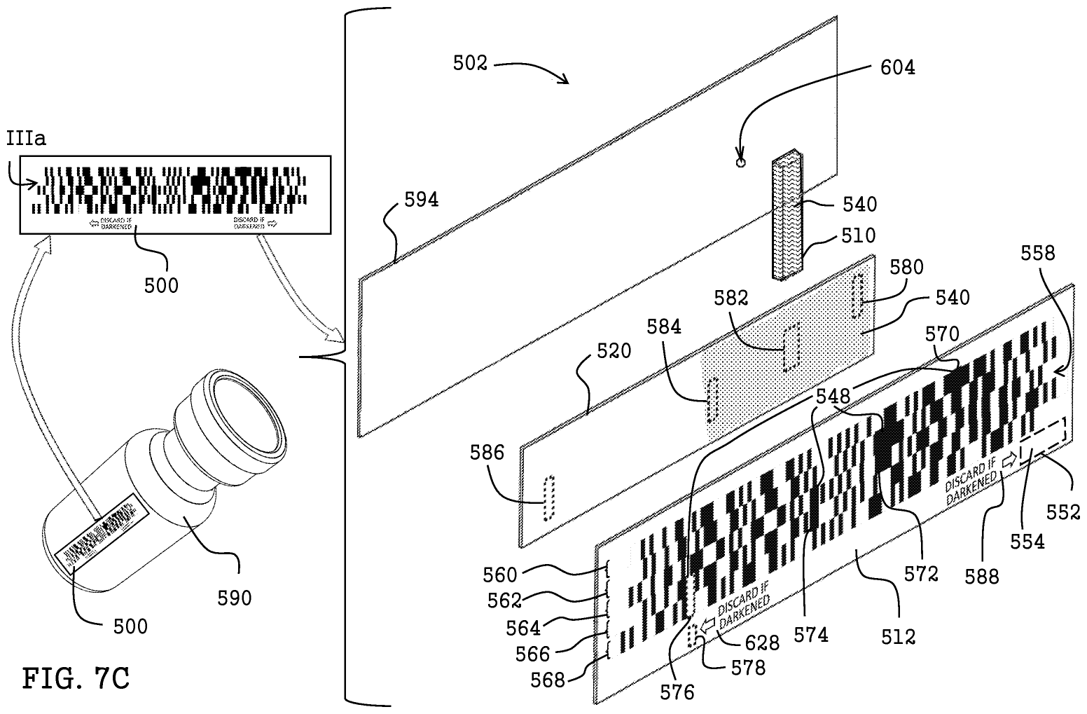

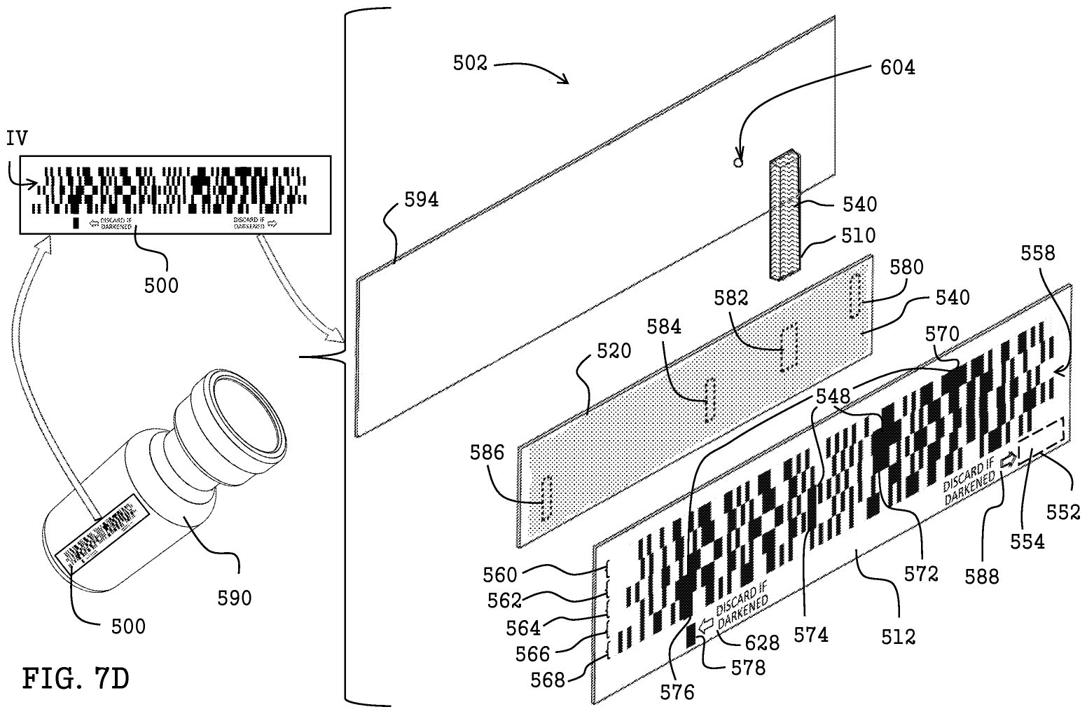

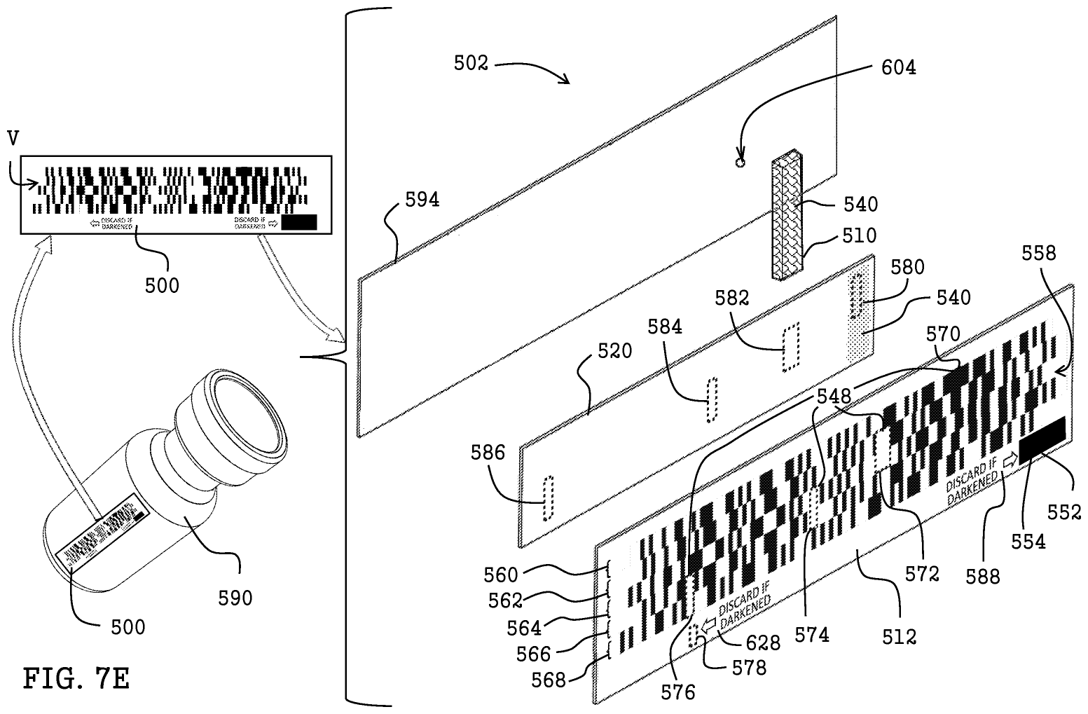

In a preferred embodiment of the present invention, as described hereinbelow with reference to FIGS. 4A-4D, a different one of barcodes 111 is machine-readable at each of visible states VI, VII, VIII, IX and X. In another preferred embodiment of the present invention, as described hereinbelow with reference to FIGS. 7A-7E, at least one of visible states VI, VII, VIII, IX and X is not associated with a particular one of barcodes 111. Instead, the one or more visible states VI, VII, VIII, IX and X which are not associated with a particular one of barcodes 111 is associated with a change in HRQI assembly 105 that is readily human sensible, machine-readable or both human sensible and machine-readable, but preferably is not associated with a particular barcode 111.

HRQI assemblies 105 are preferably assembled by supplying HRCM thereto, as described hereinbelow with reference to FIGS. 2-3D and 5-6D.

It is appreciated that a numerical sequence of a particular one of barcodes 111 which is machine-readable at each of visible states VI, VII, VIII, IX and X may differ from a numerical sequence of a particular one of barcodes 110. Alternatively, a numerical sequence of a particular one of barcodes 111 which is machine-readable at each of visible states VI, VII, VIII, IX and X may be the same as a numerical sequence of one of barcodes 110. If the same barcode numerical sequence is associated with a visible state of both HRQI assemblies 100 and HRQI assemblies 105, then an identity of an HRQI assembly read by a barcode reader is preferably provided to an indication interpreter by other indicia located thereon or any other suitable method, for example by a manual entry to a database.

It is appreciated that the upper temperature thresholds, the lower temperature thresholds and the predetermined cumulative amounts of time may be selected as appropriate for a given application.

Additionally, in another embodiment of the present invention, HRQI assemblies 100 and/or 105 provide an indication of continuous amounts of time spent either above or below a predetermined temperature threshold or thresholds. In other words, HRQI assemblies 100 and/or 105 only show an exceedance of a predetermined temperature threshold or thresholds if a time spent over such a threshold or thresholds is a consecutive time, and HRQI assemblies 100 and/or 105 begin counting the time from 0 seconds if a temperature of HRQI assemblies 100 and/or 105 falls below the threshold or thresholds for a minimum period of time. Thus, in such an embodiment, HRQI assemblies 100 and/or 105 provide an indication of a consecutive amount of time spent above a temperature threshold.

In such an embodiment, an HRQI assembly 100 and/or 105 preferably indicates that a temperature of the HRQI assembly 100 and/or 105 exceeded a temperature threshold, such as 8 degrees Celsius, for a time period of 4 consecutive hours. However, such a label preferably would not provide a warning if a temperature of the HRQI assembly 100 and/or 105 exceeds the threshold for 3 consecutive hours, thereafter remains below the threshold, such as at a temperature of 5 degrees Celsius, for a minimum duration, such as 30 minutes, and thereafter exceeds the threshold for an additional 1 hour.

In a preferred embodiment of the present invention, following a supply of HRCM to NHRQI sub-assembly 103 to form HRQI assembly 100, HRQI assembly 100 associated with a specific package 101 remains in visible state II as long as the temperature of the specific package 101 neither exceeds the upper temperature threshold for at least the first over-temperature cumulative time duration nor falls below the lower temperature threshold for at least the under-temperature time duration, as seen particularly in enlargement circle B of FIG. 1A. Similarly, in an alternative embodiment wherein HRQI assembly 100 is not operative to assume visible state V, HRQI assembly 100 associated with a specific package 101 remains in visible state II as long as a temperature of the specific package 101 does not exceed the upper temperature threshold for at least the first over-temperature cumulative time duration.

As seen in enlargement circles C & G of FIG. 1A, in the illustrated embodiment of the present invention, following a supply of HRCM to NHRQI sub-assembly 108 to form HRQI assembly 105, HRQI assembly 105 associated with a specific carton 106 remains in visible state VII as long as the temperature of the specific carton 106 neither exceeds the upper temperature threshold for at least the first over-temperature cumulative time duration, nor falls below the lower temperature threshold for at least the under-temperature time duration. Similarly, in an alternative embodiment wherein HRQI assembly 105 is not operative to assume visible state X, HRQI assembly 105 associated with a specific carton 106 remains in visible state VI as long as a temperature of the specific carton 106 does not exceed the upper temperature threshold for at least the first over-temperature cumulative time duration.

If, however, as seen in enlargement circle E of FIG. 1A, the temperature of a specific carton 106 falls below the lower temperature threshold, HRQI assembly 105 associated with the specific carton 106 assumes visible state X. For example, if one of cartons 106 is stored next to a faulty ventilation duct, thereby exposing that carton 106 to a temperature of 1 degree Celsius, the HRQI assembly 105 associated with that carton 106 assumes visible state X. Preferably, visible state X is irreversible, and the HRQI assembly 105 remains in visible state X notwithstanding that the temperature of HRQI assembly 105 and the associated carton 106 subsequently exceeds the lower temperature threshold.

As further seen in FIG. 1A, if during loading of truck A, as indicated by reference numeral 112, one or more cartons 106 is exposed to a temperature of at least 8 degrees Celsius for a period of four and a half hours, which is longer than the second over-temperature cumulative time duration of four hours, corresponding HRQI assemblies 105 assume visible state IX, as seen in enlargement circle F. Preferably, HRQI assemblies 105 in visible state IX cannot revert to any of visible states VI, VII or VIII, notwithstanding that a temperature of that carton 106 and corresponding HQRI assembly 105 subsequently drops below the upper temperature threshold. Upon a delivery of these cartons 106, these cartons 106 are preferably inspected to determine whether the temperature of the HQRI assemblies 100 and associated packages 101 inside the cartons 106 exceeded predetermined time and temperature thresholds.

Accordingly, upon inspection, as upon delivery, as seen in FIG. 1B, the HRQI assemblies 105 attached to the cartons 106 which were exposed to a temperature of at least 8 degrees Celsius for a period of four and a half hours may be read using a conventional barcode reader 113, such as a hand-held barcode reader 113 or an automated barcode reader 113. Hand-held barcode reader 113 may be embodied as any suitable barcode reader, such as, inter alia, a smartphone running a barcode-reading application. Barcode reader 113, upon reading barcodes 111 on HRQI assembly 105 in visible state IX, preferably provides information to a quality indication computer 115 which enables quality indication computer 115 to provide an immediate indication of a quality status, such as a BAD indication 116. This BAD indication 116 indicates that at some time in a history of the HRQI assembly 105 read by barcode reader 113, the HRQI assembly 105 and the carton 106 with which it is associated exceeded the upper temperature threshold for at least the second over-temperature cumulative time duration and that this may have rendered one or more of the products in carton 106 unacceptable for use.

In a preferred embodiment of the present invention, quality indication computer 115 preferably maintains or communicates with a database which preferably includes at least an event description table, associating various visible states of HRQI assemblies 101 and 105 with various events, such as injection of ink and exposure to a temperature in exceedance of a particular temperature threshold for a particular time duration, and a product status table, associating various events with product types, product descriptions, and product quality statuses.

It is appreciated that until the cartons 106 are opened, which normally occurs only upon delivery, it is impractical to visually inspect the HRQI assemblies 100 which are attached to the individual packages 101 inside the cartons 106. Depending on circumstances, a temperature of individual packages 101 within a carton 106 may or may not have exceeded the upper temperature threshold for at least the second over-temperature cumulative time duration, and the HRQI assemblies 100 which are attached to the packages 101 may or may not be in visible state III or visible state IV. This normally can only be seen upon opening cartons 106, as shown in FIG. 1C.

It is appreciated that the time and temperature thresholds of HRQI assemblies 100 and 105, placed on individual packages 101 and cartons 106 containing them, respectively, may be related in order to provide highly effective cold chain management. For example, HRQI assemblies 105 may provide a time in temperature warning even if, upon inspection, HRQI assemblies 100 show that individual packages 101 have not experienced unacceptable temperatures. It is appreciated that, preferably, the thresholds of HRQI assemblies 100 and 105 may be calibrated with respect to each other based, inter alia, on empirical data, in order to minimize the number of required inspections of individual packages 101, to generally avoid a situation where HRQI assembly 105 provides a ‘BAD’ indication for a carton 106, while all HRQI assemblies 100 within carton 106 provide acceptable indications.

As further seen in FIG. 1A, if, during loading of truck B, the temperature outside of truck B reaches 10 degrees Celsius for 30 minutes, which is less than the predetermined duration of one hour, the HRQI assemblies 105 associated with cartons 106 in truck B remain in visible state VII, as seen at reference numeral 117.

At any stage, such as upon delivery, HRQI assemblies 105 can be read with barcode reader 113, which preferably communicates with remote quality indication computer 115 and provides an immediate indication of a quality status, such as an OK indication 118. It is appreciated that normally, until delivery, it is impractical to visually inspect HRQI assemblies 100 on individual packages 101.

As stated hereinabove with relation to loading of truck A, it is preferable that HRQI assemblies 105 provide a warning of an exceedance of the upper temperature threshold for at least the first over-temperature time duration even if, upon inspection, HRQI assemblies 100 show that individual packages 101 have not experienced unacceptable temperatures for unacceptable durations. Accordingly, upon subsequent reading of indicators 100 on packages 101 inside a carton 106 for which no such warning was provided, it is not expected that the indicators 100 will indicate exceedance of a corresponding exceedance of the upper temperature threshold for at least the first over-temperature time duration.

As seen in FIG. 1B, if, during vehicle breakdown of truck B, the temperature outside of the cartons 106 is 15 degrees Celsius, which is more than the upper temperature threshold of 8 degrees Celsius, for 90 minutes, which is more than the predetermined total duration of one hour, the HRQI assemblies 105 assume visible state VIII, as seen at reference numeral 119. It is appreciated that once HQRI assembly 105 assumes visible state VIII it cannot revert to either of visible states VI or VII, notwithstanding that the temperature of the HQRI assembly 105 and the associated carton 106 subsequently drops below the upper temperature threshold.

Typically, upon delivery, HRQI assemblies 105 are preferably read using barcode reader 113. Barcode reader 113, upon reading barcodes 111 in visible state VIII, preferably provides information to the quality indication computer 115 which enables quality indication computer 115 to provide an immediate indication of a quality status, such as a “W” indication 120. This “W” indication 120 indicates that at some time in the history of the HRQI assembly 105, the carton 106 to which it was attached was at a temperature greater than the upper temperature threshold for at least the first over-temperature cumulative time duration and, while unlikely, this may have rendered one or more of the products in carton 106 unacceptable for use. It is appreciated that normally, until cartons 106 are opened, typically following delivery, it is impractical to visually inspect indicators 100 on individual packages 101.

Depending on the circumstances, the temperatures of the individual packages 101 within the cartons 106 may or may not have exceeded the upper temperature threshold for at least the first over-temperature time duration and the HRQI assemblies 100 which are attached to the packages 101 may or may not be in the visible state III or visible state IV. This normally can only be seen upon opening cartons 106 and inspecting HQRI assemblies 100 associated with individual packages 101, as shown in FIG. 1C.

As further seen in FIG. 1B and indicated by reference numeral 121, upon inspection, as upon delivery, the HRQI assemblies 105 attached to the cartons 106 which were delivered by truck A may be read, preferably using barcode reader 113. If, as seen in FIG. 1A, during loading of truck A, one or more cartons 106 were exposed to a temperature of at least 8 degrees Celsius for a period of four and a half hours, the HRQI assemblies 105 of these cartons assumed the visible state IX, indicating exceedance of the upper temperature threshold for at least the second over-temperature cumulative time duration. Barcode reader 113, upon reading barcodes 111 in visible state IX, preferably provides information to quality indication computer 115 which enables quality indication computer 115 to provide an immediate indication of a quality status, such as a BAD indication 116.

In contrast, the HRQI assemblies 105 of other cartons 106 which were not exposed to a temperature of 8 degrees Celsius for a period of at least four hours remained in visible state VII. Barcode reader 113, upon reading the HQRI assemblies 105 with barcodes 111 in visible state VII, preferably provides information to the quality indication computer 115 which enables quality indication computer 115 to provide an OK indication, similar to OK indication 118.

Turning now specifically to FIG. 1C, it is seen that upon opening the cartons 106 of packages 101 which were delivered by truck B, as indicated by reference numeral 123, the HRQI assemblies 100 attached to the packages 101 may be read by barcode reader 113. In this example, the HRQI assemblies 100 of some of the packages 101 are in visible state II, indicating that notwithstanding that HRQI assembly 105 on carton 106 indicates an exceedance of the upper temperature threshold for at least the first over-temperature cumulative time duration, some of the HRQI assemblies 100 associated with some of packages 101, particularly those at the interior of the carton 106, may not have exceeded the upper temperature threshold for the first or second over-temperature cumulative time duration, and may be acceptable for use.

Barcode reader 113 preferably communicates with a remote quality indication computer 115 and provides an OK indication 124 to an inspector, indicating that the temperature of some of packages 101 did not exceed the upper temperature threshold for at least the first over-temperature cumulative time duration.

This OK indication 124 is in contrast to the “W” indication 120 provided by the HRQI assemblies 105 associated with the cartons 106 containing these packages 101 as the result of refrigeration breakdown of truck B, as indicated by reference numeral 119 in FIG. 1B. As stated hereinabove with relation to truck A loading, HRQI assemblies 105 associated with cartons 106 may provide a time in temperature warning even if, upon inspection, HRQI assemblies 100 associated with individual packages 101 show that individual packages 101 have not experienced unacceptable temperatures.

As is further stated hereinabove, the thresholds of HRQI assemblies 100 and 105 may be calibrated with respect to each other based, inter alia, on empirical data, in order to minimize the number of required inspections of individual packages 101, to generally avoid a situation where an HRQI assembly 105 provides a ‘BAD’ indication for a carton 106, while all HRQI assemblies 100 within the carton 106 with which that HRQI assembly 105 is associated provide acceptable indications. It is appreciated that the thresholds of HRQI assemblies 100 and 105 are thus not necessarily the same thresholds as indicated in the example of FIGS. 1A-1E, which are provided for illustration purposes only. For example, a BAD indication for a carton 106 containing packages 101 all having an OK indication can be prevented if HRQI assemblies 105 attached to the cartons 106 are calibrated to indicate the exceedance of a higher time or temperature threshold than that of HRQI assemblies 100 on packages 101.

As further seen in FIG. 1C and indicated by reference numeral 125, upon opening the cartons 106 of packages 101 which were delivered by truck A and for which a BAD indication has already been provided by the HRQI assemblies 105 associated therewith during loading of truck A, as seen in FIG. 1A, it is seen that as least some of the HRQI assemblies 100 assumed visible state IV. It is appreciated that once HQRI assembly 100 assumes visible state IV, the HRQI assembly 100 preferably cannot thereafter revert to any of states I, II and III, notwithstanding that the temperature of the HQRI assembly 100 and associated package 101 subsequently drops below the upper temperature threshold.

Accordingly, upon inspection, as upon delivery, HRQI assembly 100 is read, preferably using barcode reader 113. Barcode reader 113, upon reading barcodes 110 of HQRI assembly 100 in visible state IV, preferably provides information to quality indication computer 115 which enables quality indication computer 115 to provide an immediate indication of a quality status, such as a BAD indication 126. This BAD indication 126 indicates that at some time in the history of the HRQI assembly 100, the package 101 to which it was attached was at a temperature exceeding the upper temperature threshold for more than at least the second over-temperature cumulative time duration, and that this event has rendered the product in package 101 unacceptable for use.

As indicated by reference number 127, it is noted that it is undesirable for a carton 106 to be associated with a NHRQI sub-assembly 108, without that NHRQI sub-assembly 108 having been supplied with an HRCM. In such a case, as seen in enlargement circle C in FIG. 1C, the NHRQI sub-assembly 108 preferably displays pre-supply visible state VI. Barcode reader 113, upon reading barcodes 111 of NHRQI sub-assembly 108 in pre-supply visible state VI, preferably provides information to quality indication computer 115 which enables quality indication computer 115 to provide an immediate indication of a quality status, such as a “NO” indication 128, which indicates that the NHRQI sub-assembly 108 is not fully assembled and thus cannot provide time in temperature history of the carton 106 with which it is associated.

Similarly, as indicated by reference number 129, it is undesirable for a package 101 to be associated with a NHRQI sub-assembly 103, without that NHRQI sub-assembly 103 having been supplied with an HRCM. In such a case, as seen in enlargement circle D in FIG. 1C, NHRQI sub-assembly 103 preferably displays pre-supply visible state I. Barcode reader 113, upon reading barcodes 110 in pre-supply visible state I, preferably provides information to quality indication computer 115 which enables quality indication computer 115 to provide an immediate indication of a quality status, such as a “NO” indication 130, which indicates that the NHRQI sub-assembly 103 is not fully assembled and thus cannot provide time in temperature history of the package 101 with which it is associated.

In a preferred embodiment of the present invention, each HRQI assembly 100 and 105, or in the undesirable case wherein the HRCM was not supplied to an NHRQI sub-assembly 103 or 108, each NHRQI sub-assembly 103 and 108, is inspected prior to being associated with a package 101 or carton 106, respectively. Preferably, a conventional barcode reader, such as barcode reader 113, reads barcodes 110 and 111 on each HRQI assembly 100 and 105 or NHRQI sub-assembly 103 and 108 substantially immediately prior to the association of the same with a package 101 or carton 106. Barcode reader 113, upon reading barcodes 110 and 111 on HRQI assembly 100 and 105 or NHRQI sub-assembly 103 and 108, preferably provides information to a quality indication computer 115 which enables quality indication computer 115 to provide an immediate indication of a quality status of the HRQI assembly 100 and 105 or NHRQI sub-assembly 103 and 108 read by barcode reader 113.

If, as a result of the reading by the conventional barcode reader, an indication is provided that the HRQI assembly 100 and 105 or NHRQI sub-assembly 103 and 108 is unfit for use, then the HRQI assembly 100 and 105 or NHRQI sub-assembly 103 and 108 is preferably discarded and is not associated with a package 101 or carton 106. Examples of an HRQI assembly 100 and 105 or NHRQI sub-assembly 103 and 108 that is unfit for use include an HRQI assembly 100 and 105 or NHRQI sub-assembly 103 and 108 that is in pre-supply visible state I or VI, that is in visible state V or X, or that is unreadable by a typical barcode reader 113.

It is appreciated that whereas machine reading of the NHRQI sub-assemblies 103 and 108 and HRQI assemblies 100 and 105 provides an indication of whether or not a given event has occurred, the indication of a quality status by the quality indication computer 115 provides an indication of whether and to what extent that event has affected the quality of a given product with which NHRQI sub-assembly 103, NHRQI sub-assembly 108, HRQI assembly 100 or HRQI assembly 105 is associated. It is appreciated that there may be a great variation in the effect of a given event depending on the type of product. Thus, for example, exposure to 30 degrees Celsius for a short period of time may cause a live attenuated influenza vaccine to be rendered unfit for use but may not appreciably affect the quality or usability of ibuprofen tablets.

As seen in FIG. 1D, as indicated by reference numeral 131, a user employing an imager-equipped telephone, such as, inter alia, a smartphone running a barcode-reading application, or other suitable mobile communicator 132, for example during an inspection of a pharmacy refrigerator, may image HRQI assembly 100 and communicate the image information to a suitably programmed quality indication computer 133. Quality indication computer 133 may be different from computer 115 or identical to computer 115, and is capable of reading the barcodes 110 from the image information generated by mobile communicator 132 and providing to the user, via SMS or any other suitable communication methodology, an immediate indication of a quality status, such as a GOOD QUALITY indication 134. This quality status indicates that the product is safe for use. Alternatively, if the user employs a barcode reader-equipped communicator, the communicator can provide to the computer 115 an output resulting from reading the barcode 110.

In a preferred embodiment of the present invention, quality indication computer 133 preferably maintains or communicates with a database which preferably includes at least an event description table, associating various visible states of HRQI assemblies 101 and 105 with various events, such as injection of ink and exposure to a temperature in exceedance of a particular temperature threshold for a particular time duration, and a product status table, associating various events with product types, product descriptions, and product quality statuses.

It is appreciated that quality indication computers 115 and 133 may provide reports to various interested entities, such as the manufacturer or distributor of the products, health authorities and other governmental or private entities, to enable real-time monitoring of the quality of products offered for use. Quality indication computers 115 and 133 may have a user identification functionality, such as a caller ID functionality, so as to be able to identify a user requesting information, classify the user, for example as a pharmacist, a manufacturer's QA inspector and a health inspector, and provide an appropriate quality indication output. Additionally or alternatively, quality indication computers 115 and 133 may send messages to pharmacy or supply-chain management regarding remedial steps to be taken, such as refrigeration maintenance or repair instructions.

As described hereinabove and as seen in FIG. 1D, HRQI assembly 100 may indicate an exceedance of the upper temperature threshold for at least the second over-temperature cumulative time duration. Thus, upon exceedance of the second over-temperature cumulative time duration, HRQI assembly 100 assumes visible state III, as seen at reference numeral 135 in FIG. 1D.

Accordingly, upon inspection, such as a periodic inspection at a medical facility, an inspector using barcode reader 113 may read HQRI assemblies 100. Barcode reader 113, upon reading HRQI assembly 100 with barcodes 110 in visible state III, as seen in enlargement circle A of FIG. 1D, provides information to quality indication computer 115 which enables quality indication computer 115 to provide an immediate indication of a quality status, such as a “W” indication 136. This “W” indication 136 indicates that, although the package 101 to which HRQI assembly 100 is attached is still suitable for use, the upper temperature threshold has been exceeded.

Additionally or alternatively, as seen at reference numeral 140 in FIG. 1D, a medical practitioner may conduct a final inspection of HRQI assembly 100 immediately prior to removing contents of package 101 therefrom. For example, a nurse may use a suitable mobile communicator 142, such as, inter alia, a smartphone running a barcode-reading application, or any suitable conventional barcode reader, to scan HRQI assembly 100 prior to withdrawing a vaccine from package 101 with which HRQI assembly 100 is associated, such as a vial. As seen in enlargement circle B of FIG. 1D, in the illustrated example, the barcode 110 of HRQI assembly 100 is in its visible state V. Mobile communicator 142 or barcode reader 113, upon reading HQRI assembly with barcodes 110 in visible state V, provides information to quality indication computer 133 which enables quality indication computer 133 to provide an immediate indication of a quality status, such as a BAD: FROZE indication 144, to the medical practitioner. This BAD: FROZE indication 144 indicates that the package 101 to which it was attached is not usable, since the package 101 was exposed to a temperature below the lower temperature threshold for the under-temperature time duration.

In another embodiment of the present invention, an additional inspection may be carried out automatically at a pharmacy checkout, where the HRQI assembly 100 is read by a checkout scanner. It is appreciated that further inspections may be carried out, either manually or automatically, at suitable times and locations.

It is appreciated that HRQI assembly 100 may also include other product quality related indications, such as an indication of the elapse of a relatively long period of time at an acceptable storage temperature. Additionally, the HRQI assembly 100 may be used to indicate events which occur following the release or purchase of a product.

In a preferred embodiment of the present invention, as seen in FIG. 1E, at least one of package 101 and carton 106 are associated with an additional label 150 and 155, respectively. Additional labels 150 and 155 preferably include indicia 157 and 159, respectively, which may be machine-readable, human sensible, or both machine-readable and human sensible. Indicia 157 and 159 preferably provide product information relating to package 101 and carton 106, respectively, such as any or all of, inter alia, product type, manufacturing date, packaging location and quality assurance (QA) inspector identification. In a preferred embodiment of the present invention, each of indicia 157 and 159 are machine-readable indicia, such as, inter alia, a bar code or a QR code.

Preferably, additional label 150 is in close physical proximity to HRQI assembly 100 and additional label 155 on package 101 is in close physical proximity to HRQI assembly 105 on carton 106. Thus, in a preferred embodiment of the present invention, HRQI assembly 100 and additional label 150 can be read substantially simultaneously by either or both of a human user and a machine reader, such as barcode reader 113 or mobile communicator 142. Similarly, HRQI assembly 105 and additional label 155 can be read substantially simultaneously by either or both of a human user and a machine reader, such as barcode reader 113 or mobile communicator 142.

Thus, in a preferred embodiment of the present invention, quality indication computer 115 receives outputs from both HRQI assembly 100 or 105 and corresponding additional label 150 or 155. Preferably, quality indication computer 115 relates the output from HRQI assembly 100 or 105 with the product output from additional label 150 or 155. In other words, output from a scan of HRQI assembly 100 or 105 and additional label 150 or 155 is provided to quality indication computer 115, and quality indication computer 115 preferably bases the quality indication output on outputs from both HRQI assembly 100 or 105 and corresponding additional label 150 or 155.

For example, if the product output from additional label 150 or 155 indicates that package 101 or carton 106 is subject to a manufacturer recall, quality indication computer 115 preferably provides an output indicating that the contents of package 101 or carton 106 should not be used, even if output from HRQI assembly 100 or 105 indicates that package 101 or carton 106 has not been exposed to temperatures either above an upper temperature threshold temperature or below a lower temperature threshold temperature. Conversely, if the output from HRQI assembly 100 or 105 indicates that package 101 or carton 106 has been exposed to temperatures either above an upper temperature threshold temperature for a predetermined time duration or below a lower temperature threshold temperature for a predetermined time duration, quality indication computer 115 preferably provides an output indicating that the contents of package 101 or carton 106 should not be used, even if the product output from additional label 150 or 155 indicates that package 101 or carton 106 is acceptable for use.

Additionally, in a preferred embodiment of the present invention, quality indication computer 115 maintains and updates the decision table which provides product quality status outputs based on the output indications provided by the indicator reader and the additional parameters. In such an embodiment, if, for example, a predetermined number or percentage of packages 101 or cartons 106 from a particular group, such as for example a batch, a lot, a manufacturing facility, a storage facility or a transportation line, are found to have been exposed to temperatures either above an upper temperature threshold temperature for a predetermined time duration or below a lower temperature threshold for a predetermined time duration, then entries on the decision table for all packages 101 or cartons 106 from that group are updated. For example, entries on the decision table for all packages 101 or cartons 106 from that group may be modified to include a warning regarding possible unacceptable temperature exposure, and/or include a request for an investigation into temperature history of the batch.

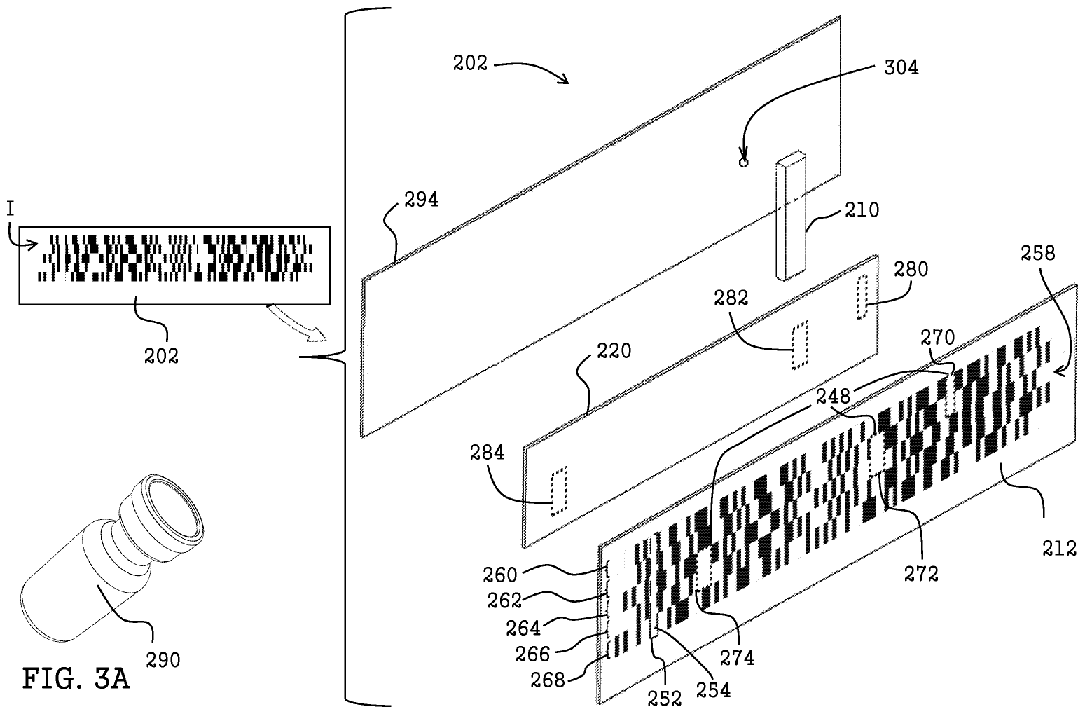

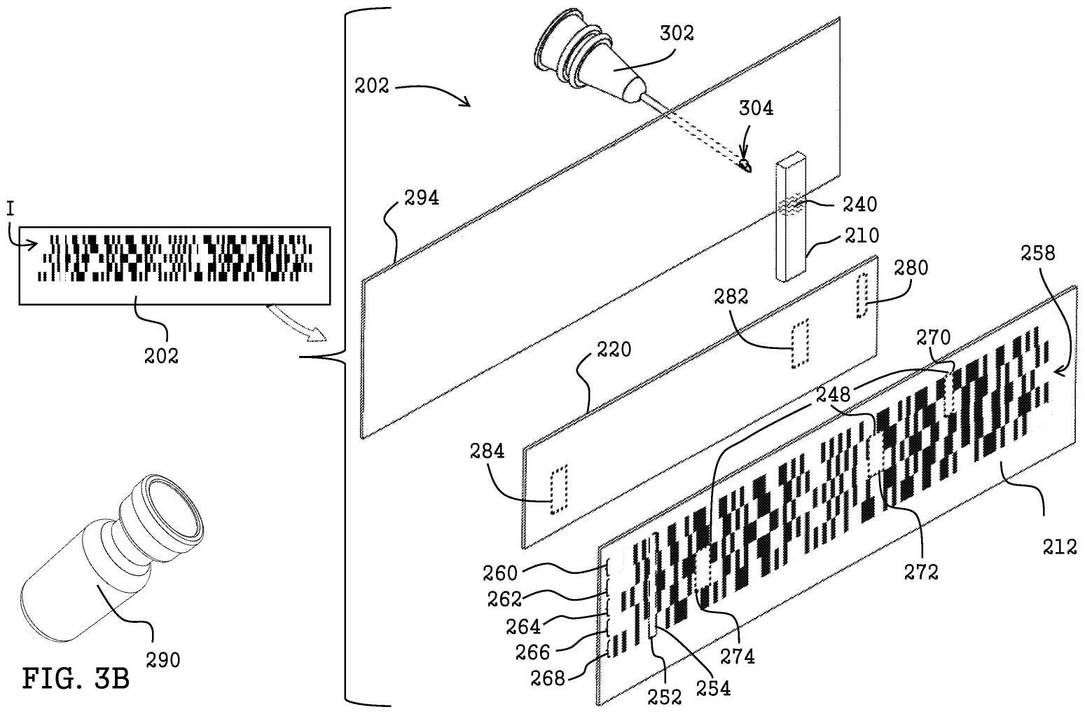

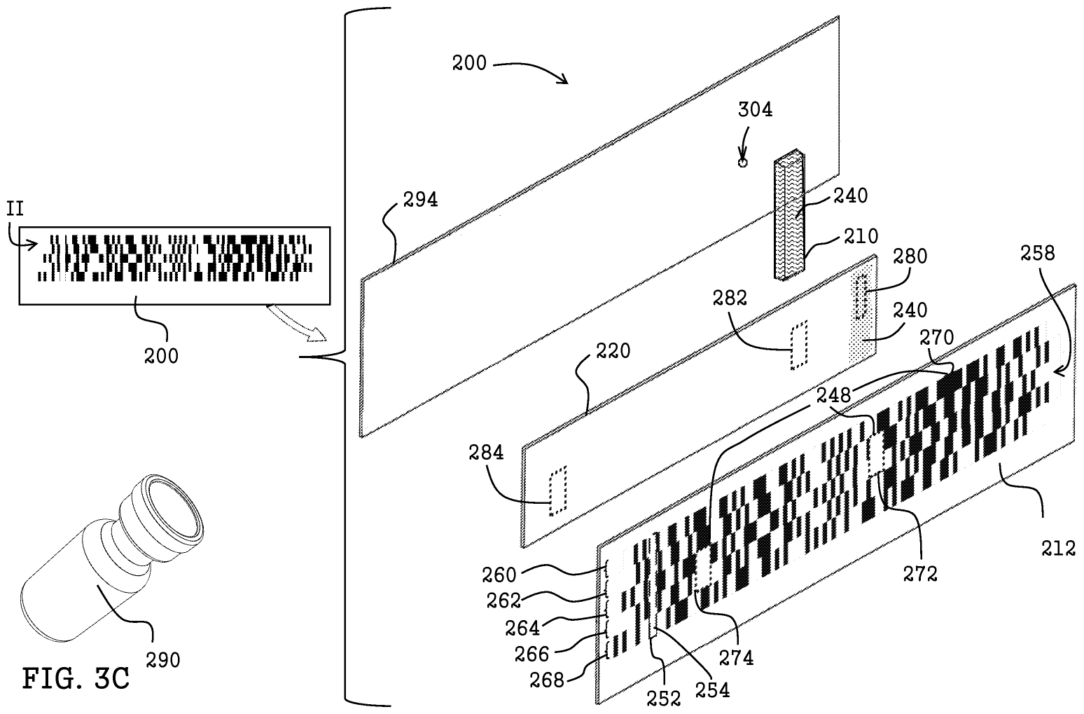

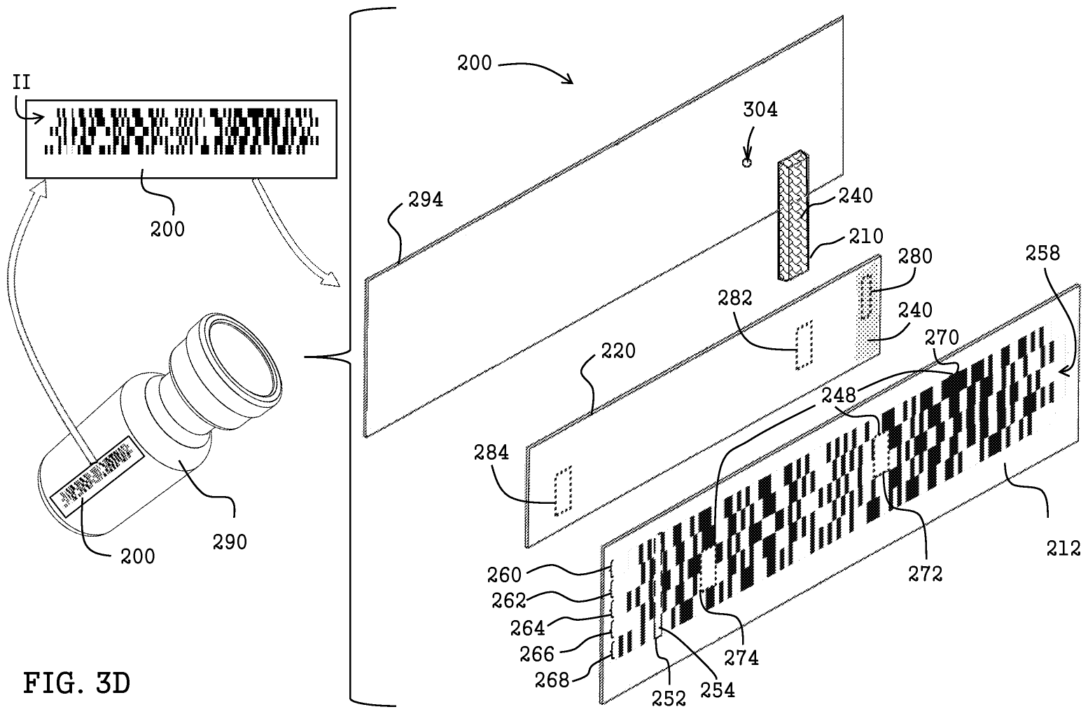

Reference is now made to FIG. 2, which is a simplified illustration of a heat responsive coloring material supplier (HRCMS) 190, which is an example of one or both of HRCMSs 102 and 107 of FIGS. 1A-1E, and to FIGS. 3A-3D, which together are a simplified illustration of a preferred method of construction of a heat responsive quality indicator (HRQI) 200, which is an embodiment of one or both of HRQI assemblies 100 and 105 of FIGS. 1A-1E.

HRQI assembly 200 preferably includes a shelf-stable, non-heat responsive quality indicator (NHRQI) sub-assembly 202 including at least one coloring material reservoir 210, at least one indicator template 212 and at least one coloring material diffuser 220. HRQI assembly 200 preferably additionally includes a quality parameter responsive coloring material (QPRCM) 240. In a preferred embodiment of the present invention, QPRCM 240 is an HRCM, which is flowable at a temperature exceeding an upper temperature threshold, as indicated by waved lines in corresponding figures. QPRCM 240 is characterized by a viscosity and a melting point such that QPRCM 240 is flowable through or on coloring material diffuser 220 at temperatures above an upper temperature threshold and is not flowable through or on coloring material diffuser 220 at temperatures below the upper temperature threshold. Additionally, QPRCM 240 is preferably characterized by a color that is readily distinguishable from a color of coloring material diffuser 220.

QPRCM 240, when supplied to coloring material diffuser 220 of NHRQI sub-assembly 202, preferably converts NHRQI sub-assembly 202 to HRQI assembly 200, which is responsive to changes in temperature over time in exceedance of the upper temperature threshold, for changing an appearance of HRQI assembly 200. Thus, HRQI assembly 200 is formed by supplying QPRCM 240 to NHRQI sub-assembly 202, preferably by injecting QPRCM 240 into NHRQI sub-assembly 202.

When QPRCM 240 is flowable, QPRCM 240 preferably diffuses through coloring material diffuser 220. Conversely, when QPRCM 240 is not flowable, QPRCM 240 preferably does not diffuse through coloring material diffuser 220. Preferably, HRQI assembly 200 includes a quantity of QPRCM 240 sufficient to saturate the entirety or nearly the entirety of coloring material diffuser 220 following an exposure of HRQI assembly 200 to the upper temperature threshold for predetermined cumulative time duration.

It is further appreciated that QPRCM 240 may additionally or alternatively be embodied as a coloring material that is responsive to at least one alternative or additional quality parameter, including, inter alia, moisture, force, pressure, pH and elapsed time. In such a case, HRQI assembly 200 is preferably embodied as at least, inter alia, a moisture responsive quality indicator, a force responsive quality indicator, a pressure responsive quality indicator, a pH responsive quality indicator and an elapsed time responsive quality indicator, respectively.

In one embodiment of the present invention, (not shown), QPRCM 240 is supplied directly to coloring material diffuser 220. In such an embodiment, coloring material reservoir 210 may be obviated.

In another embodiment of the present invention, as seen particularly in FIGS. 2-3D, QPRCM 240 is supplied indirectly to coloring material diffuser 220. In such an embodiment, QPRCM 240 is preferably supplied to coloring material reservoir 210, and coloring material reservoir 210 supplies QPRCM 240 to coloring material diffuser 220.

In a preferred embodiment of the present invention, coloring material diffuser 220 is embodied as filter paper, such as Whatman No. 3 filter paper commercially available from Whatman International [CAT #: 1003917]. Additionally, coloring material reservoir 210 is preferably embodied as a pad, for example, K-R; 210/34/28, commercially available from Noam-Urim of Kibbutz Urim, Israel, and QPRCM 240 is preferably embodied as a coloring agent, such as Sudan Black, a black color dye [CAS: 4197-25-5], combined at a ratio of 1.4 grams per 1 kilogram in Decyl Decanoate [CAS: 1654-86-0].

Preferably, indicator template 212 includes a transparent substrate on which is formed non-transparent printing. In a preferred embodiment of the present invention, all areas on the transparent substrate which are desired to be opaque, including both a background and areas in which features will be printed, are printed with white ink, and a plurality of features, such as bars forming part of barcodes corresponding to barcodes 110 or 111 of FIGS. 1A-1E, are preferably printed with black ink over the white ink as desired.

In another embodiment of the present invention, a background area of indicator template 212 is printed with white ink; however, the white ink is not deposited in the areas in which the plurality of features are formed, and the plurality of features are preferably printed with black ink.

More generally, in all embodiments of the present invention, the background area of indicator template 212 and the plurality of features of indicator template 212 are printed in such colors as to define high contrast therebetween.

Indicator template 212 preferably further includes at least one transparent area 248, indicated by dotted lines in FIGS. 3A-3D. It is appreciated that the dotted lines indicating transparent area or areas 248 are drawn for ease of understanding, and preferably transparent area or areas 248 are not readily distinguishable from surrounding areas of indicator template 212. In a preferred embodiment of the present invention, transparent area or areas 248 are not printed, i.e., preferably no material is deposited on transparent area or areas 248. For the purposes of the present specification and claims, the term “transparent area” is defined so as to include within its scope areas that are either transparent or translucent.

Preferably, coloring material diffuser 220 is visible through the entirety of each of transparent areas 248. Thus, a color visible in each of transparent areas 248 is determined by a color of a portion of coloring material diffuser 220 located therebehind. In a preferred embodiment of the present invention, each of transparent areas 248 is initially white in color, and assumes a black color upon a coloring of coloring material diffuser 220 by QPRCM 240.

In a preferred embodiment of the present invention, indicator template 212 additionally includes at least one area 252 upon which is deposited a cold responsive coloring material 254, such as a thermochromic coloring material, such as irreversible thermochromic ink commercially available from CTI Technology, Colorado Springs, USA. It is appreciated that although, for ease of understanding, dashed lines in FIGS. 3A-3D indicate area 252, preferably area 252 is not readily distinguishable from surrounding areas of indicator template 212.

It is appreciated that as used herein, “cold responsive” is used to indicate an element or system that changes as a result of cold, wherein “cold” is used to indicate a temperature below a lower temperature threshold, such as a temperature at which cold responsive coloring material 254 typically changes color.

In a preferred embodiment of the present invention, cold responsive coloring material 254 is initially characterized by a first color, and irreversibly assumes a second color, which is different from the first color, upon exposure to a temperature below a lower temperature threshold for example, below 2 degrees Celsius, for an under-temperature time duration. As described hereinabove, in one embodiment of the present invention, the under-temperature time duration is very short, preferably less than 60 seconds, more preferably less than 30 seconds, more preferably less than 15 seconds, even more preferably less than 10 seconds and most preferably less than 5 seconds. In another embodiment of the present invention, the under-temperature time duration is relatively long, and may be, for example, 5 minutes, 10 minutes, 20 minutes, 30 minutes or 45 minutes.

Thus, if the under-temperature time duration is very short, then cold responsive coloring material 254 preferably assumes the second color substantially immediately upon being exposed to a temperature below the lower temperature threshold. In contrast, if the under-temperature time duration is relatively long, for example 30 minutes, then cold responsive coloring material 254 assumes the second color only upon an exposure to a temperature less than the lower temperature threshold for at least 30 minutes.

It is appreciated that the first color and the second color assumed by cold responsive coloring material 254 may be any suitable colors which are discernable from one another. In one embodiment of the present invention, the first and second colors are readily discernable from one another by a human. Additionally or alternatively, the first and second colors are readily discernable from one another by a machine. For example, in one embodiment of the present invention, cold responsive coloring material 254 characterized by the first color is colorless and transparent, and cold responsive coloring material 254 characterized by the second color is blue.

In the example illustrated in FIGS. 2-3D, indicator templates 212 are embodied as a plurality of barcodes 258, such as barcodes 110 or 111, including a first barcode 260, a second barcode 262, a third barcode 264, a fourth barcode 266 and a fifth barcode 268, which are preferably different from each other and arranged in a stacked arrangement. As indicated by dotted lines, formed within barcodes 258 are transparent areas 248, including a transparent area 270, a transparent area 272 and a transparent area 274.

As described hereinabove, coloring material diffuser 220 is preferably visible through the entirety of each of transparent areas 248. More particularly, a portion 280 of coloring material diffuser 220 is preferably visible through transparent area 270, a portion 282 of coloring material diffuser 220 is preferably visible through transparent area 272 and a portion 284 of coloring material diffuser 220 is preferably visible through transparent area 274. Thus, it is appreciated that a color visible in each of transparent areas 270, 272 and 274 is determined by a color of each of portions 280, 282 and 284, respectively. It is appreciated that although, for ease of understanding, dotted lines in FIGS. 3A-3D indicate each of portions 280, 282 and 284, preferably portions 280, 282 and 284 are not readily distinguishable from surrounding areas of coloring material diffuser 220.

Preferably, each of transparent areas 270, 272 and 274 is formed within at least two of barcodes 258 and forms a readable portion thereof. In the illustrated embodiment of FIGS. 3A-4D, transparent area 270 forms part of barcodes 260 and 262, transparent area 272 forms part of barcodes 262 and 264, and transparent area 274 forms part of barcodes 264 and 266. Each of transparent areas 248 preferably has the same width as a single barcode bar. Alternatively, the width of any of the transparent areas 270, 272 and 274 may be different from the width of a single barcode bar. Additionally, the width of the portion of a transparent area 248 which forms part of one of barcodes 258 may be different from the width of the portion of the same transparent area 248 which forms part of another of barcodes 258.

Preferably, all of barcodes 258 include at least a portion of area 252 within which is located cold responsive coloring material 254, and the at least portion of area 252 forms a readable portion of barcodes 258. Accordingly, area 252 forms part of each of barcodes 260, 262, 264, 266 and 268. Area 252 preferably has the same width as a single barcode bar. Alternatively, the width of at least a portion of area 252 may be different from the width of a single barcode bar.

It is appreciated that barcodes 260, 262, 264, 266 and 268 may be arranged in any suitable order with respect to one another. Similarly, transparent areas 270, 272 and 274 may be arranged in any suitable order with respect to one another. Furthermore, it is appreciated that at least one of barcodes 260, 262, 264, 266 and 268 and/or transparent areas 270, 272 and 274 may be obviated from indicator template 212 and HRQI assembly 200. Similarly, one or more additional barcodes and/or transparent areas may be added to indicator template 212 and HRQI assembly 200.

In a preferred embodiment of the present invention, a different single one of barcodes 258 is machine-readable at each of visible states I, II, III, IV and V. For example, in the example illustrated in FIGS. 2-4D, barcode 260 is read as 7290003804191 at pre-supply visible state I, barcode 262 is read as 7290003804108 at post-supply visible state II, barcode 264 is read as 7290003804122 in visible state III, barcode 266 is read as 7290003804115 in visible state IV and barcode 268 is read as 7290003804139 in visible state V. Preferably, each of barcodes 258 is machine-readable only in the single one of visible states I, II, III, IV and V, as listed above. In one embodiment of the present invention, at least some of the characters associated with a numeric or alphanumeric code are a quality code.

As seen particularly in FIGS. 3A-3D, when coloring material diffuser 220 is in an uncolored state, meaning that QPRCM 240 has not been supplied to coloring material diffuser 220, coloring material diffuser 220 causes each of transparent areas 270, 272 and 274 to appear white in color. The white appearance of transparent area 270 preferably allows barcode 260 to be machine-readable, while the white appearance of transparent areas 270, 272 and 274 preferably causes barcodes 262, 264 and 266 to be non-machine-readable. Additionally, as long as NHRQI sub-assembly 202 has not been exposed to a temperature less than the lower temperature threshold, cold responsive coloring material 254 is preferably characterized by the first color thereof, for example colorless and transparent, and area 252 does not interfere with the readability of any of barcodes 260, 262, 264 and 266, while the first color of area 252 preferably prevents barcode 268 from being read. Thus, when coloring material diffuser 220 is in an uncolored state and NHRQI sub-assembly 202 has not been exposed to a temperature less than the lower temperature threshold, NHRQI sub-assembly 202 is preferably in pre-supply visible state I, wherein only barcode 260 is in a machine-readable state.

As seen in FIG. 3A, a container 290, such as, inter alia, package 101 or carton 106, is ready to be associated with an HRQI assembly 200. It is appreciated that container 290 is typically a product package, and may be embodied as, inter alia, an individual product package, such as a vial, a box of product packages, a pallet of product packages or a shipping container of product packages. In a preferred embodiment of the present invention, a type of container 290 with which an HRQI assembly 200 is associated, and more particularly a number of individual products contained by the container 290 associated with HRQI assembly 200, is at least partially determined by a relationship between a cost of monitoring container 290, a temperature-sensitivity of a product within container 290 and a financial value of a product within container 290.

Preferably, as further seen in FIG. 3A, QPRCM 240 has not yet been supplied to NHRQI sub-assembly 202, and therefore NHRQI sub-assembly 202 is preferably not yet associated with container 290. As described hereinabove, prior to a supply of QPRCM 240 to NHRQI sub-assembly 202, NHRQI sub-assembly 202 has not been exposed to a temperature less than the lower temperature threshold and is preferably in pre-supply visible state I.

Preferably, in visible state I, barcode 260 is typically readable by a conventional barcode reader, such as barcode reader 113, mobile communicator 132 or mobile communicator 142 of FIGS. 1A-1E, and barcodes 262, 264, 266 and 268 are preferably not readable by a barcode reader. Thus, the NHRQI sub-assembly 202 is in pre-supply visible state I and presents a single machine-readable barcode 260, typically readable by a conventional barcode reader as 7290003804191.

NHRQI sub-assembly 202 is preferably embodied as a self-adhesive label. Typically, after fabrication of NHRQI sub-assemblies 202 and before QPRCM 240 is supplied thereto, NHRQI sub-assemblies 202 are stored on a roll liner 292. NHRQI sub-assembly 202 includes a back portion 294, on a rear side (not shown) of which is preferably an adhesive (not shown). The adhesive preferably serves to affix NHRQI sub-assembly 202 to roll liner 292. Typically, following the production of HRQI assembly 200, the adhesive on NHRQI sub-assembly 202 is also used to affix HRQI assembly 200 to container 290.

As seen particularly in FIGS. 2 and 3B, HRCMS 190 preferably includes a coloring material supplier 298, such as injection module 104 of FIG. 1A, which includes at least one injector 302, such as a needle assembly. In a preferred embodiment of the present invention, coloring material supplier 298 includes a heating assembly 303, such as a resistive heating assembly. If an ambient temperature of coloring material supplier 298 is below the upper temperature threshold of QPRCM 240 while coloring material supplier 298 supplies QPRCM 240 to NHRQI sub-assembly 202, heating assembly 303 provides heat to QPRCM 240 during the supply thereof to NHRQI sub-assembly 202, thereby maintaining QPRCM 240 at a temperature at which QPRCM 240 is flowable during the supply thereof to NHRQI sub-assembly 202.

Typically, coloring material supplier 298 supplies QPRCM 240 to NHRQI sub-assembly 202 while NHRQI sub-assembly 202 is affixed to roll liner 292. In the embodiment shown in FIGS. 2-3D, coloring material supplier 298 supplies QPRCM 240 to coloring material reservoir 210, and coloring material reservoir 210 then supplies QPRCM 240 to coloring material diffuser 220. In another embodiment of the present invention, coloring material supplier 298 supplies QPRCM 240 directly to coloring material diffuser 220, and coloring material reservoir 210 may be obviated.

In a preferred embodiment of the present invention, QPRCM 240 is supplied to NHRQI sub-assembly 202 immediately prior to the association of HRQI assembly 200 with container 290. In other words, QPRCM 240 is preferably supplied to NHRQI sub-assemblies 202 as NHRQI sub-assemblies 202 are being positioned for imminent association with containers 290. Thus, in the illustrated embodiment shown in FIG. 2, as roll liner 292 is unspooled to make NHRQI sub-assemblies 202 available for affixation to containers 290, QPRCM 240 is supplied to NHRQI sub-assemblies 202.

Preferably, an aperture 304 is formed in back portion 294 of NHRQI sub-assembly 202. As seen particularly in FIG. 3B, QPRCM 240 is preferably supplied by injector 302 to NHRQI sub-assembly 202 through aperture 304. In the illustrated embodiment of the present invention, aperture 304 enables fluid communication between injector 302 and coloring material reservoir 210, which in turn is in fluid communication with coloring material diffuser 220. In another embodiment of the present invention, in which coloring material reservoir 210 may be obviated, aperture 304 enables fluid communication directly between injector 302 and coloring material diffuser 220.

Preferably, a plurality of apertures 314 are formed on roll liner 292, and each of apertures 314 is generally aligned with one of apertures 304. It is appreciated that apertures 304 and 314 may be formed either during respective fabrications of NHRQI sub-assembly 202 and roll liner 292, or as part of the supply of QPRCM 240 to NHRQI sub-assembly 202. Alternatively, one of plurality of apertures 304 and 314 may be formed during a respective fabrication of NHRQI sub-assembly 202 and roll liner 292, and the other of plurality of apertures 304 and 314 may be formed as part of the supply of QPRCM 240 to NHRQI sub-assembly 202. Typically, in an embodiment wherein at least one of plurality of apertures 304 and 314 is formed as part of the supply of QPRCM 240 to NHRQI sub-assembly 202, the at least one of plurality of apertures 304 and 314 is formed by injector 302.

As described above, in the embodiment illustrated in FIGS. 2 and 3B, QPRCM 240 is supplied to NHRQI sub-assembly 202 via aperture 304 on back portion 294 of NHRQI sub-assembly 202 prior to, preferably immediately prior to, associating HRQI assembly 200 with container 290. In an alternative embodiment of the present invention, QPRCM 240 is supplied to NHRQI sub-assembly 202 after associating NHRQI sub-assembly 202 with container 290. In an embodiment wherein the supply of QPRCM 240 to NHRQI sub-assembly 202 occurs after associating NHRQI sub-assembly 202 with container 290, coloring material supplier 298 and apertures 314 may be obviated, and aperture 304 may be obviated or located elsewhere on NHRQI sub-assembly 202.

In an embodiment wherein QPRCM 240 is supplied to NHRQI sub-assembly 202 following the association of NHRQI sub-assembly 202 with container 290, for example, an injector may supply QPRCM 240 to NHRQI sub-assembly 202 through an aperture formed in a front surface or a side surface of NHRQI sub-assembly 202.

Turning now particularly to FIG. 3C, it is seen that immediately following a supply of QPRCM 240 to NHRQI sub-assembly 202, portion 280 of coloring material diffuser 220 preferably becomes colored with QPRCM 240, and thus the color visible through transparent area 270 is determined by the color of QPRCM 240. In the example shown in FIGS. 2-3D, as seen particularly in FIG. 3C, immediately following a supply of QPRCM 240 to NHRQI sub-assembly 202, transparent area 270 shows a black color, and HRQI assembly 200 thus preferably assumes post-supply visible state II immediately following a supply of QPRCM 240 to NHRQI sub-assembly 202.

It is appreciated that the coloring of portion 280 by QPRCM 240, and thus the changing of the color visible through transparent area 270, changes an appearance of HRQI assembly 200, and more particularly, changes an appearance of barcode 260 and of barcode 262.

In post-supply visible state II, transparent area 270 shows a color similar to the color of bars of barcodes 258, while transparent areas 272 and 274 remain uncolored. Therefore, barcodes 260, 264 and 266 are preferably unreadable by a conventional barcode reader, such as barcode reader 113, mobile communicator 132 or mobile communicator 142 of FIGS. 1A-1E, and only barcode 262 is readable by a conventional barcode reader. Additionally, at post-supply visible state II, HRQI assembly 200 has preferably not been exposed to a temperature less than the lower temperature threshold for at least the under-temperature time duration. Therefore, cold responsive coloring material 254 is preferably characterized by the first color thereof, for example colorless and transparent, and area 252 does not interfere with the readability of any of barcodes 260, 262, 264 and 266, while the first color of area 252 preferably prevents barcode 268 from being read. Thus, HRQI assembly 200 in post-supply visible state II presents a single machine-readable barcode typically readable by a conventional barcode reader, here exemplified as barcode 262 having numerical sequence 7290003804108.

It is appreciated that once HQRI assembly 200 assumes visible state II, HRQI assembly 200 preferably cannot thereafter revert to visible state I.

Preferably, QPRCM 240 is supplied in a flowable state, as indicated by waved lines in FIGS. 3B & 3C, to NHRQI sub-assembly 202. In order to maintain a flowable state thereof, QPRCM 240 is typically supplied to NHRQI sub-assembly 202 at a temperature exceeding the upper temperature threshold. However, as seen particularly in enlargement circle B of FIG. 2 and in FIG. 3D, following supply of QPRCM 240 to NHRQI sub-assembly 202, HRQI assembly 200 is cooled to, and maintained at, a temperature which does not exceed the upper temperature threshold, such that QPRCM 240 is not flowable, as indicated by interlocking lines in enlargement circle B of FIG. 2 and in FIG. 3D.

In one embodiment of the present invention, HRCMS 190 includes at least one cooling system 330. Preferably, following a supply of QPRCM 240 to NHRQI sub-assembly 202, HRQI assembly 200 is brought into thermal contact with cooling system 330, thereby rapidly reducing the temperature of HRQI assembly 200 to a temperature below the upper temperature threshold, so that QPRCM 240 is not flowable. It is appreciated that cooling system 330 preferably does not cool HRQI assembly 200 to a temperature below the lower temperature threshold, and thus cold responsive coloring material 254 does not change color in response to temperature conditions within cooling system 330.

In another embodiment of the present invention, cooling system 330 may be obviated, and following the supply of QPRCM 240 to NHRQI sub-assembly 202, HRQI assembly 200 may be cooled to a temperature below the upper temperature threshold, such that QPRCM 240 is no longer flowable, after being associated with container 290. In this embodiment, cooling of HRQI assembly 200 is preferably effected by thermal contact with container 290 which, at the time of the association of HRQI assembly 200 therewith, is at a temperature below the upper temperature threshold. Alternatively, HRQI assembly 200 may be cooled by placing HQRI assembly 200 and the associated container 290 in a cold storage environment, such as a refrigerator. It is appreciated that the temperature of HRQI assembly 200 and associated container 290 is preferably not less than the lower temperature threshold, and thus cold responsive coloring material 254 does not change color in response to temperature conditions of container 290 at the time of association of HQRI assembly 200 with container 290.

As described hereinabove with reference to FIGS. 1A-1E, NHRQI sub-assembly 202 is preferably embodied as a self-adhesive label, and the association of HRQI assembly 200 with container 290 is preferably embodied as an affixation of HRQI assembly 200 to container 290, and more particularly as an adherence of HRQI assembly 200 to container 290. It is noted that the adhesive on the rear side of back portion 294 of HRQI assembly 200 preferably serves to affix HRQI assembly 200 to container 290, and that the adhesion of HRQI assembly 200 to container 290 preferably serves to seal aperture 304, preventing an egress of QPRCM 240 therefrom.

It is appreciated that in an embodiment wherein QPRCM 240 is supplied to NHRQI sub-assembly 202 after associating NHRQI sub-assembly 202 with container 290, cooling system 330 is typically not included in HRCMS 190. Instead, HRQI assembly 200 is cooled only after being associated with container 290. Similarly, in such an embodiment, if an aperture is included on a front or a side surface of NHRQI sub-assembly 202, the aperture may be sealed with a suitable sealant, preventing an egress of QPRCM 240 therefrom.

As illustrated in FIGS. 3A & 3B, in one embodiment of the present invention, NHRQI sub-assembly 202 is not yet associated with container 290. Similarly, as illustrated in FIG. 3C, immediately after the supply of QPRCM 240 to HRQI assembly 200, HRQI assembly 200 is preferably still not associated with container 290.

As illustrated in FIG. 2, in one embodiment of the present invention, HRQI assembly 200 is cooled to a temperature below the upper temperature threshold before being associated with container 290, preferably by cooling system 330. In an alternative embodiment, HRQI assembly 200 may be cooled by placing HQRI assembly 200 and associated container 290 in a cold storage environment, such as a refrigerator. Thus, the lowering of the temperature of QPRCM 240 and the association of HRQI assembly 200 with container 290 are separate steps.

However, in another embodiment of the present invention, as illustrated in FIG. 3D, HRQI assembly 200 is cooled to a temperature below the upper temperature threshold only after being associated with container 290. As described hereinabove, in this embodiment, cooling of HRQI assembly 200 is preferably effected by thermal contact with container 290 which, at the time of the association of HRQI assembly 200 therewith, is at a temperature below the upper temperature threshold. Thus, the lowering of the temperature of QPRCM 240 and the association of HRQI assembly 200 with container 290 are achieved in a single step.

In a preferred embodiment of the present invention, HRCMS 190 further includes a barcode reader 340, which preferably reads barcodes 258 substantially immediately prior to an association of HRQI assembly 200 or NHQRI sub-assembly 202 with container 290. Barcode reader 340, upon reading barcodes 258, preferably provides information to a quality indication computer, such as quality indication computer 115, which enables the quality indication computer to provide an immediate indication of a quality status of the HRQI assembly 200 or NHQRI sub-assembly 202 read by barcode reader 340.

If barcode reader 340 provides an indication that an HRQI assembly 200, or in an undesirable case wherein QPRCM 240 was not supplied to an NHRQI sub-assembly 202, an NHRQI sub-assembly 202, is unfit for use, then the HRQI assembly 200 or NHRQI sub-assembly 202 is preferably discarded and is not associated with a container 290. Examples of an HRQI assembly 200 or NHRQI sub-assembly 202 that is unfit for use include an HRQI assembly 200 or NHRQI sub-assembly 202 that is in pre-supply visible state I, that is in visible state V, or that is unreadable by a typical barcode reader, for example, due to damage to barcodes 258.

In another preferred embodiment of the present invention (not shown) barcode reader 340 is obviated, and is replaced with a conventional barcode reader, such as barcode reader 113, mobile communicator 132 or mobile communicator 142 of FIGS. 1A-1E, which is not part of HRCMS 190.

In a preferred embodiment of the present invention, HRCMS 190 further includes a container association module 360. If an indication is provided, for example by barcode reader 340 or barcode reader 113, that an HRQI assembly 200 is fit for use, then container association module 360 preferably associates that HRQI assembly 200 with a container 290. In a preferred embodiment of the present invention, container association module 360 positions HRQI assembly 200 relative to container 290 such that the adhesive on the rear side of HRQI assembly 200 contacts container 290, thereby affixing HRQI assembly 200 to container 290.

In the embodiment illustrated in FIG. 2, barcode reader 340 is shown as being part of container association module 360. Alternatively, barcode reader 340 may be separate from container association module 360.

Reference is now made to FIGS. 4A-4D, which are simplified illustrations of typical operative use cases of HRQI assembly 200.

It is appreciated that in the operative states shown in FIGS. 4A-4C, HRQI assembly 200 has not been exposed to a temperature below the lower temperature threshold for at least the under-temperature time duration. Therefore, cold responsive coloring material 254 is preferably characterized by the first color thereof, for example colorless and transparent, and area 252 does not interfere with the readability of any of barcodes 260, 262, 264 and 266, while the first color of area 252 preferably prevents barcode 268 from being read.

It is further appreciated that although, for ease of understanding, dotted lines in FIGS. 4A-4D indicate each of transparent areas 248 and portions 280, 282 and 284, preferably transparent areas 248 and portions 280, 282 and 284 are not readily distinguishable from surrounding areas of indicator template 212 and coloring material diffuser 220, respectively. Similarly, for ease of understanding, dashed lines in FIGS. 4A-4D indicate area 252; however, area 252 may not be readily distinguishable from surrounding areas of indicator template 212.

Following the supply of QPRCM 240 to NHRQI sub-assembly 202 and when a temperature of HRQI assembly 200 exceeds the upper temperature threshold, QPRCM 240 assumes a flowable state, as indicated by waved lines in FIG. 4A. In an embodiment wherein HRQI assembly 200 includes coloring material reservoir 210, upon assuming a flowable state, QPRCM 240 is released from coloring material reservoir 210 and begins to diffuse through coloring material diffuser 220. In an embodiment wherein HRQI assembly 200 does not include coloring material reservoir 210, upon assuming a flowable state, QPRCM 240 begins to diffuse through coloring material diffuser 220.

It is also appreciated that the respective first and second over-temperature cumulative time durations from the start of diffusion of QPRCM 240 along coloring material diffuser 220 until each of portions 282 and 284 of coloring material diffuser 220 become colored is defined, for example, by a length of coloring material diffuser 220 between portion 280 and each of portions 282 and 284. Additionally, these time durations are typically a function of a composition of QPRCM 240, as well as a function of a material from which coloring material diffuser 220 is made and a thickness thereof. For example, properties of QPRCM 240, coloring material diffuser 220, and transparent areas 272 and 274, such as composition and position thereof, are chosen such that that the respective first and second over-temperature cumulative time durations from the start of diffusion of QPRCM 240 along coloring material diffuser 220 until QPRCM 240 colors portions 282 and 284 of coloring material diffuser 220, which are visible through respective transparent areas 272 and 274, is one hour and four hours, respectively. However, it is appreciated that properties of QPRCM 240 and coloring material diffuser 220, as well as locations of transparent areas 272 and 274, may be chosen such that each of the first and second over-temperature cumulative time durations, from the start of diffusion of QPRCM 240 along coloring material diffuser 220 until QPRCM 240 colors portions 282 and 284 of coloring material diffuser 220, which are visible through respective transparent areas 272 and 274, may be any suitable respective time duration.

Typically, the first and second over-temperature cumulative time durations, as well as the upper and lower temperature thresholds, are chosen based on the requirements of contents of container 290. For example, an HRQI assembly 200 for association with a flu vaccine may have a lower temperature limit of 2 degrees Celsius, while an HRQI assembly 200 for association with a COVID-19 vaccine may have a lower temperature limit of −70 degrees Celsius. Similarly, an HRQI assembly 200 for association with a package of frozen meat may have respective first and second over-temperature cumulative time durations of one and four hours, while an HRQI assembly 200 for association with a package of fresh meat may have respective first and second over-temperature cumulative time durations of 30 minutes and one hour.

Turning particularly to FIG. 4A, it is seen that when a temperature of container 290, and of HRQI assembly 200 associated therewith, exceeds the upper temperature threshold for less than the first over-temperature cumulative time duration, QPRCM 240 begins to diffuse through coloring material diffuser 220 beyond portion 280 in a direction toward portion 282. However, as long as a temperature of container 290 and of HRQI assembly 200 associated therewith does not exceed the upper temperature threshold for at least the first over-temperature cumulative time duration, QPRCM 240 preferably does not color portion 282.

Thus, as long as a temperature of container 290 and of HRQI assembly 200 associated therewith does not exceed the upper temperature threshold for at least the first over-temperature cumulative time duration, neither portion 282 nor portion 284 of coloring material diffuser 220 become colored, and thus neither transparent area 272 nor transparent area 274 appear colored, and HRQI assembly 200 remains in visible state II, in which preferably only barcode 262 is in a readable state.

In contrast, as seen particularly to FIG. 4B, when a temperature of container 290 and of HRQI assembly 200 associated therewith exceeds the upper temperature threshold for at least the first over-temperature cumulative time duration, QPRCM 240 diffuses through portions of coloring material diffuser 220, including portion 282.

Thus, when a temperature of container 290 and of HRQI assembly 200 associated therewith exceeds the upper temperature threshold for at least the first over-temperature cumulative time duration, the color visible through transparent area 272 is determined by the color of QPRCM 240. As seen particularly in FIG. 4B, upon a coloring of portion 282 by black QPRCM 240, transparent area 272 shows a black color, and HRQI assembly 200 thus preferably assumes visible state III.

It is appreciated that the coloring of portion 282 by QPRCM 240, and thus the changing of the color visible through transparent area 272, changes an appearance of HRQI assembly 200, and more particularly, changes an appearance of barcode 262 and of barcode 264.

In visible state III, transparent areas 270 and 272 show a color similar to the color of bars of barcodes 258, while transparent area 274 remains uncolored. Therefore, barcodes 260, 262 and 266 are preferably unreadable by a conventional barcode reader, while barcode 264 is readable by a conventional barcode reader. Additionally, in visible state III, HRQI assembly 200 has preferably not been exposed to a temperature less than the lower temperature threshold for at least the under-temperature time duration. Therefore, cold responsive coloring material 254 is preferably characterized by the first color thereof, for example colorless and transparent, and area 252 does not interfere with the readability of any of barcodes 260, 262, 264 and 266, while the first color of area 252 preferably prevents barcode 268 from being read. Thus, HRQI assembly 200 in visible state III presents a single machine-readable barcode typically readable by a conventional barcode reader, here exemplified as barcode 264 having numerical sequence 7290003804122.

It is appreciated that once HRQI assembly 200 assumes visible state III, HRQI assembly 200 preferably cannot thereafter revert to either of states I or II, notwithstanding that the temperature of HRQI assembly 200 and associated container 290 subsequently drops below the upper temperature threshold.

It is additionally appreciated that once having been supplied to NHRQI sub-assembly 202, QPRCM 240 is operative to assume a non-flowable state upon HRQI assembly 200 being exposed to a temperature below the upper temperature threshold, regardless of a visible state then displayed by HRQI assembly 200. Similarly, once having been supplied to NHRQI sub-assembly 202, QPRCM 240 is operative to assume a flowable state upon HRQI assembly 200 being exposed to a temperature exceeding the upper temperature threshold, regardless of a visible state then displayed by HRQI assembly 200.

Turning now particularly to FIG. 4C, it is seen that following an elapse of an additional time duration at a temperature exceeding the upper temperature threshold, such that the total cumulative elapsed time is at least the second over-temperature cumulative time duration, QPRCM 240 diffuses further through coloring material diffuser 220, including through portion 284.

Thus, when a temperature of container 290 and of HRQI assembly 200 associated therewith exceeds the upper temperature threshold for at least the second over-temperature cumulative time duration, the color visible through transparent area 274 is determined by the color of QPRCM 240. As seen particularly in FIG. 4C, upon a coloring of portion 284 by black QPRCM 240, transparent area 274 shows a black color, and HRQI assembly 200 thus preferably assumes visible state IV.

It is appreciated that the coloring of portion 284 by QPRCM 240, and thus the changing of the color visible through transparent area 274, changes an appearance of HRQI assembly 200, and more particularly, changes an appearance of barcode 264 and of barcode 266.

In visible state IV, each of transparent areas 270, 272 and 274 shows a color similar to the color of bars of barcodes 258. Therefore, barcodes 260, 262 and 264 are preferably unreadable by a conventional barcode reader, while barcode 266 is readable by a conventional barcode reader. Additionally, in visible state IV, HRQI assembly 200 has preferably not been exposed to a temperature less than the lower temperature threshold for at least the under-temperature time duration. Therefore, cold responsive coloring material 254 is preferably characterized by the first color thereof, for example colorless and transparent, and area 252 does not interfere with the readability of any of barcodes 260, 262, 264 and 266, while the first color of area 252 preferably prevents barcode 268 from being read. Thus, upon exposure of container 290 and of HRQI assembly 200 associated thereto to a temperature exceeding the upper temperature threshold for at least the second over-temperature cumulative time duration, HRQI assembly 200 assumes visible state IV. In visible state IV, HRQI assembly 200 preferably presents a single machine-readable barcode typically readable by a conventional barcode reader, here exemplified as barcode 266 having numerical sequence 7290003804115.

It is appreciated that once HRQI assembly 200 has assumed visible state IV, HRQI assembly 200 preferably cannot thereafter revert to any of states I, II and III, notwithstanding that the temperature of HRQI assembly 200 and associated container 290 subsequently drops below the upper temperature threshold.

Turning now particularly to FIG. 4D, it is seen that when a temperature of container 290 and of HRQI assembly 200 associated therewith falls below the lower temperature threshold for at least the under-temperature time duration, cold responsive coloring material 254 irreversibly assumes the second color, and HRQI assembly 200 assumes visible state V.

It is appreciated that the assumption of the second color by cold responsive coloring material 254 changes an appearance of HRQI assembly 200, and more particularly, changes an appearance of barcodes 260, 262, 264, 266 and 268.

It is appreciated that once cold responsive coloring material 254 assumes the second color, area 252 preferably prevents any of barcodes 260, 262, 264 and 266 from being read, while the second color of area 252 preferably allows barcode 268 to be read. It is appreciated that in visible state V, transparent areas 248 may show any color, since the second color of cold responsive coloring material 254 in area 252 preferably prevents barcodes 260, 262, 264 and 266 from being read regardless of a color visible through any of transparent areas 248.

Thus, upon exposure of container 290 and of HRQI assembly 200 associated therewith to a temperature below the lower temperature threshold for at least the under-temperature time duration, HRQI assembly 200 assumes visible state V. In visible state V, HRQI assembly 200 preferably presents a single machine-readable barcode typically readable by a conventional barcode reader, here exemplified as barcode 268 having numerical sequence 7290003804139.

It is appreciated that once HRQI assembly 200 assumes visible state V, HRQI assembly 200 preferably cannot thereafter revert to any of states I, II, III and IV, notwithstanding that the temperature of HRQI assembly 200 and associated container 290 subsequently exceeds the lower temperature threshold, or even the upper temperature threshold.

It is noted that while it is typically undesirable to associate container 290 to NHRQI sub-assembly 202 to which QPRCM 240 has not been supplied, in the illustrated embodiment of the present invention, NHRQI sub-assembly 202 without QPRCM 240 may be operative to assume visible state V.

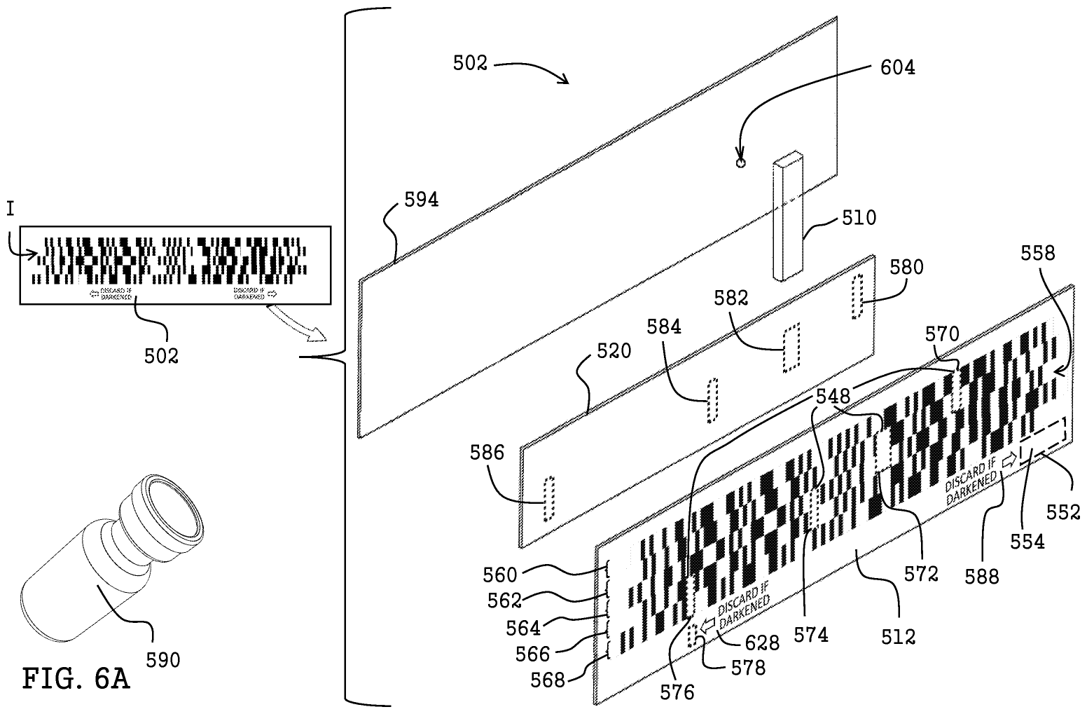

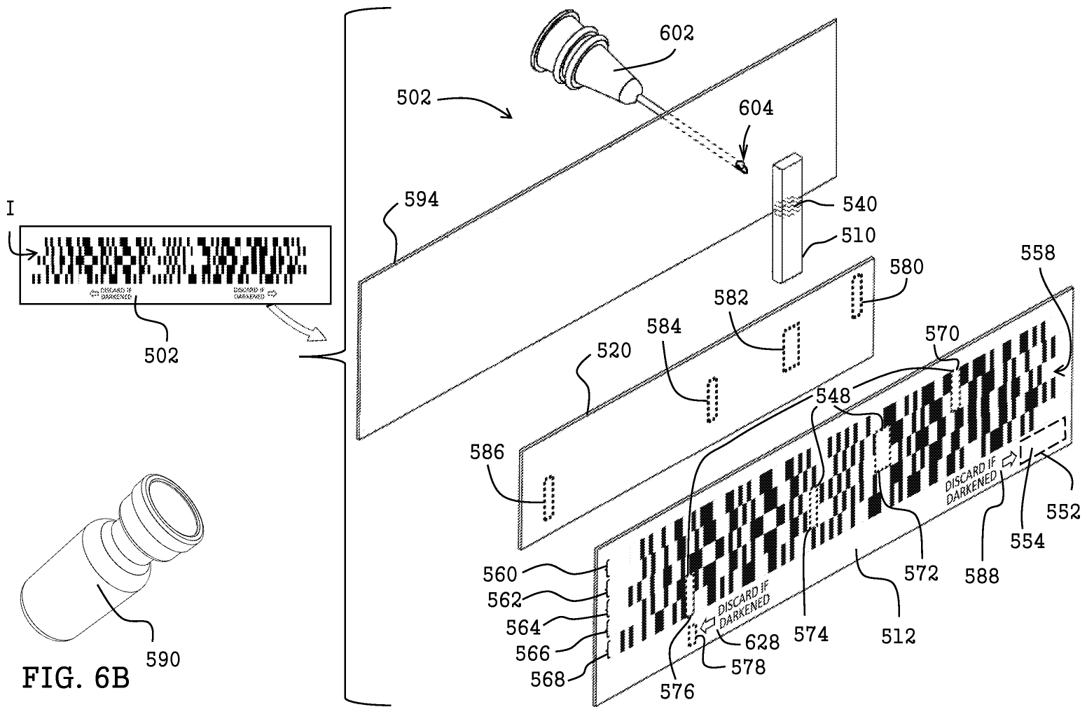

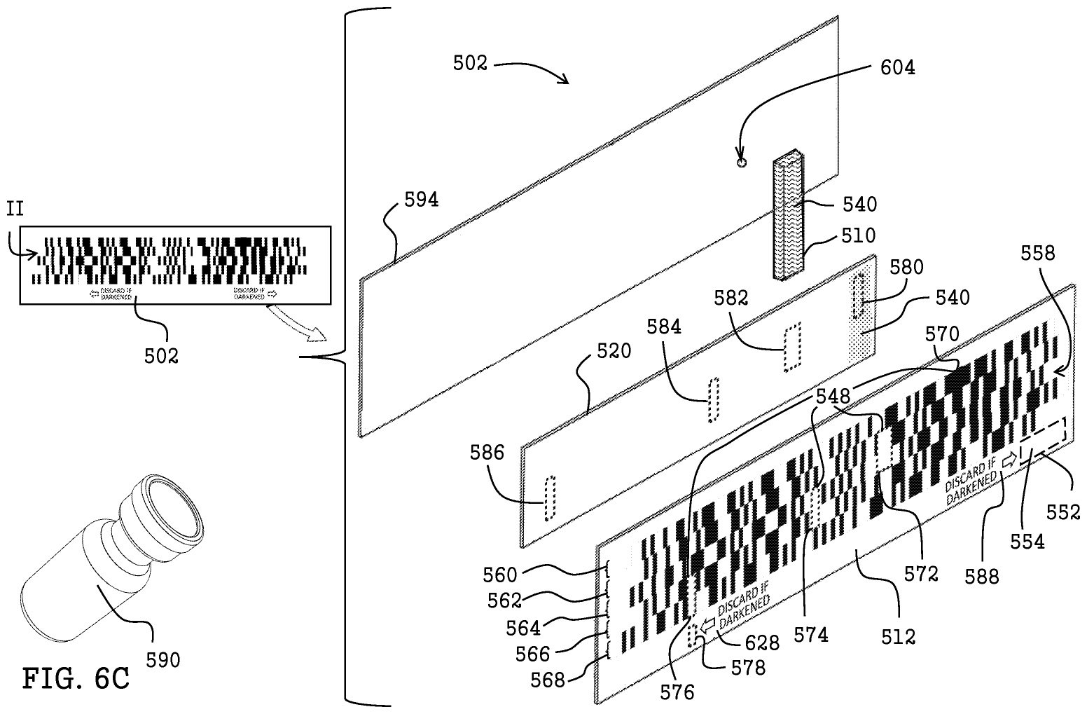

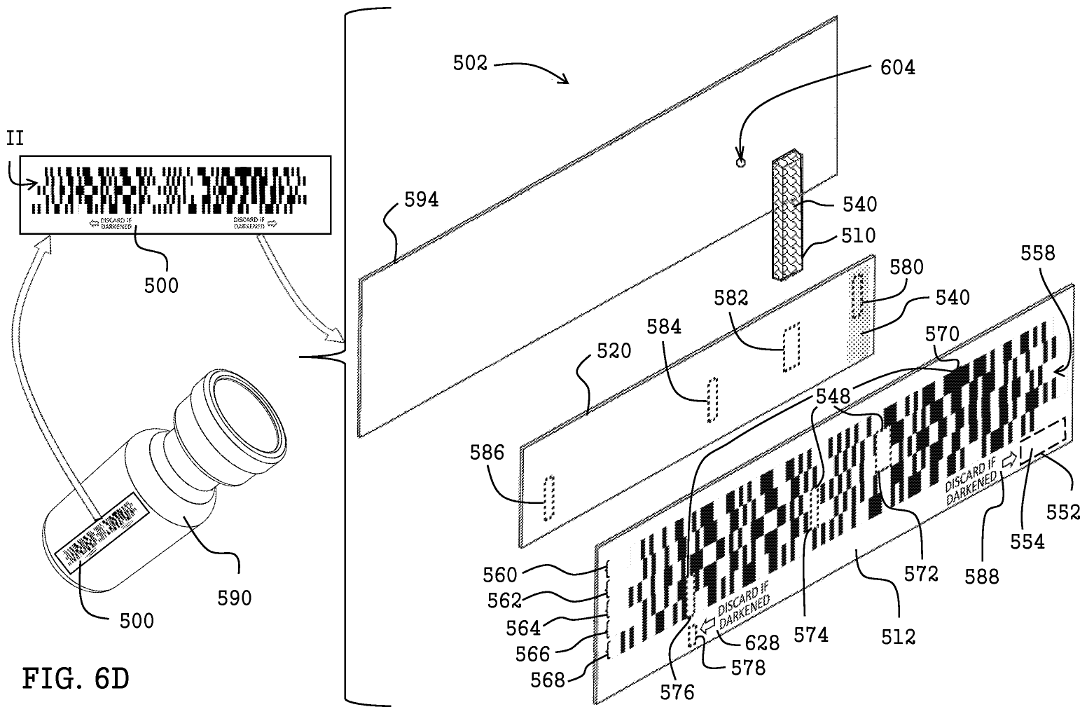

Reference is now made to FIG. 5, which is a simplified illustration of a heat responsive coloring material supplier (HRCMS) 490, which is an example of one or both of HRCMSs 102 and 107 of FIGS. 1A-1E, and to FIGS. 6A-6D, which together are a simplified illustration of a preferred method of construction of a heat responsive quality indicator (HRQI) 500, which is an embodiment of one or both of HRQI assemblies 100 and 105 of FIGS. 1A-1E.

HRQI assembly 500 preferably includes a shelf-stable, non-heat responsive quality indicator (NHRQI) sub-assembly 502 including at least one coloring material reservoir 510, at least one indicator template 512 and at least one coloring material diffuser 520. HRQI assembly 500 preferably additionally includes a quality parameter responsive coloring material (QPRCM) 540. In a preferred embodiment of the present invention, QPRCM 540 is a HRCM, which is flowable at a temperature exceeding an upper temperature threshold, as indicated by waved lines in corresponding figures.

QPRCM 540 is characterized by a viscosity and a melting point such that QPRCM 540 is flowable through or on coloring material diffuser 520 at temperatures above an upper temperature threshold and is not flowable through or on coloring material diffuser 520 at temperatures below the upper temperature threshold. Additionally, QPRCM 540 is preferably characterized by a color that is readily distinguishable from a color of coloring material diffuser 520.

QPRCM 540, when supplied to coloring material diffuser 520 of NHRQI sub-assembly 502, preferably converts NHRQI sub-assembly 502 to HRQI assembly 500, which is responsive to changes in temperature over time in exceedance of the upper temperature threshold, for changing an appearance of HRQI assembly 500. Thus, HRQI assembly 500 is formed by supplying QPRCM 540 to NHRQI sub-assembly 502, preferably by injecting QPRCM 540 into NHRQI sub-assembly 502.

When QPRCM 540 is flowable, QPRCM 540 preferably diffuses through coloring material diffuser 520. Conversely, when QPRCM 540 is not flowable, QPRCM 540 preferably does not diffuse through coloring material diffuser 520. Preferably, HRQI assembly 500 includes a quantity of QPRCM 540 sufficient to saturate the entirety or nearly the entirety of coloring material diffuser 520 following an exposure of HRQI assembly 500 to the upper temperature threshold for a predetermined cumulative time duration.

It is further appreciated that QPRCM 540 may additionally or alternatively be embodied as a coloring material that is responsive to at least one alternative or additional quality parameter, including, inter alia, moisture, force, pressure, pH and elapsed time. In such a case, HRQI assembly 500 is preferably embodied as at least, inter alia, a moisture responsive quality indicator, a force responsive quality indicator, a pressure responsive quality indicator, a pH responsive quality indicator and an elapsed time responsive quality indicator, respectively.

In one embodiment of the present invention, (not shown), QPRCM 540 is supplied directly to coloring material diffuser 520. In such an embodiment, coloring material reservoir 510 may be obviated.

In another embodiment of the present invention, as seen particularly in FIGS. 5-6D, QPRCM 540 is supplied indirectly to coloring material diffuser 520. In such an embodiment, QPRCM 540 is preferably supplied to coloring material reservoir 510, and coloring material reservoir 510 supplies QPRCM 540 to coloring material diffuser 520.

In a preferred embodiment of the present invention, coloring material diffuser 520 is embodied as filter paper, such as Whatman No. 3 filter paper commercially available from Whatman International [CAT #: 1003917]. Additionally, coloring material reservoir 510 is preferably embodied as a pad, for example, K-R; 210/34/28, commercially available from Noam-Urim of Kibbutz Urim, Israel, and QPRCM 540 is preferably embodied as a coloring agent, such as Sudan Black, a black color dye [CAS: 4197-25-5], combined at a ratio of 1.4 grams per 1 kilogram in Decyl Decanoate [CAS: 1654-86-0].

Preferably, indicator template 512 includes a transparent substrate on which is formed non-transparent printing. In a preferred embodiment of the present invention, all areas on the transparent substrate which are desired to be opaque, including both a background and areas in which features will be printed, are printed with white ink, and a plurality of features, such as bars forming part of barcodes corresponding to barcodes 110 or 111 of FIGS. 1A-1E, are preferably printed with black ink over the white ink as desired.

In another embodiment of the present invention, a background area of indicator template 512 is printed with white ink; however, the white ink is not deposited in the areas in which the plurality of features are formed, and the plurality of features are preferably printed with black ink.

More generally, in all embodiments of the present invention, the background area of indicator template 512 and the plurality of features of indicator template 512 are printed in such colors as to define high contrast therebetween.

Indicator template 512 preferably further includes at least one transparent area 548, indicated by dotted lines in FIGS. 6A-6D. It is appreciated that the dotted lines indicating transparent area or areas 548 are drawn for ease of understanding, and preferably transparent area or areas 548 are not readily distinguishable from surrounding areas of indicator template 512. In a preferred embodiment of the present invention, transparent area or areas 548 are not printed, i.e., preferably no material is deposited on transparent area or areas 548. For the purposes of the present specification and claims, the term “transparent area” is defined so as to include within its scope areas that are either transparent or translucent.

Preferably, coloring material diffuser 520 is visible through the entirety of each of transparent areas 548. Thus, a color visible in each of transparent areas 548 is determined by a color of a portion of coloring material diffuser 520 located therebehind. In a preferred embodiment of the present invention, each of transparent areas 548 is initially white in color, and assumes a black color upon a coloring of coloring material diffuser 520 by QPRCM 540.

In a preferred embodiment of the present invention, indicator template 512 additionally includes at least one area 552 upon which is deposited a cold responsive coloring material 554, such as a thermochromic coloring material, such as irreversible thermochromic ink commercially available from CTI Technology, Colorado Springs, USA. Alternatively, area 552 and cold responsive coloring material 554 may be embodied as a commercially available cold responsive label, such as a Model 54000 Freeze Check™ temperature indicator commercially available from DeltaTrak Inc., Pleasanton, USA. It is appreciated that although, for ease of understanding, dashed lines in FIGS. 6A-6D indicate area 552, preferably area 552 is not readily distinguishable from surrounding areas of indicator template 512.

It is appreciated that as used herein, “cold responsive” is used to indicate an element or system that changes as a result of cold, wherein “cold” is used to indicate a temperature below a lower temperature threshold, such as a temperature at which cold responsive coloring material 554 typically changes color.

In a preferred embodiment of the present invention, cold responsive coloring material 554 is initially characterized by a first color, and irreversibly assumes a second color, which is different from the first color, upon exposure to a temperature below a lower temperature threshold, for example, below 2 degrees Celsius, for an under-temperature time duration. As described hereinabove, in one embodiment of the present invention, the under-temperature time duration is very short, preferably less than 60 seconds, more preferably less than 30 seconds, more preferably less than 15 seconds, even more preferably less than 10 seconds and most preferably less than 5 seconds. In another embodiment of the present invention, the under-temperature time duration is relatively long, and may be, for example, 5 minutes, 10 minutes, 20 minutes, 30 minutes or 45 minutes.

Thus, if the under-temperature time duration is very short, then cold responsive coloring material 554 preferably assumes the second color substantially immediately upon being exposed to a temperature below the lower temperature threshold. In contrast, if the under-temperature time duration is relatively long, for example 30 minutes, then cold responsive coloring material 554 assumes the second color only upon an exposure to a temperature less than the lower temperature threshold for at least 30 minutes.

It is appreciated that the first color and the second color assumed by cold responsive coloring material 554 may be any suitable colors which are discernable from one another. In one embodiment of the present invention, the first and second colors are readily discernable from one another by a human. Additionally or alternatively, the first and second colors are readily discernable from one another by a machine. For example, in one embodiment of the present invention, cold responsive coloring material 554 characterized by the first color is colorless and transparent, and cold responsive coloring material 554 characterized by the second color is blue. In another embodiment of the present invention, cold responsive coloring material 554 characterized by the first color is green, and cold responsive coloring material 554 characterized by the second color is colorless and transparent.

It is appreciated that while the embodiment illustrated in FIGS. 5-6D includes cold responsive coloring material 554, in another embodiment of the present invention, HRQI assembly 500 does not include cold responsive coloring material 554.

In the example illustrated in FIGS. 5-6D, indicator templates 512 includes a plurality of barcodes 558, such as barcodes 110 or 111, including a first barcode 560, a second barcode 562, a third barcode 564, a fourth barcode 566 and a fifth barcode 568, which are preferably different from each other and arranged in a stacked arrangement. As indicated by dotted lines, formed within barcodes 558 are transparent areas 548, including a transparent area 570, a transparent area 572, a transparent area 574 and a transparent area 576. In the example illustrated in FIGS. 5-6D, indicator templates 512 further includes human sensible indicia, including area 552 and a transparent area 578.

It is appreciated that human sensible indica corresponding to at least one of area 552 and transparent area 578 may also be included in the embodiment described hereinabove with reference to FIGS. 2-4D.

As described hereinabove, coloring material diffuser 520 is preferably visible through the entirety of each of transparent areas 548. More particularly, a portion 580 of coloring material diffuser 520 is preferably visible through transparent area 570, a portion 582 of coloring material diffuser 520 is preferably visible through transparent area 572, a portion 584 of coloring material diffuser 520 is preferably visible through transparent area 574 and a portion 586 of coloring material diffuser 520 is preferably visible through transparent areas 576 and 578. Thus, it is appreciated that a color visible in each of transparent areas 570, 572, 574 and 576 is determined by a color of each of portions 580, 582, 584 and 586, respectively, and that a color visible in transparent area 578 is determined by a color of portion 586. It is appreciated that although, for ease of understanding, dotted lines in FIGS. 6A-6D indicate each of portions 580, 582, 584 and 586, preferably portions 580, 582, 584, and 586 are not readily distinguishable from surrounding areas of coloring material diffuser 520.

Preferably, each of transparent areas 570, 572, 574 and 576 is formed within at least two of barcodes 558 and forms a readable portion thereof. In the illustrated embodiment of FIGS. 6A-7E, transparent area 570 forms part of barcodes 560 and 562, transparent area 572 forms part of barcodes 562 and 564, transparent area 574 forms part of barcodes 564 and 566 and transparent area 576 forms part of barcodes 566 and 568. Each of transparent areas 548 preferably has the same width as a single barcode bar. Alternatively, the width of any of the transparent areas 570, 572, 574 and 576 may be different from the width of a single barcode bar. Additionally, the width of the portion of a transparent area 548 which forms part of one of barcodes 558 may be different from the width of the portion of the same transparent area 548 which forms part of another of barcodes 558.

It is appreciated that barcodes 560, 562, 564, 566 and 568 may be arranged in any suitable order with respect to one another. Similarly, transparent areas 570, 572, 574 and 576 may be arranged in any suitable order with respect to one another. Furthermore, it is appreciated that at least one of barcodes 560, 562, 564, 566 and 568 and/or transparent areas 570, 572, 574, 576 and 578 may be obviated from indicator template 512 and HRQI assembly 500. Similarly, one or more additional barcodes and/or transparent areas may be added to indicator template 512 and HRQI assembly 500.

In a preferred embodiment of the present invention, a different single one of barcodes 558 is machine-readable at each of visible states I, II, III, IIIa, and IV. For example, in the example illustrated in FIGS. 5-6D, barcode 560 is read as 7290003804191 at pre-supply visible state I, barcode 562 is read as 7290003804108 at post-supply visible state II, barcode 564 is read as 7290003804122 in visible state III, barcode 566 is read as 7290003804115 in a visible state IIIa and barcode 568 is read as 7290003804139 in visible state IV. Preferably, each of barcodes 558 is machine-readable only in the single one of visible states I, II, III, IIIa and IV listed above.

As seen particularly in FIGS. 6A-6D, when coloring material diffuser 520 is in an uncolored state, meaning that QPRCM 540 has not been supplied to coloring material diffuser 520, coloring material diffuser 520 causes each of transparent areas 570, 572, 574, 576 and 578 to appear white in color. The white appearance of transparent area 570 preferably allows barcode 560 to be machine-readable, while the white appearance of transparent areas 570, 572, 574 and 576 preferably causes barcodes 562, 564, 566 and 568 to be non-machine-readable. Thus, when coloring material diffuser 520 is in an uncolored state and NHRQI sub-assembly 502 has not been exposed to a temperature less than the lower temperature threshold, NHRQI sub-assembly 502 is preferably in pre-supply visible state I, wherein only barcode 560 is in a machine-readable state.

Additionally, as long as NHRQI sub-assembly 502 has not been exposed to a temperature less than the lower temperature threshold, cold responsive coloring material 554 is preferably characterized by the first color thereof, for example colorless and transparent, and area 552 provides an indication that a temperature of NHRQI sub-assembly 502 has not fallen below the lower temperature threshold.

In the embodiment illustrated in FIGS. 5-6D, area 552 and cold responsive coloring material 554 thereon preferably provide a human sensible indication of whether or not a temperature of NHRQI sub-assembly 502 has fallen below the lower temperature threshold for the under-temperature time duration. In a preferred embodiment of the present invention, NHRQI sub-assembly 502 includes explanatory features, such as text and/or graphics, explaining at least one visible appearance of area 552. For example, in the illustrated embodiment, NHRQI sub-assembly 502 includes a message 588 “DISCARD IF DARKENED→” adjacent to area 552, thereby indicating to a user that if cold responsive coloring material 554 is characterized by the first color thereof, a temperature of NHRQI sub-assembly 502 has not fallen below the lower temperature threshold for the under-temperature time duration, but if cold responsive coloring material 554 is characterized by the second color thereof, a temperature of NHRQI sub-assembly 502 has fallen below the lower temperature threshold for the under-temperature time duration.

Typically, if QPRCM 540 has not yet been supplied to NHRQI sub-assembly 502, a characterization of cold responsive coloring material 554 by the second color thereof indicates to a user that NHRQI sub-assembly 502 should not be associated with a product package and should be discarded. Similarly, if QPRCM 540 has been supplied to NHRQI sub-assembly 502, thus forming HRQI assembly 500, and HRQI assembly 500 has been associated with a product package, a characterization of cold responsive coloring material 554 by the second color thereof indicates to a user that the product package with which HRQI assembly 500 is associated should be discarded.

It is appreciated that in the embodiment illustrated in FIGS. 5-6D, area 552 and cold responsive coloring material 554 thereon preferably additionally provide a machine-sensible indication of whether or not a temperature of NHRQI sub-assembly 502 has fallen below the lower temperature threshold for the under-temperature time duration. Preferably, a system such as a suitably programmed machine vision system is operative to assess a color visible in area 552 and provide a suitable indication based thereon.

As seen in FIG. 6A, a container 590, such as, inter alia, package 101 or carton 106, is ready to be associated with an HRQI assembly 500. It is appreciated that container 590 is typically a product package, and may be embodied as, inter alia, an individual product package, a box of product packages, a pallet of product packages or a shipping container of product packages. In a preferred embodiment of the present invention, a type of container 590 with which an HRQI assembly 500 is associated, and more particularly a number of individual products contained by the container 590 associated with HRQI assembly 500, is at least partially determined by a relationship between a cost of monitoring container 590, a temperature-sensitivity of a product within container 590 and a financial value of a product within container 590.

Preferably, as further seen in FIG. 6A, QPRCM 540 has not yet been supplied to NHRQI sub-assembly 502, and therefore NHRQI sub-assembly 502 is preferably not yet associated with container 590. As described hereinabove, prior to a supply of QPRCM 540 to NHRQI sub-assembly 502, NHRQI sub-assembly 502 has not been exposed to a temperature less than the lower temperature threshold and is preferably in pre-supply visible state I.

Preferably, in visible state I, barcode 560 is typically readable by a conventional barcode reader, such as barcode reader 113, mobile communicator 132 or mobile communicator 142 of FIGS. 1A-1E, and barcodes 562, 564, 566 and 568 are preferably not readable by a barcode reader. Thus, the NHRQI sub-assembly 502 is in pre-supply visible state I and presents a single machine-readable barcode 560, typically readable by a conventional barcode reader as 7290003804191.

NHRQI sub-assembly 502 is preferably embodied as a self-adhesive label. Typically, after fabrication of NHRQI sub-assemblies 502 and before QPRCM 540 is supplied thereto, NHRQI sub-assemblies 502 are stored on a roll liner 592. NHRQI sub-assembly 502 includes a back portion 594, on a rear side (not shown) of which is preferably an adhesive (not shown). The adhesive preferably serves to affix NHRQI sub-assembly 502 to roll liner 592. Typically, following the production of HRQI assembly 500, the adhesive on NHRQI sub-assembly 502 is also used to affix HRQI assembly 500 to container 590.

As seen particularly in FIGS. 5 and 6B, HRCMS 490 preferably includes a coloring material supplier 598, such as injection module 104 of FIG. 1A, which includes at least one injector 602, such as a needle assembly. In a preferred embodiment of the present invention, coloring material supplier 598 includes a heating assembly 603, such as a resistive heating assembly. If an ambient temperature of coloring material supplier 598 is below the upper temperature threshold of QPRCM 540 while coloring material supplier 598 supplies QPRCM 540 to NHRQI sub-assembly 502, heating assembly 603 provides heat to QPRCM 540 during the supply thereof to NHRQI sub-assembly 502, thereby maintaining QPRCM 540 at a temperature at which QPRCM 540 is flowable during the supply thereof to NHRQI sub-assembly 502.

Typically, coloring material supplier 598 supplies QPRCM 540 to NHRQI sub-assembly 502 while NHRQI sub-assembly 502 is affixed to roll liner 592. In the embodiment shown in FIGS. 5-6D, coloring material supplier 598 supplies QPRCM 540 to coloring material reservoir 510, and coloring material reservoir 510 then supplies QPRCM 540 to coloring material diffuser 520. In another embodiment of the present invention, coloring material supplier 598 supplies QPRCM 540 directly to coloring material diffuser 520, and coloring material reservoir 510 may be obviated.

In a preferred embodiment of the present invention, QPRCM 540 is supplied to NHRQI sub-assembly 502 immediately prior to the association of HRQI assembly 500 with container 590. In other words, QPRCM 540 is preferably supplied to NHRQI sub-assemblies 502 as NHRQI sub-assemblies 502 are being positioned for imminent association with containers 590. Thus, in the illustrated embodiment shown in FIG. 5, as roll liner 592 is unspooled to make NHRQI sub-assemblies 502 available for affixation to containers 590, QPRCM 540 is supplied to NHRQI sub-assemblies 502.

Preferably, an aperture 604 is formed in back portion 594 of NHRQI sub-assembly 502. As seen particularly in FIG. 6B, QPRCM 540 is preferably supplied by injector 602 to NHRQI sub-assembly 502 through aperture 604. In the illustrated embodiment of the present invention, aperture 604 enables fluid communication between injector 602 and coloring material reservoir 510, which in turn is in fluid communication with coloring material diffuser 520. In another embodiment of the present invention, in which coloring material reservoir 510 may be obviated, aperture 604 enables fluid communication directly between injector 602 and coloring material diffuser 520.

Preferably, a plurality of apertures 614 are formed on roll liner 592, and each of apertures 614 is generally aligned with one of apertures 604. It is appreciated that apertures 604 and 614 may be formed either during respective fabrications of NHRQI sub-assembly 502 and roll liner 592, or as part of the supply of QPRCM 540 to NHRQI sub-assembly 502. Alternatively, one of plurality of apertures 604 and 614 may be formed during a respective fabrication of NHRQI sub-assembly 502 and roll liner 592, and the other of plurality of apertures 604 and 614 may be formed as part of the supply of QPRCM 540 to NHRQI sub-assembly 502. Typically, in an embodiment wherein at least one of plurality of apertures 604 and 614 is formed as part of the supply of QPRCM 540 to NHRQI sub-assembly 502, the at least one of plurality of apertures 604 and 614 is formed by injector 602.

As described above, in the embodiment illustrated in FIGS. 5 and 6B, QPRCM 540 is supplied to NHRQI sub-assembly 502 via aperture 604 shown on back portion 594 of NHRQI sub-assembly 502 prior to, preferably immediately prior to, associating HRQI assembly 500 with container 590. In an alternative embodiment of the present invention, QPRCM 540 is supplied to NHRQI sub-assembly 502 after associating NHRQI sub-assembly 502 with container 590. In an embodiment wherein the supply of QPRCM 540 to NHRQI sub-assembly 502 occurs after associating NHRQI sub-assembly 502 with container 590, coloring material supplier 598 and apertures 614 may be obviated, and aperture 604 may be obviated or located elsewhere on NHRQI sub-assembly 502.

In an embodiment wherein QPRCM 540 is supplied to NHRQI sub-assembly 502 following the association of NHRQI sub-assembly 502 with container 590, for example, an injector may supply QPRCM 540 to NHRQI sub-assembly 502 through an aperture formed in a front surface or a side surface of NHRQI sub-assembly 502.

In a preferred embodiment of the present invention, HRQI assembly 500 also includes explanatory features, such as text and/or graphics, explaining at least one visible appearance of transparent area 578. For example, in the illustrated embodiment, HRQI assembly 500 includes a message 628, with the text “DISCARD IF DARKENED→”, adjacent to transparent area 578.

Turning now particularly to FIG. 6C, it is seen that immediately following a supply of QPRCM 540 to NHRQI sub-assembly 502, portion 580 of coloring material diffuser 520 preferably becomes colored with QPRCM 540, and thus the color visible through transparent area 570 is determined by the color of QPRCM 540. In the example shown in FIGS. 5-6D, as seen particularly in FIG. 6C, immediately following a supply of QPRCM 540 to NHRQI sub-assembly 502, transparent area 570 shows a black color, and HRQI assembly 500 thus preferably assumes post-supply visible state II immediately following a supply of QPRCM 540 to NHRQI sub-assembly 502.

It is appreciated that the coloring of portion 580 by QPRCM 540, and thus the changing of the color visible through transparent area 570, changes an appearance of HRQI assembly 500, and more particularly, changes an appearance of barcode 560 and of barcode 562.

In post-supply visible state II, transparent area 570 shows a color similar to the color of bars of barcodes 558, while transparent areas 572, 574, 576 and 578 remain uncolored. Therefore, barcodes 560, 564, 566 and 568 are preferably unreadable by a conventional barcode reader, such as barcode reader 113, mobile communicator 132 or mobile communicator 142 of FIGS. 1A-1E, and only barcode 562 is readable by a conventional barcode reader. Thus, HRQI assembly 500 in post-supply visible state II presents a single machine-readable barcode typically readable by a conventional barcode reader, here exemplified as barcode 562 having numerical sequence 7290003804108. Additionally, at post-supply visible state II, HRQI assembly 500 has preferably not been exposed to a temperature less than the lower temperature threshold for at least the under-temperature time duration. Therefore, cold responsive coloring material 554 is preferably characterized by the first color thereof, for example colorless and transparent, such that area 552 provides an indication that a temperature of NHRQI sub-assembly 502, and thus a temperature of HRQI assembly 500, has not fallen below the lower temperature threshold.

It is appreciated that once HQRI assembly 500 assumes visible state II, HRQI assembly 500 preferably cannot thereafter revert to visible state I.

Preferably, QPRCM 540 is supplied in a flowable state, as indicated by waved lines in FIGS. 6B & 6C, to NHRQI sub-assembly 502. In order to maintain a flowable state thereof, QPRCM 540 is typically supplied to NHRQI sub-assembly 502 at a temperature exceeding the upper temperature threshold. However, as seen particularly in enlargement circle B of FIG. 5 and in FIG. 6D, following supply of QPRCM 540 to NHRQI sub-assembly 502, HRQI assembly 500 is cooled to, and maintained at, a temperature which does not exceed the upper temperature threshold, such that QPRCM 540 is no longer flowable, as indicated by interlocking lines in enlargement circle B of FIG. 5 and in FIG. 6D.

In one embodiment of the present invention, HRCMS 490 includes at least one cooling system 630. Preferably, following a supply of QPRCM 540 to NHRQI sub-assembly 502, HRQI assembly 500 is brought into thermal contact with cooling system 630, thereby rapidly reducing the temperature of HRQI assembly 500 to a temperature below the upper temperature threshold, so that QPRCM 540 is no longer flowable. It is appreciated that cooling system 630 preferably does not cool HRQI assembly 500 to a temperature below the lower temperature threshold, and thus cold responsive coloring material 554 does not change color in response to temperature conditions within cooling system 630.

In another embodiment of the present invention, cooling system 630 may be obviated, and following the supply of QPRCM 540 to NHRQI sub-assembly 502, HRQI assembly 500 may be cooled to a temperature below the upper temperature threshold, such that QPRCM 540 is no longer flowable, after being associated with container 590. In this embodiment, cooling of HRQI assembly 500 is preferably effected by thermal contact with container 590 which, at the time of the association of HRQI assembly 500 therewith, is at a temperature below the upper temperature threshold. Alternatively, HRQI assembly 500 may be cooled by placing HQRI assembly 500 and the associated container 590 in a cold storage environment, such as a refrigerator. It is appreciated that the temperature of HQRI assembly 500 and associated container 590 is preferably not less than the lower temperature threshold, and thus cold responsive coloring material 554 does not change color in response to temperature conditions of container 590 at the time of association of HQRI assembly 500 with container 590.

As described hereinabove with reference to FIGS. 1A-1E, NHRQI sub-assembly 502 is preferably embodied as a self-adhesive label, and the association of HRQI assembly 500 with container 590 is preferably embodied as an affixation of HRQI assembly 500 to container 590, and more particularly as an adherence of HRQI assembly 500 to container 590. It is noted that the adhesive on the rear side of back portion 594 of HRQI assembly 500 preferably serves to affix HRQI assembly 500 to container 590, and that the adhesion of HRQI assembly 500 to container 590 preferably serves to seal aperture 604, preventing an egress of QPRCM 540 therefrom.

It is appreciated that in an embodiment wherein QPRCM 540 is supplied to NHRQI sub-assembly 502 after associating NHRQI sub-assembly 502 with container 590, cooling system 630 is typically not included in HRCMS 490. Instead, HRQI assembly 500 is cooled only after being associated with container 590. Similarly, in such an embodiment, if an aperture is included on a front or a side surface of NHRQI sub-assembly 502, the aperture may be sealed with a suitable sealant, preventing an egress of QPRCM 540 therefrom.

As illustrated in FIGS. 6A & 6B, in one embodiment of the present invention, NHRQI sub-assembly 502 is not yet associated with container 590. Similarly, as illustrated in FIG. 6C, immediately after the supply of QPRCM 540 to HRQI assembly 500, HRQI assembly 500 is preferably still not associated with container 590.

As illustrated in FIG. 5, in one embodiment of the present invention, HRQI assembly 500 is cooled to a temperature below the upper temperature threshold before being associated with container 590, preferably by cooling system 630. In an alternative embodiment, HRQI assembly 500 may be cooled by placing HQRI assembly 500 and associated container 590 in a cold storage environment, such as a refrigerator. Thus, the lowering of the temperature of QPRCM 540 and the association of HRQI assembly 500 with container 590 are separate steps.

However, in another embodiment of the present invention, as illustrated in FIG. 6D, HRQI assembly 500 is cooled to a temperature below the upper temperature threshold only after being associated with container 590. As described hereinabove, in this embodiment, cooling of HRQI assembly 500 is preferably effected by thermal contact with container 590 which, at the time of the association of HRQI assembly 500 therewith, is at a temperature below the upper temperature threshold. Thus, the lowering of the temperature of QPRCM 540 and the association of HRQI assembly 500 with container 590 are achieved in a single step.

In a preferred embodiment of the present invention, HRCMS 490 further includes a barcode reader 640, which preferably reads barcodes 558 substantially immediately prior to an association of HRQI assembly 500 or NHQRI sub-assembly 502 with container 590. Barcode reader 640, upon reading barcodes 558, preferably provides information to a quality indication computer, such as quality indication computer 115, which enables the quality indication computer to provide an immediate indication of a quality status of the HRQI assembly 500 or NHQRI sub-assembly 502 read by barcode reader 640.

If barcode reader 640 provides an indication that an HRQI assembly 500, or in an undesirable case wherein QPRCM 540 was not supplied to an NHRQI sub-assembly 502, an NHRQI sub-assembly 502, is unfit for use, then the HRQI assembly 500 or NHRQI sub-assembly 502 is preferably discarded and is not associated with a container 590. Examples of an HRQI assembly 500 or NHRQI sub-assembly 502 that is unfit for use include an HRQI assembly 500 or NHRQI sub-assembly 502 that is in pre-supply visible state I, that is in visible state V, or that is unreadable by a typical barcode reader, for example, due to damage to barcodes 558.

In another preferred embodiment of the present invention (not shown) barcode reader 640 is obviated, and is replaced with a conventional barcode reader, such as barcode reader 113, mobile communicator 132 or mobile communicator 142 of FIGS. 1A-1E, which is not part of HRCMS 490.

In a preferred embodiment of the present invention, HRCMS 490 further includes a container association module 660. If an indication is provided, for example by barcode reader 640 or barcode reader 113, that an HRQI assembly 500 is fit for use, then container association module 660 preferably associates that HRQI assembly 500 with a container 590. In a preferred embodiment of the present invention, container association module 660 positions HRQI assembly 500 relative to container 590 such that the adhesive on the rear side of HRQI assembly 500 contacts container 590, thereby affixing HRQI assembly 500 to container 590.

In the embodiment illustrated in FIG. 5, barcode reader 640 is shown as being part of container association module 660. Alternatively, barcode reader 640 may be separate from container association module 660.

Reference is now made to FIGS. 7A-7E, which are simplified illustrations of typical operative use cases of HRQI assembly 500.

It is appreciated that in the operative states shown in FIGS. 7A-7D, HRQI assembly 500 has not been exposed to a temperature below the lower temperature threshold for at least the under-temperature time duration. Therefore, cold responsive coloring material 554 is preferably characterized by the first color thereof, for example colorless and transparent.

It is further appreciated that although, for ease of understanding, dotted lines in FIGS. 7A-7E indicate each of transparent areas 548 and portions 580, 582, 584 and 586, preferably transparent areas 548 and portions 580, 582, 584 and 586 are not readily distinguishable from surrounding areas of indicator template 512 and coloring material diffuser 520, respectively. Similarly, for ease of understanding, dashed lines in FIGS. 7A-7E indicate areas 552 and 578; however, areas 552 and 578 may not be readily distinguishable from surrounding areas of indicator template 512.

Following the supply of QPRCM 540 to NHRQI sub-assembly 502 and when a temperature of HRQI assembly 500 exceeds the upper temperature threshold, QPRCM 540 assumes a flowable state, as indicated by waved lines in FIG. 7A. In an embodiment wherein HRQI assembly 500 includes coloring material reservoir 510, upon assuming a flowable state, QPRCM 540 is released from coloring material reservoir 510 and begins to diffuse through coloring material diffuser 520. In an embodiment wherein HRQI assembly 500 does not include coloring material reservoir 510, upon assuming a flowable state, QPRCM 540 begins to diffuse through coloring material diffuser 520. It is appreciated that respective first, second and third over-temperature cumulative time durations from the start of diffusion of QPRCM 540 along coloring material diffuser 520 until respective portions 582, 584 and 586 of coloring material diffuser 520 become colored is defined, for example, by a length of coloring material diffuser 520 between portion 580 and each of portions 582, 584 and 586. Additionally, these time durations are typically a function of a composition of QPRCM 540, as well as a function of a material from which coloring material diffuser 520 is made and a thickness thereof.

For example, properties of QPRCM 540, coloring material diffuser 520, and transparent areas 572, 574, 576 and 578, such as composition and position thereof, may be chosen such that that the respective first, second and third over-temperature cumulative time durations from the start of diffusion of QPRCM 540 along coloring material diffuser 520 until QPRCM 540 colors portions 582, 584 and 586 of coloring material diffuser 520, which are visible through respective transparent areas 572, 574, 576 and 578 is one hour, two hours and four hours, respectively. However, it is appreciated that properties of QPRCM 540 and coloring material diffuser 520, as well as locations of transparent areas 572, 574, 576 and 578, may be chosen such that each of the first, second and third over-temperature cumulative time durations, from the start of diffusion of QPRCM 540 along coloring material diffuser 520 until QPRCM 540 colors portions 582, 586, and 584 of coloring material diffuser 520, which are visible through respective transparent areas 572, 574, 576 and 578, may be any suitable respective time duration.

Typically, the first, second and third over-temperature cumulative time durations, as well as the upper and lower temperature thresholds, are chosen based on the requirements of contents of container 590. For example, an HRQI assembly 500 for association with a flu vaccine may have a lower temperature limit of 2 degrees Celsius, while an HRQI assembly 500 for association with a COVID-19 vaccine may have a lower temperature limit of −70 degrees Celsius. Similarly, an HRQI assembly 500 for association with a package of frozen meat may have respective first, second and third over-temperature cumulative time durations of one hour, two hours and four hours, while an HRQI assembly 500 for association with a package of fresh meat may have respective first, second and third over-temperature cumulative time durations of 30 minutes, 45 minutes and one hour.

Turning particularly to FIG. 7A, it is seen that when a temperature of container 590, and of HRQI assembly 500 associated therewith, exceeds the upper temperature threshold for less than the first over-temperature cumulative time duration, QPRCM 540 begins to diffuse through coloring material diffuser 520 beyond portion 580 in a direction toward portion 582. However, as long as a temperature of container 590 and of HRQI assembly 500 associated therewith does not exceed the upper temperature threshold for at least the first over-temperature cumulative time duration, QPRCM 540 preferably does not color portion 582.

Thus, as long as a temperature of container 590 and of HRQI assembly 500 associated therewith does not exceed the upper temperature threshold for at least the first over-temperature cumulative time duration, none of portions 582, 584 and 586 become colored, and thus none of transparent areas 572, 574, 576 and 578 appear colored, and HRQI assembly 500 remains in visible state II, in which preferably only barcode 562 is in a readable state.

In contrast, as seen particularly to FIG. 7B, when a temperature of container 590 and of HRQI assembly 500 associated therewith exceeds the upper temperature threshold for at least the first over-temperature cumulative time duration, QPRCM 540 diffuses through portions of coloring material diffuser 520, including portion 582.

Thus, when a temperature of container 590 and of HRQI assembly 500 associated therewith exceeds the upper temperature threshold for at least the first over-temperature cumulative time duration, the color visible through transparent area 572 is determined by the color of QPRCM 540. As seen particularly in FIG. 7B, upon a coloring of portion 582 by black QPRCM 540, transparent area 572 shows a black color, and HRQI assembly 500 thus preferably assumes visible state III.

It is appreciated that the coloring of portion 582 by QPRCM 540, and thus the changing of the color visible through transparent area 572, changes an appearance of HRQI assembly 500, and more particularly, changes an appearance of barcode 562 and of barcode 564.

In visible state III, transparent areas 570 and 572 show a color similar to the color of bars of barcodes 558, while transparent areas 574, 576 and 578 remain uncolored. Therefore, barcodes 560, 562, 566 and 568 are preferably unreadable by a conventional barcode reader, while barcode 564 is readable by a conventional barcode reader. Thus, HRQI assembly 500 in visible state III presents a single machine-readable barcode typically readable by a conventional barcode reader, here exemplified as barcode 564 having numerical sequence 7290003804122.

Additionally, in visible state III, HRQI assembly 500 has preferably not been exposed to a temperature less than the lower temperature threshold for at least the under-temperature time duration. Therefore, cold responsive coloring material 554 is preferably characterized by the first color thereof, for example colorless and transparent, and area 552 provides an indication that a temperature of NHRQI sub-assembly 502, and thus a temperature of HRQI assembly 500, has not fallen below the lower temperature threshold.

It is appreciated that once HRQI assembly 500 assumes visible state III, HRQI assembly 500 preferably cannot thereafter revert to either of states I or II, notwithstanding that the temperature of HRQI assembly 500 and associated container 590 subsequently drops below the upper temperature threshold.

It is additionally appreciated that once having been supplied to NHRQI sub-assembly 502, QPRCM 540 is operative to assume a non-flowable state upon HRQI assembly 500 being exposed to a temperature below the upper temperature threshold, regardless of a visible state then displayed by HRQI assembly 500. Similarly, once having been supplied to NHRQI sub-assembly 502, QPRCM 540 is operative to assume a flowable state upon HRQI assembly 500 being exposed to a temperature exceeding the upper temperature threshold, regardless of a visible state then displayed by HRQI assembly 500.

Turning now particularly to FIG. 7C, it is seen that following an elapse of an additional time duration at a temperature exceeding the upper temperature threshold, such that the total cumulative elapsed time is at least the second over-temperature cumulative time duration, QPRCM 540 diffuses further through coloring material diffuser 520, including through portion 584.

Thus, when a temperature of container 590 and of HRQI assembly 500 associated therewith exceeds the upper temperature threshold for at least the second over-temperature cumulative time duration, the color visible through transparent area 574 is determined by the color of QPRCM 540. As seen particularly in FIG. 7C, upon a coloring of portion 584 by black QPRCM 540, transparent area 574 shows a black color, and HRQI assembly 500 thus preferably assumes visible state IIIa.

It is appreciated that the coloring of portion 584 by QPRCM 540, and thus the changing of the color visible through transparent area 574, changes an appearance of HRQI assembly 500, and more particularly, changes an appearance of barcode 564 and of barcode 566.

In visible state IIIa, transparent areas 570, 572 and 574 show a color similar to the color of bars of barcodes 558, while transparent areas 576 and 578 remain uncolored. Therefore, barcodes 560, 562, 564 and 568 are preferably unreadable by a conventional barcode reader, while barcode 566 is readable by a conventional barcode reader. Thus, HRQI assembly 500 in visible state IIIa presents a single machine-readable barcode typically readable by a conventional barcode reader, here exemplified as barcode 566 having numerical sequence 7290003804115.

Additionally, in visible state IIIa, HRQI assembly 500 has preferably not been exposed to a temperature less than the lower temperature threshold for at least the under-temperature time duration. Therefore, cold responsive coloring material 554 is preferably characterized by the first color thereof, for example colorless and transparent, and area 552 provides an indication that a temperature of NHRQI sub-assembly 502, and thus a temperature of HRQI assembly 500, has not fallen below the lower temperature threshold.

It is appreciated that once HRQI assembly 500 assumes visible state IIIa, HRQI assembly 500 preferably cannot thereafter revert to any of states I, II and III, notwithstanding that the temperature of HRQI assembly 500 and associated container 590 subsequently drops below the upper temperature threshold.

Turning now particularly to FIG. 7D, it is seen that following an elapse of an additional time duration at a temperature exceeding the upper temperature threshold, such that the total cumulative elapsed time is at least the third over-temperature cumulative time duration, QPRCM 540 diffuses further through coloring material diffuser 520, including through portion 586.

Thus, when a temperature of container 590 and of HRQI assembly 500 associated therewith exceeds the upper temperature threshold for at least the third over-temperature cumulative time duration, the color visible through transparent areas 576 and 578 is determined by the color of QPRCM 540. As seen particularly in FIG. 7D, upon a coloring of portion 586 by black QPRCM 540, transparent areas 576 and 578 each show a black color, and HRQI assembly 500 thus preferably assumes visible state IV.

It is appreciated that the coloring of portion 586 by QPRCM 540, and thus the changing of the color visible through transparent areas 576 and 578, changes an appearance of HRQI assembly 500, and more particularly, changes an appearance of barcode 566, barcode 568, and of the human sensible indicium of transparent area 578.

In visible state IV, each of transparent areas 570, 572, 574 and 576 shows a color similar to the color of bars of barcodes 558. Therefore, barcodes 560, 562, 564 and 566 are preferably unreadable by a conventional barcode reader, while barcode 568 is readable by a conventional barcode reader. Thus, upon exposure of container 590 and of HRQI assembly 500 associated thereto to a temperature exceeding the upper temperature threshold for at least the third over-temperature cumulative time duration, HRQI assembly 500 assumes visible state IV. In visible state IV, HRQI assembly 500 preferably presents a single machine-readable barcode typically readable by a conventional barcode reader, here exemplified as barcode 568 having numerical sequence 7290003804139.

Additionally, in visible state IV, transparent area 578 provides a human sensible indication that a temperature of HRQI assembly 500 has exceeded the upper temperature threshold for the third over-temperature cumulative time duration. As noted above, in a preferred embodiment of the present invention, HRQI assembly 500 includes explanatory features, such as text and/or graphics, explaining at least one visible appearance of transparent area 578. For example, in the illustrated embodiment, HRQI assembly 500 includes message 628, with the text “DISCARD IF DARKENED→”, adjacent to transparent area 578. Thus, message 628 indicates to a user that if a color visible through transparent area 578, as determined by a color of portion 586 of coloring material diffuser 520, is similar to a background color of indicator template 512, then a temperature of HRQI assembly 500 has not exceeded the upper temperature threshold for the third over-temperature cumulative time duration. Similarly, message 628 indicates to a user that if a color visible through transparent area 578 is not the same as the background color of indicator template 512, such as the color of QPRCM 540, then a temperature of HRQI assembly 500 has exceeded the upper temperature threshold for the third over-temperature cumulative time duration and container 590 with which HRQI assembly 500 is associated should be discarded.

In a preferred embodiment of the present invention, as described above, if either one or both of areas 552 and 578 indicates an unsuitable environment experienced by HRQI assembly 500, then the product being monitored by HRQI assembly 500 is not fit for use. Preferably, information is included with HRQI assembly 500, either as instructions separate from HRQI assembly 500 or as instructions forming part of HRQI assembly 500, indicating to a user and/or a machine reading HRQI assembly 500 that HRQI assembly 500 is not fit for use if either one or both of areas 552 and 578 indicates that HRQI assembly 500 has experienced an unsuitable environment for an unsuitable amount of time.

It is appreciated that in the embodiment illustrated in FIGS. 5-7E, transparent area 578 preferably additionally provides a machine-sensible indication of whether or not a temperature of HRQI assembly 500 has exceeded the upper temperature threshold for the third over-temperature cumulative time duration. Preferably, a system such as a suitably programmed machine vision system is operative to assess a color visible in transparent area 578 and provide a suitable indication based thereon.

Additionally, in visible state IV, HRQI assembly 500 has preferably not been exposed to a temperature less than the lower temperature threshold for at least the under-temperature time duration. Therefore, cold responsive coloring material 554 is preferably characterized by the first color thereof, for example colorless and transparent, and area 552 provides an indication that a temperature of NHRQI sub-assembly 502, and thus a temperature of HRQI assembly 500, has not fallen below the lower temperature threshold.

It is appreciated that once HRQI assembly 500 assumes visible state IV, HRQI assembly 500 preferably cannot thereafter revert to any of states I, II, III and IIIa, notwithstanding that the temperature of HRQI assembly 500 and associated container 590 subsequently drops below the upper temperature threshold.

Turning now particularly to FIG. 7E, it is seen that when a temperature of container 590 and of HRQI assembly 500 associated therewith falls below the lower temperature threshold for at least the under-temperature time duration, cold responsive coloring material 554 irreversibly assumes the second color, and HRQI assembly 500 assumes visible state V.

It is appreciated that the assumption of the second color by cold responsive coloring material 554 changes an appearance of HRQI assembly 500, and more particularly, changes an appearance of the human sensible indicium of area 552. As described hereinabove, cold responsive coloring material 554 is characterized by the second color thereof, thus providing a human sensible indication that a temperature of NHRQI sub-assembly 502, and thus a temperature of HRQI assembly 500, has fallen below the lower temperature threshold for the under-temperature time duration and container 590 with which HRQI assembly 500 is associated should be discarded.

It is noted that in the embodiment illustrated in FIGS. 7A-7E, the color assumed by cold responsive coloring material 554 does not typically affect an appearance or readability of any of barcodes 560, 562, 564, 566 and 568. Additionally, in visible state V, transparent areas 548 may show any color, since, regardless of a color visible through any of transparent areas 548, the second color of cold responsive coloring material 554 in area 552 preferably provides an indication that a temperature of NHRQI sub-assembly 502, and thus a temperature of HRQI assembly 500, has fallen below the lower temperature threshold for the under-temperature time duration.

As described hereinabove with reference to FIGS. 5-6D, area 552 preferably additionally may provide a machine-sensible indication of whether or not a temperature of NHRQI sub-assembly 502, and thus a temperature of HRQI assembly 500, has fallen below the lower temperature threshold for the under-temperature time duration. Preferably, a system such as a suitably programmed machine vision system is operative to assess a color visible in area 552 and provide a suitable indication based thereon. More specifically, in visible state V, cold responsive coloring material 554 is characterized by the second color thereof, which preferably indicates to the suitably programmed machine vision system that a temperature of NHRQI sub-assembly 502, and thus a temperature of HRQI assembly 500, has fallen below the lower temperature threshold for the under-temperature time duration.

Thus, upon exposure of container 590 and of HRQI assembly 500 associated therewith to a temperature below the lower temperature threshold for at least the under-temperature time duration, HRQI assembly 500 assumes visible state V, in which a human- and machine-sensible indication is provided that a temperature of NHRQI sub-assembly 502, and thus a temperature of HRQI assembly 500, has fallen below the lower temperature threshold for the under-temperature time duration.

It is appreciated that once HRQI assembly 500 assumes visible state V, HRQI assembly 500 preferably cannot thereafter revert to any of states I, II, III, IIIa and IV, notwithstanding that the temperature of HRQI assembly 500 and associated container 590 subsequently exceeds the lower temperature threshold, or even the upper temperature threshold.

It is noted that while it is typically undesirable to associate container 590 to NHRQI sub-assembly 502 to which QPRCM 540 has not been supplied, in the illustrated embodiment of the present invention, NHRQI sub-assembly 502 without QPRCM 540 may be operative to assume visible state V when a temperature thereof has fallen below the lower temperature threshold for the under-temperature time duration.

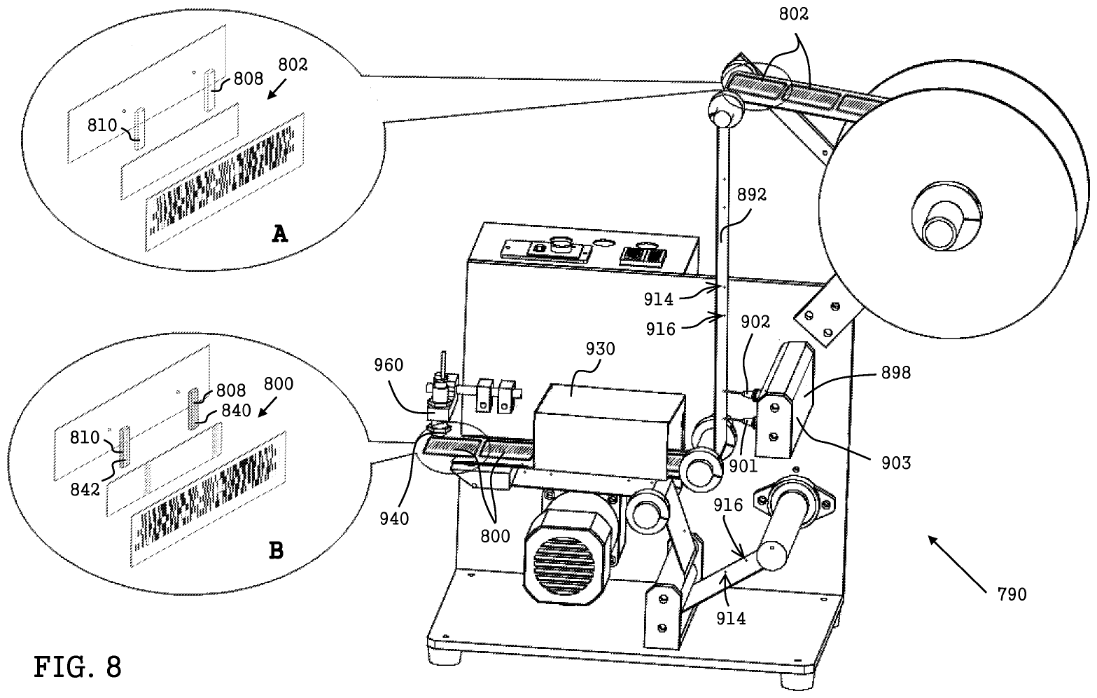

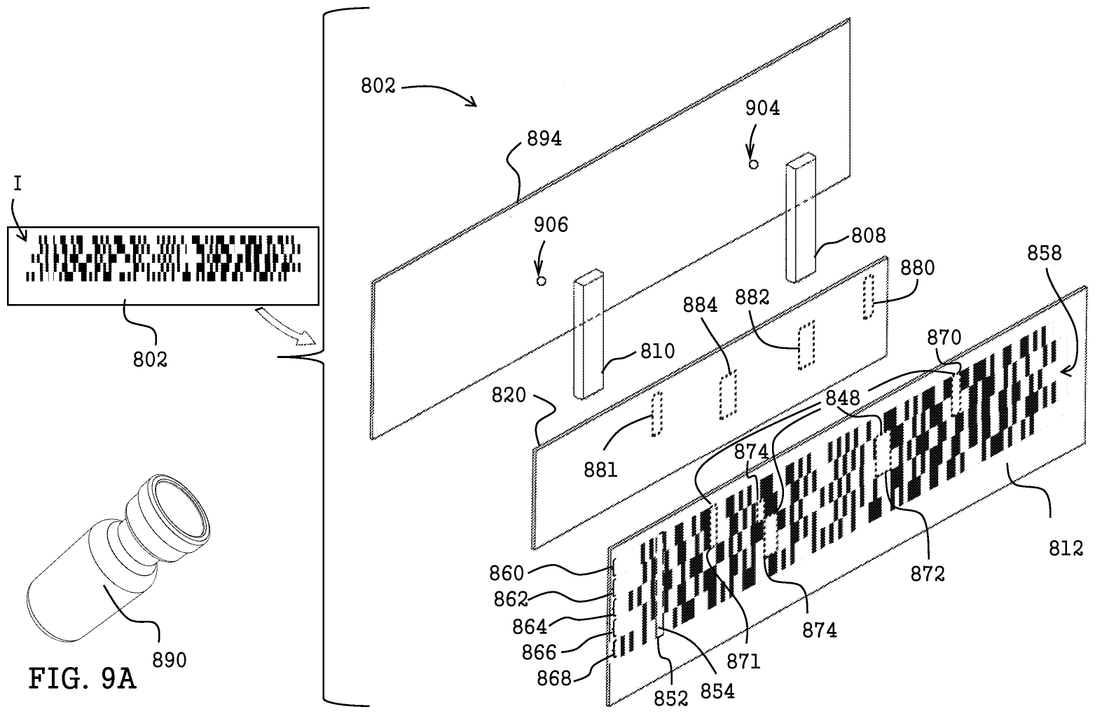

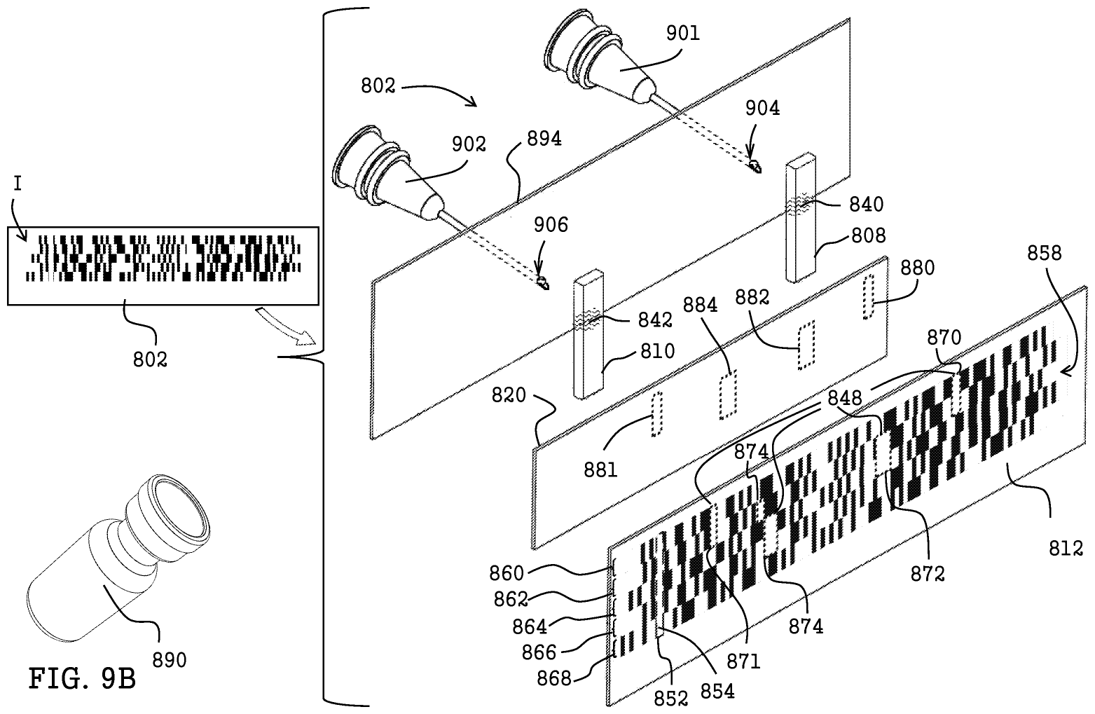

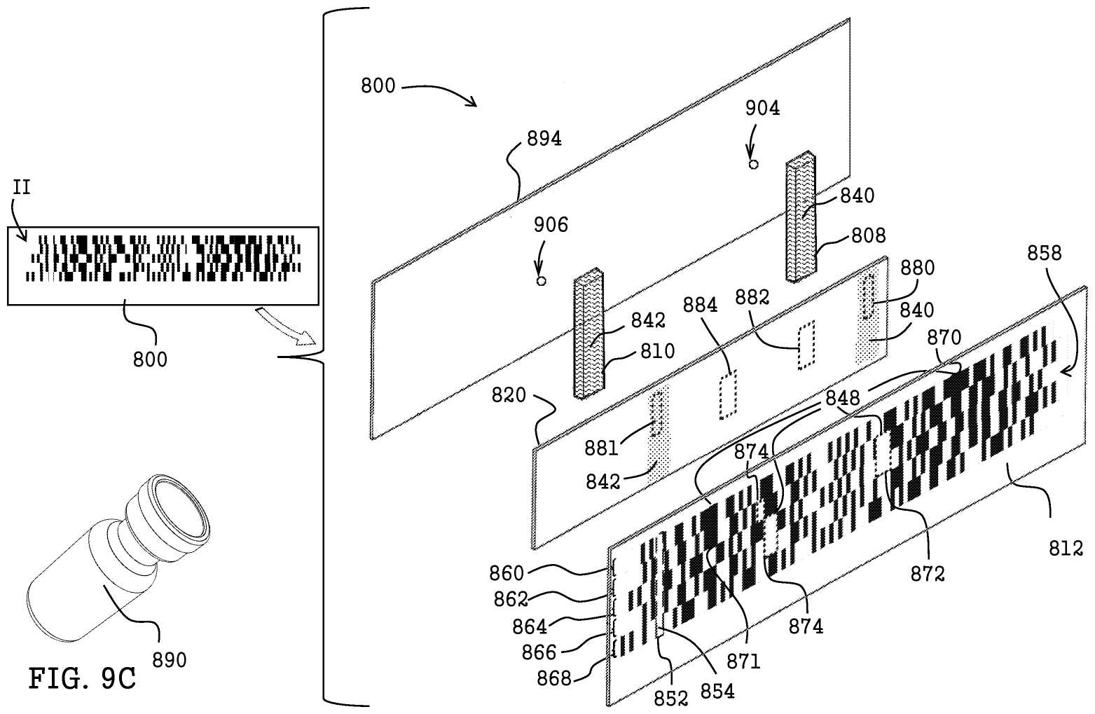

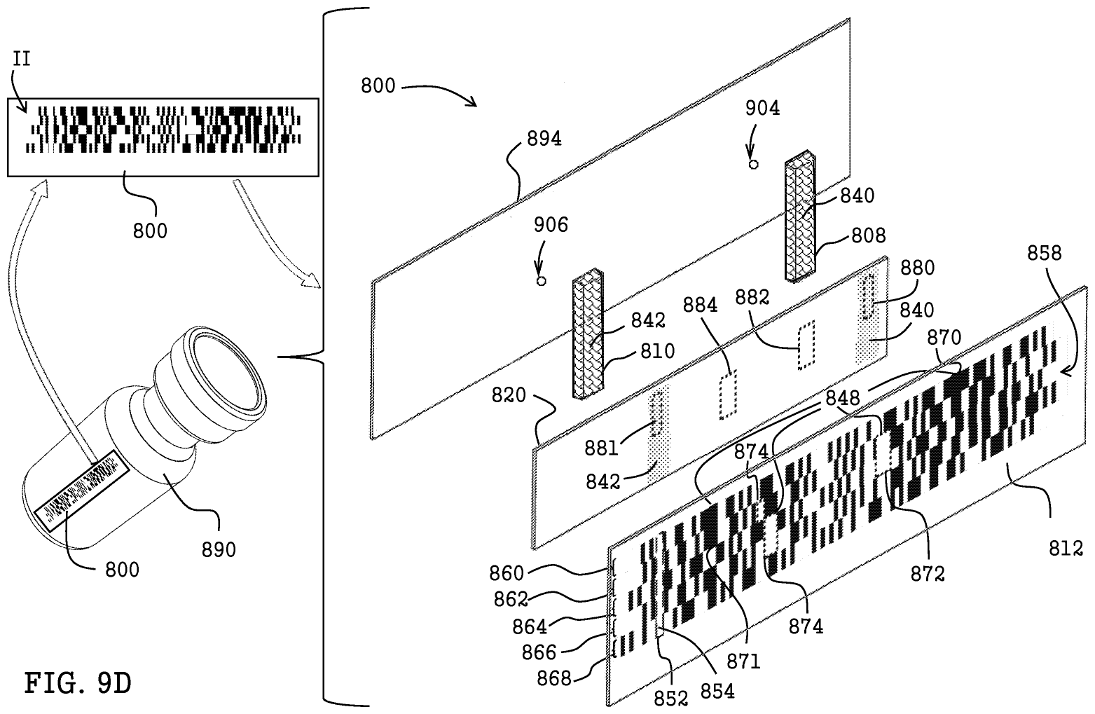

Reference is now made to FIG. 8, which is a simplified illustration of a heat responsive coloring material supplier (HRCMS) 790, which is an example of one or both of HRCMSs 102 and 107 of FIGS. 1A-1E, and to FIGS. 9A-9D, which together are a simplified illustration of a preferred method of construction of a heat responsive quality indicator (HRQI) 800, which is an embodiment of one or both of HRQI assemblies 100 and 105 of FIGS. 1A-1E.

HRQI assembly 800 preferably includes a shelf-stable, non-heat responsive quality indicator (NHRQI) sub-assembly 802 including at least a first coloring material reservoir 808 and a second coloring material reservoir 810, at least one indicator template 812 and at least one coloring material diffuser 820.

HRQI assembly 800 preferably additionally includes a first quality parameter responsive coloring material (QPRCM) 840 and a second QPRCM 842. In a preferred embodiment of the present invention, each of first and second QPRCMs 840 and 842 is an HRCM, which is flowable at a temperature exceeding a first and second upper temperature threshold, respectively, as indicated by waved lines in corresponding figures.

First QPRCM 840 is characterized by a viscosity and melting point such that first QPRCM 840 is flowable through or on coloring material diffuser 820 at temperatures above a first upper temperature threshold and is not flowable through or on coloring material diffuser 820 at temperatures below the first upper temperature threshold. Similarly, second QPRCM 842 is characterized by a viscosity and melting point such that second QPRCM 842 is flowable through or on coloring material diffuser 820 at temperatures above a second upper temperature threshold and is not flowable through or on coloring material diffuser 820 at temperatures below the second upper temperature threshold. Both first QPRCM 840 and second QPRCM 842 are preferably characterized by a color that is readily distinguishable from a color of coloring material diffuser 820.

In a preferred embodiment of the present invention, first QPRCM 840 and second QPRCM 842, when supplied to coloring material diffuser 820 of NHRQI sub-assembly 802, preferably convert NHRQI sub-assembly 802 to HRQI assembly 800, which is responsive to changes in temperature over time in exceedance of the first upper temperature threshold and the second upper temperature threshold, for changing an appearance of HRQI assembly 800. Thus, HRQI assembly 800 is formed by supplying first QPRCM 840 and second QPRCM 842 to NHRQI sub-assembly 802, preferably by injecting first QPRCM 840 and second QPRCM 842 into NHRQI sub-assembly 802.

When first QPRCM 840 is flowable, first QPRCM 840 preferably diffuses through coloring material diffuser 820. Conversely, when first QPRCM 840 is not flowable, first QPRCM 840 preferably does not diffuse through coloring material diffuser 820. Similarly, when second QPRCM 842 is flowable, second QPRCM 842 preferably diffuses through coloring material diffuser 820. Conversely, when second QPRCM 842 is not flowable, second QPRCM 842 preferably does not diffuse through coloring material diffuser 820.

It is further appreciated that at least one of first and second QPRCMs 840 and 842 may additionally or alternatively be embodied as a coloring material that is responsive to at least one alternative or additional quality parameter, including, inter alia, moisture, force, pressure, pH and elapsed time. In such a case, HRQI assembly 800 is preferably embodied as at least, inter alia, a moisture responsive quality indicator, a force responsive quality indicator, a pressure responsive quality indicator, a pH responsive quality indicator and an elapsed time responsive quality indicator, respectively.

In one embodiment of the present invention, (not shown), at least one of first QPRCM 840 and second QPRCM 842 is supplied directly to coloring material diffuser 820. In such an embodiment, at least one of corresponding first coloring material reservoir 808 and second coloring material reservoir 810 may be obviated.

In another embodiment of the present invention, as seen particularly in FIGS. 8-9D, both first QPRCM 840 and second QPRCM 842 are supplied indirectly to coloring material diffuser 820. In such an embodiment, first QPRCM 840 and second QPRCM 842 are preferably supplied to first coloring material reservoir 808 and second coloring material reservoir 810, respectively, and first coloring material reservoir 808 supplies first QPRCM 840 to coloring material diffuser 820 and second coloring material reservoir 810 supplies second QPRCM 842 to coloring material diffuser 820.

In a preferred embodiment of the present invention, coloring material diffuser 820 is embodied as filter paper, such as Whatman No. 3 filter paper commercially available from Whatman International [CAT #: 1003917]. Additionally, first and second coloring material reservoirs 808 and 810 are preferably each embodied as a pad, for example, K-R; 210/34/28, commercially available from Noam-Urim of Kibbutz Urim, Israel, first QPRCM 840 is preferably embodied as a coloring agent, such as Sudan Black, a black color dye [CAS: 4197-25-5], combined at a ratio of 1.4 grams per 1 kilogram in Decyl Decanoate [CAS: 1654-86-0], and second QPRCM 842 is preferably embodied as a coloring agent, such as Sudan Black, a black color dye [CAS: 4197-25-5], combined at a ratio of 1.4 grams per 1 kilogram in Butyl Stearate [CAS: 123-95-5].

Preferably, indicator template 812 includes a transparent substrate on which is formed non-transparent printing. In a preferred embodiment of the present invention, all areas on the transparent substrate which are desired to be opaque, including both a background and areas in which features will be printed, are printed with white ink, and a plurality of features, such as bars forming part of barcodes corresponding to barcodes 110 or 111 of FIGS. 1A-1E, are preferably printed with black ink over the white ink as desired.

In another embodiment of the present invention, a background area of indicator template 812 is printed with white ink; however, the white ink is not deposited in the areas in which the plurality of features are formed, and the plurality of features are preferably printed with black ink.

More generally, in all embodiments of the present invention, the background area of indicator template 812 and the plurality of features of indicator template 812 are printed in such colors as to define high contrast therebetween.

Indicator template 812 preferably further includes at least one transparent area 848, indicated by dotted lines in FIGS. 9A-9D. It is appreciated that the dotted lines indicating transparent area or areas 848 are drawn for ease of understanding, and preferably transparent area or areas 848 are not readily distinguishable from surrounding areas of indicator template 812. In a preferred embodiment of the present invention, transparent area or areas 848 are not printed, i.e., preferably no material is deposited on transparent area or areas 848. For the purposes of the present specification and claims, the term “transparent area” is defined so as to include within its scope areas that are either transparent or translucent.

Preferably, coloring material diffuser 820 is visible through the entirety of each of transparent areas 848. Thus, a color visible in each of transparent areas 848 is determined by a color of a portion of coloring material diffuser 820 located therebehind. In a preferred embodiment of the present invention, each of transparent areas 848 is initially white in color, and assumes a black color upon a coloring of coloring material diffuser 820 by either first QPRCM 840 or second QPRCM 842.

In a preferred embodiment of the present invention, indicator template 812 additionally includes at least one area 852 upon which is deposited a cold responsive coloring material 854, such as a thermochromic coloring material, such as irreversible thermochromic ink commercially available from CTI Technology, Colorado Springs, USA. It is appreciated that although, for ease of understanding, dashed lines in FIGS. 9A-9D indicate area 852, preferably area 852 is not readily distinguishable from surrounding areas of indicator template 812.

It is appreciated that as used herein, “cold responsive” is used to indicate an element or system that changes as a result of cold, wherein “cold” is used to indicate a temperature below a lower temperature threshold, such as a temperature at which cold responsive coloring material 854 typically changes color.

In a preferred embodiment of the present invention, cold responsive coloring material 854 is initially characterized by a first color, and irreversibly assumes a second color, which is different from the first color, upon exposure to a temperature below a lower temperature threshold for example, below 2 degrees Celsius, for an under-temperature time duration. As described hereinabove, in one embodiment of the present invention, the under-temperature time duration is very short, preferably less than 60 seconds, more preferably less than 30 seconds, more preferably less than 15 seconds, even more preferably less than 10 seconds and most preferably less than 5 seconds. In another embodiment of the present invention, the under-temperature time duration is relatively long, and may be, for example, 5 minutes, 10 minutes, 20 minutes, 30 minutes or 45 minutes.

Thus, if the under-temperature time duration is very short, then cold responsive coloring material 854 preferably assumes the second color substantially immediately upon being exposed to a temperature below the lower temperature threshold. In contrast, if the under-temperature time duration is relatively long, for example 30 minutes, then cold responsive coloring material 854 assumes the second color only upon an exposure to a temperature less than the lower temperature threshold for at least 30 minutes.

It is appreciated that the first color and the second color assumed by cold responsive coloring material 854 may be any suitable colors which are discernable from one another. In one embodiment of the present invention, the first and second colors are readily discernable from one another by a human. Additionally or alternatively, the first and second colors are readily discernable from one another by a machine. For example, in one embodiment of the present invention, cold responsive coloring material 854 characterized by the first color is colorless and transparent, and cold responsive coloring material 854 characterized by the second color is blue.

In the example illustrated in FIGS. 8-9D, indicator templates 812 are embodied as a plurality of barcodes 858, such as barcodes 110 or 111, including a first barcode 860, a second barcode 862, a third barcode 864, a fourth barcode 866 and a fifth barcode 868, which are preferably different from each other and arranged in a stacked arrangement. As indicated by dotted lines, formed within barcodes 858 are transparent areas 848, including a transparent area 870, a transparent area 871, a transparent area 872 and a set of transparent areas 874.

As described hereinabove, coloring material diffuser 820 is preferably visible through the entirety of each of transparent areas 848. More particularly, a portion 880 of coloring material diffuser 820 is preferably visible through transparent area 870, a portion 881 of coloring material diffuser 820 is preferably visible through transparent area 871, a portion 882 of coloring material diffuser 820 is preferably visible through transparent area 872 and a portion 884 of coloring material diffuser 820 is preferably visible through transparent areas 874. Thus, it is appreciated that a color visible in each of transparent areas 870, 871, 872 and 874 is determined by a color of each of portions 880, 881, 882 and 884, respectively. It is appreciated that although, for ease of understanding, dotted lines in FIGS. 9A-9D indicate each of portions 880, 881, 882 and 884, preferably portions 880, 881, 882 and 884 are not readily distinguishable from surrounding areas of coloring material diffuser 820.

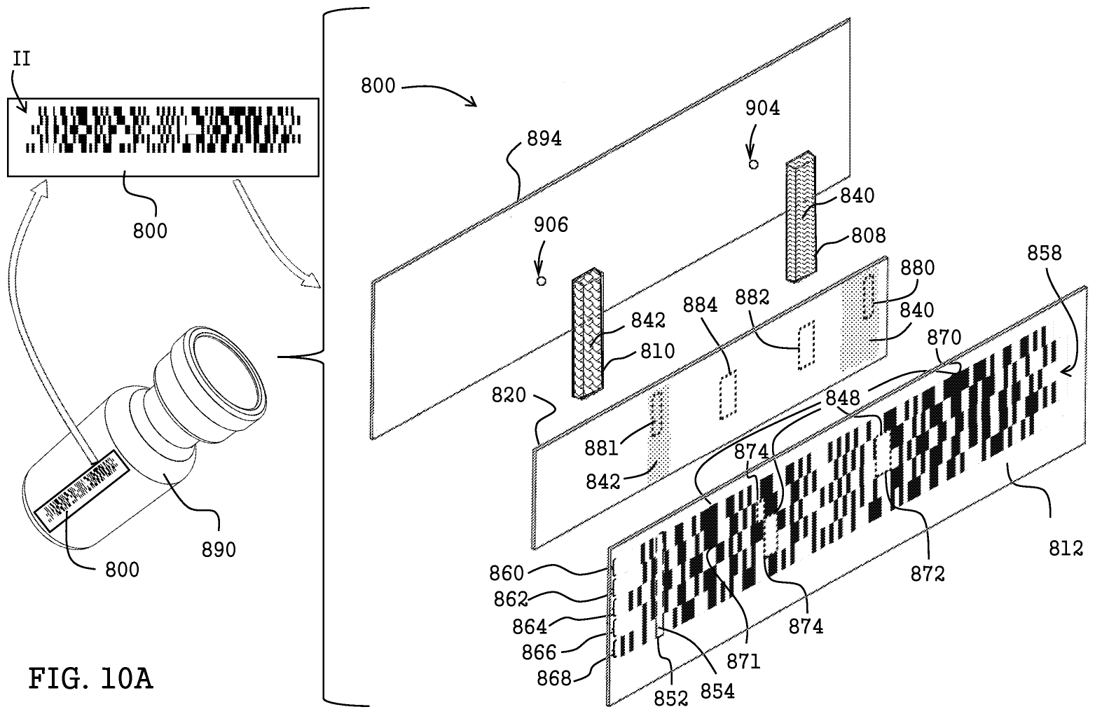

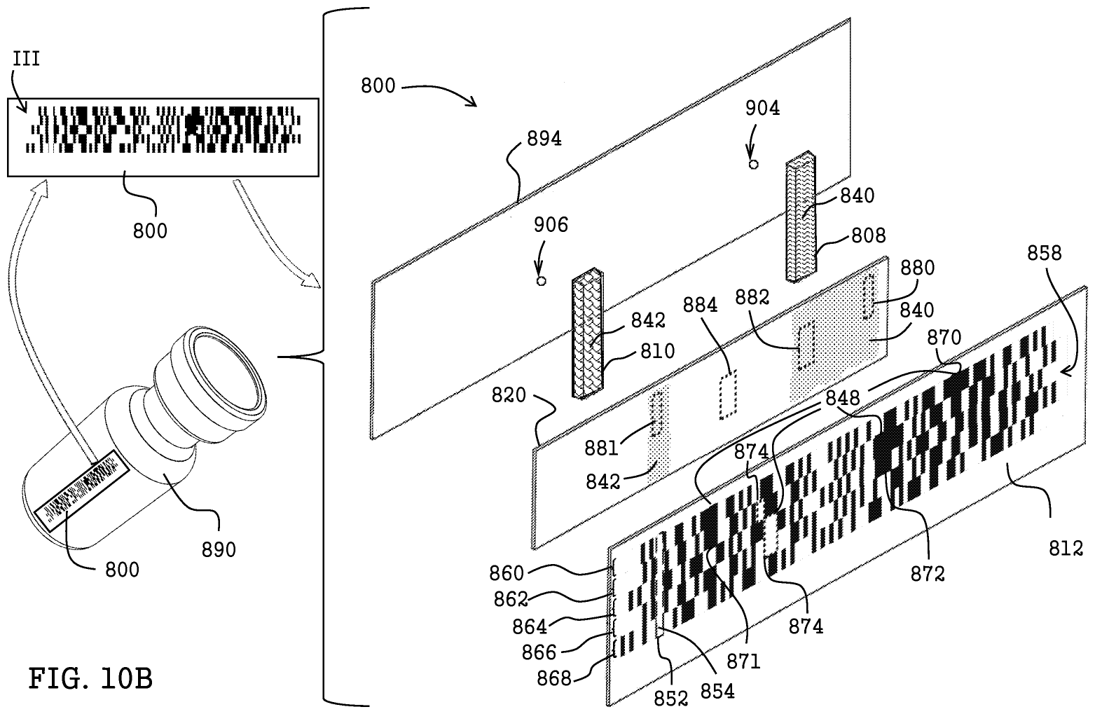

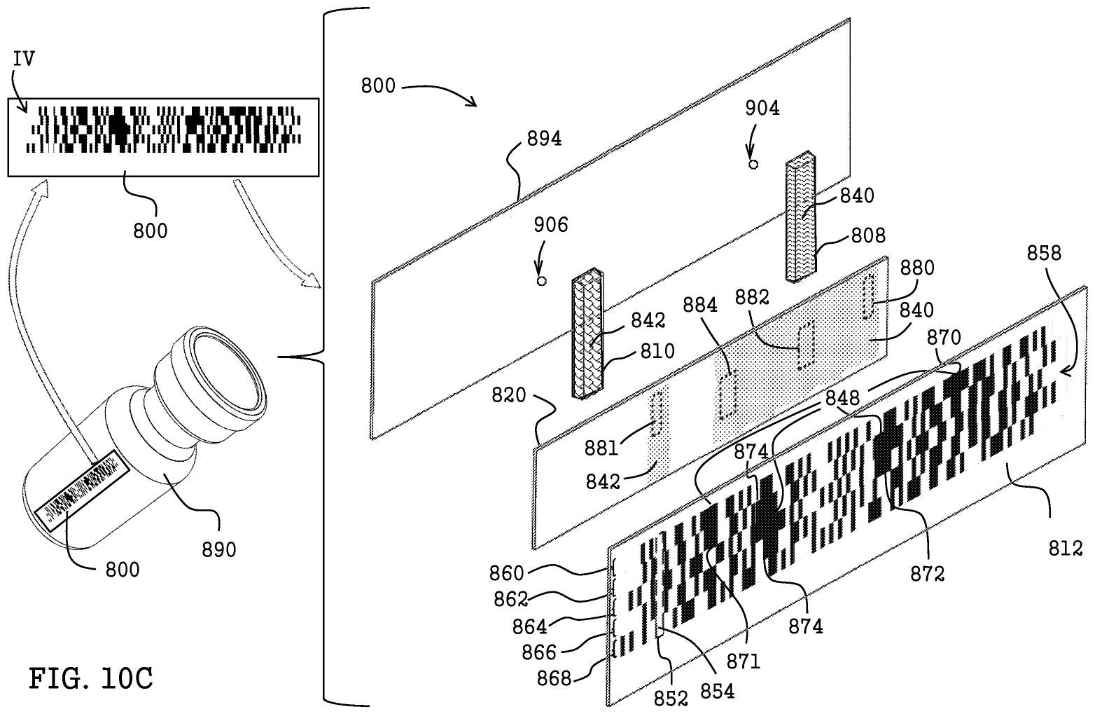

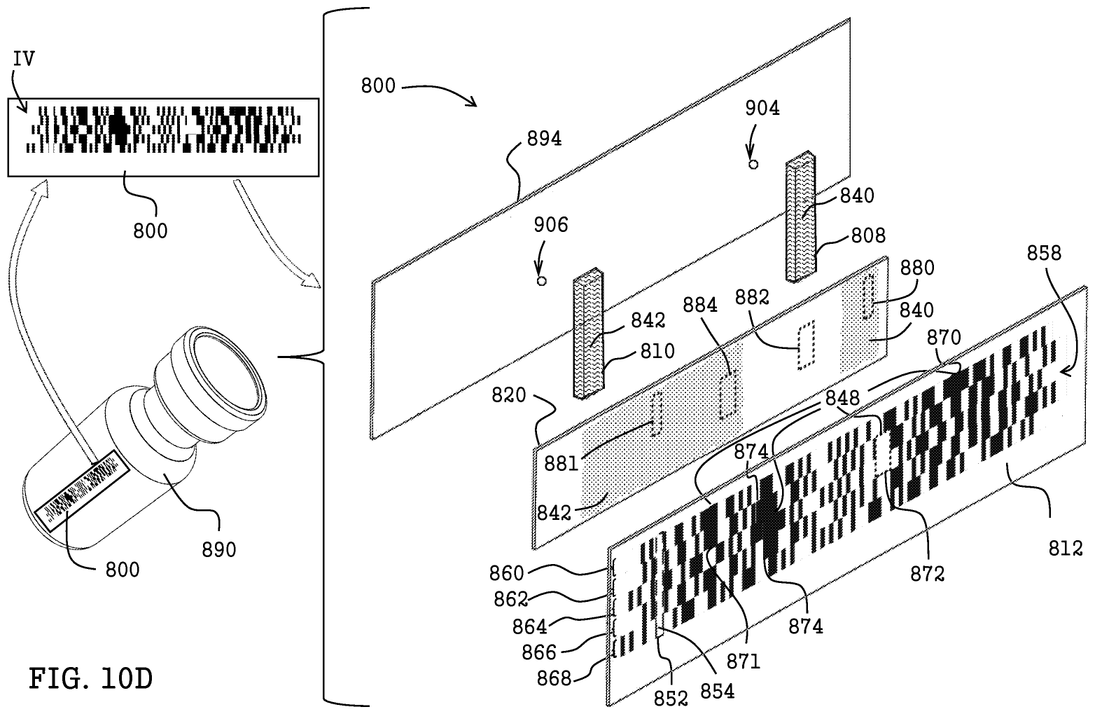

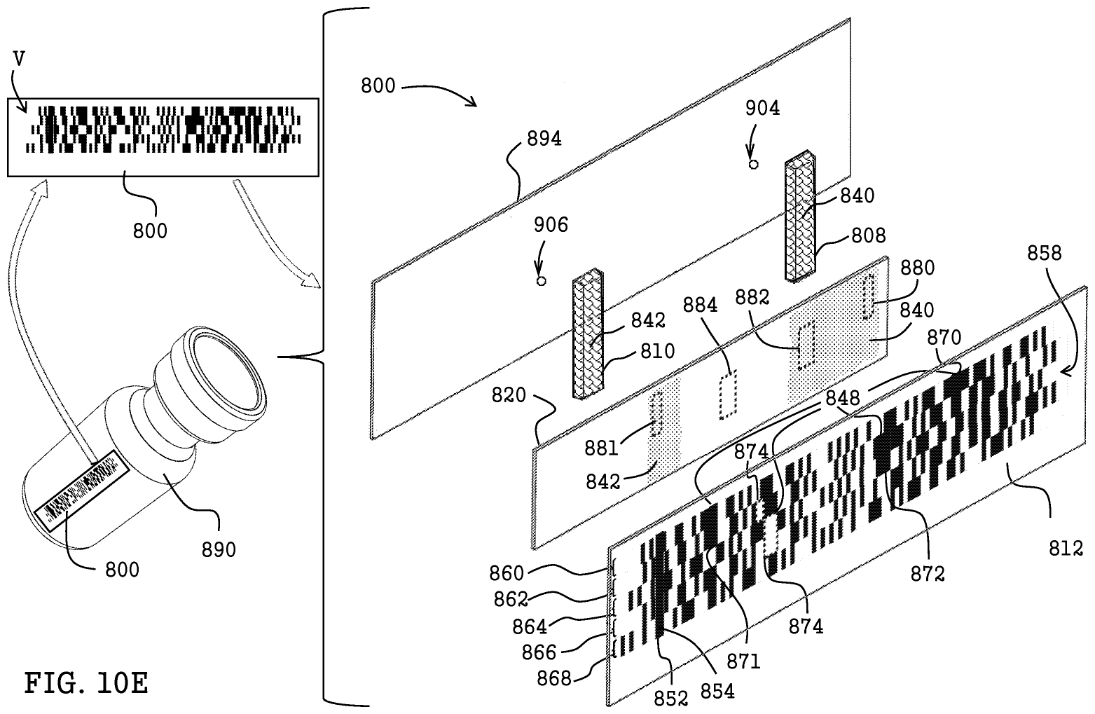

Preferably, each of transparent areas 870, 871, 872 and 874 is formed within at least two of barcodes 858 and forms a readable portion thereof. In the illustrated embodiment of FIGS. 9A-10E, transparent area 870 forms part of barcodes 860 and 862, transparent area 871 forms part of barcodes 860 and 862, transparent area 872 forms part of barcodes 862 and 864, and transparent areas 874 form part of barcodes 862, 864 and 866. Each of transparent areas 848 preferably has the same width as a single barcode bar. Alternatively, the width of any of the transparent areas 870, 872 and 874 may be different from the width of a single barcode bar. Additionally, the width of the portion of a transparent area 848 which forms part of one of barcodes 858 may be different from the width of the portion of the same transparent area 848 which forms part of another of barcodes 858.

Preferably, all of barcodes 858 include at least a portion of area 852 within which is located cold responsive coloring material 854, and the at least portion of area 852 forms a readable portion of barcodes 858. Accordingly, area 852 forms part of each of barcodes 860, 862, 864, 866 and 868. Area 852 preferably has the same width as a single barcode bar. Alternatively, the width of at least a portion of area 852 may be different from the width of a single barcode bar.

It is appreciated that barcodes 860, 862, 864, 866 and 868 may be arranged in any suitable order with respect to one another. Similarly, transparent areas 870, 871, 872 and 874 may be arranged in any suitable order with respect to one another. Furthermore, it is appreciated that at least one of barcodes 860, 862, 864, 866 and 868 and/or transparent areas 870, 871, 872 and 874 may be obviated from indicator template 812 and HRQI assembly 800. Similarly, one or more additional barcodes and/or transparent areas may be added to indicator template 812 and HRQI assembly 800.

In a preferred embodiment of the present invention, a different single one of barcodes 858 is machine-readable at each of visible states I, II, III, IV and V. For example, in the example illustrated in FIGS. 8-9D, barcode 860 is read as 7290003804191 at pre-supply visible state I, barcode 862 is read as 7290003804108 at post-supply visible state II, barcode 864 is read as 7290003804122 in visible state III, barcode 866 is read as 7290003804115 in visible state IV and barcode 868 is read as 7290003804139 in visible state V. Preferably, each of barcodes 858 is machine-readable only in the single one of visible states I, II, III, IV and V, as listed above. In one embodiment of the present invention, at least some of the characters associated with a numeric or alphanumeric code are a quality code.

As seen particularly in FIGS. 9A-9D, when coloring material diffuser 820 is in an uncolored state, meaning that neither first QPRCM 840 nor second QPRCM 842 has been supplied to coloring material diffuser 820, coloring material diffuser 820 causes each of transparent areas 870, 871, 872 and 874 to appear white in color. The white appearance of transparent areas 870 and 871 preferably allow barcode 860 to be machine-readable, while the white appearance of transparent areas 870, 871, 872 and 874 preferably causes barcodes 862, 864 and 866 to be non-machine-readable. Additionally, as long as NHRQI sub-assembly 802 has not been exposed to a temperature less than the lower temperature threshold, cold responsive coloring material 854 is preferably characterized by the first color thereof, for example colorless and transparent, and area 852 does not interfere with the readability of any of barcodes 860, 862, 864 and 866, while the first color of area 852 preferably prevents barcode 868 from being read. Thus, when coloring material diffuser 820 is in an uncolored state and NHRQI sub-assembly 802 has not been exposed to a temperature less than the lower temperature threshold, NHRQI sub-assembly 802 is preferably in pre-supply visible state I, wherein only barcode 860 is in a machine-readable state.

As seen in FIG. 9A, a container 890, such as, inter alia, package 101 or carton 106, is ready to be associated with an HRQI assembly 800. It is appreciated that container 890 is typically a product package, and may be embodied as, inter alia, an individual product package, such as a vial, a box of product packages, a pallet of product packages or a shipping container of product packages. In a preferred embodiment of the present invention, a type of container 890 with which an HRQI assembly 800 is associated, and more particularly a number of individual products contained by the container 890 associated with HRQI assembly 800, is at least partially determined by a relationship between a cost of monitoring container 890, a temperature-sensitivity of a product within container 890 and a financial value of a product within container 890.

Preferably, as further seen in FIG. 9A, neither first QPRCM 840 nor second QPRCM 842 has yet been supplied to NHRQI sub-assembly 802, and therefore NHRQI sub-assembly 802 is preferably not yet associated with container 890. As described hereinabove, prior to a supply of first QPRCM 840 and second QPRCM 842 to NHRQI sub-assembly 802, NHRQI sub-assembly 802 has not been exposed to a temperature less than the lower temperature threshold and is preferably in pre-supply visible state I.

Preferably, in visible state I, barcode 860 is typically readable by a conventional barcode reader, such as barcode reader 113, mobile communicator 132 or mobile communicator 142 of FIGS. 1A-1E, and barcodes 862, 864, 866 and 868 are preferably not readable by a barcode reader. Thus, the NHRQI sub-assembly 802 is in pre-supply visible state I and presents a single machine-readable barcode 860, typically readable by a conventional barcode reader as 7290003804191.

NHRQI sub-assembly 802 is preferably embodied as a self-adhesive label. Typically, after fabrication of NHRQI sub-assemblies 802 and before first QPRCM 840 and second QPRCM 842 are supplied thereto, NHRQI sub-assemblies 802 are stored on a roll liner 892. NHRQI sub-assembly 802 includes a back portion 894, on a rear side (not shown) of which is preferably an adhesive (not shown). The adhesive preferably serves to affix NHRQI sub-assembly 802 to roll liner 892. Typically, following the production of HRQI assembly 800, the adhesive on NHRQI sub-assembly 802 is also used to affix HRQI assembly 800 to container 890.

As seen particularly in FIGS. 8 and 9B, HRCMS 790 preferably includes a coloring material supplier 898, such as injection module 104 of FIG. 1A, which includes at least a first injector 901 and a second injector 902, such as a first and second needle assembly, respectively. In a preferred embodiment of the present invention, coloring material supplier 898 includes a heating assembly 903, such as a resistive heating assembly. If an ambient temperature of coloring material supplier 898 is below the first upper temperature threshold of first QPRCM 840 while coloring material supplier 898 supplies first QPRCM 840 to NHRQI sub-assembly 802, heating assembly 903 provides heat to first QPRCM 840 during the supply thereof to NHRQI sub-assembly 802, thereby maintaining first QPRCM 840 at a temperature at which first QPRCM 840 is flowable during the supply thereof to NHRQI sub-assembly 802. Similarly, if an ambient temperature of coloring material supplier 898 is below the second upper temperature threshold of second QPRCM 842 while coloring material supplier 898 supplies second QPRCM 842 to NHRQI sub-assembly 802, heating assembly 903 provides heat to second QPRCM 842 during the supply thereof to NHRQI sub-assembly 802, thereby maintaining second QPRCM 842 at a temperature at which second QPRCM 842 is flowable during the supply thereof to NHRQI sub-assembly 802.

For example, if the first upper temperature threshold of first QPRCM 840 is 8 degrees Celsius and the second upper temperature threshold of second QPRCM 842 is 30 degrees Celsius and HRQI assembly 800 is being assembled in an area having an ambient temperature of 10 degrees Celsius, first QPRCM 840 is preferably flowable at the ambient temperature, while second QPRCM 842 is preferably not flowable at the ambient temperature. Therefore, in this example, heating assembly 903 preferably warms second QPRCM 842 in coloring material supplier 898 to a temperature of at least 30 degrees Celsius, thereby maintaining second QPRCM 842 at a temperature in which second QPRCM 842 is in a flowable state.

Typically, coloring material supplier 898 supplies both first and second QPRCMs 840 and 842 to NHRQI sub-assembly 802 while NHRQI sub-assembly 802 is affixed to roll liner 892. In the embodiment shown in FIGS. 8-9D, coloring material supplier 898 supplies first and second QPRCMs 840 and 842 to first and second coloring material reservoirs 808 and 810, respectively, and coloring material reservoir 808 and 810 then respectively supply first and second QPRCMs 840 and 842 to coloring material diffuser 820. In another embodiment of the present invention, coloring material supplier 898 supplies at least one of first and second QPRCMs 840 and 842 directly to coloring material diffuser 820, and at least one of corresponding first coloring material reservoir 808 and second coloring material reservoir 810 may be obviated.

In a preferred embodiment of the present invention, both first QPRCM 840 and second QPRCM 842 are supplied to NHRQI sub-assembly 802 immediately prior to the association of HRQI assembly 800 with container 890. In other words, both first QPRCM 840 and second QPRCM 842 are preferably supplied to NHRQI sub-assemblies 802 as NHRQI sub-assemblies 802 are being positioned for imminent association with containers 890. Thus, in the illustrated embodiment shown in FIG. 8, as roll liner 892 is unspooled to make NHRQI sub-assemblies 802 available for affixation to containers 890, both first QPRCM 840 and second QPRCM 842 are supplied to NHRQI sub-assemblies 802.

Preferably, a first aperture 904 and a second aperture 906 are each formed in back portion 894 of NHRQI sub-assembly 802. As seen particularly in FIG. 9B, first QPRCM 840 is preferably supplied by first injector 901 to NHRQI sub-assembly 802 through first aperture 904, and second QPRCM 842 is preferably supplied by second injector 902 to NHRQI sub-assembly 802 through second aperture 906. In the illustrated embodiment of the present invention, first and second apertures 904 and 906 enable respective fluid communication between each of first and second injectors 901 and 902 and corresponding first and second coloring material reservoirs 808 and 810, which in turn are each in fluid communication with coloring material diffuser 820. In another embodiment of the present invention, in which at least one of first and second coloring material reservoirs 808 and 810 may be obviated, at least one of first and second apertures 904 and 906 enables fluid communication directly between respective first and second injectors 901 and 902 and coloring material diffuser 820.

Preferably, a plurality of pairs of apertures 914 and 916 are formed on roll liner 892, and each of pairs of apertures 914 and 916 is generally aligned with corresponding ones of apertures 904 and 906. It is appreciated that apertures 904, 906, 914 and 916 may be formed either during respective fabrications of NHRQI sub-assembly 802 and roll liner 892, or as part of the supply of first and second QPRCMs 840 and 842 to NHRQI sub-assembly 802. Alternatively, some of apertures 904, 906, 914 and 916 may be formed during a respective fabrication of NHRQI sub-assembly 802 and roll liner 892, and the others of plurality of apertures 904, 906, 914 and 916 may be formed as part of the supply of first and second QPRCMs 840 and 842 to NHRQI sub-assembly 802. Typically, in an embodiment wherein at least one of plurality of apertures 904, 906, 914 and 916 is formed as part of the supply of first and second QPRCMs 840 and 842 to NHRQI sub-assembly 802, the at least one of plurality of apertures 904, 906, 914 and 916 is formed by corresponding injector 901 or 902.

As described above, in the embodiment illustrated in FIGS. 8 and 9B, first and second QPRCMs 840 and 842 are supplied to NHRQI sub-assembly 802 via respective apertures 904 and 906 on back portion 894 of NHRQI sub-assembly 802 prior to, preferably immediately prior to, associating HRQI assembly 800 with container 890. In an alternative embodiment of the present invention, at least one of first QPRCM 840 and second QPRCM 842 is supplied to NHRQI sub-assembly 802 after associating NHRQI sub-assembly 802 with container 890. In an embodiment wherein the supply of at least one of first QPRCM 840 second QPRCM 842 to NHRQI sub-assembly 802 occurs after associating NHRQI sub-assembly 802 with container 890, at least one of injectors 901 and 902, as well as at least one of apertures 914 and 916, may be obviated, and at least one of apertures 904 and 906 may be obviated or located elsewhere on NHRQI sub-assembly 802.

In an embodiment wherein at least one of first QPRCM 840 and second QPRCM 842 is supplied to NHRQI sub-assembly 802 following the association of NHRQI sub-assembly 802 with container 890, for example, an injector may supply at least one of first QPRCM 840 and second QPRCM 842 to NHRQI sub-assembly 802 through at least one aperture formed in a front surface or a side surface of NHRQI sub-assembly 802.

Turning now particularly to FIG. 9C, it is seen that immediately following a supply of first and second QPRCMs 840 and 842 to NHRQI sub-assembly 802, portions 880 and 881 of coloring material diffuser 820 preferably become colored with first QPRCM 840 and second QPRCM 842, respectively, and thus the color visible through each of transparent areas 870 and 871 is determined by the color of first QPRCM 840 and second QPRCM 842, respectively. In the example shown in FIGS. 8-9D, as seen particularly in FIG. 9C, immediately following a supply of first and second QPRCMs 840 and 842 to NHRQI sub-assembly 802, transparent areas 870 and 871 both show a black color, and HRQI assembly 800 thus preferably assumes post-supply visible state II immediately following a supply of first and second QPRCMs 840 and 842 to NHRQI sub-assembly 802.

It is appreciated that the coloring of portions 880 and 881 by first QPRCM 840 and second QPRCM 842, respectively, and thus the changing of the color visible through transparent areas 870 and 871, changes an appearance of HRQI assembly 800, and more particularly, changes an appearance of barcode 860 and of barcode 862. It is appreciated that if only one of first QPRCM 840 and second QPRCM 842 is provided to HRQI assembly 800, then only one of portions 880 and 881 becomes colored, and HRQI assembly 800 assumes a state in which it does not display any machine-readable barcodes. As described hereinbelow, a state in which HRQI assembly 800 does not display any machine-readable barcodes preferably provides an indication that HRQI assembly 800 is not fit for use and should not be associated with container 890.

In another embodiment of the present invention (not shown), separate visible states are provided for each of first and second QPRCMs 840 and 842. In such an embodiment, HRQI assembly 800 preferably assumes a first post-supply visible state following a supply of first QPRCM 840 and a second post-supply visible state following a supply of second QPRCM 842.

In post-supply visible state II, transparent areas 870 and 871 each show a color similar to the color of bars of barcodes 858, while transparent areas 872 and 874 remain uncolored. Therefore, barcodes 860, 864 and 866 are preferably unreadable by a conventional barcode reader, such as barcode reader 113, mobile communicator 132 or mobile communicator 142 of FIGS. 1A-1E, and only barcode 862 is readable by a conventional barcode reader. Additionally, at post-supply visible state II, HRQI assembly 800 has preferably not been exposed to a temperature less than the lower temperature threshold for at least the under-temperature time duration. Therefore, cold responsive coloring material 854 is preferably characterized by the first color thereof, for example colorless and transparent, and area 852 does not interfere with the readability of any of barcodes 860, 862, 864 and 866, while the first color of area 852 preferably prevents barcode 868 from being read. Thus, HRQI assembly 800 in post-supply visible state II presents a single machine-readable barcode typically readable by a conventional barcode reader, here exemplified as barcode 862 having numerical sequence 7290003804108.

It is appreciated that once HQRI assembly 800 assumes visible state II, HRQI assembly 800 preferably cannot thereafter revert to visible state I.

Preferably, each of first and second QPRCMs 840 and 842 is supplied in a flowable state, as indicated by waved lines in FIGS. 9B & 9C, to NHRQI sub-assembly 802. In order to maintain a flowable state thereof, first QPRCM 840 is typically supplied to NHRQI sub-assembly 802 at a temperature exceeding the first upper temperature threshold, and second QPRCM 842 is supplied to NHRQI sub-assembly 802 at a temperature exceeding the second upper temperature threshold. However, as seen particularly in enlargement circle B of FIG. 8 and in FIG. 9D, following supply of first and second QPRCMs 840 and 842 to NHRQI sub-assembly 802, HRQI assembly 800 is cooled to, and maintained at, a temperature which does not exceed either the first or second upper temperature thresholds, such that both first and second QPRCMs 840 and 842 are not flowable, as indicated by interlocking lines in enlargement circle B of FIG. 8 and in FIG. 9D.

In one embodiment of the present invention, HRCMS 790 includes at least one cooling system 930. Preferably, following a supply of first and second QPRCMs 840 and 842 to NHRQI sub-assembly 802, HRQI assembly 800 is brought into thermal contact with cooling system 930, thereby rapidly reducing the temperature of HRQI assembly 800 to a temperature below both the first and second upper temperature thresholds, so that first and second QPRCMs 840 and 842 are not flowable. It is appreciated that cooling system 930 preferably does not cool HRQI assembly 800 to a temperature below the lower temperature threshold, and thus cold responsive coloring material 854 does not change color in response to temperature conditions within cooling system 930.

In another embodiment of the present invention, cooling system 930 may be obviated, and following the supply of first and second QPRCMs 840 and 842 to NHRQI sub-assembly 802, HRQI assembly 800 may be cooled to a temperature below the first and second upper temperature thresholds, such that first and second QPRCMs 840 and 842 are no longer flowable, after being associated with container 890. In this embodiment, cooling of HRQI assembly 800 is preferably effected by thermal contact with container 890 which, at the time of the association of HRQI assembly 800 therewith, is at a temperature below the first and second upper temperature thresholds. Alternatively, HRQI assembly 800 may be cooled by placing HQRI assembly 800 and the associated container 890 in a cold storage environment, such as a refrigerator. It is appreciated that the temperature of HRQI assembly 800 and associated container 890 is preferably not less than the lower temperature threshold, and thus cold responsive coloring material 854 does not change color in response to temperature conditions of container 890 at the time of association of HQRI assembly 800 with container 890.

As described hereinabove with reference to FIGS. 1A-1E, NHRQI sub-assembly 802 is preferably embodied as a self-adhesive label, and the association of HRQI assembly 800 with container 890 is preferably embodied as an affixation of HRQI assembly 800 to container 890, and more particularly as an adherence of HRQI assembly 800 to container 890. It is noted that the adhesive on the rear side of back portion 894 of HRQI assembly 800 preferably serves to affix HRQI assembly 800 to container 890, and that the adhesion of HRQI assembly 800 to container 890 preferably serves to seal apertures 904 and 906, preventing an egress of first and second QPRCMs 840 and 842 therefrom.

It is appreciated that in an embodiment wherein first and second QPRCMs 840 and 842 are supplied to NHRQI sub-assembly 802 after associating NHRQI sub-assembly 802 with container 890, cooling system 930 is typically not included in HRCMS 790. Instead, HRQI assembly 800 is cooled only after being associated with container 890. Similarly, in such an embodiment, if one or more apertures are included on a front or a side surface of NHRQI sub-assembly 802, the apertures may be sealed with a suitable sealant, preventing an egress of first and second QPRCMs 840 and 842 therefrom.

As illustrated in FIGS. 9A & 9B, in one embodiment of the present invention, NHRQI sub-assembly 802 is not yet associated with container 890. Similarly, as illustrated in FIG. 9C, immediately after the supply of first and second QPRCMs 840 and 842 to HRQI assembly 800, HRQI assembly 800 is preferably still not associated with container 890.

As illustrated in FIG. 8, in one embodiment of the present invention, HRQI assembly 800 is cooled to a temperature below the first and second upper temperature thresholds before being associated with container 890, preferably by cooling system 930. In an alternative embodiment, HRQI assembly 800 may be cooled by placing HQRI assembly 800 and associated container 890 in a cold storage environment, such as a refrigerator. Thus, the lowering of the temperatures of first and second QPRCMs 840 and 842 and the association of HRQI assembly 800 with container 890 are separate steps.

However, in another embodiment of the present invention, as illustrated in FIG. 9D, HRQI assembly 800 is cooled to a temperature below the first and second upper temperature thresholds only after being associated with container 890. As described hereinabove, in this embodiment, cooling of HRQI assembly 800 is preferably effected by thermal contact with container 890 which, at the time of the association of HRQI assembly 800 therewith, is at a temperature below both the first and second upper temperature thresholds. Thus, the lowering of the temperatures of first and second QPRCMs 840 and 842 and the association of HRQI assembly 800 with container 890 are achieved in a single step.

In a preferred embodiment of the present invention, HRCMS 790 further includes a barcode reader 940, which preferably reads barcodes 858 substantially immediately prior to an association of HRQI assembly 800 or NHQRI sub-assembly 802 with container 890. Barcode reader 940, upon reading barcodes 858, preferably provides information to a quality indication computer, such as quality indication computer 115, which enables the quality indication computer to provide an immediate indication of a quality status of the HRQI assembly 800 or NHQRI sub-assembly 802 read by barcode reader 940.

If barcode reader 940 provides an indication that an HRQI assembly 800, or in an undesirable case wherein first and second QPRCMs 840 and 842 were not supplied to an NHRQI sub-assembly 802, an NHRQI sub-assembly 802, is unfit for use, then the HRQI assembly 800 or NHRQI sub-assembly 802 is preferably discarded and is not associated with a container 890. Examples of an HRQI assembly 800 or NHRQI sub-assembly 802 that is unfit for use include an HRQI assembly 800 or NHRQI sub-assembly 802 that is in pre-supply visible state I, that is in visible state V, or that is unreadable by a typical barcode reader, for example, due to damage to barcodes 858 or to a supply of only one of QPRCMs 840 and 842.

In another preferred embodiment of the present invention (not shown) barcode reader 940 is obviated, and is replaced with a conventional barcode reader, such as barcode reader 113, mobile communicator 132 or mobile communicator 142 of FIGS. 1A-1E, which is not part of HRCMS 790.

In a preferred embodiment of the present invention, HRCMS 790 further includes a container association module 960. If an indication is provided, for example by barcode reader 940 or barcode reader 113, that an HRQI assembly 800 is fit for use, then container association module 960 preferably associates that HRQI assembly 800 with a container 890. In a preferred embodiment of the present invention, container association module 960 positions HRQI assembly 800 relative to container 890 such that the adhesive on the rear side of HRQI assembly 800 contacts container 890, thereby affixing HRQI assembly 800 to container 890.

In the embodiment illustrated in FIG. 8, barcode reader 940 is shown as being part of container association module 960. Alternatively, barcode reader 940 may be separate from container association module 960.

Reference is now made to FIGS. 10A-10E, which are simplified illustrations of typical operative use cases of HRQI assembly 800.

It is appreciated that in the operative states shown in FIGS. 10A-10D HRQI assembly 800 has not been exposed to a temperature below the lower temperature threshold for at least the under-temperature time duration. Therefore, cold responsive coloring material 854 is preferably characterized by the first color thereof, for example colorless and transparent, and area 852 does not interfere with the readability of any of barcodes 860, 862, 864 and 866, while the first color of area 852 preferably prevents barcode 868 from being read.

It is further appreciated that although, for ease of understanding, dotted lines in FIGS. 10A-10E indicate each of transparent areas 848 and portions 880, 881, 882 and 884, preferably transparent areas 848 and portions 880, 881, 882 and 884 are not readily distinguishable from surrounding areas of indicator template 812 and coloring material diffuser 820, respectively. Similarly, for ease of understanding, dashed lines in FIGS. 10A-10E indicate area 852; however, area 852 may not be readily distinguishable from surrounding areas of indicator template 812.

Following the supply of first and second QPRCMs 840 and 842 to NHRQI sub-assembly 802 and when a temperature of HRQI assembly 800 exceeds the first upper temperature threshold, first QPRCM 840 assumes a flowable state, as indicated by waved lines in FIG. 10A. However, as long as a temperature of HRQI assembly 800 does not exceed the second upper temperature threshold, second QPRCM 842 remains in a non-flowable state, as indicated by interlocking lines in FIG. 10A.

In an embodiment wherein HRQI assembly 800 includes coloring material reservoir 808, upon assuming a flowable state, first QPRCM 840 is released from coloring material reservoir 808 and begins to diffuse through coloring material diffuser 820. In an embodiment wherein HRQI assembly 800 does not include coloring material reservoir 808, upon assuming a flowable state, first QPRCM 840 begins to diffuse through coloring material diffuser 820.

It is also appreciated that the respective first and second over-temperature cumulative time durations from the start of diffusion of first QPRCM 840 along coloring material diffuser 820 until each of portions 882 and 884 of coloring material diffuser 820 become colored is defined, for example, by a length of coloring material diffuser 820 between portion 880 and each of portions 882 and 884. Additionally, these time durations are typically a function of a composition of first QPRCM 840, as well as a function of a material from which coloring material diffuser 820 is made and a thickness thereof.

Similarly, an additional over-temperature cumulative time duration from the start of diffusion of second QPRCM 842 along coloring material diffuser 820 until portion 884 of coloring material diffuser 820 becomes colored is defined, for example, by a length of coloring material diffuser 820 between portion 881 and portion 884. Additionally, this time duration is typically a function of a composition of second QPRCM 842, as well as a function of a material from which coloring material diffuser 820 is made and a thickness thereof.

It is noted that preferably, the first and second over-temperature cumulative time duration provide indications of times spent above a first temperature threshold, while the additional over-temperature cumulative time duration provides an indication of a time spent above a second temperature threshold, where the first temperature threshold and the second temperature thresholds are characterized by different temperatures. Thus, as used herein, “additional over-temperature cumulative time duration” typically provides an indication of exceedance of a different temperature than an indication of exceedance of a temperature indicated by both the “first over-temperature cumulative time duration” and the “second over-temperature cumulative time duration.” It is further appreciated that HRQI 800 may include any suitable number of transparent areas, placed to allow indications of any suitable number of time durations spent either above the first or second temperature thresholds.

In one example, which should not be construed to be limiting, properties of first QPRCM 840, coloring material diffuser 820, and transparent areas 872 and 874, such as composition and position thereof, are chosen such that that the respective first and second over-temperature cumulative time durations from the start of diffusion of first QPRCM 840 along coloring material diffuser 820 until QPRCM 840 colors portions 882 and 884 of coloring material diffuser 820, which are visible through respective transparent areas 872 and 874, is two hours and four hours, respectively. Similarly, for example, properties of second QPRCM 842, coloring material diffuser 820, and transparent areas 874, such as composition and position thereof, are chosen such that that the additional over-temperature cumulative time duration from the start of diffusion of second QPRCM 842 along coloring material diffuser 820 until second QPRCM 842 colors portion 884 of coloring material diffuser 820, which is visible through transparent areas 874, is 30 minutes.

However, it is appreciated that properties of first QPRCM 840 and coloring material diffuser 820, as well as locations of transparent areas 872 and 874, may be chosen such that each of the first and second over-temperature cumulative time durations, from the start of diffusion of first QPRCM 840 along coloring material diffuser 820 until first QPRCM 840 colors portions 882 and 884 of coloring material diffuser 820, which are visible through respective transparent areas 872 and 874, may be any suitable respective time duration. Similarly, properties of second QPRCM 842 and coloring material diffuser 820, as well as location of transparent areas 874, may be chosen such that the additional over-temperature cumulative time duration, from the start of diffusion of second QPRCM 842 along coloring material diffuser 820 until second QPRCM 842 colors portion 884 of coloring material diffuser 820, which is visible through transparent areas 874, may be any suitable time duration.

As is known in the art, product quality is often sensitive to different temperatures to varying extents. Specifically, a slightly elevated temperature may degrade the quality of a product more slowly than an extremely elevated temperature.

For example, if a vial of vaccine whose recommended storage temperature, in order to maintain the quality thereof, is 2 degrees Celsius, an exposure of the vial to a temperature of 8 degrees Celsius may only render the vial of vaccine unfit for use after a cumulative exposure of 4 hours. However, an exposure of the vial to a temperature of 30 degrees Celsius may cause the quality of the vaccine to reach an unusable state after a cumulative exposure of only 30 minutes. Additionally, even a very short exposure, such as an exposure of 2 seconds, of the vial to a temperature of 0 degrees Celsius, may cause the quality of the vaccine to reach an unusable state.

Typically, the first over-temperature cumulative time duration, the second over-temperature cumulative time duration and the additional over-temperature cumulative time duration, as well as the first upper temperature threshold, the second upper temperature threshold and the lower temperature threshold, are chosen based on the requirements of contents of container 890.

For example, an HRQI assembly 800 for association with a flu vaccine may have a lower temperature limit of 2 degrees Celsius, while an HRQI assembly 800 for association with a COVID-19 vaccine may have a lower temperature limit of −70 degrees Celsius. Similarly, an HRQI assembly 800 for association with a package of frozen meat may have respective first and second over-temperature cumulative time durations of two and four hours for a first upper temperature threshold of 8 degrees Celsius and an additional over-temperature cumulative time duration of 30 minutes for a second upper temperature threshold of 30 degrees Celsius, while an HRQI assembly 800 for association with a package of fresh meat may have respective first and second over-temperature cumulative time durations of 30 minutes and one hour for a first upper temperature threshold of 10 degrees Celsius, and an additional over-temperature cumulative time duration of 15 minutes for a second upper temperature threshold of 30 degrees Celsius.

Turning particularly to FIG. 10A, it is seen that when a temperature of container 890, and of HRQI assembly 800 associated therewith, exceeds the first upper temperature threshold for less than the first over-temperature cumulative time duration, but does not exceed the second upper temperature threshold, first QPRCM 840 begins to diffuse through coloring material diffuser 820 beyond portion 880 in a direction toward portion 882, while second QPRCM 842 remains in a non-flowable state. However, as long as a temperature of container 890 and of HRQI assembly 800 associated therewith does not exceed the first upper temperature threshold for at least the first over-temperature cumulative time duration, first QPRCM 840 preferably does not color portion 882. Thus, as long as a temperature of container 890 and of HRQI assembly 800 associated therewith does not exceed either the first upper temperature threshold for at least the first over-temperature cumulative time duration or the second over-temperature threshold for at least the additional over-temperature cumulative time duration, neither portion 882 nor portion 884 of coloring material diffuser 820 become colored, and thus neither transparent area 872 nor transparent areas 874 appear colored, and HRQI assembly 800 remains in visible state II, in which preferably only barcode 862 is in a readable state.

In contrast, as seen particularly to FIG. 10B, when a temperature of container 890 and of HRQI assembly 800 associated therewith exceeds the first upper temperature threshold, for at least the first over-temperature cumulative time duration, but does not exceed the second upper temperature threshold, first QPRCM 840 diffuses through portions of coloring material diffuser 820, including portion 882, while second QPRCM 842 remains in a non-flowable state.

Thus, when a temperature of container 890 and of HRQI assembly 800 associated therewith exceeds the first upper temperature threshold for at least the first over-temperature cumulative time duration, the color visible through transparent area 872 is determined by the color of first QPRCM 840. As seen particularly in FIG. 10B, upon a coloring of portion 882 by black first QPRCM 840, transparent area 872 shows a black color, and HRQI assembly 800 thus preferably assumes visible state III.

It is appreciated that the coloring of portion 882 by first QPRCM 840, and thus the changing of the color visible through transparent area 872, changes an appearance of HRQI assembly 800, and more particularly, changes an appearance of barcode 862 and of barcode 864.

In visible state III, transparent areas 870, 871 and 872 show a color similar to the color of bars of barcodes 858, while transparent areas 874 remain uncolored. Therefore, barcodes 860, 862 and 866 are preferably unreadable by a conventional barcode reader, while barcode 864 is readable by a conventional barcode reader. Additionally, in visible state III, HRQI assembly 800 has preferably not been exposed to a temperature less than the lower temperature threshold for at least the under-temperature time duration. Therefore, cold responsive coloring material 854 is preferably characterized by the first color thereof, for example colorless and transparent, and area 852 does not interfere with the readability of any of barcodes 860, 862, 864 and 866, while the first color of area 852 preferably prevents barcode 868 from being read. Thus, HRQI assembly 800 in visible state III presents a single machine-readable barcode typically readable by a conventional barcode reader, here exemplified as barcode 864 having numerical sequence 7290003804122.

It is appreciated that once HQRI assembly 800 assumes visible state III, HRQI assembly 800 preferably cannot thereafter revert to either of states I or II, notwithstanding that the temperature of HRQI assembly 800 and associated container 890 subsequently drops below the first upper temperature threshold.

It is additionally appreciated that once having been supplied to NHRQI sub-assembly 802, first QPRCM 840 is operative to assume a non-flowable state upon HRQI assembly 800 being exposed to a temperature below the first upper temperature threshold, regardless of a visible state then displayed by HRQI assembly 800. Similarly, once having been supplied to NHRQI sub-assembly 802, first QPRCM 840 is operative to assume a flowable state upon HRQI assembly 800 being exposed to a temperature exceeding the first upper temperature threshold, regardless of a visible state then displayed by HRQI assembly 800.

It is appreciated that HRQI assembly 800 is also operative to assume visible state III if second QPRCM 842 begins to diffuse beyond portion 881, but does not reach portion 884.

Turning now particularly to FIG. 10C, it is seen that following an elapse of an additional time duration at a temperature exceeding the first upper temperature threshold, such that the total cumulative elapsed time is at least the second over-temperature cumulative time duration, first QPRCM 840 diffuses further through coloring material diffuser 820, including through portion 884.

Thus, when a temperature of container 890 and of HRQI assembly 800 associated therewith exceeds the first upper temperature threshold for at least the second over-temperature cumulative time duration, the color visible through transparent areas 874 is determined by the color of first QPRCM 840. As seen particularly in FIG. 10C, upon a coloring of portion 884 by black first QPRCM 840, transparent areas 874 show a black color, and HRQI assembly 800 thus preferably assumes visible state IV.

It is appreciated that the coloring of portion 884 by first QPRCM 840, and thus the changing of the color visible through transparent areas 874, changes an appearance of HRQI assembly 800, and more particularly, changes an appearance of barcodes 862, 864 and 866.

As seen in FIG. 10C, in a first version of visible state IV, each of transparent areas 870, 871, 872 and 874 shows a color similar to the color of bars of barcodes 858. Therefore, barcodes 860, 862 and 864 are preferably unreadable by a conventional barcode reader, while barcode 866 is readable by a conventional barcode reader. Additionally, in visible state IV, HRQI assembly 800 has preferably not been exposed to a temperature less than the lower temperature threshold for at least the under-temperature time duration. Therefore, cold responsive coloring material 854 is preferably characterized by the first color thereof, for example colorless and transparent, and area 852 does not interfere with the readability of any of barcodes 860, 862, 864 and 866, while the first color of area 852 preferably prevents barcode 868 from being read. Thus, upon exposure of container 890 and of HRQI assembly 800 associated thereto to a temperature exceeding the first upper temperature threshold for at least the second over-temperature cumulative time duration, HRQI assembly 800 assumes visible state IV. In visible state IV, HRQI assembly 800 preferably presents a single machine-readable barcode typically readable by a conventional barcode reader, here exemplified as barcode 866 having numerical sequence 7290003804115.

It is appreciated that once HRQI assembly 800 has assumed visible state IV, HRQI assembly 800 preferably cannot thereafter revert to any of states I, II and III, notwithstanding that the temperature of HRQI assembly 800 and associated container 890 subsequently drops below the first upper temperature threshold.

Similarly, as seen particularly in FIG. 10D, when a temperature of container 890, and of HRQI assembly 800 associated therewith, exceeds the second upper temperature threshold for at least the additional over-temperature cumulative time duration, second QPRCM 842 diffuses through coloring material diffuser 820 beyond portion 881, including through portion 884.

Thus, the color visible through transparent areas 874 is determined by the color of second QPRCM 842. In the example shown in FIGS. 10A-10E, as seen particularly in FIG. 10D, upon a coloring of portion 884 by second QPRCM 842, transparent areas 874 show a black color, and HRQI assembly 800 thus preferably assumes visible state IV.

It is appreciated that the coloring of portion 884 by second QPRCM 842, and thus the changing of the color visible through transparent areas 874, changes an appearance of HRQI assembly 800, and more particularly, changes an appearance of barcodes 862, 864 and 866.

In the second version of visible state IV, each of transparent areas 870, 871 and 874 shows a color similar to the color of bars of barcodes 858, and transparent area 872 remains uncolored. Therefore, barcodes 860, 862 and 864 are preferably unreadable by a conventional barcode reader, while barcode 866 is readable by a conventional barcode reader. Additionally, in visible state IV, HRQI assembly 800 has preferably not been exposed to a temperature less than the lower temperature threshold for at least the under-temperature time duration. Therefore, cold responsive coloring material 854 is preferably characterized by the first color thereof, for example colorless and transparent, and area 852 does not interfere with the readability of any of barcodes 860, 862, 864 and 866, while the first color of area 852 preferably prevents barcode 868 from being read. Thus, upon exposure of container 890 and of HRQI assembly 800 associated thereto to a temperature exceeding the second upper temperature threshold for at least the additional over-temperature cumulative time duration, HRQI assembly 800 assumes visible state IV. As described hereinabove with reference to FIG. 10C, in visible state IV, HRQI assembly 800 preferably presents a single machine-readable barcode typically readable by a conventional barcode reader, here exemplified as barcode 866 having numerical sequence 7290003804115.

As noted above with reference to FIG. 10C, it is appreciated that once HRQI assembly 800 has assumed visible state IV, HRQI assembly 800 preferably cannot thereafter assume any of states I, II and III, notwithstanding that the temperature of HRQI assembly 800 and associated container 890 subsequently drops below the second upper temperature threshold or exceeds either the first or second upper temperature thresholds for additional amounts of time.

Turning now particularly to FIG. 10E, it is seen that when a temperature of container 890 and of HRQI assembly 800 associated therewith falls below the lower temperature threshold for at least the under-temperature time duration, cold responsive coloring material 854 irreversibly assumes the second color, and HRQI assembly 800 assumes visible state V.

It is appreciated that the assumption of the second color by cold responsive coloring material 854 changes an appearance of HRQI assembly 800, and more particularly, changes an appearance of barcodes 860, 862, 864, 866 and 868.

It is appreciated that once cold responsive coloring material 854 assumes the second color, area 852 preferably prevents any of barcodes 860, 862, 864 and 866 from being read, while the second color of area 852 preferably allows barcode 868 to be read. It is appreciated that in visible state V, transparent areas 848 may show any color, since the second color of cold responsive coloring material 854 in area 852 preferably prevents barcodes 860, 862, 864 and 866 from being read regardless of a color visible through any of transparent areas 848.

Thus, upon exposure of container 890 and of HRQI assembly 800 associated therewith to a temperature below the lower temperature threshold for at least the under-temperature time duration, HRQI assembly 800 assumes visible state V. In visible state V, HRQI assembly 800 preferably presents a single machine-readable barcode typically readable by a conventional barcode reader, here exemplified as barcode 868 having numerical sequence 7290003804139.

It is appreciated that once HRQI assembly 800 has assumed visible state V, HRQI assembly 800 preferably cannot thereafter assume any of states I, II, III and IV, notwithstanding that the temperature of HRQI assembly 800 and associated container 890 subsequently exceeds the lower temperature threshold, or even either the first or second upper temperature thresholds.

It is noted that while it is typically undesirable to associate container 890 to NHRQI sub-assembly 802 to which one or both of first and second QPRCMs 840 and 842 have not been supplied, in the illustrated embodiment of the present invention, NHRQI sub-assembly 802 without either or both of first and second QPRCMs 840 and 842 may be operative to assume visible state V.

Alternatively, HRQI assembly 800 may include, instead of NHRQI sub-assembly 802, an initial heat responsive quality indicator (IHRQI) sub-assembly (not shown), similar to NHRQI sub-assembly 802, including at least one coloring material diffuser, such as a coloring material diffuser 820 and at least one indicator template, such as an indicator template 812. In contrast to sub-assembly NHRQI 802, in this alternative embodiment, the IHRQI sub-assembly also includes at least a first heat responsive coloring material (HRCM), corresponding to second QPRCM 842, which is flowable at a first temperature exceeding a first upper temperature threshold. It is appreciated that unlike second QPRCM 842, which is preferably injected into NHRQI sub-assembly 802, the first HRCM may be supplied to the IHRQI sub-assembly in any suitable manner.

In this embodiment, HRQI assembly 800 further includes a second HRCM, corresponding to first QPRCM 840, which, when supplied to the coloring material diffuser of the IHRQI sub-assembly, preferably by injection, preferably converts the IHRQI sub-assembly to HRQI assembly 800. Thus, in this embodiment, HRQI assembly 800 is formed by supplying the second HRCM to the IHRQI sub-assembly, preferably by injecting the second HRCM into the IHRQI sub-assembly.

Typically, in this embodiment, the first upper temperature threshold of HRQI 800 is higher than the second upper temperature threshold of HRQI 800. For example, the first upper temperature threshold may be 45 degrees Celsius, and the second upper temperature threshold may be 8 degrees Celsius. In contrast to the embodiment shown in FIGS. 8-10E, in this embodiment, the first HRCM is supplied to the IHRQI sub-assembly at the time of manufacture of the IHRQI sub-assembly, because the first upper temperature threshold of the first HRCM is typically a temperature higher than ambient temperatures normally experienced during standard storage, shipping and handling of the IHRQI sub-assembly, and thus maintaining the IHRQI sub-assembly at temperatures below the first upper temperature threshold is typically neither difficult nor expensive. However, since temperatures normally experienced during standard storage, shipping and handling of the IHRQI assembly may often exceed the second upper temperature threshold of the second HRCM, the second HRCM is injected into the IHRQI sub-assembly substantially immediately prior to an association of HRQI assembly 800 of this embodiment with a container, thereby reducing the effort and cost associated with maintaining the IHRQI sub-assembly at a temperature below the second upper temperature threshold.

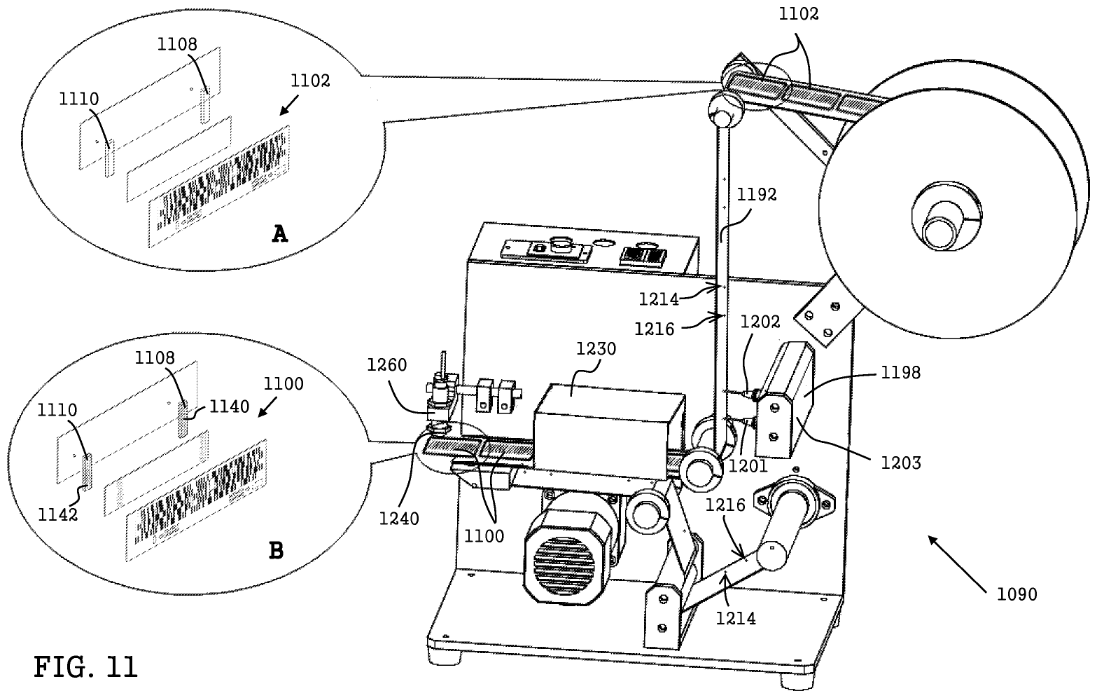

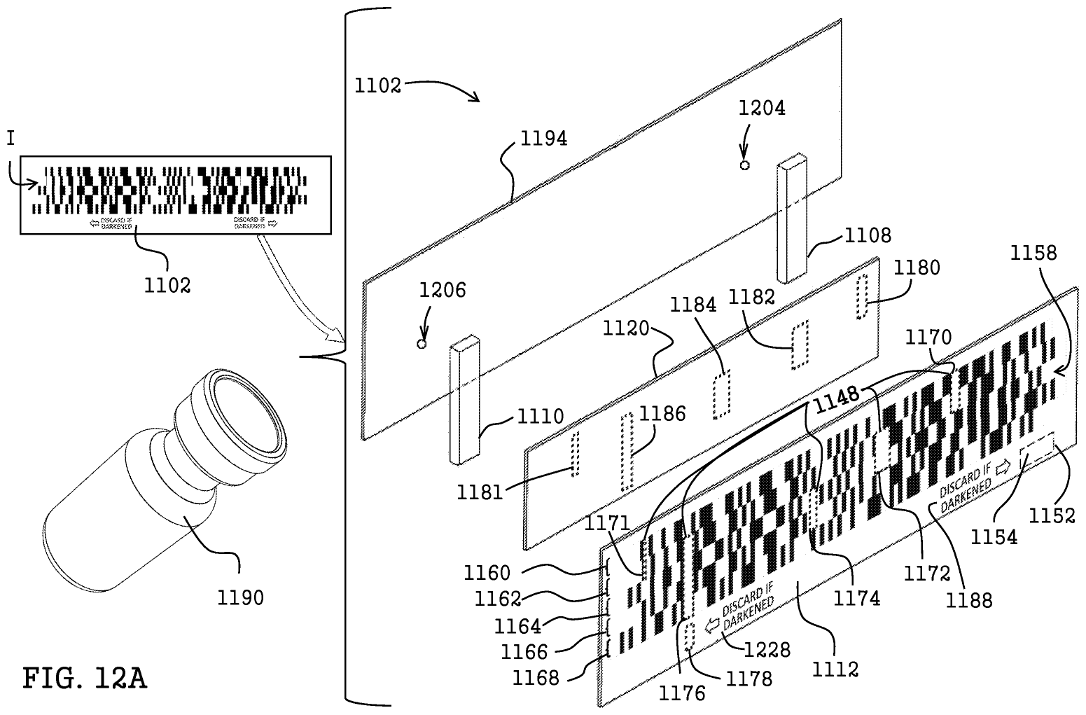

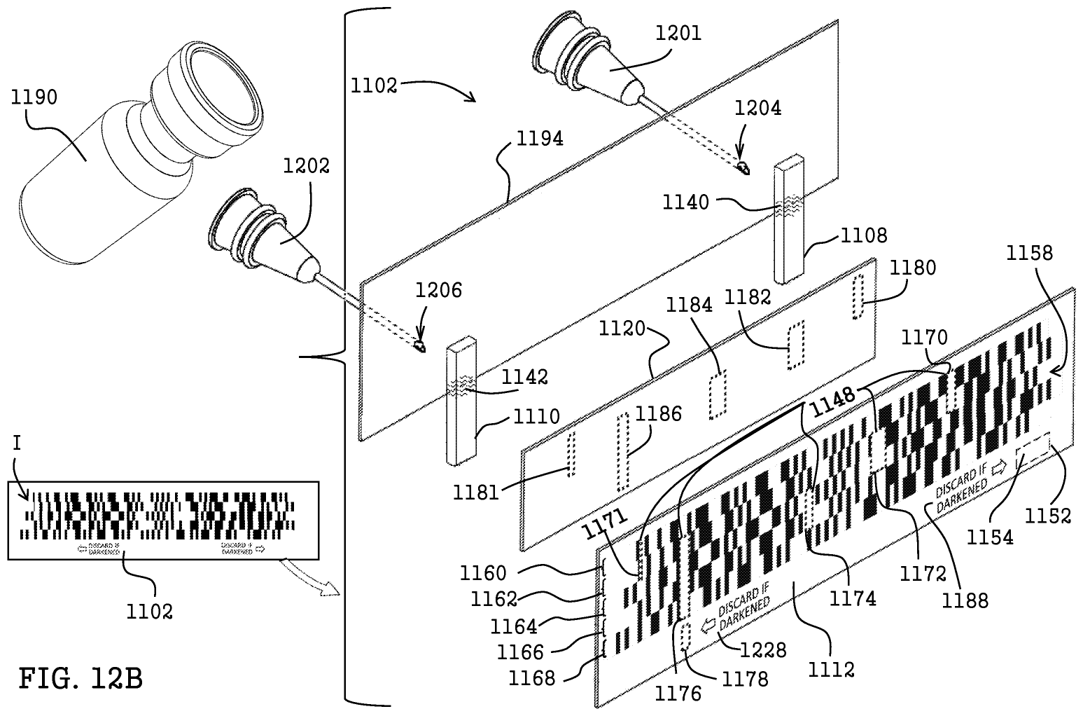

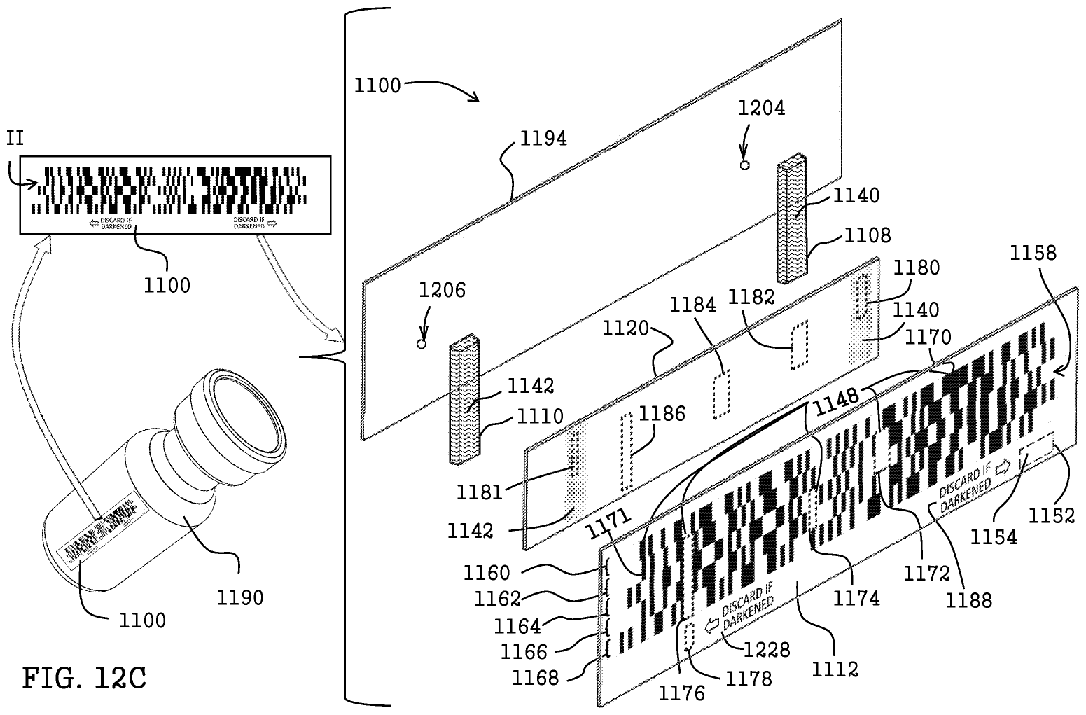

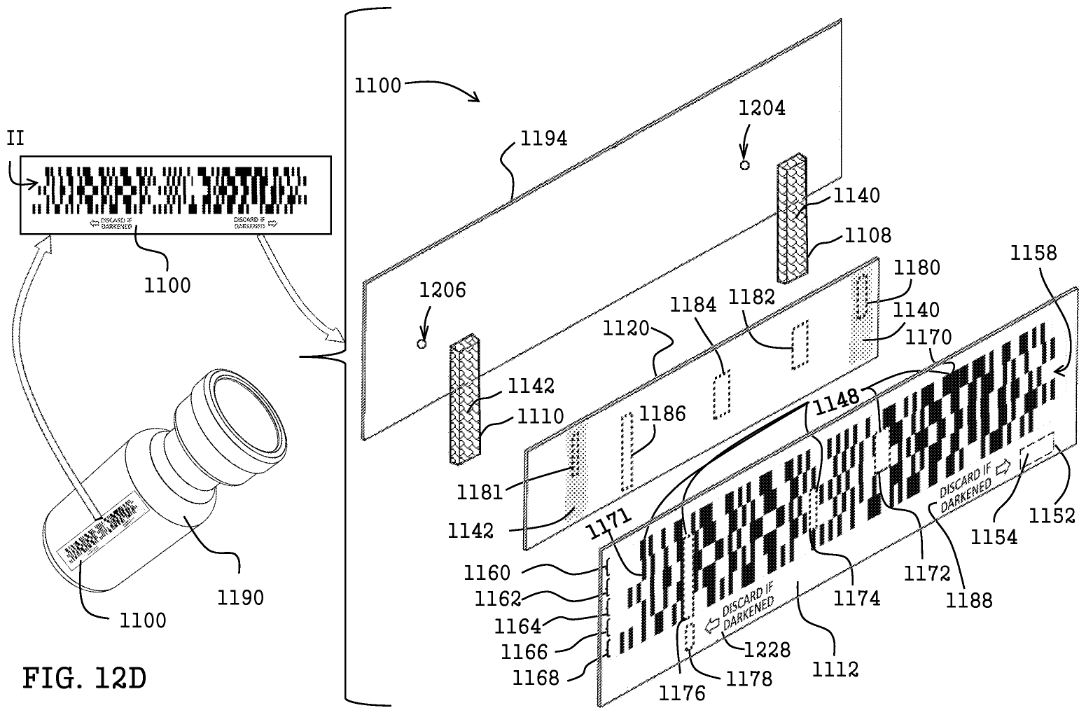

Reference is now made to FIG. 11, which is a simplified illustration of a heat responsive coloring material supplier (HRCMS) 1090, which is an example of one or both of HRCMSs 102 and 107 of FIGS. 1A-1E, and to FIGS. 12A-12D, which together are a simplified illustration of a preferred method of construction of a heat responsive quality indicator (HRQI) 1100, which is an embodiment of one or both of HRQI assemblies 100 and 105 of FIGS. 1A-1E.

HRQI assembly 1100 preferably includes a shelf-stable, non-heat responsive quality indicator (NHRQI) sub-assembly 1102 including at least a first coloring material reservoir 1108 and a second coloring material reservoir 1110, at least one indicator template 1112 and at least one coloring material diffuser 1120.

HRQI assembly 1100 preferably additionally includes a first quality parameter responsive coloring material (QPRCM) 1140 and a second QPRCM 1142. In a preferred embodiment of the present invention, each of first and second QPRCMs 1140 and 1142 is an HRCM, which is flowable at a temperature exceeding a first and second upper temperature threshold, respectively, as indicated by waved lines in corresponding figures. First QPRCM 1140 is characterized by a viscosity and melting point such that first QPRCM 1140 is flowable through or on coloring material diffuser 1120 at temperatures above a first upper temperature threshold and is not flowable through or on coloring material diffuser 1120 at temperatures below the first upper temperature threshold. Similarly, second QPRCM 1142 is characterized by a viscosity and melting point such that second QPRCM 1142 is flowable through or on coloring material diffuser 820 at temperatures above a second upper temperature threshold and is not flowable through or on coloring material diffuser 1120 at temperatures below the second upper temperature threshold. Both first QPRCM 1140 and second QPRCM 1142 are preferably characterized by a color that is readily distinguishable from a color of coloring material diffuser 1120.

First QPRCM 1140 and second QPRCM 1142, when supplied to coloring material diffuser 1120 of NHRQI sub-assembly 1102, preferably convert NHRQI sub-assembly 1102 to HRQI assembly 1100, which is responsive to changes in temperature over time in exceedance of the first upper temperature threshold and the second upper temperature threshold, for changing an appearance of HRQI assembly 1100. Thus, HRQI assembly 1100 is formed by supplying first QPRCM 1140 and second QPRCM 1142 to NHRQI sub-assembly 1102, and more preferably by injecting first QPRCM 1140 and second QPRCM 1142 into NHRQI sub-assembly 1102.

When first QPRCM 1140 is flowable, first QPRCM 1140 preferably diffuses through coloring material diffuser 1120. Conversely, when first QPRCM 1140 is not flowable, first QPRCM 1140 preferably does not diffuse through coloring material diffuser 1120. Similarly, when second QPRCM 1142 is flowable, second QPRCM 1142 preferably diffuses through coloring material diffuser 1120. Conversely, when second QPRCM 1142 is not flowable, second QPRCM 1142 preferably does not diffuse through coloring material diffuser 1120.

It is further appreciated that at least one of QPRCMs 1140 and 1142 may additionally or alternatively be embodied as a coloring material that is responsive to at least one alternative or additional quality parameter, including, inter alia, moisture, force, pressure, pH and elapsed time. In such a case, HRQI assembly 1100 is preferably embodied as at least, inter alia, a moisture responsive quality indicator, a force responsive quality indicator, a pressure responsive quality indicator, a pH responsive quality indicator and an elapsed time responsive quality indicator, respectively.

In one embodiment of the present invention, (not shown), at least one of first QPRCM 1140 and second QPRCM 1142 is supplied directly to coloring material diffuser 1120. In such an embodiment, at least one of corresponding first coloring material reservoir 1108 and second coloring material reservoir 1110 may be obviated.

In another embodiment of the present invention, as seen particularly in FIGS. 11-12D, both first QPRCM 1140 and second QPRCM 1142 are supplied indirectly to coloring material diffuser 1120. In such an embodiment, first QPRCM 1140 and second QPRCM 1142 are preferably supplied to first coloring material reservoir 1108 and second coloring material reservoir 1110, respectively, and first coloring material reservoir 1108 supplies first QPRCM 1140 to coloring material diffuser 1120 and second coloring material reservoir 1110 supplies second QPRCM 1142 to coloring material diffuser 1120.

In a preferred embodiment of the present invention, coloring material diffuser 1120 is embodied as filter paper, such as Whatman No. 3 filter paper commercially available from Whatman International [CAT #: 1003917]. Additionally, coloring material reservoirs 1108 and 1110 are each preferably embodied as a pad, for example, K-R; 210/34/28, commercially available from Noam-Urim of Kibbutz Urim, Israel, first QPRCM 1140 is preferably embodied as a coloring agent, such as Sudan Black, a black color dye [CAS: 4197-25-5], combined at a ratio of 1.4 grams per 1 kilogram in Decyl Decanoate [CAS: 1654-86-0], and second QPRCM 1142 is preferably embodied as a coloring agent, such as Sudan Black, a black color dye [CAS: 4197-25-5], combined at a ratio of 1.4 grams per 1 kilogram in Butyl Stearate [CAS: 123-95-5].

Preferably, indicator template 1112 includes a transparent substrate on which is formed non-transparent printing. In a preferred embodiment of the present invention, all areas on the transparent substrate which are desired to be opaque, including both a background and areas in which features will be printed, are printed with white ink, and a plurality of features, such as bars forming part of barcodes corresponding to barcodes 110 or 111 of FIGS. 1A-1E, are preferably printed with black ink over the white ink as desired.

In another embodiment of the present invention, a background area of indicator template 1112 is printed with white ink; however, the white ink is not deposited in the areas in which the plurality of features are formed, and the plurality of features are preferably printed with black ink.

More generally, in all embodiments of the present invention, the background area of indicator template 1112 and the plurality of features of indicator template 1112 are printed in such colors as to define high contrast therebetween.

Indicator template 1112 preferably further includes at least one transparent area 1148, indicated by dotted lines in FIGS. 12A-12D. It is appreciated that the dotted lines indicating transparent area or areas 1148 are drawn for ease of understanding, and preferably transparent area or areas 1148 are not readily distinguishable from surrounding areas of indicator template 1112. In a preferred embodiment of the present invention, transparent area or areas 1148 are not printed, i.e., preferably no material is deposited on transparent area or areas 1148. For the purposes of the present specification and claims, the term “transparent area” is defined so as to include within its scope areas that are either transparent or translucent.

Preferably, coloring material diffuser 1120 is visible through the entirety of each of transparent areas 1148. Thus, a color visible in each of transparent areas 1148 is determined by a color of a portion of coloring material diffuser 1120 located therebehind. In a preferred embodiment of the present invention, each of transparent areas 1148 is initially white in color, and assumes a black color upon a coloring of coloring material diffuser 1120 by either first QPRCM 1140 or second QPRCM 1142.

In a preferred embodiment of the present invention, indicator template 1112 additionally includes at least one area 1152 upon which is deposited a cold responsive coloring material 1154, such as a thermochromic coloring material, such as irreversible thermochromic ink commercially available from CTI Technology, Colorado Springs, USA. Alternatively, area 1152 and cold responsive coloring material 1154 may be embodied as a commercially available cold responsive label, such as a Model 54000 Freeze Check™ temperature indicator commercially available from DeltaTrak Inc., Pleasanton, USA. It is appreciated that although, for ease of understanding, dashed lines in FIGS. 12A-12D indicate area 1152, preferably area 1152 is not readily distinguishable from surrounding areas of indicator template 1112.

It is appreciated that as used herein, “cold responsive” is used to indicate an element or system that changes as a result of cold, wherein “cold” is used to indicate a temperature below a lower temperature threshold, such as a temperature at which cold responsive coloring material 1154 typically changes color.

In a preferred embodiment of the present invention, cold responsive coloring material 1154 is initially characterized by a first color, and irreversibly assumes a second color, which is different from the first color, upon exposure to a temperature below a lower temperature threshold, for example, below 2 degrees Celsius, for an under-temperature time duration. As described hereinabove, in one embodiment of the present invention, the under-temperature time duration is very short, preferably less than 60 seconds, more preferably less than 30 seconds, more preferably less than 15 seconds, even more preferably less than 10 seconds and most preferably less than 5 seconds. In another embodiment of the present invention, the under-temperature time duration is relatively long, and may be, for example, 5 minutes, 10 minutes, 20 minutes, 30 minutes or 45 minutes.

Thus, if the under-temperature time duration is very short, then cold responsive coloring material 1154 preferably assumes the second color substantially immediately upon being exposed to a temperature below the lower temperature threshold. In contrast, if the under-temperature time duration is relatively long, for example 30 minutes, then cold responsive coloring material 1154 assumes the second color only upon an exposure to a temperature less than the lower temperature threshold for at least 30 minutes.

It is appreciated that the first color and the second color assumed by cold responsive coloring material 1154 may be any suitable colors which are discernable from one another. In one embodiment of the present invention, the first and second colors are readily discernable from one another by a human. Additionally or alternatively, the first and second colors are readily discernable from one another by a machine. For example, in one embodiment of the present invention, cold responsive coloring material 1154 characterized by the first color is colorless and transparent, and cold responsive coloring material 1154 characterized by the second color is blue. In another embodiment of the present invention, cold responsive coloring material 1154 characterized by the first color is green, and cold responsive coloring material 1154 characterized by the second color is colorless and transparent.

It is appreciated that while the embodiment illustrated in FIGS. 11-12D includes cold responsive coloring material 1154, in another embodiment of the present invention, HRQI assembly 1100 does not include cold responsive coloring material 1154.

In the example illustrated in FIGS. 11-12D, indicator templates 1112 includes a plurality of barcodes 1158, such as barcodes 110 or 111, including a first barcode 1160, a second barcode 1162, a third barcode 1164, a fourth barcode 1166 and a fifth barcode 1168, which are preferably different from each other and arranged in a stacked arrangement. As indicated by dotted lines, formed within barcodes 1158 are transparent areas 1148, including a transparent area 1170, a transparent area 1171, a transparent area 1172, a transparent area 1174 and a transparent area 1176. In the example illustrated in FIGS. 11-12D, indicator templates 1112 further includes human sensible indicia, including area 1152 and a transparent area 1178.

It is appreciated that human sensible indica corresponding to at least one of area 1152 and transparent area 1178 may also be included in the embodiment described hereinabove with reference to FIGS. 8-10E.

As described hereinabove, coloring material diffuser 1120 is preferably visible through the entirety of each of transparent areas 1148. More particularly, a portion 1180 of coloring material diffuser 1120 is preferably visible through transparent area 1170, a portion 1181 of coloring material diffuser 1120 is preferably visible through transparent area 1171, a portion 1182 of coloring material diffuser 1120 is preferably visible through transparent area 1172, a portion 1184 of coloring material diffuser 1120 is preferably visible through transparent area 1174 and a portion 1186 of coloring material diffuser 1120 is preferably visible through transparent areas 1176 and 1178. Thus, it is appreciated that a color visible in each of transparent areas 1170, 1171, 1172, 1174 and 1176 is determined by a color of each of portions 1180, 1181, 1182, 1184 and 1186, respectively, and that a color visible in transparent area 1178 is determined by a color of portion 1186. It is appreciated that although, for ease of understanding, dotted lines in FIGS. 12A-12D indicate each of portions 1180, 1181, 1182, 1184 and 1186, preferably portions 1180, 1181, 1182, 1184 and 1186 are not readily distinguishable from surrounding areas of coloring material diffuser 1120.

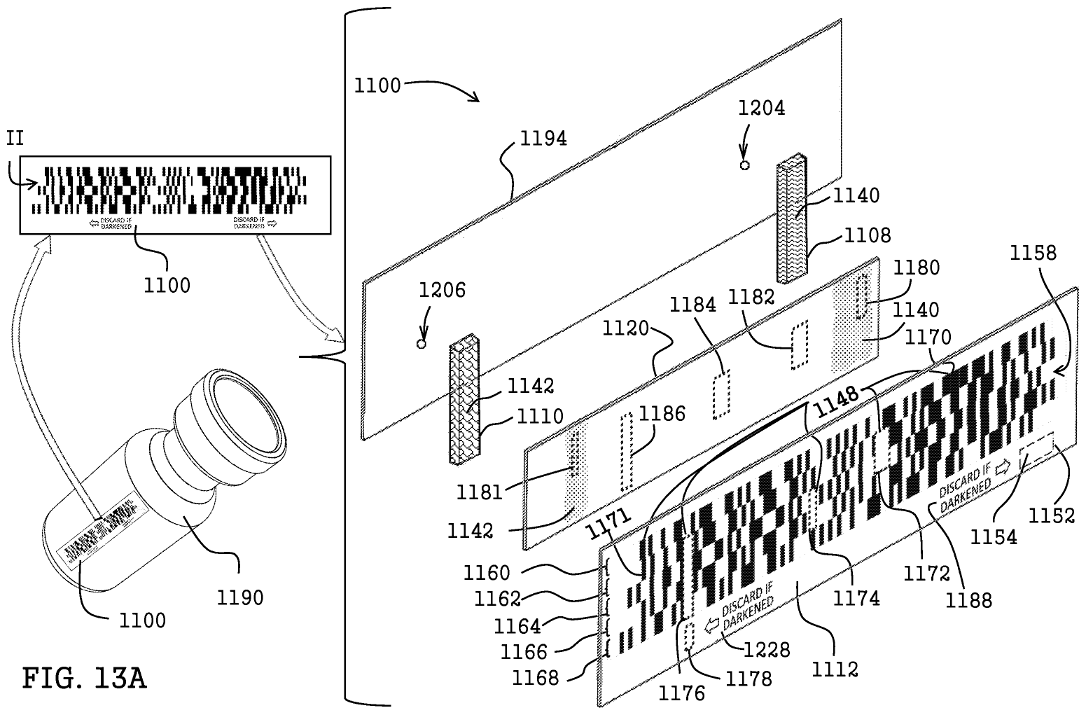

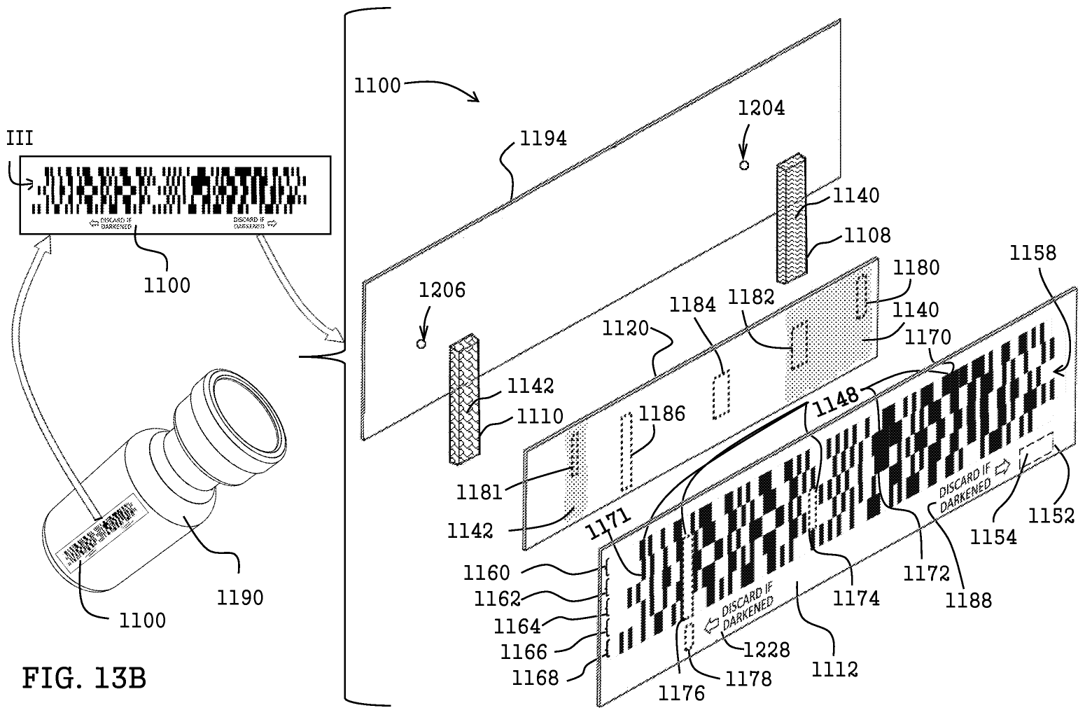

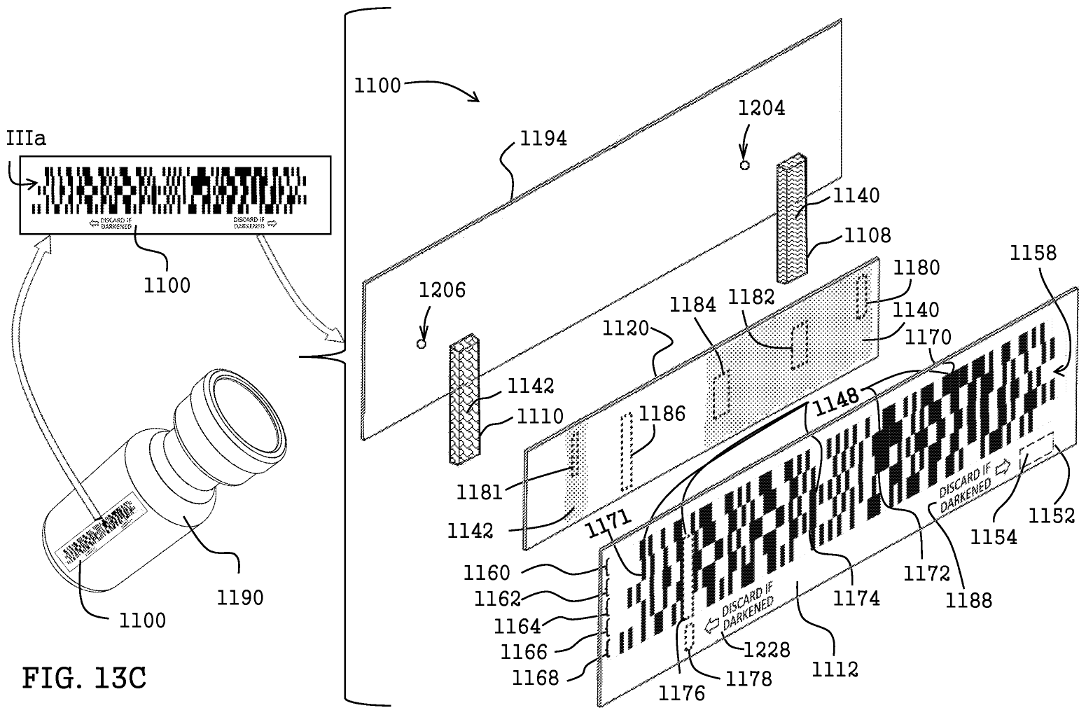

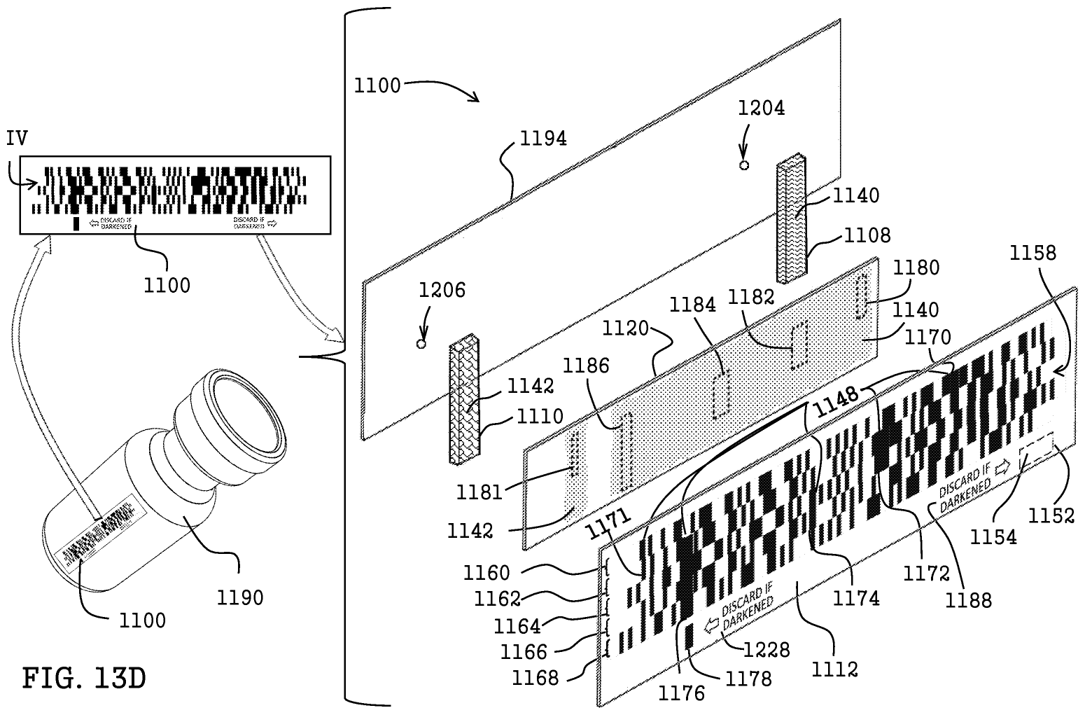

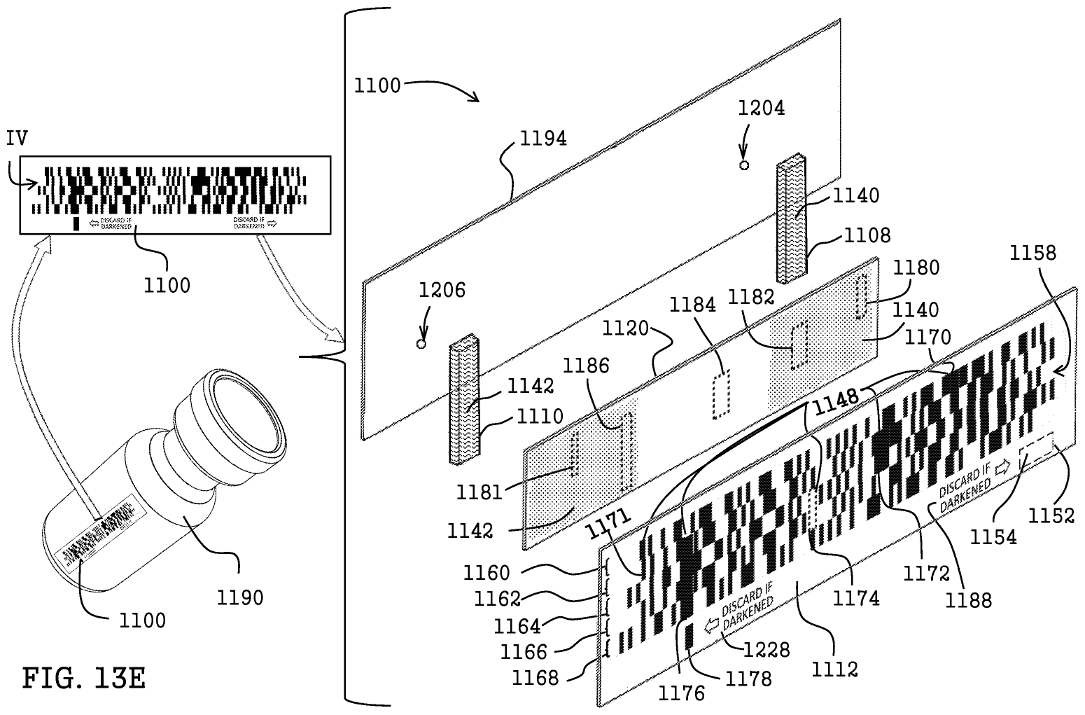

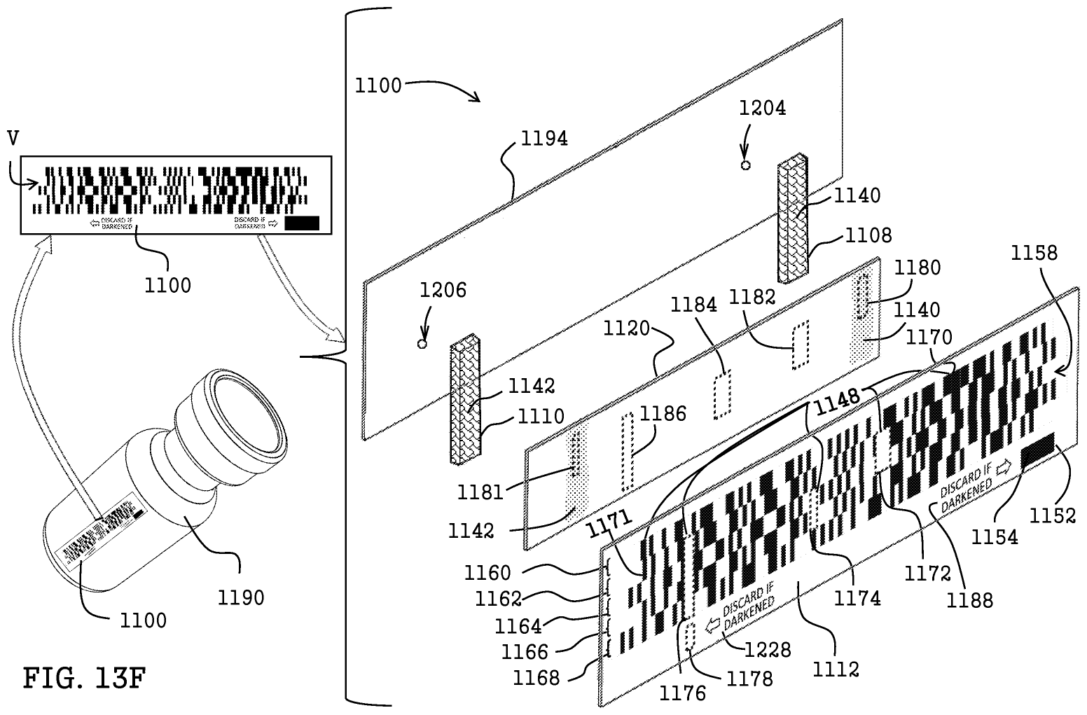

Preferably, each of transparent areas 1170, 1171, 1172, 1174 and 1176 is formed within at least two of barcodes 1158 and forms a readable portion thereof. In the illustrated embodiment of FIGS. 12A-13F, transparent areas 1170 and 1171 each form part of barcodes 1160 and 1162, transparent area 1172 forms part of barcodes 1162 and 1164, transparent area 1174 forms part of barcodes 1164 and 1166 and transparent area 1176 forms part of barcodes 1162, 1164, 1166 and 1168. Each of transparent areas 1148 preferably has the same width as a single barcode bar. Alternatively, the width of any of the transparent areas 1170, 1171, 1172, 1174 and 1176 may be different from the width of a single barcode bar. Additionally, the width of the portion of a transparent area 1148 which forms part of one of barcodes 1158 may be different from the width of the portion of the same transparent area 1148 which forms part of another of barcodes 1158.

It is appreciated that barcodes 1160, 1162, 1164, 1166 and 1168 may be arranged in any suitable order with respect to one another. Similarly, transparent areas 1170, 1171, 1172, 1174 and 1176 may be arranged in any suitable order with respect to one another. Furthermore, it is appreciated that at least one of barcodes 1160, 1162, 1164, 1166 and 1168 and/or transparent areas 1170, 1171, 1172, 1174, 1176 and 1178 may be obviated from indicator template 1112 and HRQI assembly 1100. Similarly, one or more additional barcodes and/or transparent areas may be added to indicator template 1112 and HRQI assembly 1100.

In a preferred embodiment of the present invention, a different single one of barcodes 1158 is machine-readable at each of visible states I, II, III, IIIa, and IV. For example, in the example illustrated in FIGS. 11-12D, barcode 1160 is read as 7290003804191 at pre-supply visible state I, barcode 1162 is read as 7290003804108 at post-supply visible state II, barcode 1164 is read as 7290003804122 in visible state III, barcode 1166 is read as 7290003804115 in a visible state IIIa and barcode 1168 is read as 7290003804139 in visible state IV. Preferably, each of barcodes 1158 is machine-readable only in the single one of visible states I, II, III, IIIa and IV listed above.

As seen particularly in FIGS. 12A-12D, when coloring material diffuser 1120 is in an uncolored state, meaning that neither first QPRCM 1140 nor second QPRCM 1142 has been supplied to coloring material diffuser 1120, coloring material diffuser 1120 causes each of transparent areas 1170, 1171, 1172, 1174, 1176 and 1178 to appear white in color. The white appearance of transparent areas 1170 and 1171 preferably allows barcode 1160 to be machine-readable, while the white appearance of transparent areas 1170, 1171, 1172, 1174 and 1176 preferably causes barcodes 1162, 1164, 1166 and 1168 to be non-machine-readable. Thus, when coloring material diffuser 1120 is in an uncolored state and NHRQI sub-assembly 1102 has not been exposed to a temperature less than the lower temperature threshold, NHRQI sub-assembly 1102 is preferably in pre-supply visible state I, wherein only barcode 1160 is in a machine-readable state.

Additionally, as long as NHRQI sub-assembly 1102 has not been exposed to a temperature less than the lower temperature threshold, cold responsive coloring material 1154 is preferably characterized by the first color thereof, for example colorless and transparent, and area 1152 provides an indication that a temperature of NHRQI sub-assembly 1102 has not fallen below the lower temperature threshold.

In the embodiment illustrated in FIGS. 11-12D, area 1152 and cold responsive coloring material 1154 thereon preferably provide a human sensible indication of whether or not a temperature of NHRQI sub-assembly 1102 has fallen below the lower temperature threshold for the under-temperature time duration. In a preferred embodiment of the present invention, NHRQI sub-assembly 1102 includes explanatory features, such as text and/or graphics, explaining at least one visible appearance of area 1152. For example, in the illustrated embodiment, NHRQI sub-assembly 1102 includes a message 1188 “DISCARD IF DARKENED→” adjacent to area 1152, thereby indicating to a user that if cold responsive coloring material 1154 is characterized by the first color thereof, a temperature of NHRQI sub-assembly 1102 has not fallen below the lower temperature threshold for the under-temperature time duration, but if cold responsive coloring material 1154 is characterized by the second color thereof, a temperature of NHRQI sub-assembly 1102 has fallen below the lower temperature threshold for the under-temperature time duration.

Typically, if first and second QPRCMs 1140 and 1142 have not yet been supplied to NHRQI sub-assembly 1102, a characterization of cold responsive coloring material 1154 by the second color thereof indicates to a user that NHRQI sub-assembly 1102 should not be associated with a product package and should be discarded. Similarly, if first and second QPRCMs 1140 and 1142 have been supplied to NHRQI sub-assembly 1102, thus forming HRQI assembly 1100, and HRQI assembly 1100 has been associated with a product package, a characterization of cold responsive coloring material 1154 by the second color thereof indicates to a user that the product package with which HRQI assembly 1100 is associated should be discarded.

It is appreciated that in the embodiment illustrated in FIGS. 11-12D, area 1152 and cold responsive coloring material 1154 thereon preferably additionally provide a machine-sensible indication of whether or not a temperature of NHRQI sub-assembly 1102 has fallen below the lower temperature threshold for the under-temperature time duration. Preferably, a system such as a suitably programmed machine vision system is operative to assess a color visible in area 1152 and provide a suitable indication based thereon.

As seen in FIG. 12A, a container 1190, such as, inter alia, package 101 or carton 106, is ready to be associated with an HRQI assembly 1100. It is appreciated that container 1190 is typically a product package, and may be embodied as, inter alia, an individual product package, a box of product packages, a pallet of product packages or a shipping container of product packages. In a preferred embodiment of the present invention, a type of container 1190 with which an HRQI assembly 1100 is associated, and more particularly a number of individual products contained by the container 1190 associated with HRQI assembly 1100, is at least partially determined by a relationship between a cost of monitoring container 1190, a temperature-sensitivity of a product within container 1190 and a financial value of a product within container 1190.

Preferably, as further seen in FIG. 12A, first and second QPRCMs 1140 and 1142 have not yet been supplied to NHRQI sub-assembly 1102, and therefore NHRQI sub-assembly 1102 is preferably not yet associated with container 1190. As described hereinabove, prior to a supply of first and second QPRCMs 1140 and 1142 to NHRQI sub-assembly 1102, NHRQI sub-assembly 1102 has not been exposed to a temperature less than the lower temperature threshold and is preferably in pre-supply visible state I.

Preferably, in visible state I, barcode 1160 is typically readable by a conventional barcode reader, such as barcode reader 113, mobile communicator 132 or mobile communicator 142 of FIGS. 1A-1E, and barcodes 1162, 1164, 1166 and 1168 are preferably not readable by a barcode reader. Thus, the NHRQI sub-assembly 1102 is in pre-supply visible state I and presents a single machine-readable barcode 1160, typically readable by a conventional barcode reader as 7290003804191.

NHRQI sub-assembly 1102 is preferably embodied as a self-adhesive label. Typically, after fabrication of NHRQI sub-assemblies 1102 and before first and second QPRCMs 1140 and 1142 are supplied thereto, NHRQI sub-assemblies 1102 are stored on a roll liner 1192. NHRQI sub-assembly 1102 includes a back portion 1194, on a rear side (not shown) of which is preferably an adhesive (not shown). The adhesive preferably serves to affix NHRQI sub-assembly 1102 to roll liner 1192. Typically, following the production of HRQI assembly 1100, the adhesive on NHRQI sub-assembly 1102 is also used to affix HRQI assembly 1100 to container 1190.

As seen particularly in FIGS. 11 and 12B, HRCMS 1090 preferably includes a coloring material supplier 1198, such as injection module 104 of FIG. 1A, which includes at least a first injector 1201 and a second injector 1202, such as a first and second needle assembly, respectively. In a preferred embodiment of the present invention, coloring material supplier 1198 includes a heating assembly 1203, such as a resistive heating assembly. If an ambient temperature of coloring material supplier 1198 is below the first upper temperature threshold of first QPRCM 1140 while coloring material supplier 1198 supplies first QPRCM 1140 to NHRQI sub-assembly 1102, heating assembly 1203 provides heat to first QPRCM 1140 during the supply thereof to NHRQI sub-assembly 1102, thereby maintaining first QPRCM 1140 at a temperature at which first QPRCM 1140 is flowable during the supply thereof to NHRQI sub-assembly 1102. Similarly, if an ambient temperature of coloring material supplier 1198 is below the second upper temperature threshold of second QPRCM 1142 while coloring material supplier 1198 supplies second QPRCM 1142 to NHRQI sub-assembly 1102, heating assembly 1203 provides heat to second QPRCM 1142 during the supply thereof to NHRQI sub-assembly 1102, thereby maintaining second QPRCM 1142 at a temperature at which second QPRCM 1142 is flowable during the supply thereof to NHRQI sub-assembly 1102.

Typically, coloring material supplier 1198 supplies both first and second QPRCMs 1140 and 1142 to NHRQI sub-assembly 1102 while NHRQI sub-assembly 1102 is affixed to roll liner 1192. In the embodiment shown in FIGS. 11-12D, coloring material supplier 1198 supplies first and second QPRCMs 1140 and 1142 to first and second coloring material reservoirs 1108 and 1110, respectively, and coloring material reservoir 1108 and 1110 then respectively supply first and second QPRCMs 1140 and 1142 to coloring material diffuser 1120. In another embodiment of the present invention, coloring material supplier 1198 supplies at least one of first and second QPRCMs 1140 and 1142 directly to coloring material diffuser 1120, and at least one of corresponding first coloring material reservoir 1108 and second coloring material reservoir 1110 may be obviated.

In a preferred embodiment of the present invention, both first QPRCM 1140 and second QPRCM 1142 are supplied to NHRQI sub-assembly 1102 immediately prior to the association of HRQI assembly 1100 with container 1190. In other words, both first QPRCM 1140 and second QPRCM 1142 are preferably supplied to NHRQI sub-assemblies 1102 as NHRQI sub-assemblies 1102 are being positioned for imminent association with containers 1190. Thus, in the illustrated embodiment shown in FIG. 11, as roll liner 1192 is unspooled to make NHRQI sub-assemblies 1102 available for affixation to containers 1190, both first QPRCM 1140 and second QPRCM 1142 are supplied to NHRQI sub-assemblies 1102.

Preferably, a first aperture 1204 and a second aperture 1206 are each formed in back portion 1194 of NHRQI sub-assembly 1102. As seen particularly in FIG. 12B, first QPRCM 1140 is preferably supplied by first injector 1201 to NHRQI sub-assembly 1102 through first aperture 1204, and second QPRCM 1142 is preferably supplied by second injector 1202 to NHRQI sub-assembly 1102 through second aperture 1206. In the illustrated embodiment of the present invention, first and second apertures 1204 and 1206 enable respective fluid communication between each of first and second injectors 1201 and 1202 and corresponding first and second coloring material reservoirs 1108 and 1110, which in turn are each in fluid communication with coloring material diffuser 1120. In another embodiment of the present invention, in which at least one of first and second coloring material reservoirs 1108 and 1110 may be obviated, at least one of first and second apertures 1204 and 1206 enables fluid communication directly between respective first and second injectors 1201 and 1202 and coloring material diffuser 1120.

Preferably, a plurality of pairs of apertures 1214 and 1216 are formed on roll liner 1192, and each of pairs of apertures 1214 and 1216 is generally aligned with corresponding ones of apertures 1204 and 1206. It is appreciated that apertures 1204, 1206, 1214 and 1216 may be formed either during respective fabrications of NHRQI sub-assembly 1102 and roll liner 1192, or as part of the supply of first and second QPRCMs 1140 and 1142 to NHRQI sub-assembly 1102. Alternatively, some of apertures 1204, 1206, 1214 and 1216 may be formed during a respective fabrication of NHRQI sub-assembly 1102 and roll liner 1192, and the others of plurality of apertures 1204, 1206, 1214 and 1216 may be formed as part of the supply of first and second QPRCMs 1140 and 1142 to NHRQI sub-assembly 1102. Typically, in an embodiment wherein at least one of plurality of apertures 1204, 1206, 1214 and 1216 is formed as part of the supply of first and second QPRCMs 1140 and 1142 to NHRQI sub-assembly 1102, the at least one of plurality of apertures 1204, 1206, 1214 and 1216 is formed by corresponding injector 1201 or 1202.

As described above, in the embodiment illustrated in FIGS. 11 and 12B, first and second QPRCMs 1140 and 1142 are supplied to NHRQI sub-assembly 1102 via respective first and second apertures 1204 and 1206 shown on back portion 1194 of NHRQI sub-assembly 1102 prior to, preferably immediately prior to, associating HRQI assembly 1100 with container 1190. In an alternative embodiment of the present invention, at least one of first and second QPRCMs 1140 and 1142 are supplied to NHRQI sub-assembly 1102 after associating NHRQI sub-assembly 1102 with container 1190. In an embodiment wherein the supply of at least one of first and second QPRCMs 1140 and 1142 to NHRQI sub-assembly 1102 occurs after associating NHRQI sub-assembly 1102 with container 1190, coloring material supplier 1198 and at least one of apertures 1214 and 1216 may be obviated, and at least one of apertures 1204 and 1206 may be obviated or located elsewhere on NHRQI sub-assembly 1102.

In an embodiment wherein at least one of first and second QPRCMs 1140 and 1142 is supplied to NHRQI sub-assembly 1102 following the association of NHRQI sub-assembly 1102 with container 1190, for example, an injector may supply at least one of first and second QPRCMs 1140 and 1142 to NHRQI sub-assembly 1102 through at least one aperture formed in a front surface or a side surface of NHRQI sub-assembly 1102.

In a preferred embodiment of the present invention, HRQI assembly 1100 also includes explanatory features, such as text and/or graphics, explaining at least one visible appearance of transparent area 1178. For example, in the illustrated embodiment, HRQI assembly 1100 includes a message 1228, with the text “DISCARD IF DARKENED→”, adjacent to transparent area 1178.

Turning now particularly to FIG. 12C, it is seen that immediately following a supply of first and second QPRCMs 1140 and 1142 to NHRQI sub-assembly 1102, portions 1180 and 1181 of coloring material diffuser 1120 preferably become colored with first QPRCM 1140 and second QPRCM 1142, respectively, and thus the color visible through each of transparent areas 1170 and 1171 is determined by the color of first QPRCM 1140 and second QPRCM 1142, respectively. In the example shown in FIGS. 11-12D, as seen particularly in FIG. 12C, immediately following a supply of first and second QPRCMs 1140 and 1142 to NHRQI sub-assembly 1102, transparent areas 1170 and 1171 both show a black color, and HRQI assembly 1100 thus preferably assumes post-supply visible state II immediately following a supply of first and second QPRCMs 1140 and 1142 to NHRQI sub-assembly 1102.

It is appreciated that the coloring of portions 1180 and 1181 by first and second QPRCMs 1140 and 1142, respectively, and thus the changing of the color visible through transparent areas 1170 and 1171, changes an appearance of HRQI assembly 1100, and more particularly, changes an appearance of barcode 1160 and of barcode 1162. It is appreciated that if only one of first QPRCM 1140 and second QPRCM 1142 is provided to HRQI assembly 1100, then only one of portions 1180 and 1181 becomes colored, and HRQI assembly 1100 assumes a state in which it does not display any machine-readable barcodes. As described hereinbelow, a state in which HRQI assembly 1100 does not display any machine-readable barcodes preferably provides an indication that HRQI assembly 1100 is not fit for use and should not be associated with container 1190.

In another embodiment of the present invention (not shown), separate visible states are provided for each of first and second QPRCMs 1140 and 1142. In such an embodiment, HRQI assembly 1100 preferably assumes a first post-supply visible state following a supply of first QPRCM 1140 and a second post-supply visible state following a supply of second QPRCM 1142.

In post-supply visible state II, transparent areas 1170 and 1171 each show a color similar to the color of bars of barcodes 1158, while transparent areas 1172, 1174, 1176 and 1178 remain uncolored. Therefore, barcodes 1160, 1164, 1166 and 1168 are preferably unreadable by a conventional barcode reader, such as barcode reader 113, mobile communicator 132 or mobile communicator 142 of FIGS. 1A-1E, and only barcode 1162 is readable by a conventional barcode reader. Thus, HRQI assembly 1100 in post-supply visible state II presents a single machine-readable barcode typically readable by a conventional barcode reader, here exemplified as barcode 1162 having numerical sequence 7290003804108.

Additionally, at post-supply visible state II, HRQI assembly 1100 has preferably not been exposed to a temperature less than the lower temperature threshold for at least the under-temperature time duration. Therefore, cold responsive coloring material 1154 is preferably characterized by the first color thereof, for example colorless and transparent, such that area 1152 provides an indication that a temperature of NHRQI sub-assembly 1102, and thus a temperature of HRQI assembly 1100, has not fallen below the lower temperature threshold.

It is appreciated that once HQRI assembly 1100 assumes visible state II, HRQI assembly 1100 preferably cannot thereafter revert to visible state I.

Preferably, each of first and second QPRCMs 1140 and 1142 is supplied in a flowable state, as indicated by waved lines in FIGS. 12B & 12C, to NHRQI sub-assembly 1102. In order to maintain a flowable state thereof, first QPRCM 1140 is typically supplied to NHRQI sub-assembly 1102 at a temperature exceeding the first upper temperature threshold, and second QPRCM 1142 is typically supplied to NHRQI sub-assembly 1102 at a temperature exceeding the second upper temperature threshold. However, as seen particularly in enlargement circle B of FIG. 11 and in FIG. 12D, following supply of first and second QPRCMs 1140 and 1142 to NHRQI sub-assembly 1102, HRQI assembly 1100 is cooled to, and maintained at, a temperature which does not exceed either the first or second upper temperature thresholds, such that both first and second QPRCMs 1140 are not flowable, as indicated by interlocking lines in enlargement circle B of FIG. 11 and in FIG. 12D.

In one embodiment of the present invention, HRCMS 1090 includes at least one cooling system 1230. Preferably, following a supply of first and second QPRCMs 1140 and 1142 to NHRQI sub-assembly 1102, HRQI assembly 1100 is brought into thermal contact with cooling system 1230, thereby rapidly reducing the temperature of HRQI assembly 1100 to a temperature below both the first and second upper temperature thresholds, so that first and second QPRCMs 1140 and 1142 are no longer flowable. It is appreciated that cooling system 1230 preferably does not cool HRQI assembly 1100 to a temperature below the lower temperature threshold, and thus cold responsive coloring material 1154 does not change color in response to temperature conditions within cooling system 1230.

In another embodiment of the present invention, cooling system 1230 may be obviated, and following the supply of first and second QPRCMs 1140 and 1142 to NHRQI sub-assembly 1102, HRQI assembly 1100 may be cooled to a temperature below the first and second upper temperature thresholds, such that first and second QPRCMs 1140 and 1142 are no longer flowable, after being associated with container 1190. In this embodiment, cooling of HRQI assembly 1100 is preferably effected by thermal contact with container 1190 which, at the time of the association of HRQI assembly 1100 therewith, is at a temperature below the first and second upper temperature thresholds. Alternatively, HRQI assembly 1100 may be cooled by placing HQRI assembly 1100 and the associated container 1190 in a cold storage environment, such as a refrigerator. It is appreciated that the temperature of HQRI assembly 1100 and associated container 1190 is preferably not less than the lower temperature threshold, and thus cold responsive coloring material 1154 does not change color in response to temperature conditions of container 1190 at the time of association of HQRI assembly 1100 with container 1190.

As described hereinabove with reference to FIGS. 1A-1E, NHRQI sub-assembly 1102 is preferably embodied as a self-adhesive label, and the association of HRQI assembly 1100 with container 1190 is preferably embodied as an affixation of HRQI assembly 1100 to container 1190, and more particularly as an adherence of HRQI assembly 1100 to container 1190. It is noted that the adhesive on the rear side of back portion 1194 of HRQI assembly 1100 preferably serves to affix HRQI assembly 1100 to container 1190, and that the adhesion of HRQI assembly 1100 to container 1190 preferably serves to seal apertures 1204 and 1206, preventing an egress of first and second QPRCMs 1140 and 1142 therefrom.

It is appreciated that in an embodiment wherein first and second QPRCMs 1140 and 1142 are supplied to NHRQI sub-assembly 1102 after associating NHRQI sub-assembly 1102 with container 1190, cooling system 1230 is typically not included in HRCMS 1090. Instead, HRQI assembly 1100 is cooled only after being associated with container 1190. Similarly, in such an embodiment, if an aperture is included on a front or a side surface of NHRQI sub-assembly 1102, the aperture may be sealed with a suitable sealant, preventing an egress of first and second QPRCMs 1140 and 1142 therefrom.

As illustrated in FIGS. 12A & 12B, in one embodiment of the present invention, NHRQI sub-assembly 1102 is not yet associated with container 1190. Similarly, as illustrated in FIG. 12C, immediately after the supply of first and second QPRCMs 1140 and 1142 to HRQI assembly 1100, HRQI assembly 1100 is preferably still not associated with container 1190.

As illustrated in FIG. 11, in one embodiment of the present invention, HRQI assembly 1100 is cooled to a temperature below the first and second upper temperature thresholds before being associated with container 1190, preferably by cooling system 1230. In an alternative embodiment, HRQI assembly 1100 may be cooled by placing HQRI assembly 1100 and associated container 1190 in a cold storage environment, such as a refrigerator. Thus, the lowering of the temperatures of first and second QPRCMs 1140 and 1142 and the association of HRQI assembly 1100 with container 1190 are separate steps.

However, in another embodiment of the present invention, as illustrated in FIG. 12D, HRQI assembly 1100 is cooled to a temperature below the first and second upper temperature thresholds only after being associated with container 1190. As described hereinabove, in this embodiment, cooling of HRQI assembly 1100 is preferably effected by thermal contact with container 1190 which, at the time of the association of HRQI assembly 1100 therewith, is at a temperature below the first and second upper temperature thresholds. Thus, the lowering of the temperatures of first and second QPRCMs 1140 and 1142 and the association of HRQI assembly 1100 with container 1190 are achieved in a single step.

In a preferred embodiment of the present invention, HRCMS 1090 further includes a barcode reader 1240, which preferably reads barcodes 1158 substantially immediately prior to an association of HRQI assembly 1100 or NHQRI sub-assembly 1102 with container 1190. Barcode reader 1240, upon reading barcodes 1158, preferably provides information to a quality indication computer, such as quality indication computer 115, which enables the quality indication computer to provide an immediate indication of a quality status of the HRQI assembly 1100 or NHQRI sub-assembly 1102 read by barcode reader 1240.

If barcode reader 1240 provides an indication that HRQI assembly 1100, or, in an undesirable case wherein one or both of first and second QPRCMs 1140 and 1142 were not supplied to NHRQI sub-assembly 1102, NHRQI sub-assembly 1102, is unfit for use, then the HRQI assembly 1100 or NHRQI sub-assembly 1102 is preferably discarded and is not associated with a container 1190. Examples of an HRQI assembly 1100 or NHRQI sub-assembly 1102 that is unfit for use include an HRQI assembly 1100 or NHRQI sub-assembly 1102 that is in pre-supply visible state I, that is in visible state V, or that is unreadable by a typical barcode reader, for example, due to damage to barcodes 1158 or to a supply of only one of QPRCMs 1140 and 1142.

In another preferred embodiment of the present invention (not shown) barcode reader 1240 is obviated, and is replaced with a conventional barcode reader, such as barcode reader 113, mobile communicator 132 or mobile communicator 142 of FIGS. 1A-1E, which is not part of HRCMS 1090.

In a preferred embodiment of the present invention, HRCMS 1090 further includes a container association module 1260. If an indication is provided, for example by barcode reader 1240 or barcode reader 113, that an HRQI assembly 1100 is fit for use, then container association module 1260 preferably associates that HRQI assembly 1100 with a container 1190. In a preferred embodiment of the present invention, container association module 1260 positions HRQI assembly 1100 relative to container 1190 such that the adhesive on the rear side of HRQI assembly 1100 contacts container 1190, thereby affixing HRQI assembly 1100 to container 1190.

In the embodiment illustrated in FIG. 11, barcode reader 1240 is shown as being part of container association module 1260. Alternatively, barcode reader 1240 may be separate from container association module 1260.

Reference is now made to FIGS. 13A-13F, which are simplified illustrations of typical operative use cases of HRQI assembly 1100.

It is appreciated that in the operative states shown in FIGS. 13A-13E, HRQI assembly 1100 has not been exposed to a temperature below the lower temperature threshold for at least the under-temperature time duration. Therefore, cold responsive coloring material 1154 is preferably characterized by the first color thereof, for example colorless and transparent.

It is further appreciated that although, for ease of understanding, dotted lines in FIGS. 13A-13F indicate each of transparent areas 1148 and portions 1180, 1181, 1182, 1184 and 1186, preferably transparent areas 1148 and portions 1180, 1181, 1182, 1184 and 1186 are not readily distinguishable from surrounding areas of indicator template 1112 and coloring material diffuser 1120, respectively. Similarly, for ease of understanding, dashed lines in FIGS. 13A-13F indicate area 1152 and transparent area 1178; however, area 1152 and transparent area 1178 may not be readily distinguishable from surrounding areas of indicator template 1112.

Following the supply of first and second QPRCMs 1140 and 1142 to NHRQI sub-assembly 1102, and when a temperature of HRQI assembly 1100 exceeds the first upper temperature threshold, first QPRCM 1140 assumes a flowable state, as indicated by waved lines in FIG. 13A. In an embodiment wherein HRQI assembly 1100 includes first coloring material reservoir 1108, upon assuming a flowable state, first QPRCM 1140 is released from first coloring material reservoir 1108 and begins to diffuse through coloring material diffuser 1120. In an embodiment wherein HRQI assembly 1100 does not include first coloring material reservoir 1108, upon assuming a flowable state, first QPRCM 1140 begins to diffuse through coloring material diffuser 1120.

It is appreciated that respective first, second and third over-temperature cumulative time durations from the start of diffusion of first QPRCM 1140 along coloring material diffuser 1120 until respective portions 1182, 1184 and 1186 of coloring material diffuser 1120 become colored is defined, for example, by a length of coloring material diffuser 1120 between portion 1180 and each of portions 1182, 1184 and 1186. Additionally, these time durations are typically a function of a composition of first QPRCM 1140, as well as a function of a material from which coloring material diffuser 1120 is made and a thickness thereof.

Similarly, an additional over-temperature cumulative time duration from the start of diffusion of second QPRCM 1142 along coloring material diffuser 1120 until portion 1186 of coloring material diffuser 1120 becomes colored is defined, for example, by a length of coloring material diffuser 1120 between portion 1181 and portion 1186. Additionally, this time duration is typically a function of a composition of second QPRCM 1142, as well as a function of a material from which coloring material diffuser 1120 is made and a thickness thereof.

It is noted that preferably, the first, second and third over-temperature cumulative time duration provide indications of times spent above a first temperature threshold, while the additional over-temperature cumulative time duration provides an indication of a time spent above a second temperature threshold, where the first temperature threshold and the second temperature thresholds are characterized by different temperatures. Thus, as used herein, “additional over-temperature cumulative time duration” typically provides an indication of exceedance of a different temperature than an indication of exceedance of a temperature indicated by the “first over-temperature cumulative time duration,” the “second over-temperature cumulative time duration” and the “third over-temperature cumulative time duration.” It is further appreciated that HRQI 1100 may include any suitable number of transparent areas, placed to allow indications of any suitable number of time durations spent either above the first or second temperature thresholds.

In one example, which should not be construed to be limiting, properties of first QPRCM 1140, coloring material diffuser 1120, and transparent areas 1172 and 1174, such as composition and position thereof, are chosen such that that the respective first and second over-temperature cumulative time durations from the start of diffusion of first QPRCM 1140 along coloring material diffuser 1120 until first QPRCM 1140 colors portions 1182 and 1184 coloring material diffuser 1120, which are visible through respective transparent areas 1172 and 1174, are one hour and two hours, respectively. Additionally, in this example, properties of transparent area 1176, such as position thereof, are chosen such that that the third over-temperature cumulative time duration from the start of diffusion of first QPRCM 1140 along coloring material diffuser 1120 until first QPRCM 1140 colors portion 1186 of coloring material diffuser 1120, which is visible through respective transparent areas 1176 and 1178, is four hours. Similarly, for example, properties of second QPRCM 1142, coloring material diffuser 1120, and transparent areas 1176 and 1178, such as composition and position thereof, are chosen such that that the additional over-temperature cumulative time duration from the start of diffusion of second QPRCM 1142 along coloring material diffuser 1120 until second QPRCM 1142 colors portion 1186 of coloring material diffuser 1120, which is visible through transparent areas 1176 and 1178, is 30 minutes.

However, it is appreciated that properties of first QPRCM 1140 and coloring material diffuser 1120, as well as locations of transparent areas 1172, 1174, 1176 and 1178, may be chosen such that each of the first, second and third over-temperature cumulative time durations, from the start of diffusion of first QPRCM 1140 along coloring material diffuser 1120 until first QPRCM 1140 colors portions 1182, 1184 and 1186 of coloring material diffuser 1120, may be any suitable respective time duration. Similarly, properties of second QPRCM 1142 and coloring material diffuser 1120, as well as location of transparent areas 1176 and 1178, may be chosen such that the additional over-temperature cumulative time duration, from the start of diffusion of second QPRCM 1142 along coloring material diffuser 1120 until second QPRCM 1142 colors portion 1186 of coloring material diffuser 1120, may be any suitable time duration.

As discussed hereinabove, product quality is often sensitive to different temperatures to varying extents. Specifically, a slightly elevated temperature may degrade the quality of a product more slowly than an extremely elevated temperature.

For example, if a vial of vaccine whose recommended storage temperature, in order to maintain the quality thereof, is 2 degrees Celsius, an exposure of the vial to a temperature of 8 degrees Celsius may only render the vial of vaccine unfit for use after a cumulative exposure of 4 hours. However, an exposure of the vial to a temperature of 30 degrees Celsius may cause the quality of the vaccine to reach an unusable state after a cumulative exposure of only 30 minutes. Additionally, even a very short exposure, such as an exposure of 2 seconds, of the vial to a temperature of 0 degrees Celsius, may cause the quality of the vaccine to reach an unusable state.

Typically, the first, second and third over-temperature cumulative time durations, the additional over-temperature cumulative time duration, as well as the first upper temperature threshold, second upper temperature threshold and lower temperature threshold, are chosen based on the requirements of contents of container 1190. For example, an HRQI assembly 1100 for association with a flu vaccine may have a lower temperature limit of 2 degrees Celsius, while an HRQI assembly 1100 for association with a COVID-19 vaccine may have a lower temperature limit of −70 degrees Celsius. Similarly, an HRQI assembly 1100 for association with a package of frozen meat may have respective first, second and third over-temperature cumulative time durations of one hour, two hours and four hours for a first upper temperature limit of 8 degrees Celsius, and an additional over-temperature cumulative time duration of 30 minutes for a second upper temperature limit of 30 degrees Celsius, while an HRQI assembly 1100 for association with a package of fresh meat may have respective first, second and third over-temperature cumulative time durations of 30 minutes, 45 minutes and one hour for a first upper temperature limit of 10 degrees Celsius, and an additional over-temperature cumulative time duration of 15 minutes for a second upper temperature limit of 30 degrees Celsius.

Turning particularly to FIG. 13A, it is seen that when a temperature of container 1190, and of HRQI assembly 1100 associated therewith, exceeds the first upper temperature threshold, but not the second upper temperature threshold, for less than the first over-temperature cumulative time duration, first QPRCM 1140 begins to diffuse through coloring material diffuser 1120 beyond portion 1180 in a direction toward portion 1182, while second QPRCM 1142 remains in a non-flowable state. However, as long as a temperature of container 1190 and of HRQI assembly 1100 associated therewith does not exceed the first upper temperature threshold for at least the first over-temperature cumulative time duration, first QPRCM 1140 preferably does not color portion 1182.

Thus, as long as a temperature of container 1190 and of HRQI assembly 1100 associated therewith does not exceed the first upper temperature threshold for at least the first over-temperature cumulative time duration, and does not exceed the second upper temperature threshold for the additional over-temperature cumulative time duration, none of portions 1182, 1184 and 1186 become colored, and thus none of transparent areas 1172, 1174, 1176 and 1178 appear colored, and HRQI assembly 1100 remains in visible state II, in which preferably only barcode 1162 is in a readable state.

In contrast, as seen particularly to FIG. 13B, when a temperature of container 1190 and of HRQI assembly 1100 associated therewith exceeds the first upper temperature threshold, but not the second upper temperature threshold, for at least the first over-temperature cumulative time duration, first QPRCM 1140 diffuses through portions of coloring material diffuser 1120, including portion 1182, while second QPRCM 1142 remains in a non-flowable state.

Thus, when a temperature of container 1190 and of HRQI assembly 1100 associated therewith exceeds the first upper temperature threshold, but not the second upper temperature threshold, for at least the first over-temperature cumulative time duration, the color visible through transparent area 1172 is determined by the color of first QPRCM 1140. As seen particularly in FIG. 13B, upon a coloring of portion 1182 by black QPRCM 1140, transparent area 1172 shows a black color, and HRQI assembly 1100 thus preferably assumes visible state III.

It is appreciated that the coloring of portion 1182 by first QPRCM 1140, and thus the changing of the color visible through transparent area 1172, changes an appearance of HRQI assembly 1100, and more particularly, changes an appearance of barcode 1162 and of barcode 1164.

In visible state III, transparent areas 1170, 1171 and 1172 show a color similar to the color of bars of barcodes 1158, while transparent areas 1174, 1176 and 1178 remain uncolored. Therefore, barcodes 1160, 1162, 1166 and 1168 are preferably unreadable by a conventional barcode reader, while barcode 1164 is readable by a conventional barcode reader. Thus, HRQI assembly 1100 in visible state III presents a single machine-readable barcode typically readable by a conventional barcode reader, here exemplified as barcode 1164 having numerical sequence 7290003804122.

Additionally, in visible state III, HRQI assembly 1100 has preferably not been exposed to a temperature less than the lower temperature threshold for at least the under-temperature time duration. Therefore, cold responsive coloring material 1154 is preferably characterized by the first color thereof, for example colorless and transparent, and area 1152 provides an indication that a temperature of NHRQI sub-assembly 1102, and thus a temperature of HRQI assembly 1100, has not fallen below the lower temperature threshold.

It is appreciated that once HRQI assembly 1100 assumes visible state III, HRQI assembly 1100 preferably cannot thereafter revert to either of states I or II, notwithstanding that the temperature of HRQI assembly 1100 and associated container 1190 subsequently drops below the first upper temperature threshold.

It is additionally appreciated that once having been supplied to NHRQI sub-assembly 1102, first QPRCM 1140 is operative to assume a non-flowable state upon HRQI assembly 1100 being exposed to a temperature below the first upper temperature threshold, regardless of a visible state then displayed by HRQI assembly 1100. Similarly, once having been supplied to NHRQI sub-assembly 1102, first QPRCM 1140 is operative to assume a flowable state upon HRQI assembly 1100 being exposed to a temperature exceeding the first upper temperature threshold, regardless of a visible state then displayed by HRQI assembly 1100.

It is appreciated that once HQRI assembly has assumed visible state III, HRQI assembly 1100 will continue to display visible state III even if the second upper temperature threshold is exceeded and second QPRCM 1142 begins to diffuse beyond portion 1181, as long as the second upper temperature threshold has not been exceeded for the additional over-temperature cumulative time duration and second QPRCM 1142 does not reach portion 1186.

Turning now particularly to FIG. 13C, it is seen that following an elapse of an additional time duration at a temperature exceeding the first upper temperature threshold, such that the total cumulative elapsed time is at least the second over-temperature cumulative time duration, first QPRCM 1140 diffuses further through coloring material diffuser 1120, including through portion 1184.

Thus, when a temperature of container 1190 and of HRQI assembly 1100 associated therewith exceeds the first upper temperature threshold for at least the second over-temperature cumulative time duration, but does not exceed the second upper temperature threshold for at least the additional over-temperature cumulative time duration, the color visible through transparent area 1174 is determined by the color of first QPRCM 1140. As seen particularly in FIG. 13C, upon a coloring of portion 1184 by black first QPRCM 1140, transparent area 1174 shows a black color, and HRQI assembly 1100 thus preferably assumes visible state IIIa.

It is appreciated that the coloring of portion 1184 by first QPRCM 1140, and thus the changing of the color visible through transparent area 1174, changes an appearance of HRQI assembly 1100, and more particularly, changes an appearance of barcode 1164 and of barcode 1166.

In visible state IIIa, transparent areas 1170, 1171, 1172 and 1174 show a color similar to the color of bars of barcodes 1158, while transparent areas 1176 and 1178 remains uncolored. Therefore, barcodes 1160, 1162, 1164 and 1168 are preferably unreadable by a conventional barcode reader, while barcode 1166 is readable by a conventional barcode reader. Thus, HRQI assembly 1100 in visible state IIIa presents a single machine-readable barcode typically readable by a conventional barcode reader, here exemplified as barcode 1166 having numerical sequence 7290003804115.

Additionally, in visible state IIIa, HRQI assembly 1100 has preferably not been exposed to a temperature less than the lower temperature threshold for at least the under-temperature time duration. Therefore, cold responsive coloring material 1154 is preferably characterized by the first color thereof, for example colorless and transparent, and area 1152 provides an indication that a temperature of NHRQI sub-assembly 1102, and thus a temperature of HRQI assembly 1100, has not fallen below the lower temperature threshold.

It is appreciated that once HRQI assembly 1100 assumes visible state IIIa, HRQI assembly 1100 preferably cannot thereafter revert to any of states I, II and III, notwithstanding that the temperature of HRQI assembly 1100 and associated container 1190 subsequently drops below the first upper temperature threshold.

It is appreciated that once HQRI assembly has assumed visible state IIIa, HRQI assembly 1100 will continue to display visible state IIIa even if the second upper temperature threshold is exceeded and second QPRCM 1142 begins to diffuse beyond portion 1181, as long as the second upper temperature threshold has not been exceeded for the additional over-temperature cumulative time duration and second QPRCM 1142 does not reach portion 1186.

Turning now particularly to FIG. 13D, it is seen that following an elapse of an additional time duration at a temperature exceeding the first upper temperature threshold, such that the total cumulative elapsed time is at least the third over-temperature cumulative time duration, first QPRCM 1140 diffuses further through coloring material diffuser 1120, including through portion 1186.

Thus, when a temperature of container 1190 and of HRQI assembly 1100 associated therewith exceeds the first upper temperature threshold for at least the third over-temperature cumulative time duration, the color visible through transparent areas 1176 and 1178 is determined by the color of first QPRCM 1140. As seen particularly in FIG. 13D, upon a coloring of portion 1186 by black first QPRCM 1140, transparent areas 1176 and 1178 each show a black color, and HRQI assembly 1100 thus preferably assumes visible state IV.

It is appreciated that the coloring of portion 1186 by first QPRCM 1140, and thus the changing of the color visible through transparent areas 1176 and 1178, changes an appearance of HRQI assembly 1100, and more particularly, changes an appearance of barcodes 1162, 1164, 1166, barcode 1168, and of the human sensible indicium of transparent area 1178.

In visible state IV each of transparent areas 1170, 1171, 1172, 1174 and 1176 shows a color similar to the color of bars of barcodes 1158. Therefore, barcodes 1160, 1162, 1164 and 1166 are preferably unreadable by a conventional barcode reader, while barcode 1168 is readable by a conventional barcode reader. Thus, upon exposure of container 1190 and of HRQI assembly 1100 associated thereto to a temperature exceeding the first upper temperature threshold for at least the third over-temperature cumulative time duration, HRQI assembly 1100 assumes visible state IV. In visible state IV, HRQI assembly 1100 preferably presents a single machine-readable barcode typically readable by a conventional barcode reader, here exemplified as barcode 1168 having numerical sequence 7290003804139.

Additionally, in visible state IV, transparent area 1178 provides a human sensible indication that a temperature of HRQI assembly 1100 has exceeded either the first upper temperature threshold for the third over-temperature cumulative time duration or the second upper temperature threshold for the additional over-temperature cumulative time duration. As noted above, in a preferred embodiment of the present invention, HRQI assembly 1100 includes explanatory features, such as text and/or graphics, explaining at least one visible appearance of transparent area 1178. For example, in the illustrated embodiment, HRQI assembly 1100 includes message 1228, with the text “DISCARD IF DARKENED→”, adjacent to transparent area 1178.

Thus, message 1228 indicates to a user that if a color visible through transparent area 1178, as determined by a color of portion 1186 of coloring material diffuser 1120, is similar to a background color of indicator template 1112, then a temperature of HRQI assembly 1100 has not exceeded either the first upper temperature threshold for the third over-temperature cumulative time duration or the second upper temperature threshold for the additional over-temperature cumulative time duration. Similarly, message 1228 indicates to a user that if a color visible through transparent area 1178 is not the same as the background color of indicator template 1112, such as the color of first QPRCM 1140 or second QPRCM 1142, then a temperature of HRQI assembly 1100 has exceeded either the first upper temperature threshold for the third over-temperature cumulative time duration or the second upper temperature threshold for the additional over-temperature cumulative time duration, and container 1190 with which HRQI assembly 1100 is associated should be discarded.

In a preferred embodiment of the present invention, as described above, if either one or both of areas 1152 and 1178 indicates an unsuitable environment experienced by HRQI assembly 1100, then the product being monitored by HRQI assembly 1100 is not fit for use. Preferably, information is included with HRQI assembly 1100, either as instructions separate from HRQI assembly 1100 or as instructions forming part of HRQI assembly 1100, indicating to a user and/or a machine reading HRQI assembly 1100 that HRQI assembly 1100 is not fit for use if either one or both of areas 1152 and 1178 indicates that HRQI assembly 1100 has experienced an unsuitable environment for an unsuitable amount of time.

It is appreciated that in the embodiment illustrated in FIGS. 11-13F, transparent area 1178 preferably additionally provides a machine-sensible indication of whether or not a temperature of HRQI assembly 1100 has exceeded either the first upper temperature threshold for the third over-temperature cumulative time duration or the second upper temperature threshold for the additional over-temperature cumulative time duration. Preferably, a system such as a suitably programmed machine vision system is operative to assess a color visible in transparent area 1178 and provide a suitable indication based thereon.

Additionally, in visible state IV, HRQI assembly 1100 has preferably not been exposed to a temperature less than the lower temperature threshold for at least the under-temperature time duration. Therefore, cold responsive coloring material 1154 is preferably characterized by the first color thereof, for example colorless and transparent, and area 1152 provides an indication that a temperature of NHRQI sub-assembly 1102, and thus a temperature of HRQI assembly 1100, has not fallen below the lower temperature threshold.

It is appreciated that once HRQI assembly 1100 assumes visible state IV, HRQI assembly 1100 preferably cannot thereafter assume any of states I, II, III and IIIa, notwithstanding that the temperature of HRQI assembly 1100 and associated container 1190 subsequently drops below the first upper temperature threshold.

Similarly, as seen particularly to FIG. 13E, when a temperature of container 1190, and of HRQI assembly 1100 associated therewith, exceeds the second upper temperature threshold for at least the additional over-temperature cumulative time duration, second QPRCM 1142 diffuses through coloring material diffuser 1120 beyond portion 1181, including through portion 1186.

Thus, the color visible through transparent areas 1176 and 1178 is determined by the color of second QPRCM 1142. In the example shown in FIGS. 13A-13F, as seen particularly in FIG. 13E, upon a coloring of portion 1186 by second QPRCM 1142, transparent areas 1176 and 1178 show a black color, and HRQI assembly 1100 thus preferably assumes visible state IV.

It is appreciated that the coloring of portion 1186 by second QPRCM 1140, and thus the changing of the color visible through transparent areas 1176 and 1178, changes an appearance of HRQI assembly 1100, and more particularly, changes an appearance of barcodes 1162, 1164, 1166 and 1168, and of the human sensible indicium of transparent area 1178.

In visible state IV, each of transparent areas 1170, 1171, 1172, 1174 and 1176 shows a color similar to the color of bars of barcodes 1158. Therefore, barcodes 1160, 1162, 1164 and 1166 are preferably unreadable by a conventional barcode reader, while barcode 1168 is readable by a conventional barcode reader. Thus, upon exposure of container 1190 and of HRQI assembly 1100 associated thereto to a temperature exceeding the second upper temperature threshold for at least the additional over-temperature cumulative time duration, HRQI assembly 1100 assumes visible state IV. As described hereinabove with reference to FIG. 13D, in visible state IV, HRQI assembly 1100 preferably presents a single machine-readable barcode typically readable by a conventional barcode reader, here exemplified as barcode 1168 having numerical sequence 7290003804139.

Additionally, in visible state IV, transparent area 1178 provides a human sensible indication that a temperature of HRQI assembly 1100 has exceeded either the second upper temperature threshold for the additional over-temperature cumulative time duration or the first upper temperature threshold for the third over-temperature cumulative time duration.

Additionally, in visible state IV, HRQI assembly 1100 has preferably not been exposed to a temperature less than the lower temperature threshold for at least the under-temperature time duration. Therefore, cold responsive coloring material 1154 is preferably characterized by the first color thereof, for example colorless and transparent, and area 1152 provides an indication that a temperature of NHRQI sub-assembly 1102, and thus a temperature of HRQI assembly 1100, has not fallen below the lower temperature threshold.

As noted above with reference to FIG. 13D, once HRQI assembly 1100 assumes visible state IV, HRQI assembly 1100 preferably cannot thereafter assume any of states I, II, III and IIIa, notwithstanding that the temperature of HRQI assembly 1100 and associated container 1190 subsequently drops below the second or first upper temperature threshold.

Turning now particularly to FIG. 13F, it is seen that when a temperature of container 1190 and of HRQI assembly 1100 associated therewith falls below the lower temperature threshold for at least the under-temperature time duration, cold responsive coloring material 1154 irreversibly assumes the second color, and HRQI assembly 1100 assumes visible state V.

It is appreciated that the assumption of the second color by cold responsive coloring material 1154 changes an appearance of HRQI assembly 1100, and more particularly, changes an appearance of the human sensible indicium of area 1152. As described hereinabove, cold responsive coloring material 1154 is characterized by the second color thereof, thus providing a human sensible indication that a temperature of NHRQI sub-assembly 1102, and thus a temperature of HRQI assembly 1100, has fallen below the lower temperature threshold for the under-temperature time duration and container 1190 with which HRQI assembly 1100 is associated should be discarded.

It is noted that in the embodiment illustrated in FIGS. 13A-13F, the color assumed by cold responsive coloring material 1154 does not typically affect an appearance or readability of any of barcodes 1160, 1162, 1164, 1166 and 1168. Additionally, in visible state V, transparent areas 1148 may show any color, since, regardless of a color visible through any of transparent areas 1148, the second color of cold responsive coloring material 1154 in area 1152 preferably provides an indication that a temperature of NHRQI sub-assembly 1102, and thus a temperature of HRQI assembly 1100, has fallen below the lower temperature threshold for the under-temperature time duration.

As described hereinabove with reference to FIGS. 11-12D, area 1152 preferably additionally may provide a machine-sensible indication of whether or not a temperature of NHRQI sub-assembly 1102, and thus a temperature of HRQI assembly 1100, has fallen below the lower temperature threshold for the under-temperature time duration. Preferably, a system such as a suitably programmed machine vision system is operative to assess a color visible in area 1152 and provide a suitable indication based thereon. More specifically, in visible state V cold responsive coloring material 1154 is characterized by the second color thereof, which preferably indicates to the suitably programmed machine vision system that a temperature of NHRQI sub-assembly 1102, and thus a temperature of HRQI assembly 1100, has fallen below the lower temperature threshold for the under-temperature time duration.

Thus, upon exposure of container 1190 and of HRQI assembly 1100 associated therewith to a temperature below the lower temperature threshold for at least the under-temperature time duration, HRQI assembly 1100 assumes visible state V, in which a human- and machine-sensible indication is provided that a temperature of NHRQI sub-assembly 1102, and thus a temperature of HRQI assembly 1100, has fallen below the lower temperature threshold for the under-temperature time duration.

It is appreciated that once HRQI assembly 1100 assumes visible state V, HRQI assembly 1100 preferably cannot thereafter revert to any of states I, II, III, IIIa and IV, notwithstanding that the temperature of HRQI assembly 1100 and associated container 1190 subsequently exceeds the lower temperature threshold, or even the first or second upper temperature thresholds.

It is noted that while it is typically undesirable to associate container 1190 to NHRQI sub-assembly 1102 to which first and second QPRCMs 1140 and 1142 have not been supplied, in the illustrated embodiment of the present invention, NHRQI sub-assembly 1102 without one or both of first and second QPRCMs 140 and 1142 may be operative to assume visible state V when a temperature thereof has fallen below the lower temperature threshold for the under-temperature time duration.

Alternatively, HRQI assembly 1100 may include, instead of NHRQI sub-assembly 1102, an initial heat responsive quality indicator (IHRQI) sub-assembly (not shown), similar to NHRQI sub-assembly 1102, including at least one coloring material diffuser, such as a coloring material diffuser 1120 and at least one indicator template, such as an indicator template 1112. In contrast to NHRQI sub-assembly 1102, in this alternative embodiment, the IHRQI sub-assembly also includes at least a first heat responsive coloring material (HRCM), corresponding to second QPRCM 1142, which is flowable at a first temperature exceeding a first upper temperature threshold. It is appreciated that unlike second QPRCM 1142, which is preferably injected into NHRQI sub-assembly 1102, the first HRCM may be supplied to the IHRQI sub-assembly in any suitable manner.

In this embodiment, HRQI assembly 1100 further includes a second HRCM, corresponding to first QPRCM 1140, which, when supplied to the coloring material diffuser of the IHRQI sub-assembly, preferably by injection, preferably converts the IHRQI sub-assembly to HRQI assembly 1100. Thus, in this embodiment, HRQI assembly 1100 is formed by supplying the second HRCM to the IHRQI sub-assembly, preferably by injecting the second HRCM into the IHRQI sub-assembly.

Typically, in this embodiment, the first upper temperature threshold of HRQI 1100 is higher than the second upper temperature threshold of HRQI 1100. For example, the first upper temperature threshold may be 45 degrees Celsius, and the second upper temperature threshold may be 8 degrees Celsius. In contrast to the embodiment shown in FIGS. 11-13F, in this embodiment, the first HRCM is supplied to the IHRQI sub-assembly at the time of manufacture of the IHRQI sub-assembly, because the first upper temperature threshold of the first HRCM is typically a temperature higher than ambient temperatures normally experienced during standard storage, shipping and handling of the IHRQI sub-assembly, and thus maintaining the IHRQI sub-assembly at temperatures below the first upper temperature threshold is typically neither difficult nor expensive. However, since temperatures normally experienced during standard storage, shipping and handling of the IHRQI assembly may often exceed the second upper temperature threshold of the second HRCM, the second HRCM is injected into the IHRQI sub-assembly substantially immediately prior to an association of HRQI assembly 1100 of this embodiment with a container, thereby reducing the effort and cost associated with maintaining the IHRQI sub-assembly at a temperature below the second upper temperature threshold.

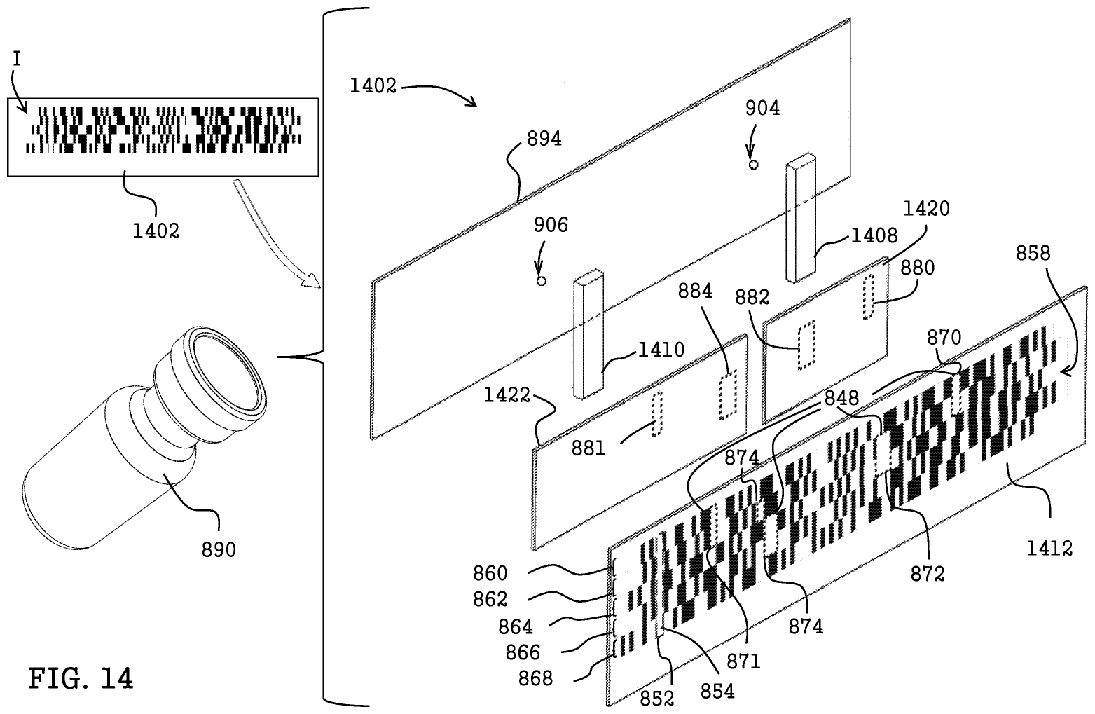

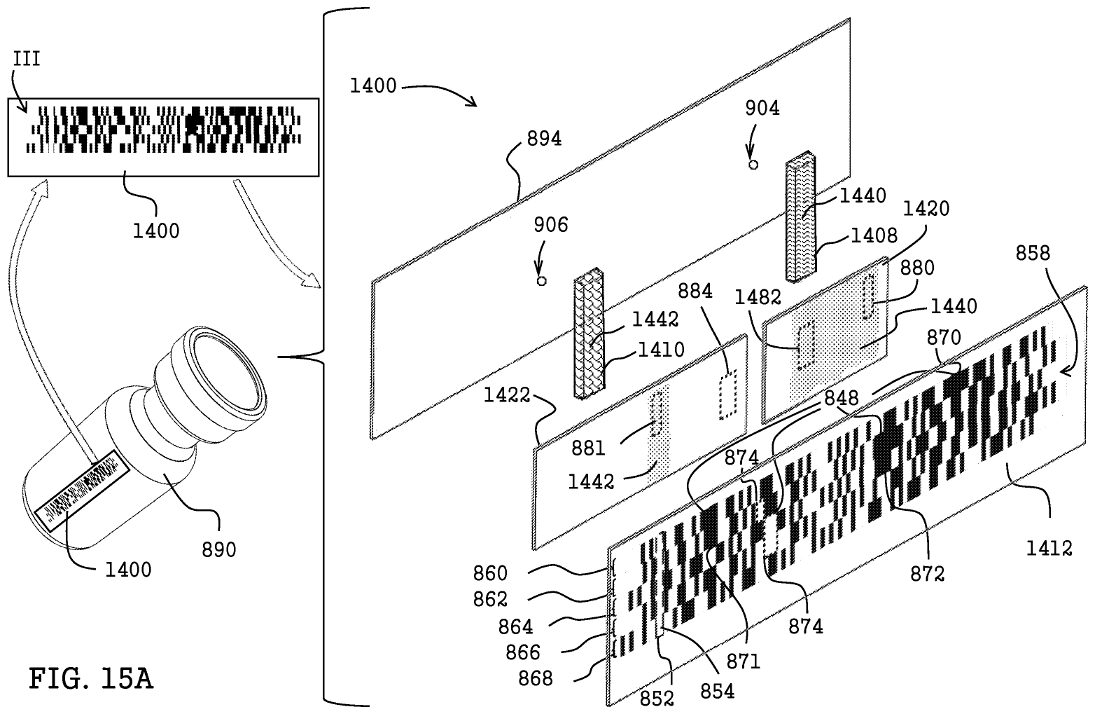

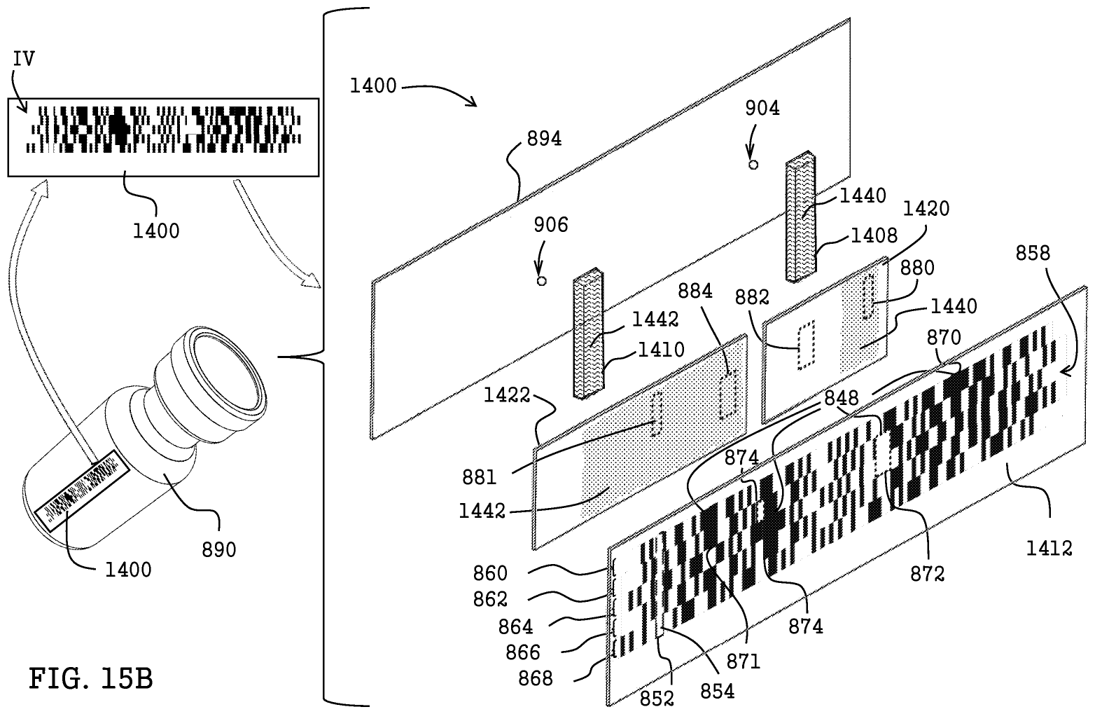

Reference is now made to FIGS. 14, 15A & 15B, of which FIGS. 15A & 15B are simplified illustrations of typical operative use cases of an HRQI assembly 1400 and FIG. 14 is a simplified illustration of a shelf-stable, non-heat responsive quality indicator (NHRQI) sub-assembly 1402 from which HRQI assembly 1400 is constructed. It is appreciated that HRQI assembly 1400 is preferably constructed in a similar manner to HRQI assembly 800, as described hereinabove with reference to FIGS. 8-9D, and features of HRQI assembly 1400 which are the same as corresponding features of HRQI assembly 800 are indicated with corresponding reference numbers.

It is further appreciated that NHRQI sub-assembly 1402 is preferably operative to assume visible state I corresponding to visible state I assumed by NHRQI sub-assembly 802, and HRQI assembly 1400 is preferably operative to assume visible states II, III, IV and V corresponding to the visible states II, III, IV and V which are operative to be assumed by HRQI assembly 800. However, while in the embodiment shown in FIGS. 8-10E of the present invention visible state III assumed by HRQI assembly 800 is preferably associated with only a warning regarding use of a product in container 890, visible state III assumed by HRQI assembly 1400, seen in FIG. 15A, is preferably associated with an indication that container 890 should be discarded. For the sake of conciseness, HRQI assembly 1400 is not illustrated having assumed visible states II or V, although it is noted that HRQI assembly 1400 is preferably operative to assume these states.

As seen in FIGS. 14-15B, HRQI assembly 1400 preferably includes an NHRQI sub-assembly 1402 including at a first coloring material reservoir 1408 and a second coloring material reservoir 1410, at least one indicator template 1412, a first coloring material diffuser 1420 and a second coloring material diffuser 1422. Preferably first coloring material diffuser 1420 is in liquid communication with first coloring material reservoir 1408, and a second coloring material diffuser 1422 is in liquid communication with second coloring material reservoir 1410.

In the illustrated embodiment shown in FIGS. 14-15B, first coloring material reservoir 1408 is supplied with a first quality parameter responsive coloring material (QPRCM) 1440, and second coloring material reservoir 1410 is supplied with a second quality parameter responsive coloring material (QPRCM) 1444. In another embodiment of the present invention, at least one of first and second QPRCMs 1440 and 1442 is supplied directly to the corresponding at least one of first and second coloring material diffusers 1420 and 1422, and the corresponding at least one of first and second coloring material reservoirs 1408 and 1410 may be obviated. In a preferred embodiment of the present invention, each of first and second QPRCMs 1440 and 1442 is an HRCM, which is flowable at a temperature exceeding a first and second upper temperature threshold, respectively, as indicated by waved lines in corresponding figures.

In a preferred embodiment of the present invention, HRQI assembly 1400 is formed by supplying first QPRCM 1440 and second QPRCM 1442 to NHRQI sub-assembly 1402, and more preferably by injecting first QPRCM 1440 and second QPRCM 1442 into NHRQI sub-assembly 1402.

First QPRCM 1440 is characterized by a viscosity and melting point such that first QPRCM 1440 is flowable through or on first coloring material diffuser 1420 at temperatures above a first upper temperature threshold and is not flowable through or on first coloring material diffuser 1420 at temperatures below the first upper temperature threshold. Similarly, second QPRCM 1442 is characterized by a viscosity and melting point such that second QPRCM 1442 is flowable through or on second coloring material diffuser 1422 at temperatures above a second upper temperature threshold and is not flowable through or on second coloring material diffuser 1422 at temperatures below the second upper temperature threshold. Both first QPRCM 1440 and second QPRCM 1442 are preferably characterized by respective colors that are readily distinguishable from a color of each of respective first and second coloring material diffusers 1420 and 1422.

It is appreciated that in the embodiment shown in FIGS. 14-15B, HRQI assembly 1400 includes both first and second coloring material diffusers 1420 and 1422, which are preferably not in liquid communication with one another. Therefore, portion 884 of second coloring material diffuser 1422 is preferably operative to be colored only by second QPRCM 1442, and not by first QPRCM 1440. This is in contrast with the embodiment illustrated in FIGS. 8-10E and described hereinabove, which includes a single coloring material diffuser 820, thereby allowing portion 884 of coloring material diffuser 820 to be colored by either one or both of first and second QPRCMs 840 and 842.

Unlike in the embodiment illustrated in FIGS. 8-10E, in the embodiment illustrated in FIGS. 14-15B, visible state IV can only be assumed when a temperature of container 890 and of HRQI assembly 1400 associated therewith exceeds the second upper temperature threshold for at least the additional over-temperature cumulative time duration, thereby causing portion 884 to become colored by second QPRCM 1442.

Alternatively, HRQI assembly 1400 may include, instead of NHRQI sub-assembly 1402, an initial heat responsive quality indicator (IHRQI) sub-assembly (not shown), similar to NHRQI sub-assembly 1402, including at least a first coloring material diffuser, such as a coloring material diffuser 1422, at least a second coloring material diffuser, such as a coloring material diffuser 1420, and at least one indicator template, such as an indicator template 1412. In contrast to NHRQI sub-assembly 1402, in this alternative embodiment, the IHRQI sub-assembly also includes at least a first heat responsive coloring material (HRCM), corresponding to second QPRCM 1442, which is flowable at a first temperature exceeding a first upper temperature threshold. It is appreciated that unlike second QPRCM 1442, which is preferably injected into NHRQI sub-assembly 1402, the first HRCM may be supplied to the IHRQI sub-assembly in any suitable manner.

In this embodiment, HRQI assembly 1400 further includes a second HRCM, corresponding to first QPRCM 1440, which, when supplied to the coloring material diffuser of the IHRQI sub-assembly, preferably by injection, preferably converts the IHRQI sub-assembly to HRQI assembly 1400. Thus, in this embodiment, HRQI assembly 1400 is formed by supplying the second HRCM to the IHRQI sub-assembly, preferably by injecting the second HRCM into the IHRQI sub-assembly.

Typically, in this embodiment, the first upper temperature threshold of HRQI 1400 is higher than the second upper temperature threshold of HRQI 1400. For example, the first upper temperature threshold may be 45 degrees Celsius, and the second upper temperature threshold may be 8 degrees Celsius. In contrast to the embodiment shown in FIGS. 14-15B, in this embodiment, the first HRCM is supplied to the IHRQI sub-assembly at the time of manufacture of the IHRQI sub-assembly, because the first upper temperature threshold of the first HRCM is typically a temperature higher than ambient temperatures normally experienced during standard storage, shipping and handling of the IHRQI sub-assembly, and thus maintaining the IHRQI sub-assembly at temperatures below the first upper temperature threshold is typically neither difficult nor expensive. However, since temperatures normally experienced during standard storage, shipping and handling of the IHRQI assembly may often exceed the second upper temperature threshold of the second HRCM, the second HRCM is injected into the IHRQI sub-assembly substantially immediately prior to an association of HRQI assembly 1400 of this embodiment with a container, thereby reducing the effort and cost associated with maintaining the IHRQI sub-assembly at a temperature below the second upper temperature threshold.

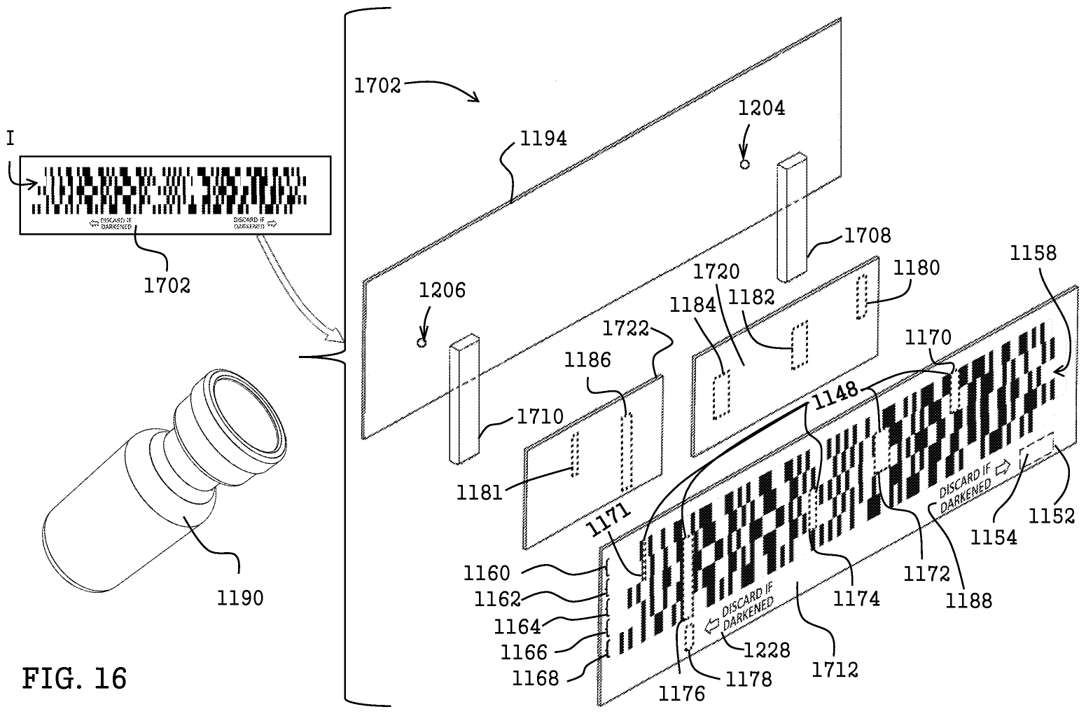

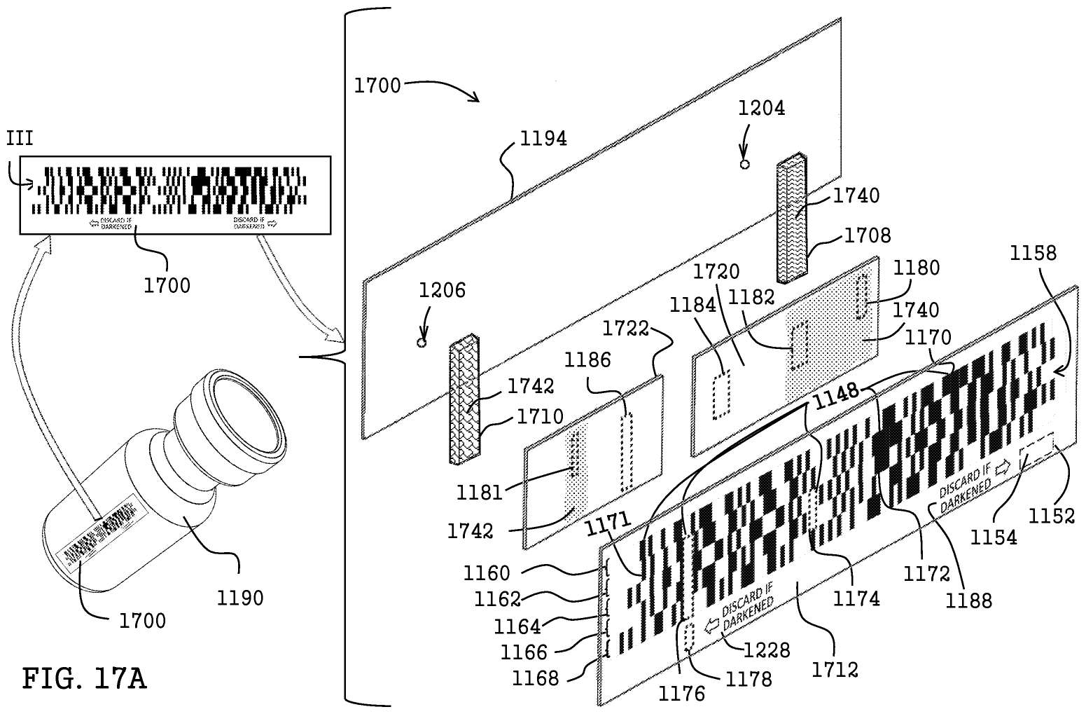

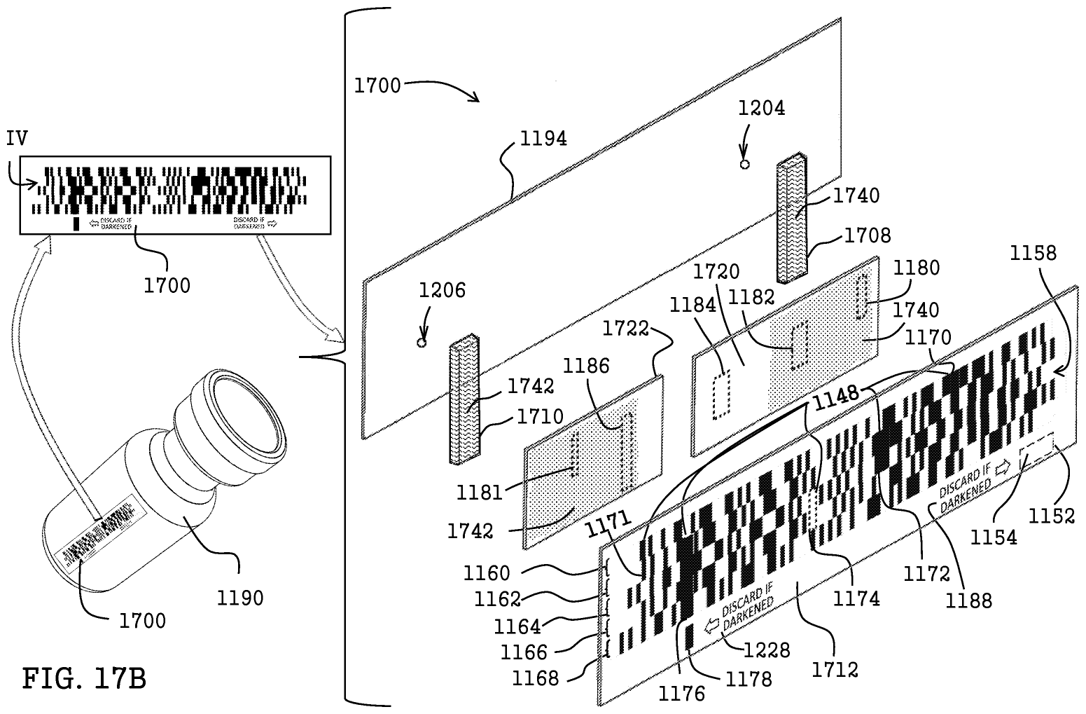

Reference is now made to FIGS. 16, 17A & 17B, of which FIGS. 17A & 17B are simplified illustrations of typical operative use cases of an HRQI assembly 1700 and FIG. 16 is a simplified illustration of a shelf-stable, non-heat responsive quality indicator (NHRQI) sub-assembly 1702 from which HRQI assembly 1700 is constructed. It is appreciated that HRQI assembly 1700 is preferably constructed in a similar manner to HRQI assembly 1100, as described hereinabove with reference to FIGS. 11-12D, and features of HRQI assembly 1700 which are the same as corresponding features of HRQI assembly 1100 are indicated with corresponding reference numbers.

It is further appreciated that NHRQI sub-assembly 1702 is preferably operative to assume visible state I corresponding to visible state I assumed by NHRQI sub-assembly 1102, and HRQI assembly 1700 is preferably operative to assume visible states II, III, IIIa, IV and V, corresponding to the visible states II, III, IIIa, IV and V which are operative to be assumed by HRQI assembly 1100. However, while in the embodiment illustrated in FIGS. 11-13F of the present invention visible state IIIa assumed by HRQI assembly 1100 is preferably associated with only a warning regarding use of a product in container 1190, while the visible state IIIa assumed by HRQI assembly 1700, seen in FIG. 17A, is preferably associated with an indication that container 1190 should be discarded. For the sake of conciseness, HRQI assembly 1700 is not illustrated having assumed any of visible states II, IIIa and V, although it is noted that HRQI assembly 1700 is preferably operative to assume these states.

As seen in FIGS. 16-17B, HRQI assembly 1700 preferably includes an NHRQI sub-assembly 1702 including at a first coloring material reservoir 1708 and a second coloring material reservoir 1710, at least one indicator template 1712, a first coloring material diffuser 1720 and a second coloring material diffuser 1722. Preferably first coloring material diffuser 1720 is in liquid communication with first coloring material reservoir 1708, and a second coloring material diffuser 1722 is in liquid communication with second coloring material reservoir 1710.

In the embodiment illustrated in FIGS. 16-17B, first coloring material reservoir 1708 is supplied with a first quality parameter responsive coloring material (QPRCM) 1740, and in second coloring material reservoir 1710 is supplied with a second quality parameter responsive coloring material (QPRCM) 1742. In another embodiment of the present invention, at least one of first and second QPRCMs 1740 and 1742 is supplied directly to the corresponding at least one of first and second coloring material diffusers 1720 and 1722, and the corresponding at least one of first and second coloring material reservoirs 1708 and 1710 may be obviated. In a preferred embodiment of the present invention, each of first and second QPRCMs 1740 and 1742 is an HRCM, which is flowable at a temperature exceeding a first and second upper temperature threshold, respectively, as indicated by waved lines in corresponding figures.

In a preferred embodiment of the present invention, HRQI assembly 1700 is formed by supplying first QPRCM 1740 and second QPRCM 1742 to NHRQI sub-assembly 1702, and more preferably by injecting first QPRCM 1740 and second QPRCM 1742 into NHRQI sub-assembly 1702.

First QPRCM 1740 is characterized by a viscosity and melting point such that first QPRCM 1740 is flowable through or on first coloring material diffuser 1720 at temperatures above a first upper temperature threshold and is not flowable through or on first coloring material diffuser 1720 at temperatures below the first upper temperature threshold. Similarly, second QPRCM 1742 is characterized by a viscosity and melting point such that second QPRCM 1742 is flowable through or on second coloring material diffuser 1722 at temperatures above a second upper temperature threshold and is not flowable through or on second coloring material diffuser 1722 at temperatures below the second upper temperature threshold. Both first QPRCM 1740 and second QPRCM 1742 are preferably characterized by respective colors that are readily distinguishable from a color of each of respective first and second coloring material diffusers 1720 and 1722.

It is appreciated that in the embodiment shown in FIGS. 16-17B, HRQI assembly 1700 includes both first and second coloring material diffusers 1720 and 1722, which are preferably not in liquid communication with one another. Therefore, portion 1186 of second coloring material diffuser 1722 is preferably operative to be colored only by second QPRCM 1742, and not by first QPRCM 1740. This is in contrast with the embodiment shown in FIGS. 11-13F and described hereinabove, which includes a single coloring material diffuser 1120, thereby allowing portion 1186 of coloring material diffuser 1120 to be colored by either one or both of first and second QPRCMs 1140 and 1142.

Unlike in the embodiment shown in FIGS. 11-13F, in the embodiment shown in FIGS. 16-17B, visible state IV can only be assumed when a temperature of container 1190 and of HRQI assembly 1700 associated therewith exceeds the second upper temperature threshold for at least the additional over-temperature cumulative time duration, thereby causing portion 1186 to become colored by second QPRCM 1742.

Alternatively, HRQI assembly 1700 may include, instead of NHRQI sub-assembly 1702, an initial heat responsive quality indicator (IHRQI) sub-assembly (not shown), similar to NHRQI sub-assembly 1702, including at least a first coloring material diffuser, such as a coloring material diffuser 1722, at least a second coloring material diffuser, such as a coloring material diffuser 1720, and at least one indicator template, such as an indicator template 1712. In contrast to NHRQI sub-assembly 1702, in this alternative embodiment, the IHRQI sub-assembly also includes at least a first heat responsive coloring material (HRCM), corresponding to second QPRCM 1742, which is flowable at a first temperature exceeding a first upper temperature threshold. It is appreciated that unlike second QPRCM 1742, which is preferably injected into NHRQI sub-assembly 1702, the first HRCM may be supplied to the IHRQI sub-assembly in any suitable manner.

In this embodiment, HRQI assembly 1700 further includes a second HRCM, corresponding to first QPRCM 1740, which, when supplied to the coloring material diffuser of the IHRQI sub-assembly, preferably by injection, preferably converts the IHRQI sub-assembly to HRQI assembly 1700. Thus, in this embodiment, HRQI assembly 1700 is formed by supplying the second HRCM to the IHRQI sub-assembly, preferably by injecting the second HRCM into the IHRQI sub-assembly.

Typically, in this embodiment, the first upper temperature threshold of HRQI 1700 is higher than the second upper temperature threshold of HRQI 1700. For example, the first upper temperature threshold may be 45 degrees Celsius, and the second upper temperature threshold may be 8 degrees Celsius. In contrast to the embodiment shown in FIGS. 16-17B, in this embodiment, the first HRCM is supplied to the IHRQI sub-assembly at the time of manufacture of the IHRQI sub-assembly, because the first upper temperature threshold of the first HRCM is typically a temperature higher than ambient temperatures normally experienced during standard storage, shipping and handling of the IHRQI sub-assembly, and thus maintaining the IHRQI sub-assembly at temperatures below the first upper temperature threshold is typically neither difficult nor expensive. However, since temperatures normally experienced during standard storage, shipping and handling of the IHRQI assembly may often exceed the second upper temperature threshold of the second HRCM, the second HRCM is injected into the IHRQI sub-assembly substantially immediately prior to an association of HRQI assembly 1700 of this embodiment with a container, thereby reducing the effort and cost associated with maintaining the IHRQI sub-assembly at a temperature below the second upper temperature threshold.

It is noted that some visible states are associated with the terms “first,” “second” and “third” herein. Such ordinal terms are used for convenience only, and do not imply a particular order of assumption of such states. Similarly, such ordinal terms do not imply a dependency between states. Thus, in some embodiments of the present invention an HRQI assembly may be operative to assume, for example, only a second state and not a first state, or only a first and third state, but not a second state.

It is noted that some thresholds are associated with the terms “first,” “second” and “third” herein. Such ordinal terms are used for convenience only, and do not imply a particular order of such thresholds. Similarly, such ordinal terms do not imply any relationship between thresholds.

It is additionally noted that the term “temperature threshold” as used herein may be embodied as a range of temperatures rather than as a single temperature value. For example, the term “upper temperature threshold” as used herein is typically embodied as a range of temperatures. Typically, the upper temperature threshold includes a first temperature value at which the QPRCM changes from a non-flowable state to a flowable state, and a second temperature value, most typically different from the first temperature value, at which the QPRCM changes from a flowable state to a non-flowable state.

It will be appreciated by persons skilled in the art that the present invention is not limited by what has been particularly shown and described hereinabove. Rather the scope of the present invention includes both combinations and sub-combinations of various features of the invention and modifications thereof which may occur to persons skilled in the art upon reading the foregoing description and which are not in the prior art.

1. For use in a quality management system for products:
a multiplicity of heat responsive quality indicator (HRQI) assemblies, each having a plurality of indicator states operative to provide an indication of quality of a product with which the HRQI assembly is associated,
each HRQI assembly comprising:
a shelf-stable, non-heat responsive quality indicator (NHRQI) sub-assembly comprising at least one coloring material diffuser and at least one indicator template; and
at least one heat responsive coloring material (HRCM) which is flowable at a temperature exceeding an upper temperature threshold, and which, when injected into said NHRQI sub-assembly, converts said NHRQI sub-assembly to said HRQI assembly, which is responsive to changes in temperature over time in exceedance of said upper temperature threshold, for changing an appearance of said HRQI assembly.

2. A multiplicity of HRQI assemblies according to claim 1 and wherein said multiplicity of HRQI assemblies are characterized in that said at least one HRCM, once injected into said shelf-stable, NHRQI sub-assembly, is initially maintained under temperature conditions, which are not in exceedance of said upper temperature threshold, such that said at least one HRCM is not flowable.

3. A multiplicity of HRQI assemblies according to claim 1 and wherein said plurality of indicator states comprises:
a pre-supply visible state, indicating that said at least one HRCM has not yet been injected into said NHRQI sub-assembly; and
a post-supply visible state, indicating that said at least one HRCM has been injected into said NHRQI sub-assembly.

4. A multiplicity of HRQI assemblies according to claim 1 and wherein said plurality of indicator states comprises:
at least a first over-temperature visible state, indicating that said at least one HRQI assembly has been exposed to a temperature in exceedance of said upper temperature threshold for at least a first over-temperature cumulative time duration.

5. A multiplicity of HRQI assemblies according to claim 4 and wherein said plurality of indicator states further comprises:
at least a second over-temperature visible state, indicating that said at least one HRQI assembly has been exposed to a temperature in exceedance of said upper temperature threshold for at least a second over-temperature cumulative time duration; and
at least a third over-temperature visible state, indicating that said at least one HRQI assembly has been exposed to a temperature in exceedance of said upper temperature threshold for at least a third over-temperature cumulative time duration.

6. A multiplicity of HRQI assemblies according to claim 1 and wherein said each HRQI assembly further comprises:
a second heat responsive coloring material (HRCM) which is flowable at a second temperature exceeding a second upper temperature threshold.

7. A multiplicity of HRQI assemblies according to claim 1 and wherein said at least one indicator template comprises a multiplicity of machine-readable indicia.

8. (canceled)

9. A multiplicity of HRQI assemblies according to claim 7 and wherein said changing an appearance of said HRQI assembly comprises changing an appearance of at least one of said multiplicity of machine-readable indica.

10. A multiplicity of HRQI assemblies according to claim 7 and wherein a single one of said multiplicity of machine-readable indicia is machine readable at all times.

11. A multiplicity of HRQI assemblies according to claim 1 and wherein said indicator template comprises at least one human sensible indicium.

12. A multiplicity of HRQI assemblies according to claim 1 and wherein:
said HRQI assembly further comprises a cold responsive coloring material; and
said plurality of indicator states comprises at least one under-temperature visible state indicating that said HRQI assembly has been exposed to a temperature below a lower temperature threshold for at least an under-temperature time duration.

13-14. (canceled)

15. A multiplicity of HRQI assemblies according to claim 1 and wherein said NHRQI sub-assembly also comprises an aperture for injecting said HRCM therethrough.

16. A multiplicity of HRQI assemblies according to claim 15, and wherein said aperture is sealed by adhering said HRQI assembly to a container.

17-40. (canceled)

41. A system for manufacture of heat responsive quality indicator (HRQI) assemblies comprising:
a non-heat responsive quality indicator (NHRQI) sub-assembly provider, providing a multiplicity of shelf-stable, NHRQI sub-assemblies, each of said sub-assemblies comprising at least one coloring material diffuser and at least one indicator template; and
a heat responsive coloring material supplier (HRCMS) operative to inject a heat responsive coloring material (HRCM) into each of said multiplicity of shelf-stable, NHRQI sub-assemblies,
said HRCM being flowable at a temperature exceeding an upper temperature threshold, and which, when injected into said NHRQI sub-assembly by said HRCMS, converts said NHRQI sub-assembly to said HRQI assembly, which is responsive to changes in temperature over time in exceedance of said upper temperature threshold and is operative to provide a machine-readable indication of exceedance of at least one threshold, said HRCM for changing an appearance of said HRQI assembly.

42. A system according to claim 41 and wherein said HRCMS also comprises a heating assembly, operative to maintain said HRCM at a temperature at which said HRCM is flowable during said injection thereof into said NHRQI sub-assembly.

43. (canceled)

44. A system according to claim 41 and wherein said HRCM is injected into said NHRQI sub-assembly immediately prior to affixing said HRQI assembly to a product package.

45-57. (canceled)

58. A method of quality management for products comprising:
associating a multiplicity of heat responsive quality indicator (HRQI) assemblies, each of whose appearance is changeable and is operative to provide an indication of exceedance of at least an upper temperature threshold, with a corresponding multiplicity of product packages,
each of said multiplicity of HRQI assemblies comprising:
a shelf-stable, non-heat responsive quality indicator (NHRQI) sub-assembly comprising at least one indicator template; and
a heat responsive coloring material (HRCM) which is flowable at a temperature exceeding said upper temperature threshold, and which, when injected into said NHRQI sub-assembly, converts said NHRQI sub-assembly to said HRQI assembly, which is responsive to changes in temperature over time in exceedance of said upper temperature threshold for changing an appearance of said indicator template;
said associating comprising:
injecting said HRCM into said shelf-stable, NHRQI sub-assembly when said HRCM is in a flowable state;
immediately after said injecting, lowering a temperature of said HRCM to a temperature below said upper temperature threshold, such that said HRCM is not flowable, thereby creating said HRQI assemblies, whose appearance is changeable and is operative to provide an indication of exceedance of said upper temperature threshold; and
affixing said HRQI assembly to a product package.

59-60. (canceled)

61. A method of quality management for products according to claim 58 and wherein said injecting comprises injecting said HRCM into said shelf-stable, NHRQI sub-assembly immediately prior to said affixing.

62-63. (canceled)

64. A method according to claim 58 and wherein:
each of said NHRQI sub-assemblies further comprises an aperture; and
said injecting comprises injecting said HRCM into said NHRQI sub-assembly through said aperture; and
wherein said affixing said HRQI assembly to said product package also comprises sealing said aperture, preventing an egress of said HRCM therefrom.

65-75. (canceled)

76. A method according to claim 58 and wherein:
said HRQI assembly further comprises a cold responsive coloring material; and
said appearance of said HRQI assembly is operative to provide a machine-readable indication that said HRQI assembly has been exposed to a temperature below a lower temperature threshold for at least an under-temperature time duration.

77-109. (canceled)
